(19) United States
(12) Patent Application Publication
(10) Pub. No.: US 2025/0265526 A1
(43) Pub. Date: Aug. 21, 2025

(54) Organizations as Dissipative Structures Utilizing Cooperative Games to Dynamically Align Value, Strategy and Operations within a Probabilistic Framework

(71) Applicant: Value-Driven Strategic Consulting LLC, Salisbury, NC (US)

(72) Inventors: John Lawton Cowan, Salisbury, NC (US); Gerard Vincent Rendell, Salisbury, NC (US)

(21) Appl. No.: 19/000,302

(22) Filed: Dec. 23, 2024

Related U.S. Application Data
(60) Provisional application No. 63/613,269, filed on Dec. 21, 2023.

(51) Int. Cl. G06Q 10/0637; G06Q 10/0631; G06Q 10/0635; G06Q 10/067

(52) U.S. Cl. CPC G06Q 10/0637; G06Q 10/06315; G06Q 10/0635; G06Q 10/067

(57) ABSTRACT

An approach is provided for organizational transformation from a current state to a target state. Common language model(s) can dynamically perform interviews with stakeholders as part of a cooperative game to use disparate stakeholder insights to define the target state, projects, milestones, tasks, and resource use/availability. Lookalike Models can be used to model the organization as a dissipative system and calculate an organizational entropy score. A Markov model identifies possible task completion pathways between current and target state. An optimal project completion path through the Markov model may be identified using Decision Tree Models to identify magnitude of contribution to organizational transformation towards target state for each project and likelihood of successful project completion for each project using Fault Tree Models. Project completion resource allocation plans can be generated based on optimal Markov path. Bayesian Priors can be calculated based on performance measured using micro-behaviors analysis.

### CROSS-REFERENCE TO RELATED APPLICATIONS

The present application claims the benefit of priority under 35 U.S.C. § 120 to U.S. Provisional Application Ser. No. 63/613,269, which was filed on Dec. 21, 2023 and entitled “Organizations as Dissipative Structures Utilizing Cooperative Games to Dynamically Align Value, Strategy and Operations within a Probabilistic Framework,” the entire disclosures of which are hereby incorporated herein by reference in their entireties for all purposes.

### FIELD

Embodiments of the present disclosure generally relate to the field of organizational strategic planning systems and methods and, more particularly, to systems and methods for dynamically aligning value, strategy, and operations for organizations as dissipative structures utilizing cooperative games within a probabilistic framework.

### BACKGROUND

Organizations such as non-profit organizations, for-profit organizations, governmental organizations, and the like, are typically managed and governed in a top-down manner with organizational leader(s) providing leadership and strategy to lower-level personnel and lower-level personnel reporting on organizational performance to organizational leader(s). A current organizational state can be characterized and described for organizations. An organization can establish organizational values and a mission statement that relate to desired organizational inputs and outcomes, desired means and modes for operational management and governance of the organization, and/or the like. How the organization is behaving or performing current with respect to the desired inputs and outcomes, desired means and modes for operational management and governance of the organization, how well the organization uses resources such as labor and materials, and other quantitative and/or qualitative metrics can be used to describe a current organizational state for an organization. However, organizations are always in flux, such that the current organizational state of an organization is typically not static but instead changes over time.

The desired inputs and outcomes, desired means and modes for operational management and governance of the organization, how well the organization uses resources such as labor and materials, and other quantitative and/or qualitative metrics can also be used to describe a target organizational state that the organization would like to transform into or move towards.

As such, there is an ongoing need for robust and dynamic methods and systems for facilitating organizational management and improving organizational strategies in order to achieve a desired organizational transformation from the current organizational state to the target organizational state.

### SUMMARY

An approach is provided for organizational transformation from a current state to a target state. Common language model(s) can dynamically perform interviews with stakeholders as part of a cooperative game to use disparate stakeholder insights to define the target state, projects, milestones, tasks, and resource use/availability. Lookalike Models can be used to model the organization as a dissipative system and calculate an organizational entropy score. A Markov model identifies possible task completion pathways between current and target state. An optimal project completion path through the Markov model may be identified using Decision Tree Models to identify magnitude of contribution to organizational transformation towards target state for each project and likelihood of successful project completion for each project using Fault Tree Models. Project completion resource allocation plans can be generated based on optimal Markov path. Bayesian Priors can be calculated based on performance measured using micro-behaviors analysis.

Some example embodiments of the present disclosure are directed to systems, devices, methods, and computer program products that are configured for evaluating and optimizing organizational strategies for organizations by modeling the organization as a dissipative system subject to increases in entropy, using machine learning and/or artificial intelligence models and programs to dynamically interview organizational stakeholders to gather stakeholder and organizational data, and defining a current organizational state and a target organizational state as well as organizational values and a vision for organizational transformation towards the target state. In some embodiments, the approach can further comprise defining and scoping projects and project tasks for the organization, which may be based upon feedback from stakeholders. In some embodiments, the approach can further comprise generating a Markov Model that illustrates spatially a temporal arrangement of tasks and some or all permutations of project or project task completion pathways through the spatially illustrated temporal arrangement of tasks between the current state and the target state. From among the permutations of project/task completion pathways, an optimal pathway, or optimal Markov path, can be identified based on current organizational information and project status information. A Project Control Plan can be created that includes success/failure criteria for each task and which incorporates one or more of a Fault Tree Model, a Decision Tree Model, Bayesian Priors, and/or the like. For example, in some embodiments the probability of success of each project along the Markov path can be determined, e.g., based on historical organizational performance data and/or similar data associated with an organizational cohort of similar organizations.

In some embodiments, the approach can comprise presenting one or more simulations of a cooperative game that use Intelligent Agency to stakeholders (or ‘players’). In some embodiments, the results of this cooperative game can facilitate determining/estimating a level of stability and a risk of bifurcation of possible outcomes with regard to the Markov path. In some embodiments, by determining/estimating level of stability and the risk of bifurcation of possible outcomes with regard to the Markov path, the described approaches can facilitate self-adaptation by the organization to changing environmental conditions. Further, the cooperative strategic game can be based on delayed and hidden rewards, can incorporate micro-behaviors analysis, and can dynamically change the Project Control Plan and Markov Model/Markov path based upon changing organizational realities. While robust but dynamic strategy formation is typically difficult for organizations, the approaches described herein can lead to reductions in complexity of decision-making and increases in the probability of success of organizational transformation from the current state to the target state.

In some embodiments, a common language model, large language mode, or the like, can be used. In some embodiments, models such as common language models can be constructed and trained/maintained based upon ongoing learning/feedback from the organization and/or individuals in the organization.

In some embodiments, an approach for strategy development and project planning at an organization can incorporate a probabilistic approach as a predictor of project success, and can incorporate the probabilistic outputs into, e.g., a Fault Tree Model used to adjust the Markov Model based upon more realistic expectations of success on a task-by-task basis.

In some embodiments, a Value Attribution Framework approach can be carried out that has a hierarchical approach structure for describing the strategy, operations, and development of solutions for an organization. The Value Attribution Framework can comprise sequential processes and functions that are performed or used for defining an organization's strategy through internal stakeholder and/or customer feedback, for example. In some embodiments, the Value Attribution Framework leverages a Value Attribution Function throughout the hierarchical structure to quantify the benefits and costs of solution development and the organization's operations.

In some embodiments, Value Attribution is a function that considers the proportion of effort to develop a portion of a solution in context of the entire solution's development. This proportion may apply to any level or attribute within a hierarchical system, or framework, of solution development. It may be expressed in value-based terms as a proportion of net benefits associated with a solution's potential impact.

In some embodiments, customer feedback (e.g., narrative customer insights, financial obligations, contract obligations, etc.) can be incorporated into the Value Attribution Framework, and strategy development and project planning can be carried out using the value attribution framework. In some embodiments, micro-behaviors analysis can be carried out using the cooperative game that is played between stakeholders/customers of an organization.

In some embodiments, the effort and cost of improvements can be weighed against the effectiveness of a strategy and operations. From a traceability perspective, the causality of impact of various strategy options or project management decisions can be more clearly attributed across the organizational hierarchy. The effect is that strategy, planning, and execution for an organization are all more tightly bound together and the permeating effects of actual or proposed changes to variables throughout the Value Attribution Framework can be more quickly and clearly identified. For example, a return on investment (ROI) calculation for the organization can be updated to incorporate, e.g., a probabilistic entropy score for the organization.

By integrating, in some embodiments, a Markov Chain Model, Fault-Tree Analysis, Decision-Tree Analysis, and Bayesian Priors, organizational decision-making can be enhanced. Integration of these approaches can improve the quality and ease of performing comprehensive risk assessment, dynamic process modeling, dynamic adaptive strategy planning, and other important organizational management processes. This approach can facilitate a more holistic view of the organization, aid in efficient and effective resource allocation, support strategic flexibility, and enable continuous improvement throughout project/task execution to facilitate informed and resilient operations that react dynamically to changing organizational realities and environments.

In some embodiments, an entropy score can be calculated/estimated for the organization. The entropy score can be updated and measured based upon modified or new information/data related to organizational resource availability, organizational resource use, organizational process changes, organizational performance, the level of alignment to the vision and goals for the organization based on potential most likely/most opportunistic actions, and/or the like.

In some embodiments, a probabilistic approach can be carried out to provide improved measures or predictors of expected feasibility of success, progress, transformation, project completion, or the like. For instance, the entropy score can be used to adjust metrics such as return on investment. In some embodiments, the entropy score can be used to reduce the risk of an organization taking on valueless projects or projects for which the value is overestimated. In this context, value is used to describe whether and the extent to which the successful completion of a project will contribute to positive organizational transformation towards the target state. Entropy score can also be used as a common measure by which organizations can benchmark and calibrate actions, decisions, projects, or work, whether already completed, in progress, scheduled, or merely proposed. In some embodiments, the probabilistic approach to modeling organizational state transformation can be used to limit entropy across the organization. As such, the entropy score can be used as a proxy for the likelihood that the organization will successfully transition from its current state to the target state.

In some embodiments, a root cause analysis (e.g., Ishikawa model) of value, alignment and learning can be added as a powerful tool for the organization to self-assess the impact of current and future actions on alignment of the organization to its strategic goals, at every level in the organizational hierarchy, and for every decision, project, task, and action taken/performed by the organization.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Having thus described the invention in general terms, reference will now be made to the accompanying drawings. The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

Some example embodiments are described with reference to the accompanying drawings, in which:

FIG. 1 shows a flowchart of an example method for modeling interactions between the physical and digital worlds, according to some example embodiments of the present disclosure;

FIG. 2 shows a flowchart of an example method for value-driven strategy modeling and analysis, according to some example embodiments of the present disclosure;

FIG. 3 shows a flowchart of an example method for value attribution framework modeling and analysis, according to some example embodiments of the present disclosure;

FIG. 4 shows a flowchart of an example method for value attribution framework modeling and analysis, according to some example embodiments of the present disclosure;

FIG. 5 shows a flowchart of an example method for performing a needs assessment, according to some example embodiments of the present disclosure;

FIG. 6 shows a flowchart of an example method for gathering or providing individual and organizational information, according to some example embodiments of the present disclosure;

FIG. 7 shows a flowchart of an example method for performing a dynamic vidison interview and dynamic delivery phase interview with one or more organizational stakeholders, according to some example embodiments of the present disclosure;

FIG. 8 shows a flowchart of an example method for performing a dynamic delivery phase goal interview, defining delivery phase success metric definition(s), and defining and/or establishing data sources and data source linkages, according to some example embodiments of the present disclosure;

FIG. 9 shows a flowchart of an example method for establishing project definitions, defining project goal and success metrics, and developing a project control plan, according to some example embodiments of the present disclosure;

FIG. 10 shows a flowchart of an example method for creating a work plan, according to some example embodiments of the present disclosure;

FIG. 11 shows a flowchart of an example method for facilitating and/or tracking execution of projects, tracking project progress using micro-behaviors and/or micro-behaviors analysis, providing feedback and/or notifications regarding micro-behaviors, mitigating risks and issues, tracking or monitoring progress and achievement along an organizational transformation pathway (e.g., Markov pathway), and recalibrating various aspects of the analysis, modeling, and/or feedback/reporting structures or content, according to some example embodiments of the present disclosure;

FIG. 12 shows a flowchart of an example method for calculating or estimating, maintaining, tracking, comparing, scoring, weighting, and/or presenting organizational entropy score(s), according to some example embodiments of the present disclosure;

FIG. 13 shows a flowchart of an example method for Markov modeling and creation of, e.g., an initial Markov pathway between a current organizational state and a target organizational state, according to some example embodiments of the present disclosure;

FIG. 14 shows a flowchart of an example method for modeling an organization as a dissipative structure or dissipative system, and performing analysis therewith, according to some example embodiments of the present disclosure;

FIG. 15 shows a flowchart of an example method for performing Lookalike Model generation, modeling, and analysis, according to some example embodiments of the present disclosure;

FIG. 16 shows a flowchart of an example method for Bayesian Priors modeling and analysis, according to some example embodiments of the present disclosure;

FIG. 17 shows a flowchart of an example method for Scenario Planning modeling and analysis, according to some example embodiments of the present disclosure;

FIG. 18 shows a flowchart of an example method for Fault-Tree modeling and Fault-Tree Analysis, according to some example embodiments of the present disclosure;

FIG. 19 shows a flowchart of an example method for Decision-Tree modeling and Decision-Tree Analysis, according to some example embodiments of the present disclosure;

FIG. 20 shows a flowchart of an example method for creating, training, updating, using, and/or performing analysis with, e.g., a Common Language Model or a Large Language Model, according to some example embodiments of the present disclosure;

FIG. 21 shows a flowchart of an example method for Materials Cost Structure modeling and analysis, according to some example embodiments of the present disclosure;

FIG. 22 shows a flowchart of an example method for Labor Cost Structure modeling and analysis, according to some example embodiments of the present disclosure;

FIG. 23 shows a flowchart of an example method for modeling timeliness performance and/or capability performance for the organization and performing analysis using the resulting Timeliness Performance Model(s) and/or Capability Performance Model(s), according to some example embodiments of the present disclosure;

FIG. 24 shows a flowchart of an example method for Cost Attribution Logic modeling and analysis, according to some example embodiments of the present disclosure;

FIG. 25 shows a flowchart of an example method for Benefit Attribution Logic modeling and analysis, according to some example embodiments of the present disclosure;

FIG. 26 shows a flowchart of an example method for creating, training, maintaining, and performing modeling and analysis using a Markov Model, such as a Simple Markov Model, according to some example embodiments of the present disclosure;

FIG. 27 shows a flowchart of an example method for creating, training, maintaining, and performing modeling and analysis using Fault-Tree Analysis and a model or algorithm therefore, such as using Simple Fault-Tree Analysis, according to some example embodiments of the present disclosure;

FIG. 28 shows a flowchart of an example method for creating, training, maintaining, and performing modeling and analysis using one or more Markov Models in combination with Fault-Tree Analysis, according to some example embodiments of the present disclosure;

FIG. 29 shows a flowchart of an example method for creating, training, maintaining, and performing modeling and Decision-Tree Analysis, such as Simple Decision-Tree Analysis, according to some example embodiments of the present disclosure;

FIG. 30 shows a flowchart of an example method for creating, training, maintaining, and performing Markov Modeling with Fault-Tree Analysis and Decision-Tree Analysis, according to some example embodiments of the present disclosure;

FIG. 31 shows a flowchart of an example method for Scenario Planning modeling and analysis, according to some example embodiments of the present disclosure;

FIG. 32 shows a flowchart of an example method for visualization of inputs and/or outputs from organizational modeling and analysis, according to some example embodiments of the present disclosure;

FIG. 33 shows a flowchart of an example method for creating, training, maintaining, and performing modeling and analysis using one or more Lookalike Models, according to some example embodiments of the present disclosure;

FIG. 34 shows a flowchart of an example method for creating, training, maintaining, and performing modeling of an organization as a dissipative structure and performing analysis using such models, according to some example embodiments of the present disclosure;

FIG. 35 shows a flowchart of an example method for creating, training, maintaining, and performing modeling and analysis using Value Attribution Framework Ishikawa Model(s), according to some example embodiments of the present disclosure;

FIG. 36 shows a flowchart of an example method for performing Benefit Attribution Logic modeling and analysis, according to some example embodiments of the present disclosure;

FIG. 37 shows a flowchart of an example method for performing Value Attribution Logic modeling and analysis, according to some example embodiments of the present disclosure;

FIG. 38 shows a flowchart of an example method for performing Return on Investment Logic modeling and analysis, according to some example embodiments of the present disclosure;

FIG. 39 shows a flowchart of an example method for performing Effort Contribution Logic modeling and analysis, according to some example embodiments of the present disclosure;

FIG. 40 shows a flowchart of an example method for performing Cost Attribution Logic modeling and analysis, according to some example embodiments of the present disclosure;

FIG. 41 illustrates a schematic of an example computing device according to any of the approaches or methods of the present disclosure;

FIG. 42 is a block flow diagram of an example method, in accordance with an embodiment disclosed herein;

FIG. 43 is a block flow diagram of an example method, in accordance with an embodiment disclosed herein;

FIG. 44 is a block flow diagram of an example method, in accordance with an embodiment disclosed herein; and

FIG. 45 is a block flow diagram of an example method, in accordance with an embodiment disclosed herein.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “circuitry” may refer to one or more or all of the following:
(a) hardware-only circuit implementations (such as implementations in only analog and/or digital circuitry); and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “instructions,” “file,” “designs,” “data,” “content,” “information,” and similar terms may be used interchangeably, according to some example embodiments described herein, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the other computing device or may be received indirectly via one or more computing devices, such as, for example, one or more servers, relays, routers, network access points, base stations, and/or the like.

As used herein, the term “computer-readable medium” refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, and infrared waves. Signals include man-made transient variations in amplitude, frequency, phase, polarization, or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term “circuitry” refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory(ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present. This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

As used herein, the term “computing device” refers to a specialized, centralized device, network, or system, comprising at least a processor and a memory device including computer program code, and configured to provide guidance or direction related to the charge transactions carried out in one or more charging networks.

As used herein, the terms “about,” “substantially,” and “approximately” generally mean plus or minus 10% of the value stated, e.g., about 250 μm would include 225 μm to 275 μm, about 1,000 μm would include 900 μm to 1,100 μm. Any provided value, whether or not it is modified by terms such as “about,” “substantially,” or “approximately,” all refer to and hereby disclose associated values or ranges of values thereabout, as described above.

Organizations can establish a vision for organizational transformation between the current organizational state and the target organizational state (or movement towards the target organizational state).

Organizations often generate a mission statement and organizational values or the like without actually creating and implementing an actionable vision for organizational transformation based on the organizational values and the mission statement. Even when a vision is created for an organization that is based on the organizational values and the mission statement for that organization, it is typically a static vision that does not account for organizational inefficiencies, labor or material constraints, timing constraints, or other organizational or external factor changes that may lead to changes over time in the target organizational state.

For some organizations, the current organizational state changes over time in the absence of a vision and in the absence of vision-oriented strategies and tactics—but rarely does this organizational state change align with the desired inputs and outcomes, desired means and modes for operational management and governance of the organization, or the organization's mission statement and/or values. Instead, this change over time in the absence of a vision and in the absence of vision-oriented strategies and tactics can be described as organizational entropy, or a natural tendency for organizations to become increasingly chaotic over time due to, e.g., miscommunication, ineffective processes, lack of stakeholder engagement, increases in conflicts and stress, lack of innovation, reduced adaptability, misalignment of mission and goals, misalignment of relevant metrics and performance indicators, and reduced organizational efficiency and performance, among others. For organizations that encounter organizational entropy, many of these organizations will fail or seriously underperform without intervention.

Conversely, for other organizations, the current organizational state may change over time in view of a well-defined vision and well-defined vision-oriented strategies and tactics. Information about the current and target organizational states for an organization can be a basis for forming a well-defined vision and vision-oriented strategies. However, even when an organization has gathered relevant metrics, defined the current and target organizational states, and developed a vision and vision-oriented strategies and tactics for moving the organization from the current state to the target state, any organizational transformation pathway formed therefrom is typically static.

Furthermore, for most organizations, the establishment of vision and vision-oriented strategies and tactics that can be used to move the organization from its current state to a target state is a top-down endeavor that relies exclusively on individual input from a leadership subset within the organization. Said otherwise, for most organizations the leader(s) (e.g., CEO, executive director, general manager, owner, partner-in-charge, etc.) of the organization typically work alone to formulate a mission statement and organizational values, estimate a current organizational state, formulate a target organizational state, develop a vision for organizational transformation towards the target state, determine relevant strategies and tactics for achieving that organizational transformation vision, and determine the relevant metrics and timelines for these strategies and tactics.

Typically, the analysis needed to determine the current organizational state is often based on historical performance data for the organization. Likewise, the vision and vision-oriented strategies and tactics for organizational transformation towards the target state are often based on such historical performance data for the organization. However, the accuracy of historical performance data, as reported to organizational leadership, in most if not all organizations, is typically affected by reporting errors, improper conflation of performance indicators and project or organizational metrics, bottom-up spin by organizational personnel to inflate project performance to organizational leader(s), and other factors.

Once the leader(s) of the organization perform this analysis and prepare organizational strategies and tactics for organizational transformation, the leader(s) of the organization typically prepare actionable project plans and timelines for various projects and tasks, based on this analysis and in view of the organizational strategies and tactics. Based on these project plans, the leader(s) of the organization then determine how and when to allocate resources such as labor, materials, and the like to certain projects. Typically, it is only after the leader(s) complete this initial analysis, project plan creation, and allocation of resources that the leader(s) provide instructions for project tasks and project task timelines to relevant personnel within the organization.

During implementation of the project plans and execution of project tasks by relevant personnel within the organization, ongoing project performance and task completion information is often only reported sporadically, and when reported prior to or upon completion of a task or a project, is often subjected, like with the historical performance data for the organization, to reporting errors, improper conflation of performance indicators and project or organizational metrics, bottom-up spin by organizational personnel to inflate project performance to organizational leader(s), etc.

Even when an organization is able to incorporate a broad array of personnel in crafting the vision for organizational transformation towards the target state, produce vision-oriented strategies and tactics, gather relevant and accurate historical performance data, determine a project-by-project pathway towards the target organizational state, create project plans and allocate resources effectively, and receive timely and accurate project performance updates throughout strategy implementation and project task execution from relevant personnel, the organization is likely to encounter one or more constraints that will reduce the likelihood of successful organizational transformation and/or increase the timeline for successful organizational transformation. Typically, at this point, organizations are not aware the increased likelihood that successful organizational transformation will be derailed or delayed, and organizations are often not able to pin-point the source of these constraints nor adjust strategies or tactics to ameliorate these constraints.

A prescriptive organizational transformation pathway can be defined, such as based upon the vision, vision-oriented strategies and tactics, project plans, project timelines, and resource allocation and availability information. The prescriptive organizational transformation pathway can be described as a temporal arrangement of projects that should be completed according to that temporal arrangement in order to move the organization towards its target state. The prescriptive organizational transformation pathway can include one or more interstitial organizational transformation milestones. The one or more interstitial organizational transformation milestones can be defined as based One or more interstitial organizational transformation milestones that might be established along a static prescriptive organizational transformation pathway between the current state and the target state

All of this is likewise within existing frameworks for organizational strategy and management that relies on a static target state for an organization, meaning that throughout implementation of the project plans and execution of project tasks by relevant personnel within the organization, the organization is not able to adjust or abandon one or more interstitial organizational transformation milestones that might be established along a static prescriptive organizational transformation pathway between the current state and the target state. Additionally, organizations are typically not able to determine during strategy implementation and project task execution while moving along the static prescriptive organizational transformation pathway towards a milestone or the target state, that the Embodiments of the present disclosure provide solution(s) to at least in part solve the above and other potential problems. Some example embodiments of the present disclosure will be described below with reference to the figures. However, those skilled in the art would readily appreciate that the detailed description given herein with respect to these figures is for explanatory purpose as the present disclosure extends beyond theses limited embodiments.

Th present disclosure introduces an innovative attribution framework designed to identify and promote value-producing activities within organizations by treating them as complex adaptive systems. Utilizing dynamic cooperative games with probabilistic hidden delayed rewards, the framework enhances traditional strategic planning. Several of the key features include fostering the emergence of dissipative structures for improved alignment and adaptation through micro-behaviors, intelligent agency, feedback loops, and a common language model.

The present disclosure emphasizes, among other things, a connection between information and energy, leveraging an energy-information framework to align and orchestrate organizational activities, effectively resisting an otherwise inevitable increase in organization entropy or disorder. According to some embodiments, the present disclosure includes descriptions of an array of different methods, features, and techniques, such as lookalike models, Markov Models, decision tree analysis, and Bayesian Priors.

Addressing challenges in strategic planning and decision-making, the described framework and approach offers distinct functionality, including a dynamic integrated approach to strategy formation and implementation through operations, providing organizations with a mechanism to adapt to evolving market conditions.

This present disclosure covers a value attribution framework and mechanisms for identifying and encouraging value-producing activities within organizations. This framework treats organizations as complex adaptive systems subject to thermodynamic laws, such as irreversibility, and utilizes dynamic cooperative games with behavior, trust, feedback, and data to replace traditional strategic and operational planning activities.

By modeling organizations as dissipative systems or structures, the organizations may be better able to adapt to changing environments and market conditions. Adaptation, which may be or include organizational learning based on quality data and using assisted intelligence and automation, can improve the likelihood of an organization's success over time. In some embodiments, the framework and approach described herein can incorporate Intelligent Agency, which may involve the use of different stakeholders actively participating in the collaborative development and refinement of an organizational strategy and orchestration of organizational operations.

The collaborative development of organizational strategy can be carried out using a cooperative game aimed at facilitating the emergence of dissipative structures and the analysis of the value attribution framework's implementation. Several key principles of cooperative game play can be considered, such as: Convergence of Interests, Mandated Exchange of Information, Voluntary Participation, Parity, and Mutual Advantage, and Binding Commitments. In some embodiments, the cooperative game is played with hidden delayed rewards which is consistent to the way many organizations operate in the real world.

The present disclosure emphasizes the importance of alignment and cooperation among participants in an organization to achieve common goals and adapt to changing market needs. It introduces a framework and approach for using cooperative game theory in the context of strategic planning and business strategy development. The focus is on achieving alignment, sharing information, and forming binding commitments to drive cooperative efforts and improve organizational adaptability.

The present disclosure also involves, according to some embodiments, the application of thermodynamics, particularly the second law of thermodynamics, to complex adaptive systems (specifically organizations), focusing on their structure, behavior, and evolution.

The present disclosure also involves, according to some embodiments, the concept of dissipative structures in nonequilibrium systems. It highlights that the state of a system can become unstable, leading to the emergence of organized structures, and this process is governed by forces and flows.

The present disclosure also involves, according to some embodiments, the concept of organizational and informational entropy in a system over time as a function of both irreversible processes and energy exchange within the environment. Irreversible entropy production is always positive, in line with the second law of thermodynamics.

Thermodynamic forces are gradients of intensive variables, while flows are time derivatives of corresponding extensive variables. Irreversible entropy production is calculated as the sum of products of forces and flows in the system, demonstrating the direct relationship between entropy and processes in a thermodynamic system.

The present disclosure also, according to some embodiments, distinguishes between classical thermodynamics, which deals with states, and modern thermodynamics, which focuses on processes and the time evolution of entropy, forces, and flows.

Modern thermodynamics includes the principle of minimal entropy production, stating that systems close to equilibrium tend to minimize the rate of entropy production. There's also the principle of maximum entropy production, where non-equilibrium systems tend toward processes and states with the highest rate of entropy production.

The present disclosure also involves, according to some embodiments, mentions that living systems are considered dissipative structures and their behaviors and evolution are related to their thermodynamic properties, and organizations are proxies for living organisms, sharing an albeit similar life and death, ascendency, and decline.

The second law of thermodynamics has implications for complex adaptive systems, including the need for a continuous flow of energy, the maintenance of order and complexity, adaptation to changing environments, entropy production, existence in non-equilibrium states, and the requirement for resilience and robustness.

Information and data, including signals from the environment, play a crucial role in complex adaptive systems. The present disclosure also involves, according to some embodiments, excess information generated by the organization and its intelligent agency can be absorbed in the formation and sustainability of a dissipative structure.

The present disclosure also involves, according to some embodiments, the computation of stability and bifurcation in the context of complex adaptive systems, indicating that these mechanisms can help identify when continuous improvement processes are needed to maintain stability.

Probabilities are considered in the source to determine bifurcation conditions, and it's highlighted that the development of a dissipative structure is subject to probabilistic influences.

The present disclosure also involves, according to some embodiments, organizations, as complex adaptive systems, utilizing information to counteract entropy, much like physical systems. The concept of “negentropy” or “negative entropy” in the context of the second law of thermodynamics, which states that entropy tends to increase in a closed system, is also disclosed. Information can play a critical role in mitigating this entropy increase through various mechanisms, including information storage and processing, feedback and control, the emergence of dissipative structures, intelligent agency, energy efficiency, adaptation and evolution, and the synergy of information and energy. Prior researchers in complexity theory have viewed organizations as complex adaptive systems, without realizing the underlying thermodynamic need for dissipative structures and the use of game theory.

The present disclosure further discloses that information allows systems to encode knowledge about their structure and environment, enabling informed decision-making, adaptation, and optimization of resource allocation.

The present disclosure further discloses that information supports feedback loops within systems, aiding in the regulation of processes and the maintenance of stability, preventing systems from descending into disorder.

The present disclosure further discloses that information and feedback are vital in the formation and stabilization of emergent properties and dissipative structures in complex adaptive systems, which are critical for remaining far from thermodynamic equilibrium.

The present disclosure further discloses that Intelligent Agents, both human and AI-based, can be used to actively intervene in systems based on acquired knowledge and information, manipulating their environment, and increasing organization and control over entropy. In some embodiments, the concept of intelligent agency relies on a common language model and organizational data to facilitate adaptation. In some embodiments, the approach can include forming, generating, training, maintaining, and/or using a common language model that is specific to an organization.

The present disclosure further discloses that information can lead to more efficient effort, or energy, and resource usage, reducing waste, optimizing processes, and minimizing entropy production. Automation, with its reliance on a common language model, data, and learning, is a part of this process.

The present disclosure also asserts, according to some embodiments, that information enables systems to adapt to changing conditions and evolve over time by learning from experiences and acquiring new information, improving resilience and the ability to cope with entropy-inducing factors. The emergence of dissipative structures plays a role in this adaptation.

The present disclosure also asserts, according to some embodiments, that information and energy are closely connected in the context of the second law of thermodynamics. Aligning the organization with the framework, building trust, and attributing value within the organization can help harness and direct energy, fostering organization and resisting entropy increase.

The present disclosure also asserts, according to some embodiments, the crucial role of information in countering entropy within complex adaptive systems, including organizations. It underscores how information storage, feedback, intelligent agency, energy efficiency, and adaptation are essential components in this process.

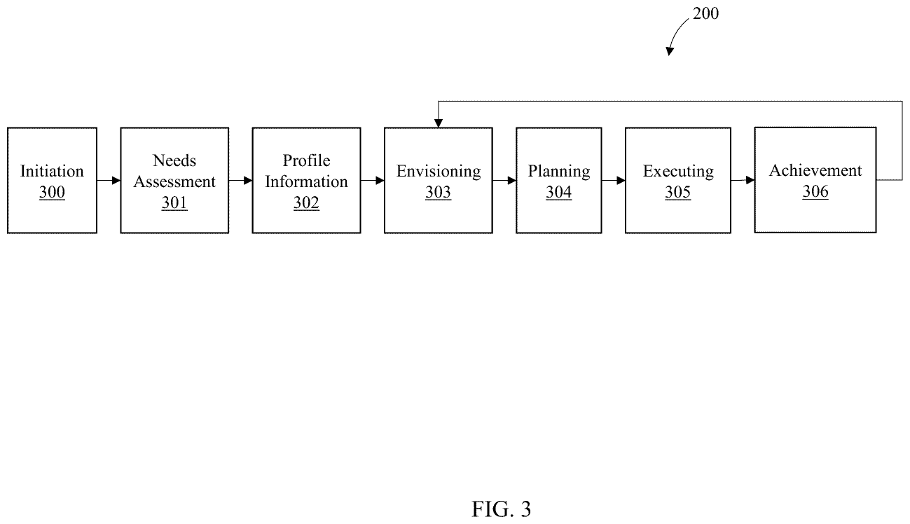

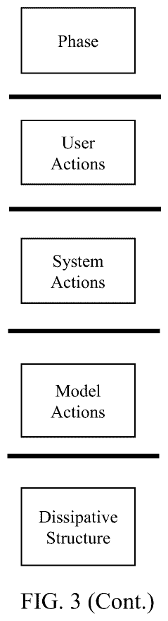

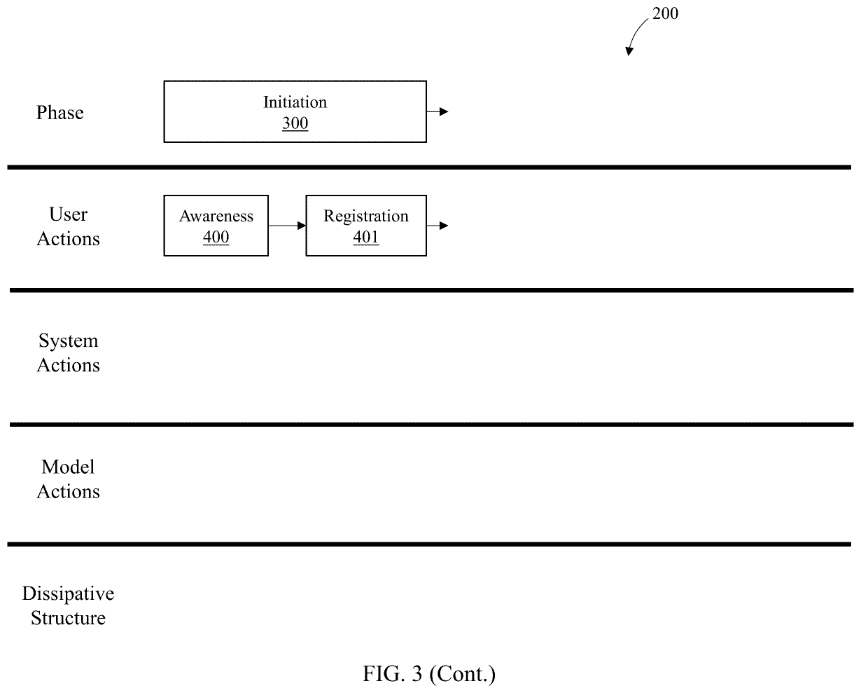

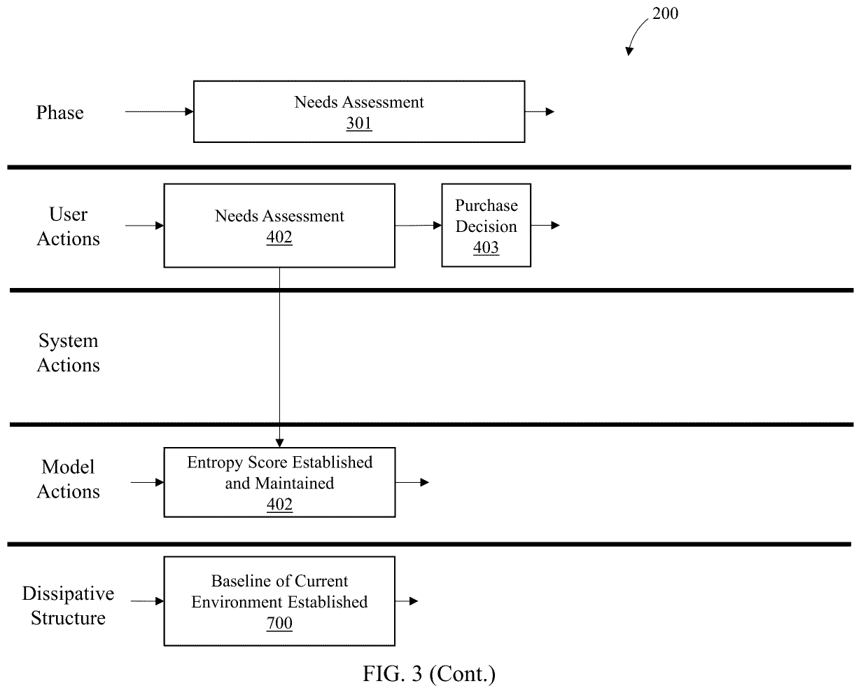

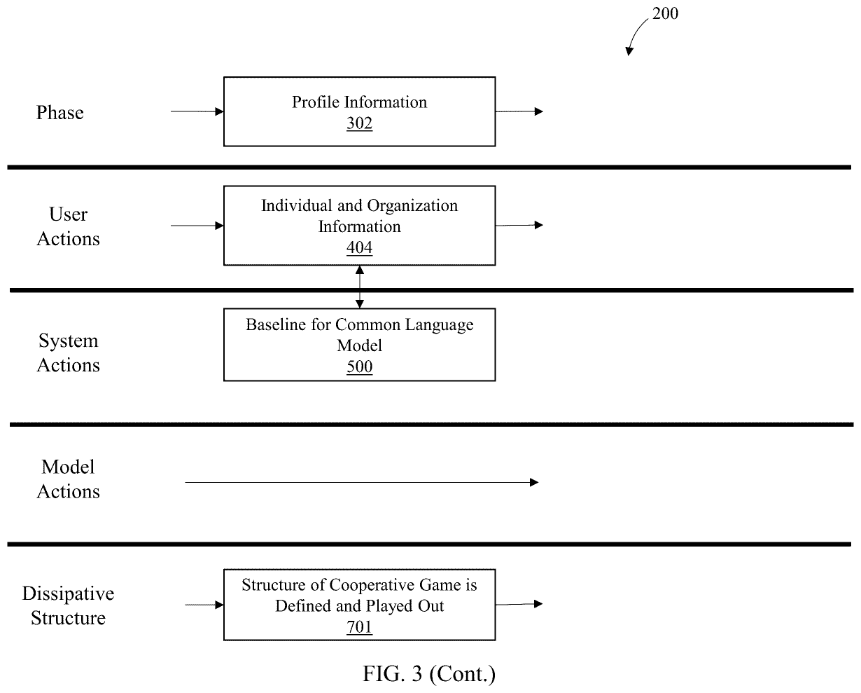

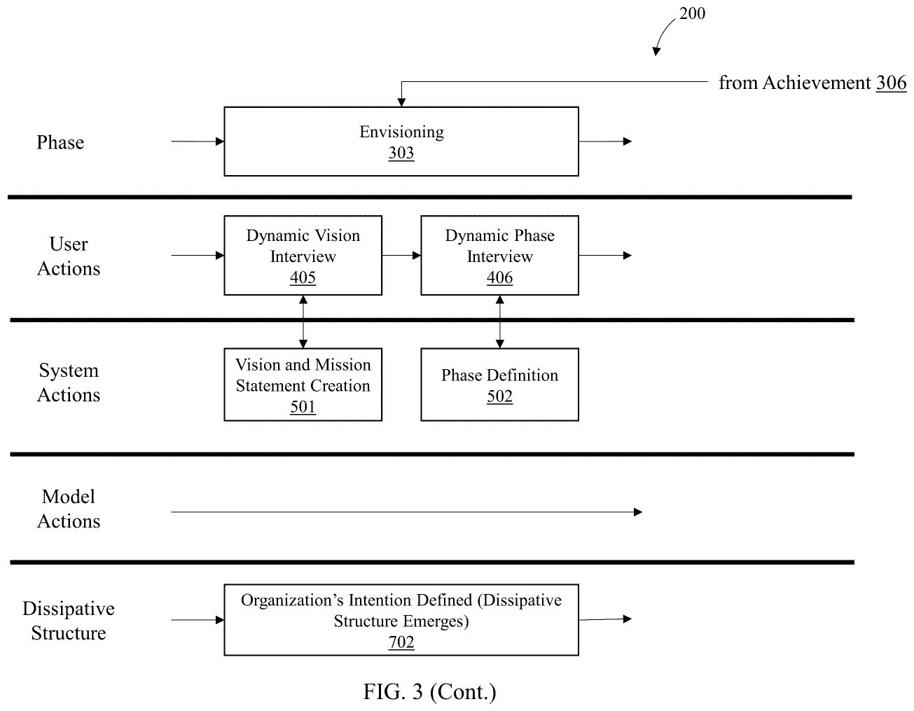

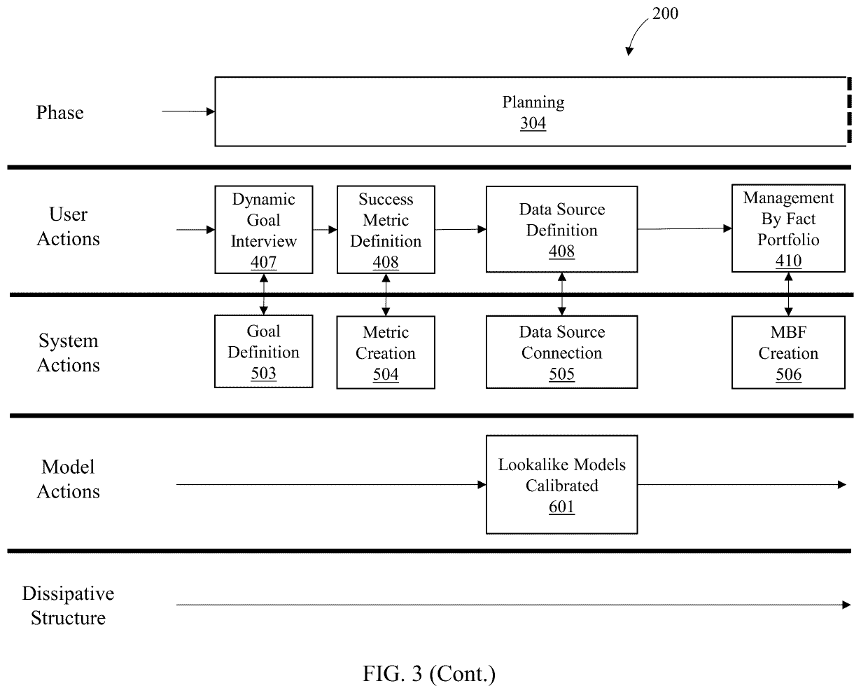

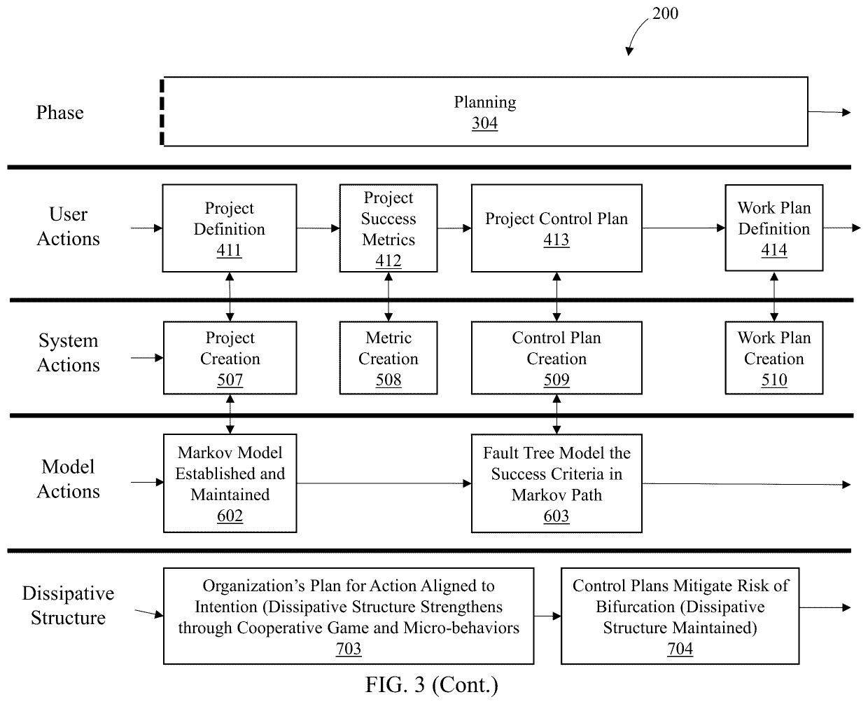

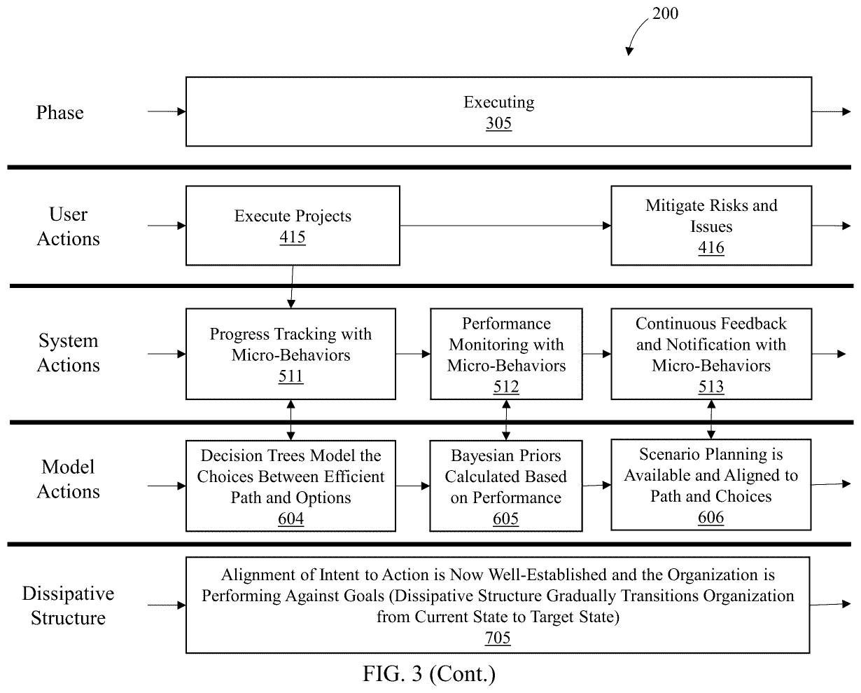

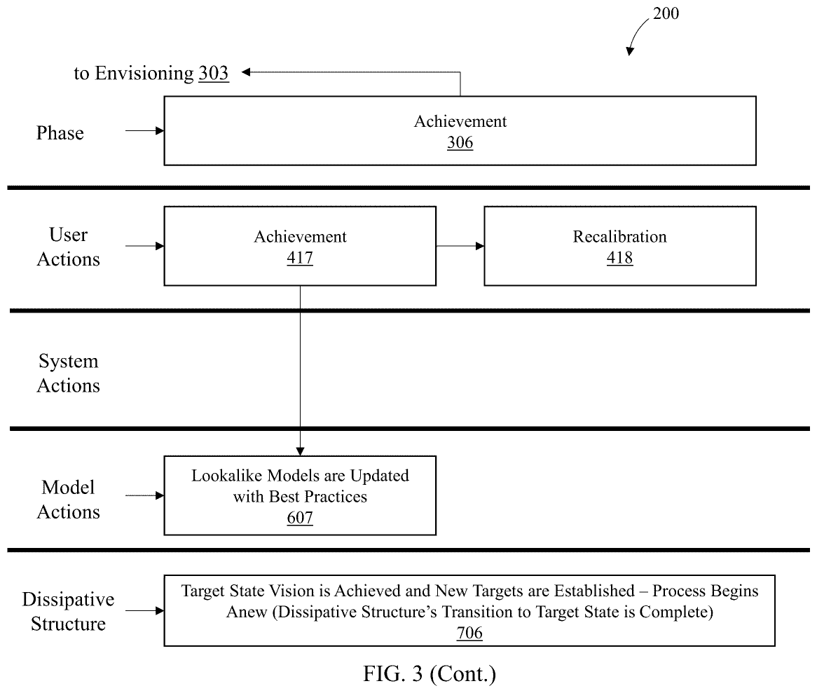

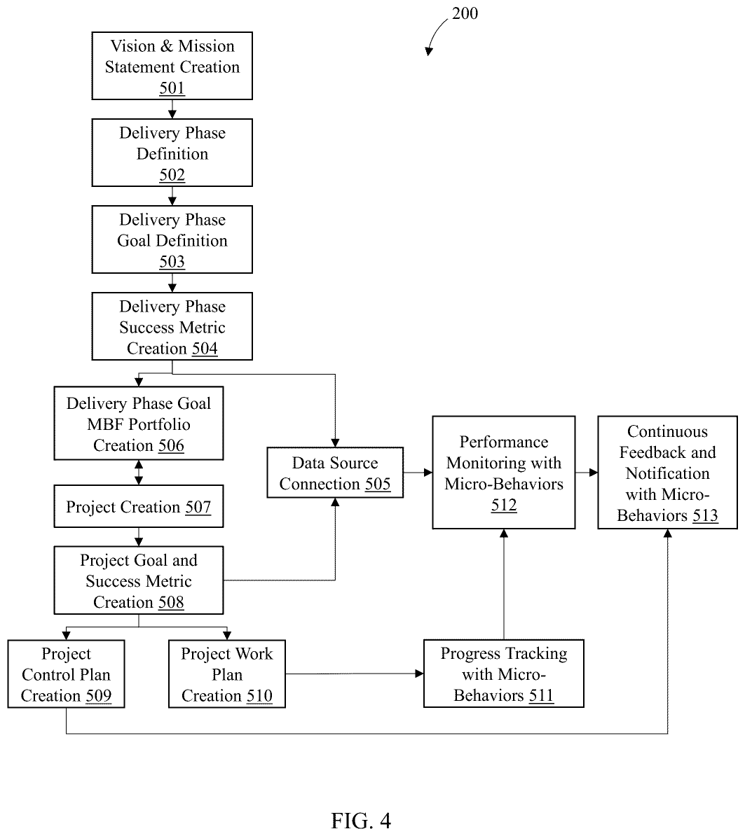

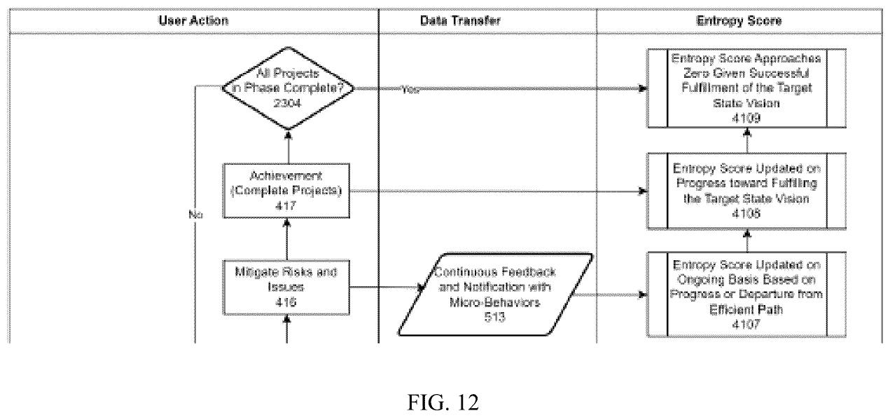

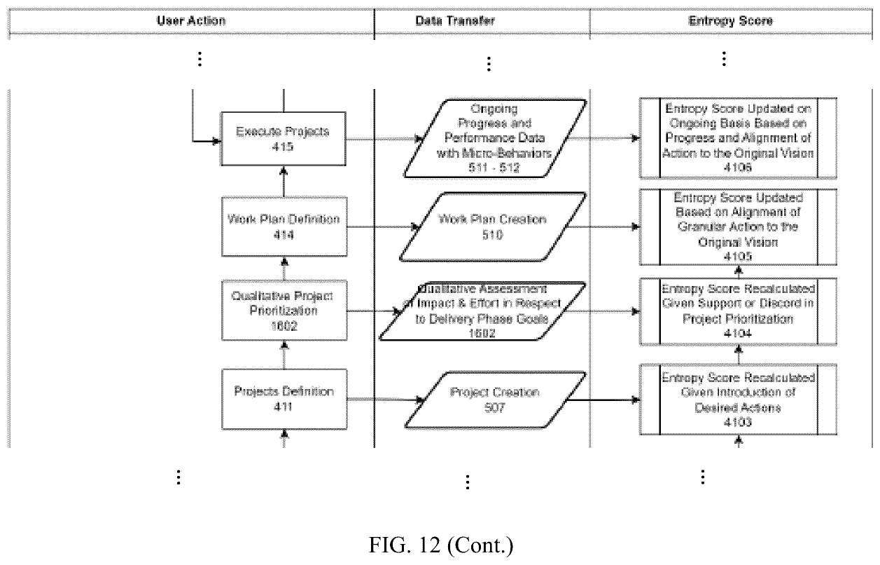

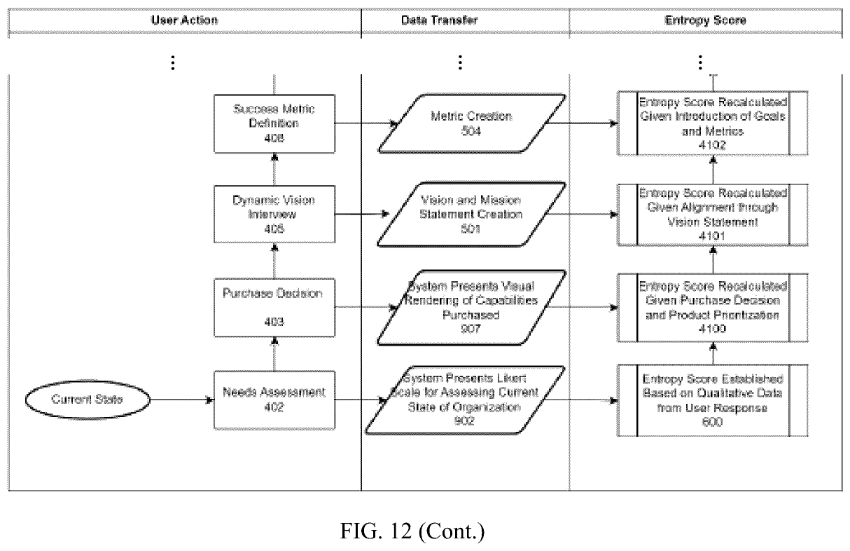

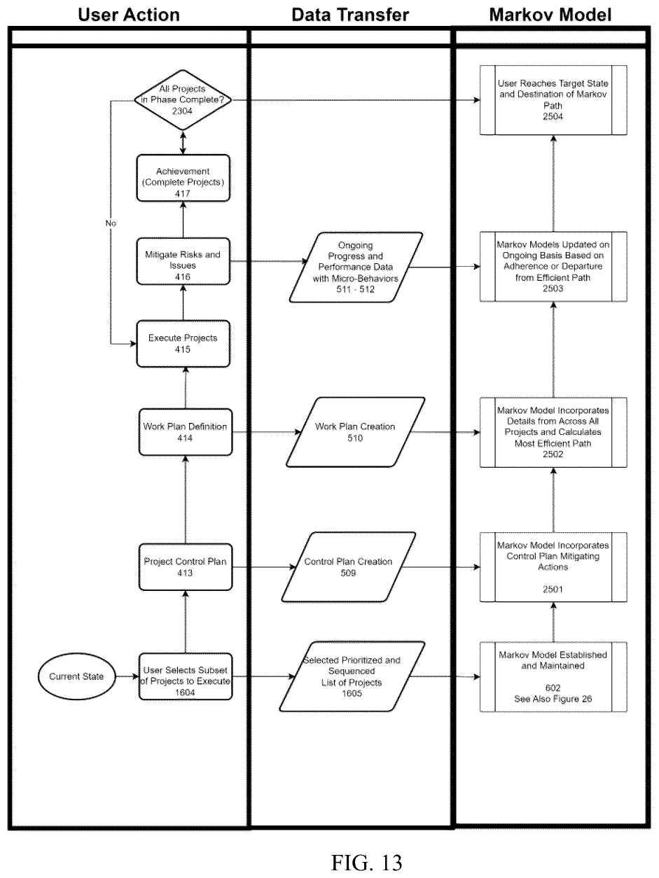

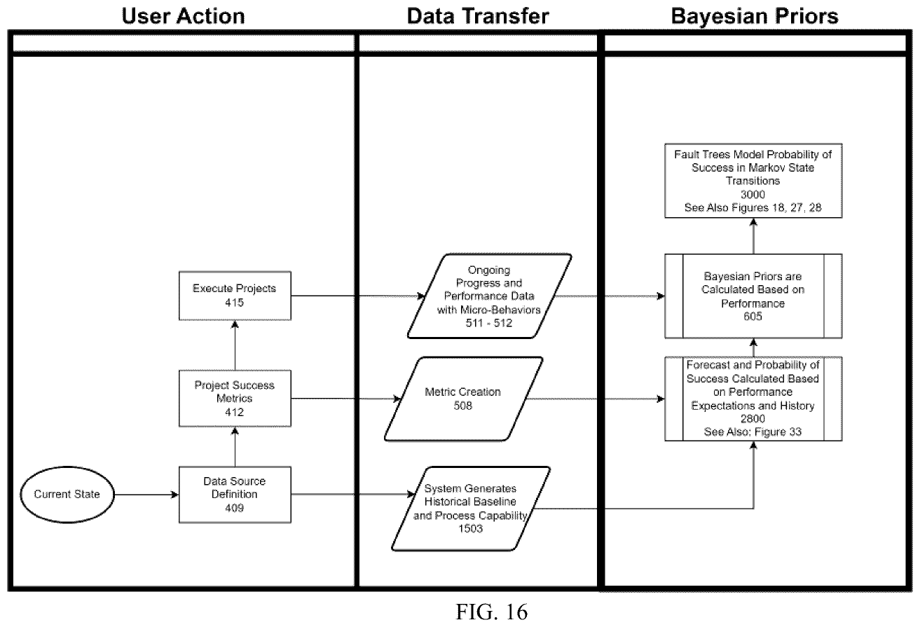

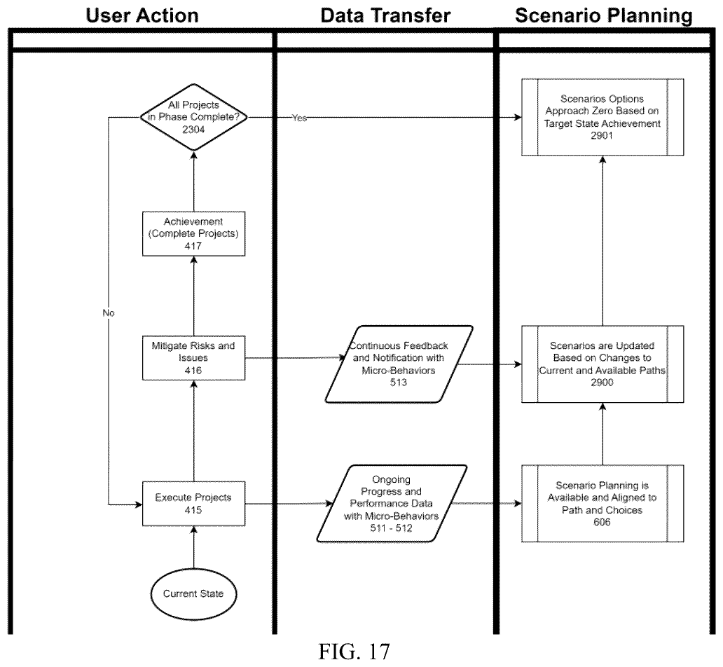

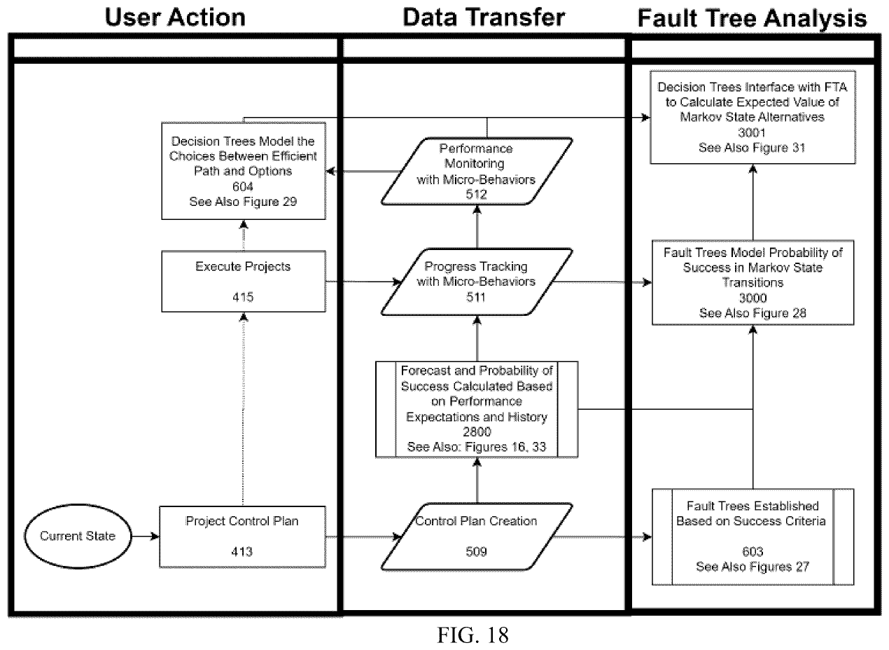

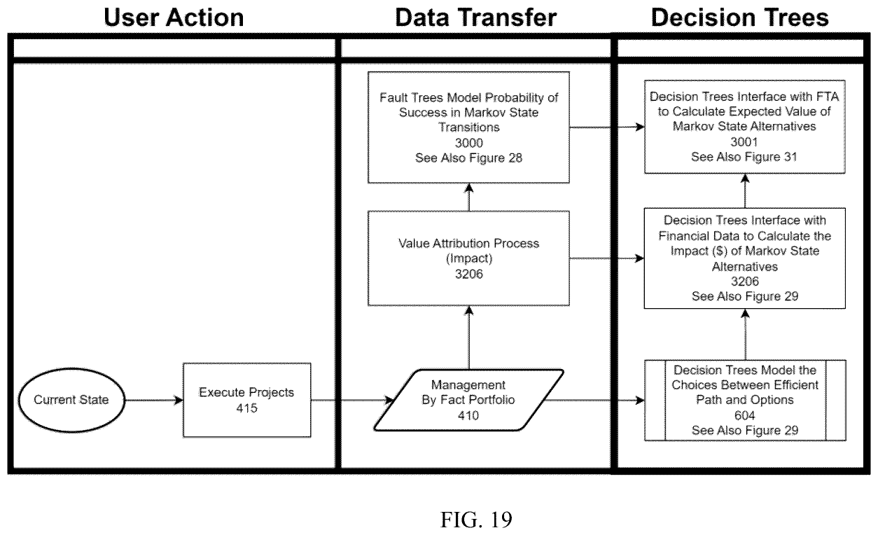

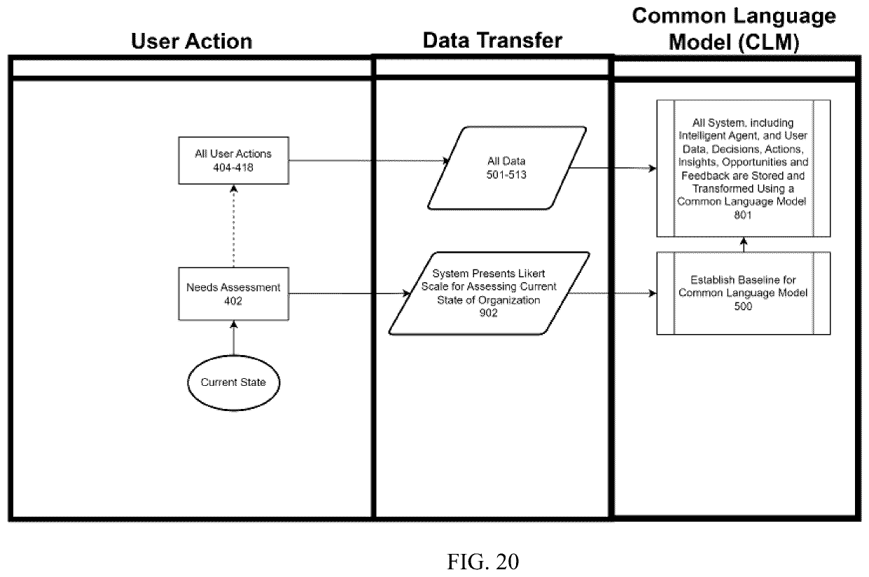

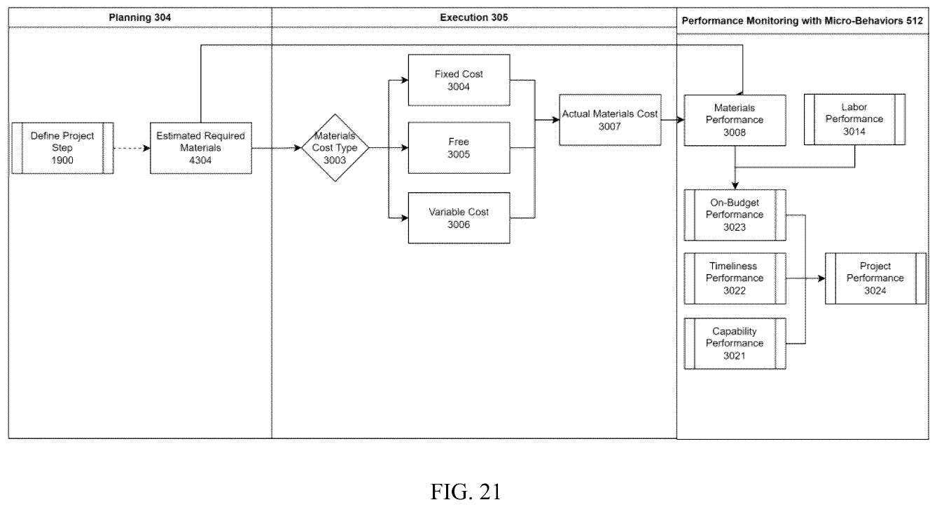

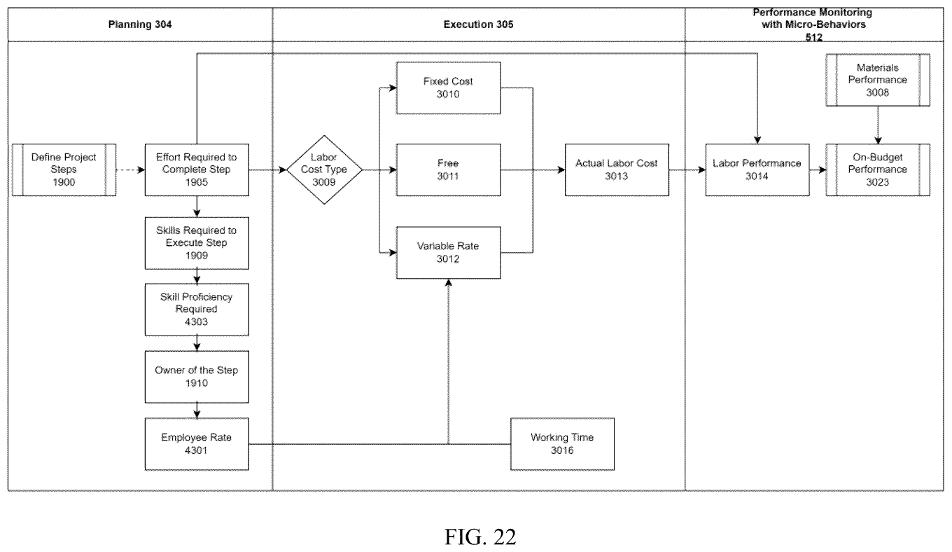

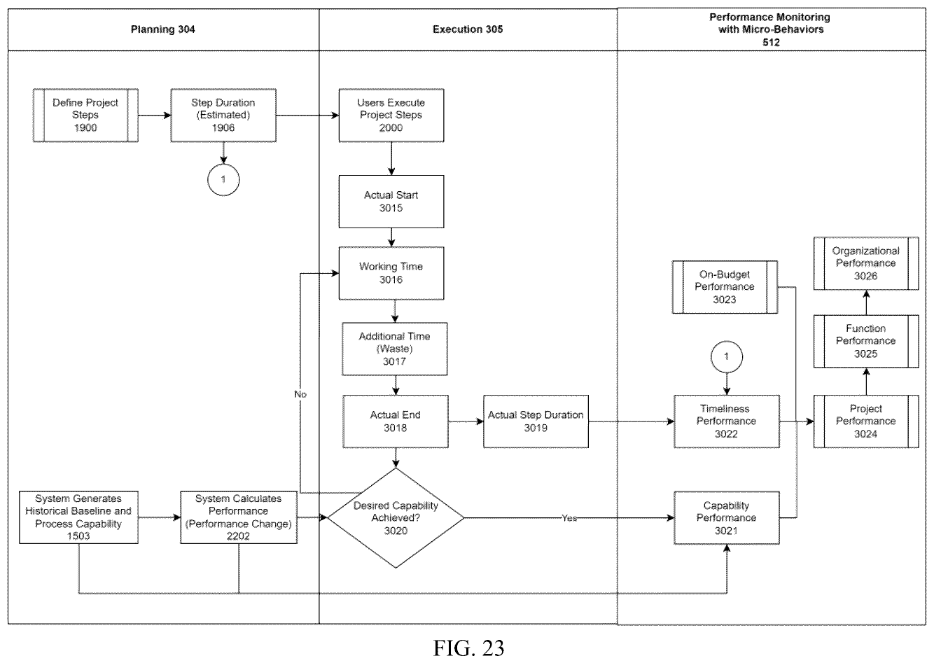

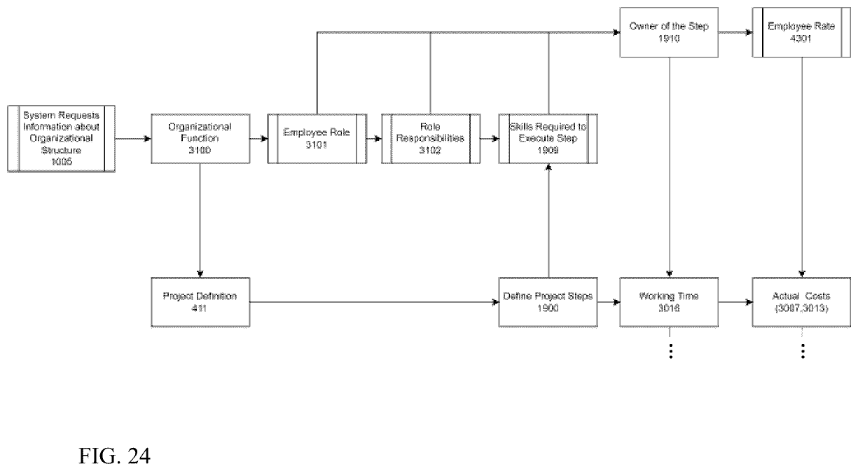

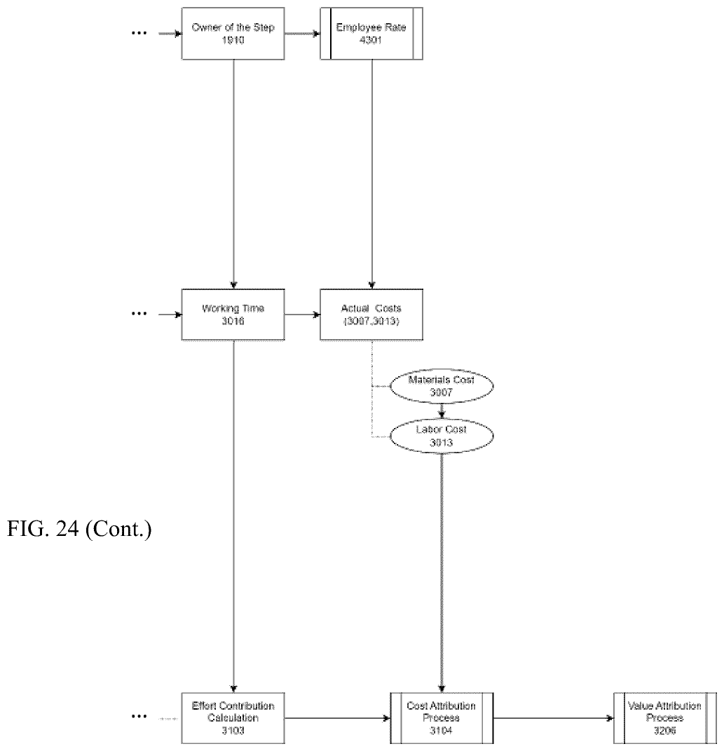

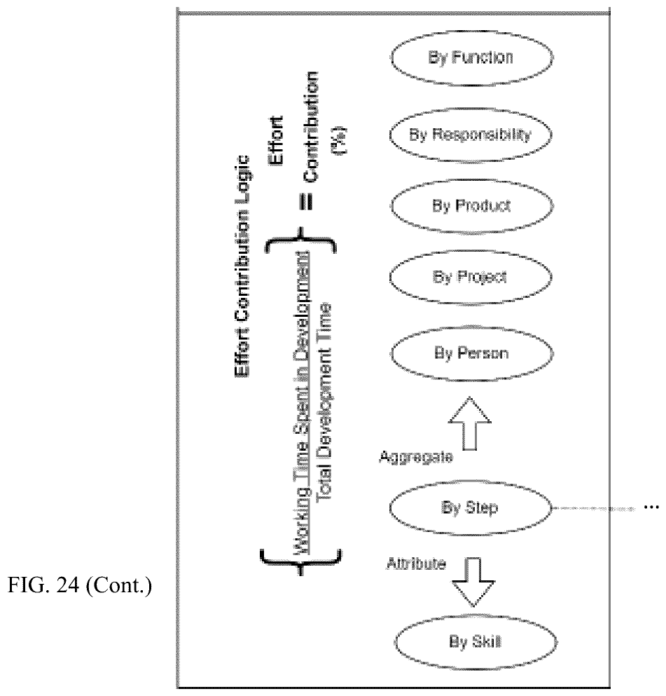

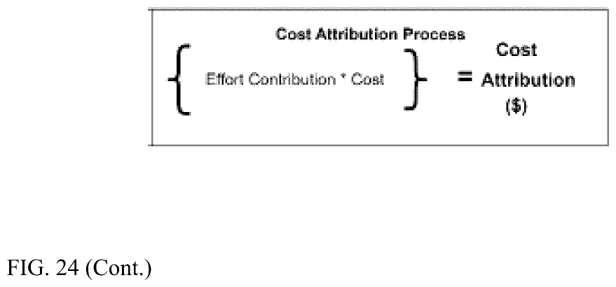

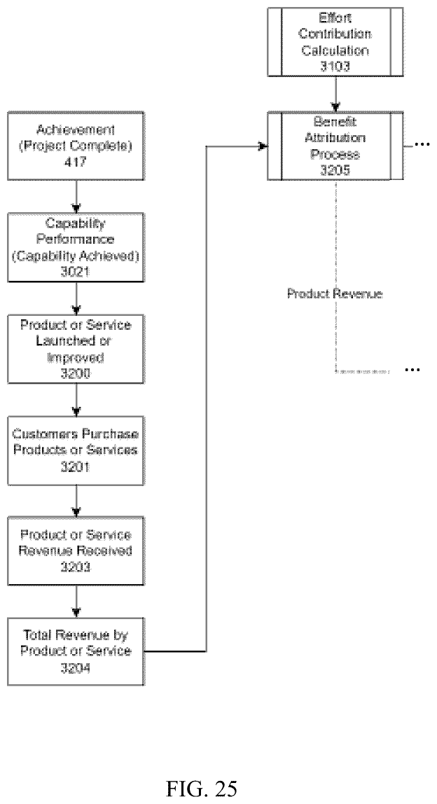

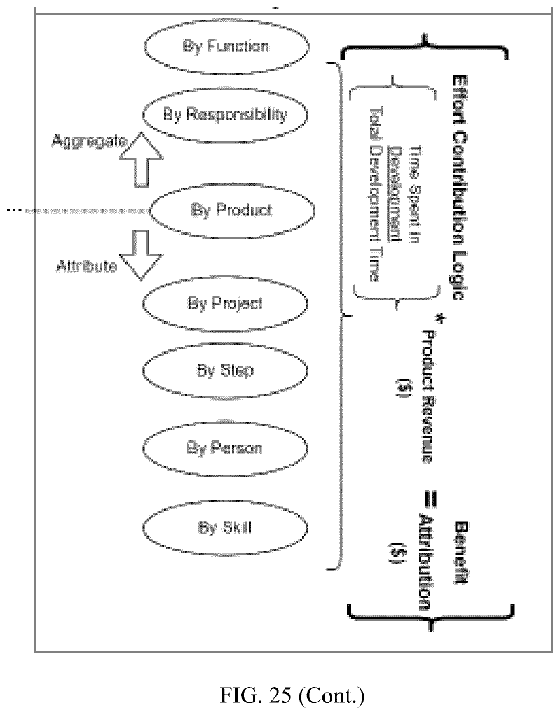

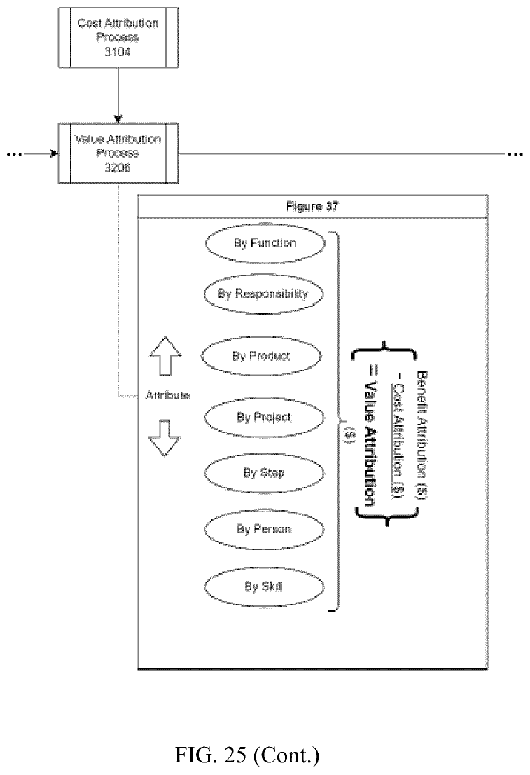

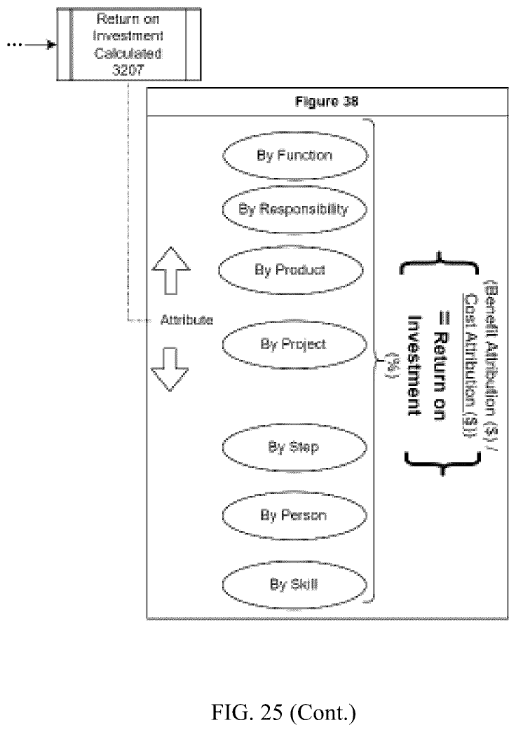

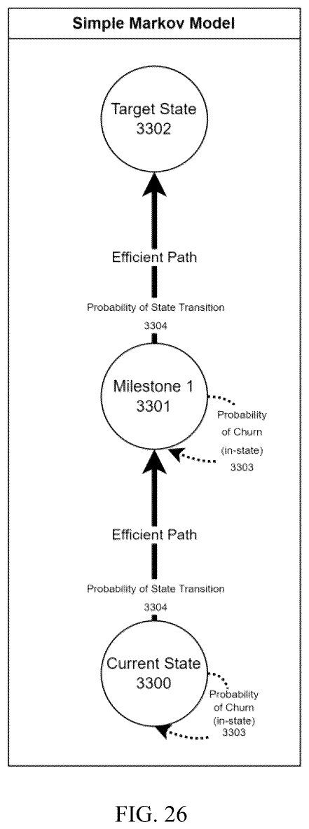

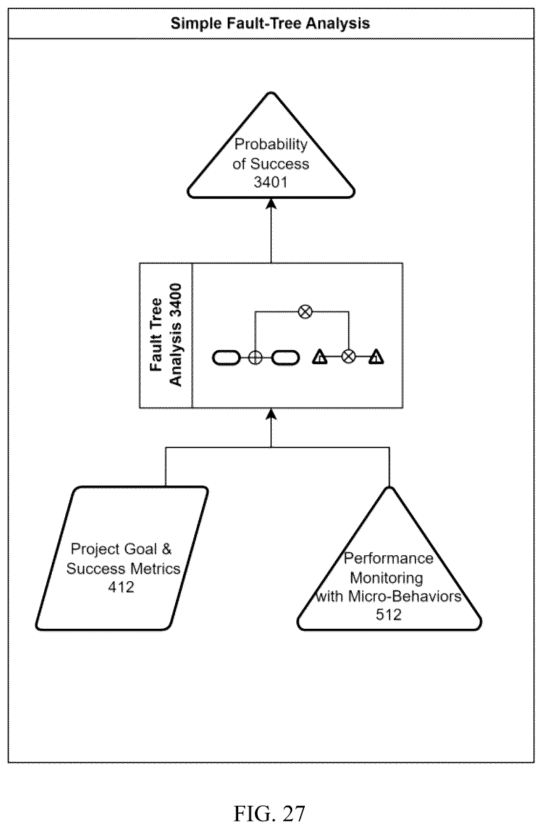

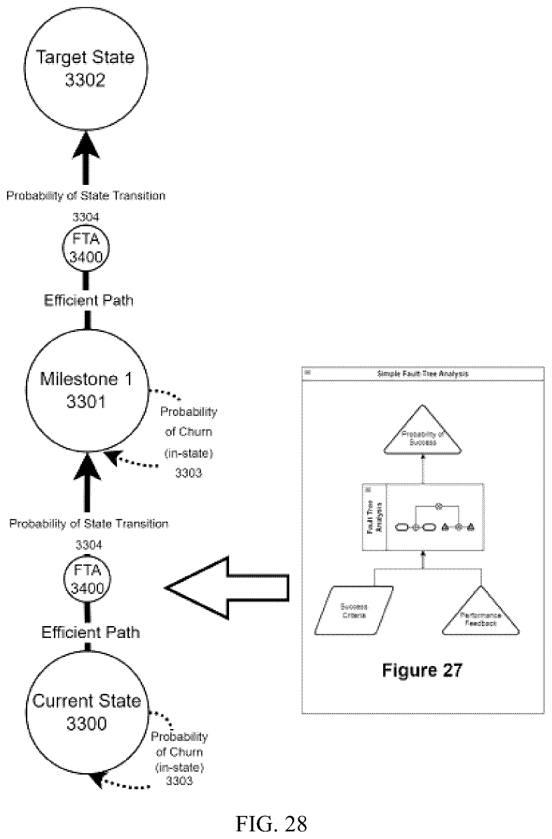

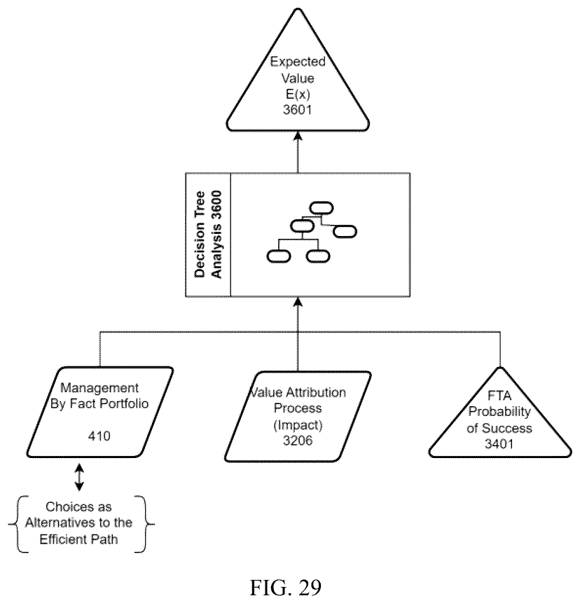

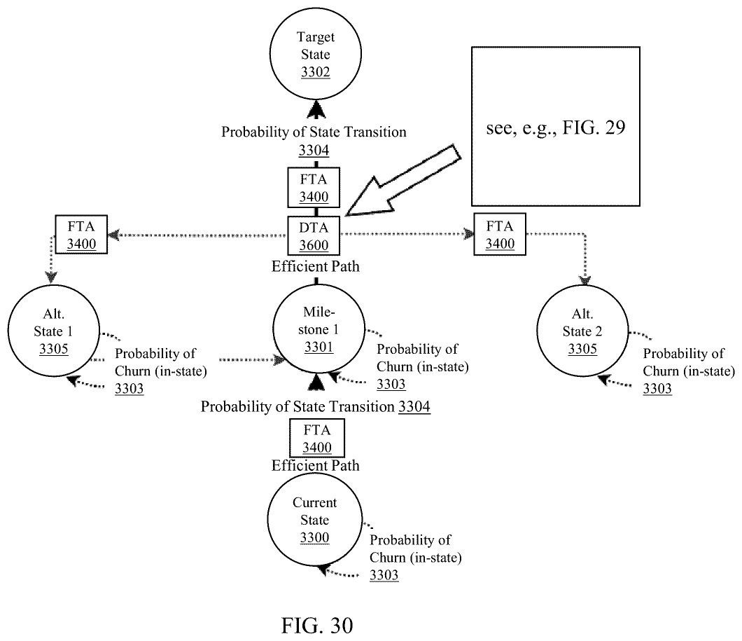

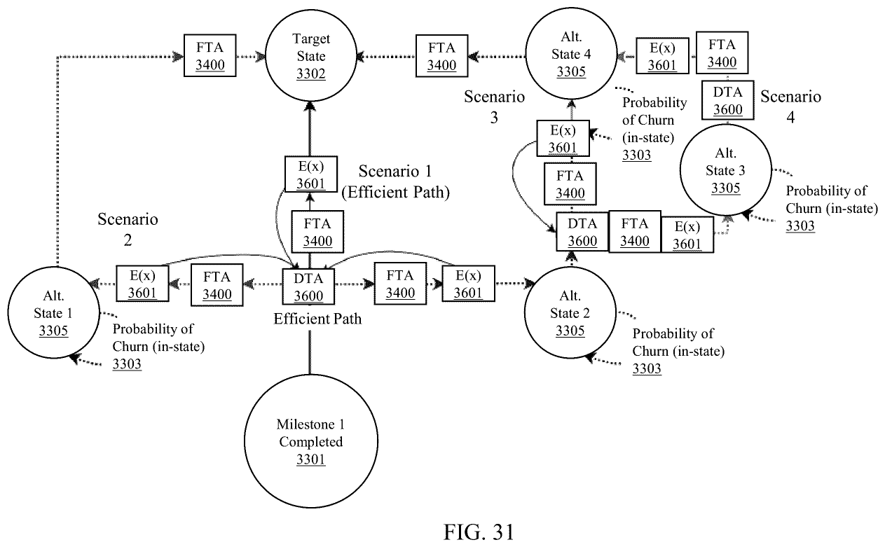

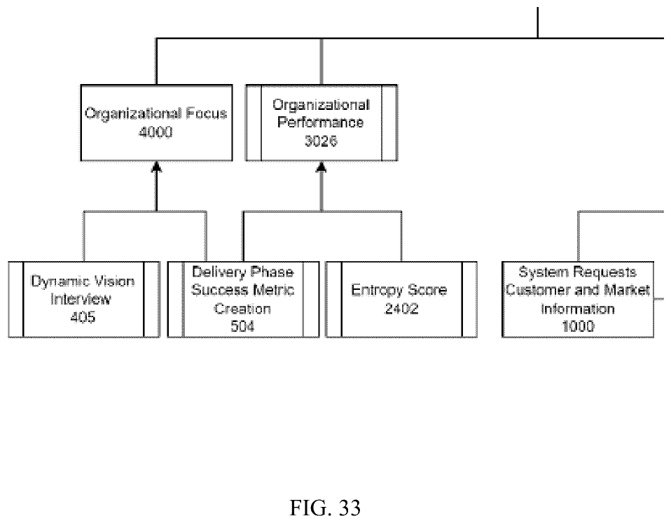

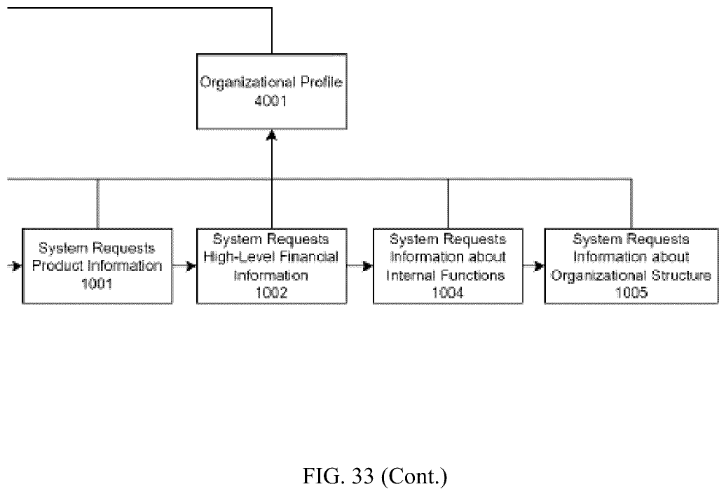

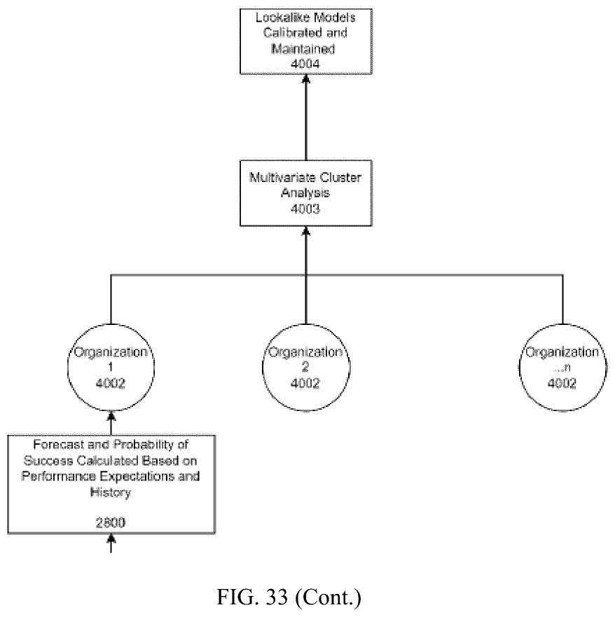

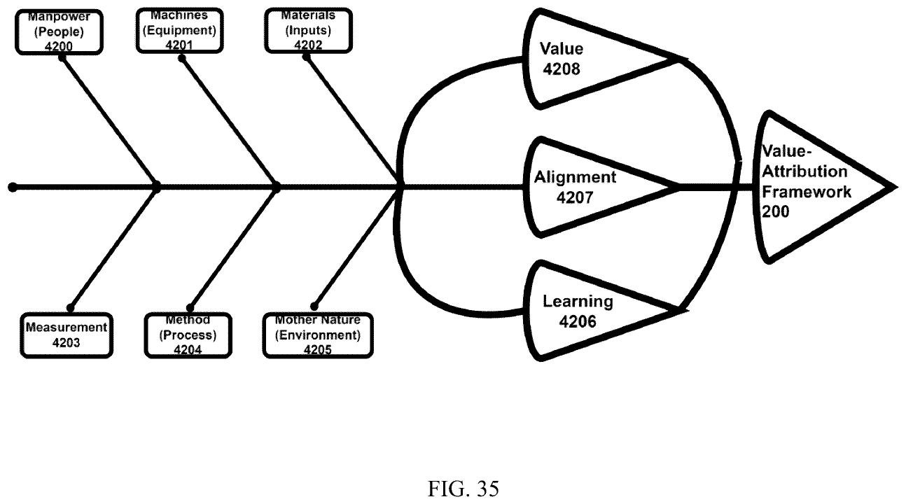

Various approaches are described herein for achieving desired outcomes and creating various outputs operable to provide organizational value information, organizational strategy information, organizational project management information, organizational tactics information, organizational resource allocation information, organizational project/task timing information, organizational efficiency information, organizational entropy score information, and/or the like. In some embodiments, a method or approach can be carried out that comprises one or more processes employed by one or more components of a system or device, such as those described herein. For example, components of a system or device as described herein can comprise means for performing one or more of: value attribution framework system actions (see, e.g., FIG. 3), such as those integrated into phases (see, e.g., FIG. 4). In some embodiments, a system or device as described herein can comprise means for creating, training, maintaining, and/or using one or more of: a common language model (see, e.g., FIG. 20), materials cost structure models (see, e.g., FIG. 21), labor cost structure models (see, e.g., FIG. 22), timeliness performance/capability performance models (see, e.g., FIG. 23), cost attribution logic models (see, e.g., FIG. 24), benefit attribution models and/or return on investment logic models (see, e.g., FIG. 25), entropy contribution models (see, e.g., FIG. 12), VAF Ishikawa models (see, e.g., FIG. 35), associated bifurcation models based on the results of scenario planning (see, e.g., FIG. 31), and/or the like. The approaches and methods described herein can comprise the integration of several distinct techniques or methods, e.g., using one or more of: lookalike models (see, e.g., FIG. 33), Markov Models (see, e.g., FIG. 13 and FIG. 26), decision tree analysis (see, e.g., FIG. 19 and FIG. 29), Markov Models with fault tree integration (see, e.g., FIG. 28), performance monitoring with micro-behaviors (see, e.g., FIG. 4, at element 512), Fault Tree Analysis (see, e.g., FIG. 18 and FIG. 27), Scenario Planning (see, e.g., FIG. 17), Bayesian Priors (see, e.g., FIG. 16), models adapted for viewing an organization as a complex adaptive system (with the distinct notion that it is irreversible in intent), and/or the like.

Several of the aspects and objectives of the approaches, methods, systems, and devices described herein include, but are not limited to, applications of game theory and/or dissipative structures/systems modeling and analysis for the development and emergence of organizational strategy. The present disclosure further discloses a mechanism to enable individuals and organizations to bootstrap their strategic planning (strategic operations) and so radically align their decision-making to the strategy, make adjustments based on what happened, what is happening and what they want to happen. The present disclosure further discloses methods, features, techniques, components, materials, and structures that enable organizations to adapt to changing market conditions by aligning their operations and decisioning making to their strategy.

The utility afforded by the purpose and its measurable objectives provides to businesses a dynamic integrated approach to strategy formation and implementation through operations, one that can bootstrap from low complexity to high complexity by leveraging the power of a common language model and viewing the business as a complex adaptive system subject to entropy and dissipative structures. These differing goals result in non-overlapping areas of application. Our method serves a different utility and purpose compared to the referenced patents.

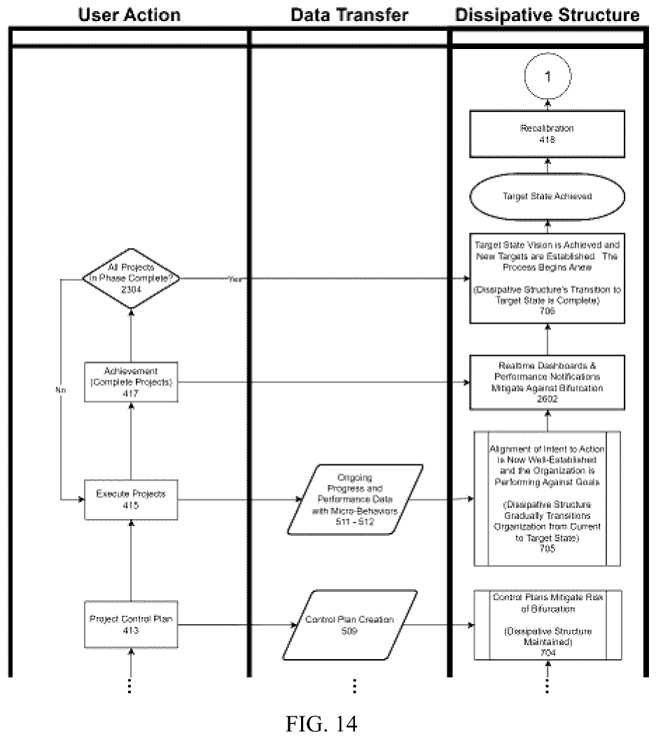

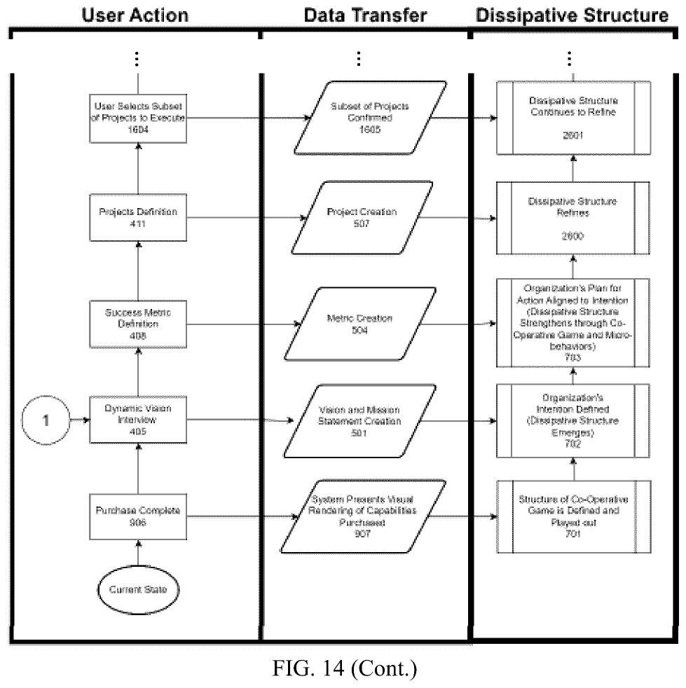

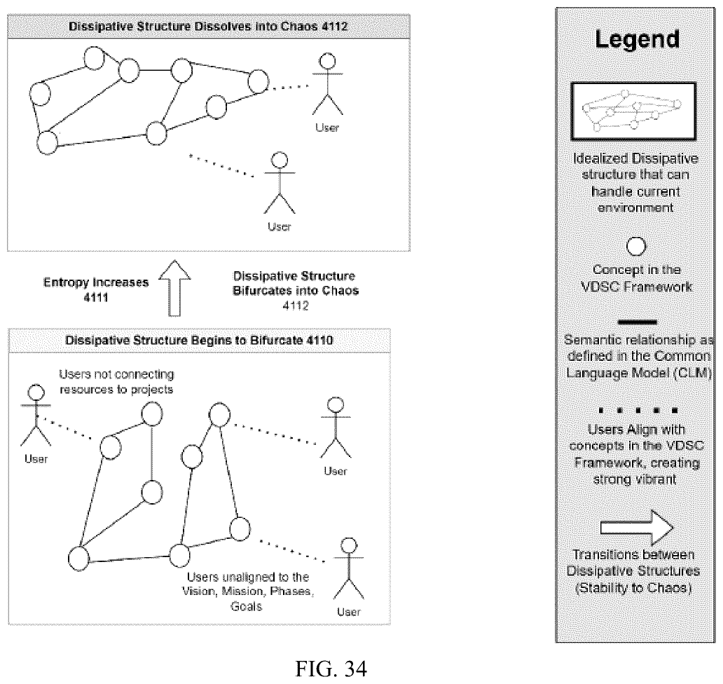

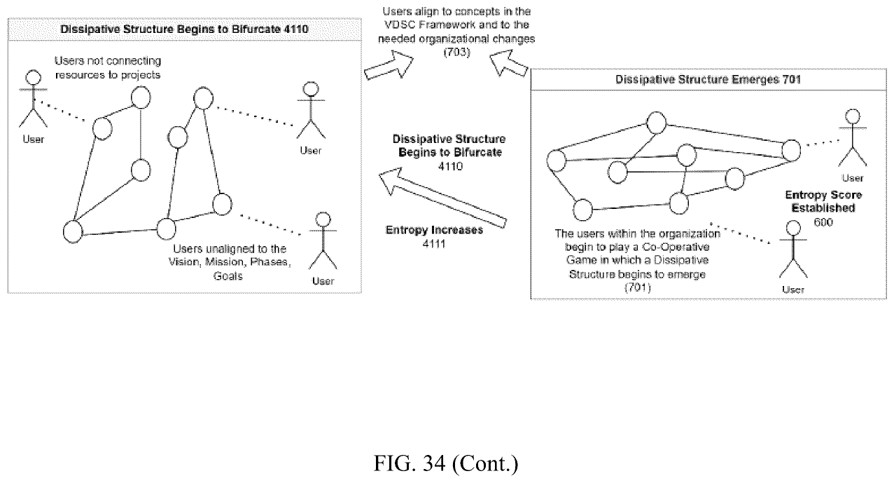

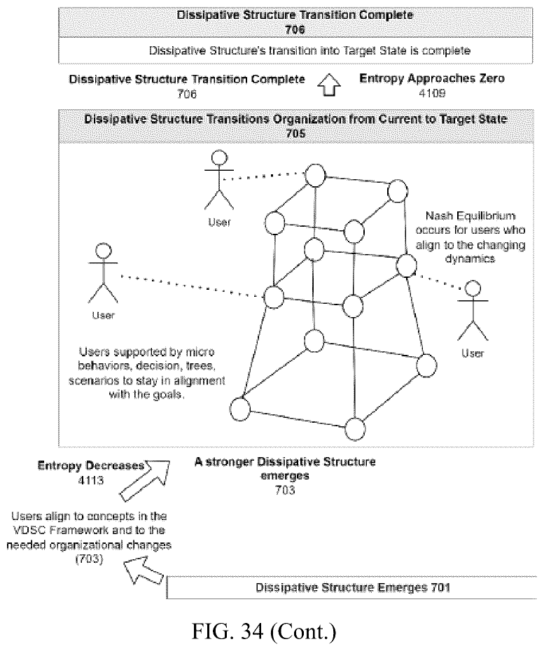

The system and approach described herein comprises specific components or elements that are configured to develop, train, and/or use one or more of: a common language model, a value attribution framework, a product development module, an operate module, a finance module, a customer module, an employee module, a continuous improvement module, and/or a core module; one or more of which can be configured to provide services and functions such as those described herein. The materials employed in the patent include the software fabric, its infrastructure and components including the use of common language models. The structures used in the patent include the emergence of the dissipative structure (see, e.g., FIG. 14 and FIG. 34). These differences in construction lead to unique functionality and ways the users will interact with the system, and how the system itself learns (see, e.g., FIG. 20).

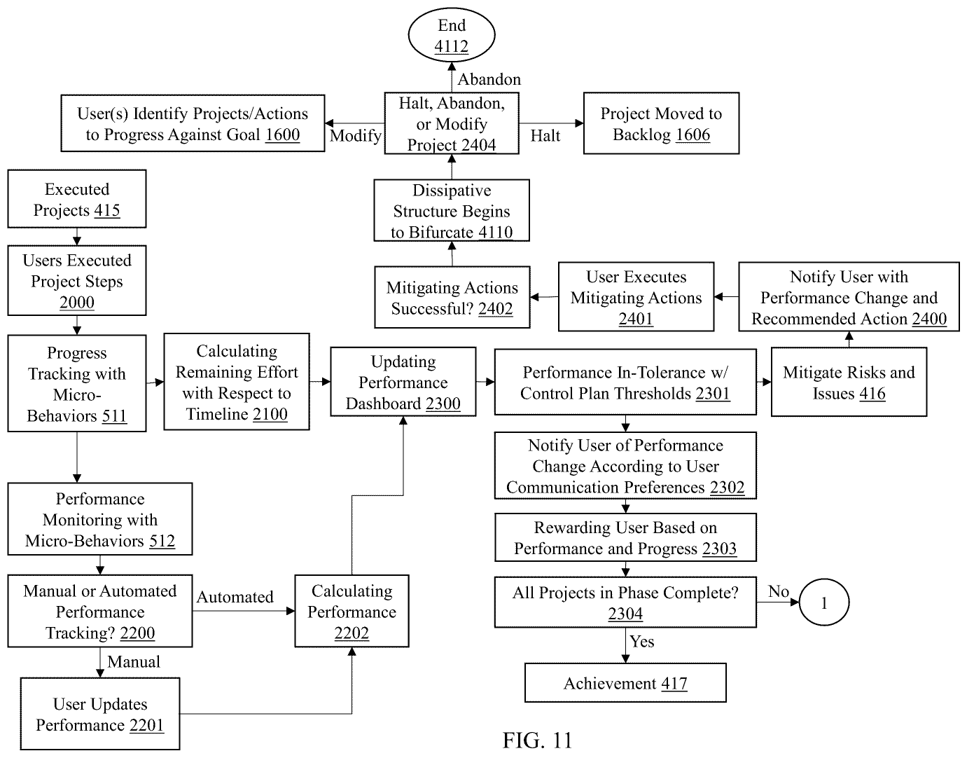

According to some embodiments, approaches and methods described herein incorporate improved aspects and features, such as improved verifiability based on the integration of one or more different models, analyses, and/or techniques, such as, e.g., Markov Models (see, e.g., FIG. 30), Fault-Tree Analysis (see, e.g., FIG. 27), Decision-Tree Analysis (see, e.g., FIG. 29), Bayesian Priors (see, e.g., FIG. 16), Scenario Planning (see, e.g., FIG. 17 and FIG. 31), Feedback and Performance Monitoring (see, e.g., FIG. 3 and FIG. 11), and/or the like. According to some embodiments, the various approaches and methods described herein may allow for various decision and action outputs being provided or developed that may be cross referenced between different model/analysis outputs.

Strategic decision-making primarily focuses on long-term planning and setting the direction and goals of an organization. Strategic decision-making may involve high-level choices that shape the overall strategy, vision, and mission of the organization. Strategic decisions typically involve allocating resources, entering new markets, identifying competitive advantages, and determining the overall positioning of the organization. These decisions are made by business leaders and involve considering external factors such as market trends, competition, and customer demands.

Operational decision-making deals with day-to-day activities and tactical execution of the strategic plans. It involves making decisions that directly impact the organization's daily operations, such as resource allocation, task assignments, production schedules, and supply chain management. Operational decisions are typically made by managers and employees who are responsible for implementing the strategic plans effectively and efficiently.

Strategic decision-making sets the direction and goals of the organization, while operational decision making translates and implements those strategic plans into day-to-day activities. The successful intersection of these two decision-making processes is vital for achieving organizational objectives, optimizing performance, and driving sustainable growth.

Successful strategic and operational decision-making lies in their mutual dependency and alignment. Strategic decisions provide the overarching framework and goals that guide operational decision making. Operational decisions, in turn, contribute to the execution of the strategic plans and help achieve the desired outcomes. For example, a strategic decision to enter a new market requires operational decisions on how to allocate resources, design marketing campaigns, and manage production processes in that market. According to some embodiments, a system, device, approach, or method described herein can be provided that is operable to identify one or more roots of identified problems by, e.g., distinguishing between and weighing various contributors to, and trade-offs between, operational effectiveness and organizational strategy. According to some embodiments, operational decisions may need to align with the strategic objectives to ensure the successful implementation of the strategy. Effective coordination and integration between strategic and operational decision making are crucial for organizational success regardless of the size of the organization or its strategic positioning. Strategic decisions inform and guide operational decisions, while operational decisions provide feedback and insights that influence strategic decision making. Close collaboration and communication between different organizational functions, levels of management and departments are essential to ensure that the operational decisions align with the strategic goals and objectives.

In the present disclosure, systems, devices, approaches, and methods are described which incorporate strategic games and cooperative games that are played by a plurality of personnel or stakeholders of an organization. In some embodiments, by employing strategic games/cooperative games and game theory aspects into the analysis and modeling, a described system, device, approach, and/or method may more easily account for the behavior of agents in the organization over traditional strategic planning and operational efficiency. These strategic games thus reduce an organization to a series of interactive behaviors, but do not combine the existing knowledge and intention of traditional strategic planning and operational planning with game theoretic approaches.

In classic strategic planning organizations are viewed as reversible machines. However, if organizations are treated or modeled as complex adaptive systems that obey the laws of thermodynamics, then some changes are likewise modeled and/or understood as being irreversible, such as capital investment and strategic change. By applying concepts related to the laws of thermodynamics to the modeling of organizations, additional insight can be provided about how certain situations and variables lead to the emergence of new and better organizational structures, while others lead to organizational decline and failure.

Self-organization in nonequilibrium systems (complex adaptive systems) has been known for over 50 years. Under nonequilibrium conditions, the state of a system can become unstable and a transition to an organized structure (a dissipative structure) can occur. Through the concepts of forces and flows, a modern formulation of thermodynamics includes irreversible processes that drive structural change. In this formulation, a change in entropy in time dt is written as:

$$dS = {d}_{i} S + {d}_{e} S \qquad Equation ( 1 )$$

where dᵢS is the entropy production due to irreversible process, always positive according to the 2^{nd} law of thermodynamics, and dₑS is due to the exchange of energy with the environment. The variable dᵢS is directly related to the thermodynamic processes occurring within the system, which are describable in terms of thermodynamic forces and flows.

Thermodynamic forces are typically gradients of intensive variables X (e.g., pressure, temperature, and chemical affinity) divided by temperature, and flows are time-derivatives of the corresponding extensive variable/(volume, heat, and reaction rate, respectively). The irreversible entropy production per unit volume is calculated as the sum of the product of all forces and flows in the system:

$$\frac{{d}_{i} s}{dt} = σ = {\sum }_{i} {X}_{i} {J}_{i} \qquad Equation ( 2 )$$

where s is the entropy density. By integrating dᵢs/dt “over the volume of the system, the total entropy production dᵢs/dt is obtained. Flows are driven by forces, as in the flow of heat driven by a temperature dt gradient, though forces are not functions of the forces alone. Flows may depend on other variables, such as catalysts. Flow rates can vary due to system properties independent of the driving force, such as heat capacity in the case of thermal flows and catalysts in the case of chemical reactions. Critically, Equation (2) establishes that entropy is a direct function of the processes driving changes in a thermodynamic system.

In mechanics, if the initial conditions and forces are known, then the time evolution of the system is entirely determined. Classical thermodynamics, being a theory of states, not processes, does not have time evolution of any variable in its formulation. Modern thermodynamics is a theory of processes, which contains the time evolution of entropy, i.e., the rate of entropy production, and time evolution of flows and forces. Thermodynamics only predicts the final state, not the path towards it and, in this sense, it is end-directed and it is this end directedness that in non-equilibrium systems gives rise to adaptive behavior.

Modern thermodynamics includes Prigogine's minimal entropy production principle, which states that for a system close to equilibrium, where flows are linear functions of forces (e.g., in a linear regime), the steady-state will be that which minimizes the rate of entropy production. If the system is not allowed to reach the state of equilibrium at which the entropy production is zero, it evolves to its minimum possible value. The Onsager reciprocal relations principle can apply in the linear regime.

Modern thermodynamics also includes the maximum entropy production principle (MEPP) that prescribes that a non-equilibrium system will tend towards processes and states for which the rate of entropy production is maximal. These principles of minimal entropy and maximal entropy can be powerful tools for predicting the time evolution of a system to its “end state” independent of knowledge of the complex processes at work within the system. Non-equilibrium thermodynamics has the promise of being both a description of processes within a system, in terms of forces and flows, and the end-states of systems, in terms state variables and the rate of entropy production.

It has been shown that non-equilibrium thermodynamics with irreversible processes leads to spontaneous organization and creation of ordered states. Some far-from-equilibrium systems with nonlinear relations between forces and flows can also develop processes that are structured in space (e.g., fluid convection rolls, chemical patterns) or time (e.g., oscillating chemical reactions) that persist through dissipative processes. Since these organized states or structures are maintained through dissipation of free energy and generation of entropy, they are referred to as dissipative structures. The emergence of these dissipative structures tends to coincide with an increased rate of entropy production required for the maintenance of such structures.

In stark contrast to designed structures (originating from an external source), dissipative structures emerge through characteristics of self-organization as i) amplification of changes, ii) symmetry breaking, iii) states and sensitivity and iv) self-healing. Each aspect of this is reported in the strategic planning literature to occur in organizations large and small.

At a certain state, a system driven by its boundary conditions i.e., the environment, crosses a point of instability, it bifurcates and can make a transition to a new state through a dissipative structure. This growth is driven by autocatalytic processes, wherein a product of a process (e.g., light, charges, or chemical compounds) catalyzes its own production i.e., it amplifies changes. The present disclosure further discloses that the framework is the catalyst of this dissipative structure that enables transition by an organization. This catalyzation has previously been missed in applications of game theory to organizational value and strategy optimization.

Dissipative structures can arise out of symmetry-breaking transitions. In such a transition, the state to which the system evolves does not have the symmetry of the processes that generated it. In mathematical terms, it means the solution to a differential equation does not have the symmetry of the equations.

Due to the symmetry of the equations, symmetry breaking leads to a multiplicity of solutions, each solution related to another through a symmetry operation. In such situations, at the point of transition to a dissipative structure, the system has several states to which it can make a transition. These are the bifurcations. Which state it will transition to will depend on external stimuli or environmental or boundary conditions or some small asymmetries influencing the time evolution of the system. These asymmetries could include external interaction from the environment. For the organizational model described, this could include new injections of capital, insights, new skills amongst others. It could be said that in symmetry breaking transitions, the environment imprints on the structure. The present disclosure further discloses that such phenomena are realized as new learnings, learning which can be aided by machine learning, statistical inference, probabilistic methods and artificial intelligence. The present disclosure further discloses that the symmetry breaking transitions may be identified through probabilistic means.

Some organizational state transitions are very sensitive to environmental conditions: the external factors become correlated with the internal structure. It is through this cooperative sensitivity, that the dissipative structure emerges. The present disclosure further discloses that such phenomena can be realized as new insights that become the loci of transition from a current state to some future desired state. These insights may likely be the realization that the organization is collectively coordinating actions through the cooperative games that is played that yields new products, innovations, or improvements.

Some dissipative structures have been shown to be stable to perturbations. If a spatial or a temporal structure is perturbed, in due course the structure is reestablished. This implies “self-healing”. When there is damage to the structure, the structure is restored. Since the irreversible processes that created a dissipative structure are within the structure, the system may restore the structure and “heal” damages. This aspect is an important characteristic of biological organisms and business organizations alike. The present disclosure further discloses that these are the self-regulatory mechanisms of the root learning model and the continuous improvement model.

Sustained by irreversible processes and continuous flows of energy and matter, living organisms, adhering to the 2^{nd} law of thermodynamics have self-organized and evolved. Though the processes are not fully known, these living organisms are undoubtedly dissipative structures.

It has been shown that modern thermodynamics has the tools of forces, flows, and rates of entropy production that can be used to understand dissipative structures and their associated behaviors. The present disclosure further discloses that these principles may be aligned with the development of a value attribution framework that encourages dissipative structures to form, principally through playing co-operative games that enable to organization to adapt to change.

Historically, organizations have been treated as reversible machines (reversible processes), in which case there is no emergence of dissipative structures, and the 2^{nd} law of thermodynamics would not have been applied. Further, the emergence of dissipative structures in organizations have not been addressed in the literature, they have assumed success and failure in organizations is for means other than entropy. However, as a product of the human condition, organizations are typically complex adaptive systems with dissipative structures that enable them to transition from their current state to their future state.

Therefore, a need exists to enable an organization to be viewed and operated as a complex dynamic system, and in such a system, irreversibility, emergence of dissipative structures, data, information, knowledge, and learning through trial-and-error approaches of game playing are seen as essential elements of its true structure.

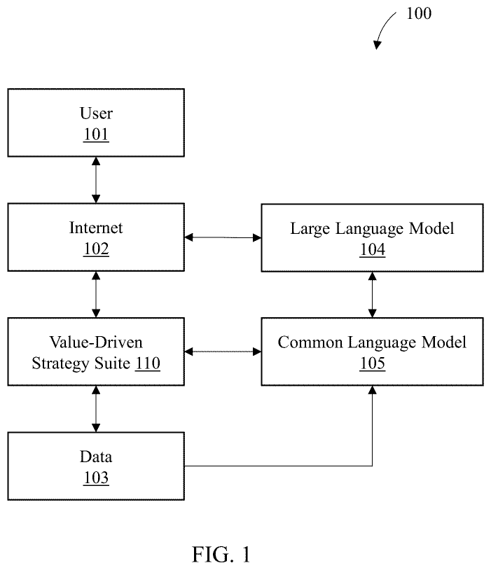

Referring now to FIG. 1, an approach is illustrated for enabling a user 100 to interact via the internet 101 with the Value-Driven Strategy suite 102. The value-Driven Strategy Suite 102 is a software-based solution that integrates data, data science machine learning models, large language models 104, common language model 105, co-operative game play 700 with micro-behaviors 512 and feedback 513 to a value attribution framework (VAF) 200. Through this user interaction as a cooperative game 701, the user 100 dynamically develops, executes and monitors their strategic, operational and tactical plans as a composite of execution and strategy simulation. By adding delayed and hidden rewards in the co-operative game, the approach may more closely mirror the reality of organizations as they adapt their products and services to meet future needs and address competition.

By modeling an organization (large or small) as a complex adaptive system, subject to the laws of thermodynamics, it positions the emergence of dissipative structures 700 through co-operative game play 701 as the central concept that enables an organization to successfully and rapidly adapt their products and services to changing market dynamics.

Extending the concept of dissipative structures from thermodynamics, the approach described herein provides probabilistic mechanisms to identify when bifurcation (breakup) of an organization is likely to occur due to lack of alignment to common goals 600, actions or sentiment. By emerging between the current state and future states of an organization, the strengthening of the dissipative structure metaphorically “pulls the future towards the organization” by enabling it to align to its visions and mission through the workplan and goals using value as the mechanism of agreement.

To support the successful adaptation of the organization's products and services, it provides a value attribution framework 200 that enables an organization to identify the work that is, and will need to be, performed to support the strategic goals.

This value attribution framework 200 provides a phased structure for the work to be performed which includes internal and external feedback as well of simulations and predictions of past and future actions.

These probabilistic predictions are supported by intelligent agents (developed using the common language model, large language models, data science and machine learning), to both explain, teach and provide ingenious alternative actions that the organization could take based on human in the loop processes as described in the framework 200.

To support the generation of strategy and the orchestration of operations, the approach described herein provides a mechanism to develop a common language for the business 105 that ensures that workforce understands the implications of decisions and actions they make, and can more readily determine decisions they should take, and the information they need to make those decisions more effective.

The approach described herein should be considered as a mechanism by which a user interacts with an intelligent system that learns about the organization and its strategy and helps to direct their focus and alignment towards sustainable growth using modern tools from complexity theory, probability, statistics and machine learning and best practice methods of strategy and operations research.

In more detail, referring still to FIG. 1, an overview of exemplary embodiments is provided that illustrate an online, dynamic system accessible via the Internet 101, which integrates user interactions 100, data 103, data science and machine learning models 102, a Large Language Model 104, Common Language Model(s) 105 to provide tailored strategic and operational consulting services for individuals and organizations 100.

In the context of FIG. 1, the User 100 may represent an individual or organization that accesses and interacts with online content, services, or networks via connected devices. The User 100 accesses the Value-Driven Strategy Suite 102 via the Internet 101, which is a global network of interconnected computers and servers that facilitates data exchange and communication across diverse protocols and platforms.

In FIG. 1, the User 100 interacts with the Value-Driven Strategy Suite 102 to develop, execute, and monitor strategic, operational, and tactical plans. The Value-Driven Strategy Suite is a software-based solution that integrates data, data science and machine learning models, and generative AI to provide tailored strategic and operational consulting services for individuals and organizations.

In FIG. 1, as the User 100 interacts with the Value-Driven Strategy Suite 102, they will produce and access Data 103. Data in this context represents a structured set of information or facts that can be processed, analyzed, or used by technology systems to perform specific functions or derive insights.

In FIG. 1, the Data 103 produced through a User's 100 interaction with the Value-Driven Strategy Suite 102 is processed through an individual's or organization's unique Common Language Model (CLM) 105. A Common Language Model (CLM) 105 is an artificial intelligence system designed to understand, process, and generate human language. CLM models utilize machine learning techniques, specifically deep learning, to analyze and generate text with context and coherence. They can perform various natural language processing tasks, such as text completion, translation, summarization, and question answering. CLMs are characterized by their adaptability to different languages and domains, making them versatile tools for a wide range of applications. Examples of CLMs 105 may include but are not limited to virtual assistants, chatbots, content generation, and sentiment analysis, amongst other examples. CLM models are built on extensive datasets and trained on vast amounts of textual data to ensure their effectiveness in comprehending and generating human language.

In FIG. 1, the Common Language Model 105 interacts with an internet-accessible Large Language Model (LLM) 104 to access data, reasoning, summarization, and other capabilities that are based on interaction with data sources from a wide variety of internet sources. According to some embodiments, an LLM 104 can be or comprise an advanced artificial intelligence system characterized by its substantial scale, encompassing an extensive neural network architecture with a vast number of parameters. It is meticulously trained on substantial datasets containing diverse text from the Internet 101, scientific literature, and various sources. In some embodiments, LLMs 104 are adept at natural language understanding and generation, proficient in processing and producing human language text with context, coherence, and relevance across multiple languages and domains. According to some embodiments, the LLM 104 may employ deep learning techniques to execute a wide spectrum of natural language processing tasks, including but not limited to text generation, translation, summarization, question answering, and more. Examples of LLMs 104 include but are not limited to content creation, virtual assistants, medical research, and language translation.

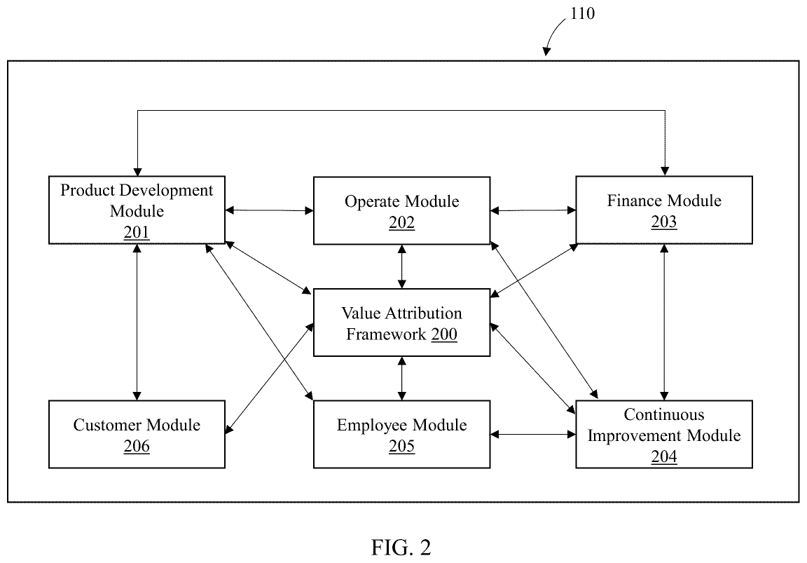

FIG. 2 describes the exemplary embodiments of modular capabilities that comprise the Value-Driven Strategy Suite as previously described in FIG. 1, e.g., step 102. The Value Attribution Framework (VAF) 200 is central to the ecosystem of related modular content.

In FIG. 2, the VAF 200 is a systematic methodology designed to quantify and assign value to specific components or features within an individual's or organization's strategic plans or technological solutions, facilitating informed decision-making for strategic or technical development in respect to investment priorities. The VAF 200 interacts with each of the exemplary modular embodiments in order to exchange information related to a specific function or aspect of an individual or organization. Exemplary embodiments of modules may include but are not limited to Product Development 201, Operate 202, Finance 203, Continuous Improvement 204, Employee 205 (also referred to herein as People 205), and Customer 206. Detailed descriptions of the embodiments are provided below.

As illustrated in FIG. 2, this disclosure, according to some embodiments, describes various unique attributes and capabilities of the VAF 200, as described in the paragraph above. The additional modules offered through the Value Driven Strategy Suite, see FIG. 2, are referenced below but are not within the scope of this patent. These modules may be further described in subsequent patent applications.

In FIG. 2, a Product Development Module 201 which may describe a module of the Value-Driven Strategy Suite FIG. 1, at step 102 that includes a systematic methodology designed to provide strategy and decision support for individuals or organizations seeking to design and implement new products.

In FIG. 2, an Operate Module 202 which may describe a module of the Value-Driven Strategy Suite FIG. 1, e.g., at step 102 that includes a systematic methodology designed to provide strategy and decision support for managing an individual's or organization's operations.

In FIG. 2, a Finance Module 203 which may describe a module of the Value-Driven Strategy Suite FIG. 1, e.g., at step 102 that includes a systematic methodology designed to provide strategy and decision support for individuals or organizations seeking to manage the performance of financial inputs, such as revenue, and outputs, such as expenses.

In FIG. 2, a Continuous Improvement Module 204 which may describe a module of the Value-Driven Strategy Suite FIG. 1, e.g., at step 102 that includes a systematic methodology designed to provide strategy and decision support for individuals or organizations seeking to improve their operations or product offerings.

In FIG. 2, an Employee (People) Module 205 which may describe a module of the Value-Driven Strategy Suite FIG. 1, e.g., at step 102 that includes a systematic methodology designed to provide strategy and decision support for individuals or organizations seeking to manage the performance of individuals within the organization or that contribute to shared goals.

In FIG. 2, a Customer Module 206 which may describe a module of the Value-Driven Strategy Suite FIG. 1, e.g., at step 102 that includes a systematic methodology designed to provide strategy and decision support for individuals or organizations seeking to manage and improve relationships with customers.

Referring now to FIG. 4, an exemplary embodiment describing the key User Actions, System Actions, Model Actions, and Dissipative Structure's organization within the context of Phases within the Value Attribution Framework FIG. 2, e.g., at step 200, is shown.

In FIG. 4, a process e.g., as illustrated in FIG. 1 at step 100 is provided in which a User interacts with the Value Attribution Framework FIG. 2 at step 200 may be described by phases of sequential activities that demonstrate progressive action toward the development of an individual's or organization's strategic and operational plans and supporting actions. The phases of the Value Attribution Framework may include but are limited to the following exemplary embodiments:

In FIG. 4, Initiation Phase 300 encompasses all activities related to a person accessing the Value-Driven Strategic Consulting company's website directly, downloading the Value-Driven Strategic Consulting mobile application through a third-party, or otherwise interacting with the Value-Driven Strategic Consulting software initially. The person (e.g., User in FIG. 1 at step 100) creates a user profile, which allows them to access the Value Attribution Framework's Needs Assessment.

In FIG. 4, Needs Assessment Phase 301 encompasses all activities involving user interaction with the VAF (Value Assessment Framework) to self-identify as either an individual or an organization. During this phase, users define ‘value’ on their own terms, which may include self-assessments of the robustness of their strategy concerning vision, mission, goals, projects, or actions. These user responses are captured qualitatively, and an Entropy baseline score is established 600. The needs assessment establishes the current environment baseline 700 and rules or conventions of the co-operative game 701 that develops the strategy and operations approach.

In FIG. 4, Profile Information Phase 302 encompasses all activities related to a user providing information regarding the customers that they serve, products or services that they offer, historical performance, internal functions and organizational structure, skills required to perform functions and responsibilities, and employees or shared resources within the organization.

### Developmental Phases

In FIG. 4, Envisioning Phase 303 primarily focuses on the creation of a vision statement and optional mission statement 501, including delivery phase information 502, for a desired target state in respect to the organization's goals. In some embodiments the Envisioning Phase 303 may also involve the playing of the co-operative game 702 that develops the strategy, operational structures, and dissipative structure.

In FIG. 4, Planning Phase 304 encompasses all activities related to aligning goals 503, phase success metrics 504, project portfolios embodied in a Management by Fact structure 506, individual projects 507, project success goals and metrics 508, risk mitigation plans embodied as Control Plans 509, 704, individual project steps as described in a Work Plan 510, and resources in respect to the vision 501 and delivery phase goals 503. In some embodiments, the Planning Phase 304 may involve the playing of the co-operative game that develops the strategy and operational structures. This phase also involves the playing of the co-operative game 703 that develops the strategy and operational structures.

In FIG. 4, Executing Phase 305 encompasses all activities related to designing, building, delivering 415, and monitoring the progress 511 and performance 512 of change related projects and actions. It includes progress, performance, and mitigating action 416 monitoring, tracking, and notification 513. In some embodiments, the Executing Phase 305 may involve the playing of the co-operative game that develops the strategy and operational structures 705.

In FIG. 4, Achievement Phase 306 encompasses all activities related to the successful completion of a user or organization's vision's target state performance 706 (see, e.g., FIG. 34, at 706). Users will have the choice as to whether to complete their journey with the VAF and not monitor future performance, or to continue their journey by completing a new, revised vision statement 418.

FIG. 4 will be referenced extensively within the context of this patent. A narrative format is used to portray the detailed descriptions of the patent's figures, as each Figure provides greater depth and concepts central to the Value Attribution Framework.

In addition to describing the phases of the VAF 200, FIG. 4 also provides additional detail regarding the User's Actions that take place during each of the aforementioned phases.

Referencing again FIG. 4, during the Initiation Phase 300, a user becomes aware 400 of the VAF 200 through various channels such as marketing, word of mouth, or social media. The user may then access the Value-Driven Strategic Consulting company's website directly, download the Value-Driven Strategic Consulting mobile application through a third-party, or otherwise interact with the Value-Driven Strategic Consulting software. The user then registers 401 by creating a user profile, which allows them to access the Value Attribution Framework's Needs Assessment 402.

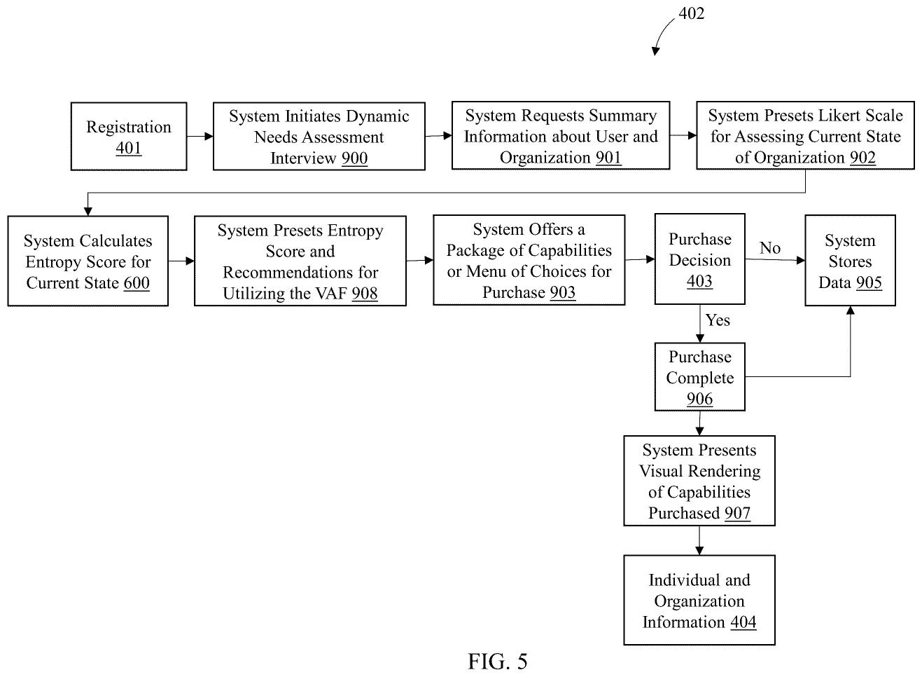

Referencing again FIG. 4, during the Needs Assessment Phase 301 the user may interact directly with the VAF 200 through answering questions contained in a Needs Assessment 402. For detailed information describing the Needs Assessment 402, please refer to FIG. 5 and the associated discussion of FIG. 5 below.

Referring now to FIG. 5, once the Registration is complete as referenced in FIG. 5, at 401, the system will Initiate a Dynamic Needs Assessment Interview 900 where the system prompts the user to provide information about themselves, their organization, their needs, and goals for the future.

Referring again to FIG. 5, the system may Request Summary Information about the User and Organization through questions presented to a user in an intuitive interview that is facilitated by software, at 901. After completing basic information such as the individual's or leader's name, organization or company, location, and contact details; the system will prompt the user to describe the purpose of the user or organization seeking to use the VAF 200.

Referring still to FIG. 5, the System can present a Likert Scale for Assessing Current State of Organization that prompts the user to rate how robust their planning or definition is currently regarding vision & mission, goals, and projects or actions. These are captured qualitatively in a Likert Scale, at 902.

Referencing FIG. 5, based on the user's assessment, the system will Calculate an Entropy Score for Current State. Establishing and Maintaining an Entropy Score 600, see also FIG. 4 and FIG. 12, at 600, which illustrate the creation and continuous calibration of a metric that models an individual's or organization's degree of support, sentiment and alignment of actions and resources toward successfully achieving the desired target state. The Entropy score will be updated throughout the user's journey with the VAF 200.

In FIG. 5, the system can then Present the Entropy Score and Recommendations for Utilizing the VAF, at 908, by presenting the user with an individual or organizational Entropy Score 600 based on the user's Likert scale responses. The system may also reiterate the benefits of utilizing the VAF 200, including but not limited to creating transparency, active management, and structure to achieve their vision. The system will align the recommendations to their Entropy Score. For instance, if entropy is high (very unorganized), then the system will reiterate the structured approach offered by the VAF 200 to achieve their desired end state. If entropy is low (well aligned) the system may recommend utilizing the VAF 200 to sustain the current momentum through data-driven progress and goal monitoring.

Still referencing FIG. 5, after the user has reviewed the recommendations, at 908, the system may Offer a Package of Capabilities or Menu of Choices for Purchase, at 903. The system may present a recommendation of a package of products as a service for purchase based on the organization's stated purpose. The system may also offer individual components as a menu of choices.

According to FIG. 5, after reviewing the offerings, the user must either select a package, select from a series of desired capabilities, or select one or more modules (which are predefined packages of capabilities) for purchase as a subscription service if they desire to obtain the rights to utilize a product module(s) 403, please also see FIG. 4, at 403.

Referencing FIG. 5, if the user decides to purchase a subscription to the VAF and optional modules, the system will capture the user's choice made, in respect to purchasing the products or services as a monthly or annual subscription 906.

Referencing FIG. 5, the System then Stores the Data that represents the results of the Needs Assessment as data in online accessible data storage 905. This action occurs regardless of a user's decision to purchase the products.

The data is stored in a common language model that enables the organization and its attendant intelligent agents to adapt to new information. This data may also be used in calibrating future Lookalike Models between unrelated individuals or organizations. For more detailed information regarding Lookalike Models, see, e.g., FIG. 4, at step 601.

Referencing FIG. 5, once the purchase is complete, the System will Present a Visual Rendering of Capabilities Purchased through a visual hierarchical rendering of the capabilities purchased (such as a block diagram) with recommended sequencing for completion 907.

Referring to FIG. 12 at 4100, the Entropy Score is Recalculated Given the user's Purchase Decision and Product Prioritization. This describes the process of adjusting the entropy score given new information about the user and their intentions. The entropy score may be adjusted now, given that the user has defined the scope of the engagement and intent on progressing forward.

Referencing FIG. 4, This action marks the end of the Needs Assessment Phase (see, e.g., FIG. 4, at 301) and transition into the Profile Phase as shown on FIG. 4, at 302.

Referencing FIG. 4, completion of the Needs Assessment 402 also sets the stage for calculating and establishing the Current Environment's Baseline 700. This action describes the first assessment of an individual's or organization's Dissipative Structure. Traditionally, a dissipative structure is described as a self-organizing system that maintains or increases its organization by exchanging energy, matter, or information with its environment, often observed in thermodynamically open systems away from equilibrium. In the context of the Value-Attribution Framework (see, e.g., FIG. 2, at step 200), the Dissipative Structure describes the degree of alignment between target state, defined goals, and specific actions.

The strength of the structure's organization is related to support for, performance of, and velocity of achieving goals based on resource sentiment, capability performance reporting, and timeliness performance reporting. A dissipative structure will form when the participation by the users is such that there is alignment between them in the definition of and achievement of shared goals. There is a corollary in the emergence of dissipative structures in physical systems to those in organizational systems. Whereas Lyapunov functions, Lyapunov equations, Eigenvalue analysis and their Jacobian are used to determine bifurcation of dissipative structures, this patent uses entropy scores 600 as predictors of stability and behavior.

Referencing FIG. 4, the data collected during the Needs Assessment 402 also provides the system with information utilized in establishing a baseline for a unique Common Language Model 500.

Referencing FIG. 20, Establishing a Baseline for a Common Language Model (CLM) 500 involves creating a model based on the specific language used within an individual's or organization's context while utilizing the VAF 200. This process includes selecting a language processing task, defining relevant evaluation metrics, and collecting diverse datasets. The initial data to create the model is sourced during the Needs Assessment (see, e.g., FIG. 4, at 402) based on the user's responses. A CLM 500 may use natural language processing (NLP) to allow agent-based interaction in all areas of the system including FTA, DTA, Scenario Planning and Micro-Behaviors. The CLM 500 allows agents in the multiagent system to communicate, store, retrieve, search and interact with each other and so optimize interactions, actions and decisions to support the goals of the system. Once the model is chosen and, if needed, fine-tuned, it's evaluated on a test dataset using predefined metrics. The resulting performance metrics serve as a baseline for measuring the model's effectiveness.

Referencing FIG. 20, users can then iterate and improve the model, adjusting configurations and comparing newer versions to the established baseline. Throughout the process of interacting with the VAF 200, system data such as, e.g., intelligent Agent, and User Data, Decisions, Actions, Insights, Opportunities and Feedback are Stored and Transformed Using a Common Language Model, at 801. This describes the process of continuously calibrating a language model with data specific to the user, individual, or organization utilizing the VAF 200. The Common Language Model will be updated throughout the process of an individual or organization transitioning from their current state to their desired target state based on the specific diction utilized in the user's responses and interaction with the VAF 200.

Referencing FIG. 4, at this point in the process, the Structure of Co-Operative Game is Defined and Played Out, at 701. This process describes all activities related to creating scenarios where users, or game players, can form binding commitments or coalitions, working collaboratively to maximize their joint utility or payoff. In the context of the Value-Attribution Framework (see, e.g., FIG. 2, at step 200), this relates specifically to different facets of an individual or members of an organization working together to achieve goals in respect to the target state. The structure of this Co-operative game is attendant on the players of the game determining the rules of their interaction, and then abiding by them. This subtle shift in focus allows the framework artifacts, their construction, and alignment to be the rules of the game. The Shapley Values and Nash Equilibria are thus derived from these constructs.

Referencing FIG. 4, after completing their purchase 403, the user may now complete activities related to providing detailed information 404 regarding the customers that they serve, products or services that they offer, historical performance, internal functions and organizational structure, skills required to perform functions and responsibilities, and employees or shared resources within the organization.

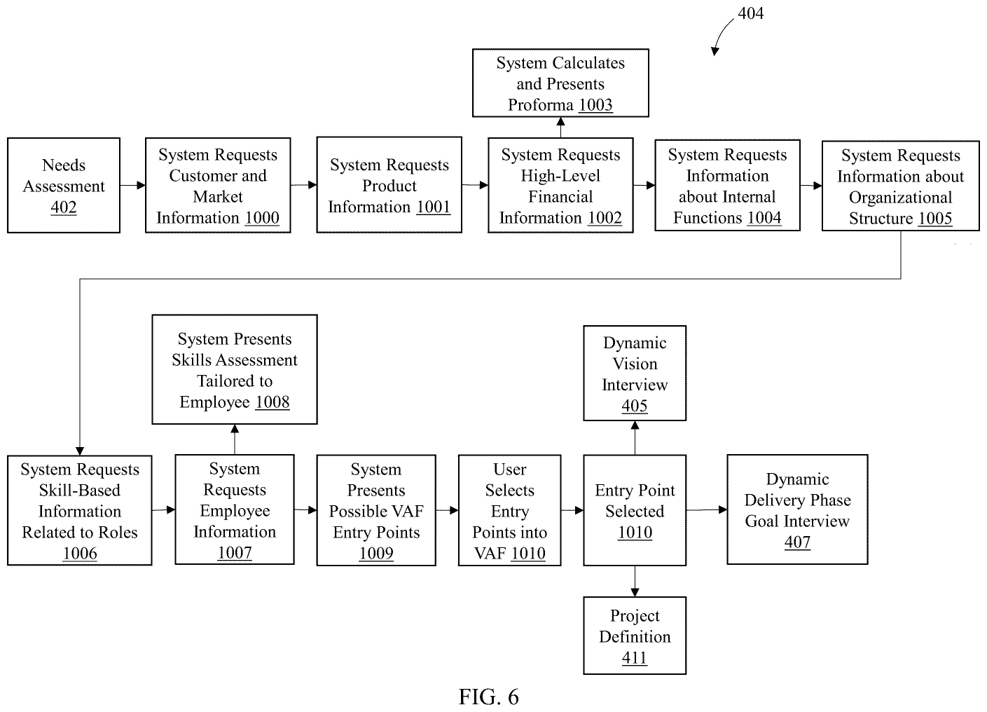

FIG. 6 provides a detailed description of the steps and information gathered during the Individual and Organizational Information step (see, e.g., FIG. 4, at 404) within the Profile Information Phase 302.

Referencing FIG. 6, during this process, the System first prompts the user to provide Customer and Market Information regarding the customers that the individual or organization serves by specifying: the customer segment, customer name, length of relationship and estimated current sentiment, at 1000.

Referencing FIG. 6, next the System Requests Product Information by prompting the user to provide information regarding the products or services they offer to their customers. Detailed information shall include but is not limited to the product or service's name, price per customer, customer segments supported, historical volume of transactions per year, fixed costs, marginal cost to produce, and estimated transactions over a user-defined time period, at 1001.

Referencing FIG. 6, next the System Requests High-Level Financial Information by prompting the user to document what products or services have been purchased by the customer historically, what they paid, and how frequently they transact with the organization, at 1002.

Referencing FIG. 6, the system can then produce a proforma, including profit and margin over time, for each product and the organization as a whole. The system will utilize the customer, product, and financial information provided to build a projected financial statement, based on current performance, and given assumptions, used to model and forecast future financial performance, at 1003.

Referencing FIG. 6, next the System may Request Information about the individual's or organization's Internal Functions. This describes the system prompting the user to provide information pertaining to the ‘internal functions’ of the organization that do not interface directly with customers. Examples may include but are not limited to management activities, payroll, accounting, training, maintenance, and marketing. The system will provide examples of common internal functions and request information regarding how much time, effort, cost are consumed by the internal functions, at 1004.

Referencing FIG. 6, next the System may Request Information about Organizational Structure by prompting the user to provide information regarding the organization's structure, including any defined departments (or unique embodiments with separate or partial adoption of the organization's focus), differentiated roles within or across departments, and alignment of roles to products, services, or internal functions, at 1005.

Referencing FIG. 6, next the System may Request Skill-Based Information Related to Roles by prompting the user to identify the critical skills required by each role within an organization and required skill level or proficiency, based on their experience with utilizing that skill, by each role, at 1006.

Referencing FIG. 6, the System may Request Employee Information by prompting the user to provide information about the organization and the individuals that work or volunteer within it. The system will require their name, ID, department (if applicable), assigned role(s), hours per week, weeks worked in a year, rate (total compensation decomposed by hour), start date, and performance rating (if available) by year, at 1007.

Referencing FIG. 6, next the System may Present the user with an optional Skills Assessment Tailored by Employee. Here the system creates the capability for the organization to assess an individual's competency based on the required skills as defined by role. The organization may now execute a skills assessment of its workers by either the leader of or a manager within the organization or by a self-assessment conducted by the workers themselves. The skills assessed would include all role-based required skills and any other selected skills that are pertinent to the organization but not directly required by the role, at 1008.

Referencing FIG. 6, next the System may Present Possible VAF Entry Points where the user is prompted to determine where, in context of the VAF's components, they would like to begin working, at 1009. In some embodiments, the default recommendation is to begin with describing their vision for a future state, however the individual can opt to begin at any defined point within the hierarchy. Defined entry points may include but are limited to beginning with the Dynamic Vision Interview (see, e.g., FIG. 4, at 405), Dynamic Delivery Phase Goal Interview (see, e.g., FIG. 4, at 407), or Project Definition (see, e.g., FIG. 4, at 411).

Referencing FIG. 6, now the User may Select their desired ‘Entry Point’ into the VAF 200. This describes the user's decision pertaining to which portion of the VAF 200 the user wishes to work on first, at 1010. After completing the information and activities associated with their chosen Entry Point, the system will then prompt the user to complete information related to sections of the VAF 200 that are hierarchically located ‘above’ the current selection or, if all preceding sections have been completed, the system will prompt the user to complete information related to the next sequential section of the VAF 200.

Referencing FIG. 6, once the Individual and Organization Information 404 has been provided, the user may now provide additional information to the system through a virtual Dynamic Vision Interview 405.

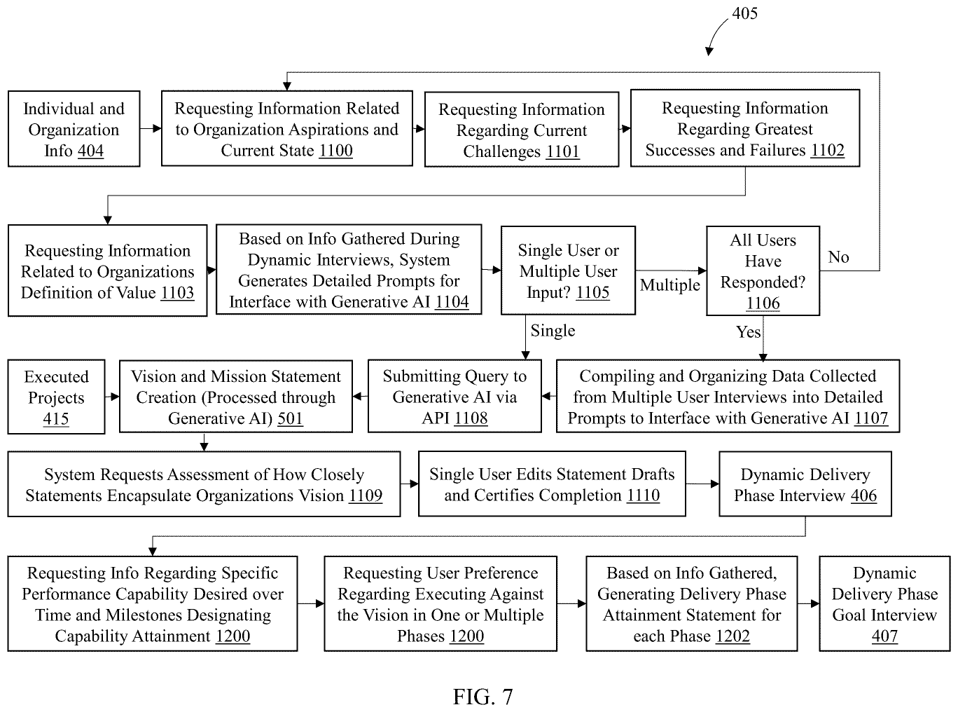

FIG. 7 provides a detailed description of the exemplary embodiments that describe the steps and information gathered during the Dynamic Vision Interview (see, e.g., FIG. 4, at 405) and Dynamic Delivery Phase Interview (see, e.g., FIG. 4, at 406) within the Envisioning Phase 303.

Referencing FIG. 7, the Dynamic Vision Interview begins with the System Requesting Information from the user Related to the Individual's or Organization's Current State and future Aspirations, at 1100. The system will prompt the user with questions regarding their desired target state in respect to their or the organization's goals. Through a virtual interview, individuals or organizations answer questions about the company's aspirations, current situation, and desired future.

Referencing FIG. 7, next the System may Request Information Regarding Current Challenges where the system will prompt the user for information regarding their current challenges or obstacles that could prevent the organization from reaching the target state, at 1101.

Referencing FIG. 7, next the System may Request Information Regarding Greatest Successes and Failures by prompting the user for information regarding their greatest successes and largest failures, why these are important to the individual or organization, and how they learned from them, at 1102.

Referencing FIG. 7, next the System may Request Information Related to the Organization's Definition of ‘Value’ by prompting the user for information regarding their unique definition of what value, in terms of the future state, means to the organization, at 1103.

Referencing FIG. 7, based on Information Gathered During Dynamic Interviews, the System may Generate Detailed Prompt(s) to Interface with Generative AI, at 1104, to process the user's responses using generative AI or a Large Language Model (see, e.g., FIG. 1, at step 104) to form a draft of the individual's or organization's vision and mission statements (see, e.g., FIG. 4, at 501).

Referencing FIG. 7, next the system may prompt the user to select whether the information they have provided represents all perspectives or one of many perspectives, at 1105. The user's response determines how the system-generated prompts are constructed and submitted to a generative AI model in order to construct the vision and mission statements.

Referencing FIG. 7, if multiple responses from unique individuals or members of an organization are required as input, the system may not submit the prompt to the LLM (e.g., 104) to produce the vision and mission statements until all required responses have been received, at 1106.

Referencing FIG. 7, once all responses have been received, where multiple responses are required or received, the system may then Compile and Organize the response Data Collected from the Multiple User Interviews into Detailed Prompt(s) to Interface with Generative AI, at 1107. Unlike a single user's input, the system must first collate response data when multiple responses are required or received.

Referencing FIG. 7, once the prompts are generated, the System may then Submit the Query to Generative AI through API Connection. This describes the process of submitting the structured prompt, for either a single user or collated results from multiple users, to a generative AI model through a defined API connection, at 1108.

Referencing FIG. 7, based on the results returned from the generative AI model, the system will present the Vision and Mission Statements 501, (see, e.g., FIG. 4 and FIG. 12, at 501). The target state Vision Statement and optional Mission Statement describe the desired future state of performance, capability, or progress of an individual or organization.

Referring to FIG. 12, the Entropy Score is now Recalculated Given the Alignment established through Vision Statement, at 4101. This describes the process for adjusting the entropy score given new information about the user and their intentions. Given that a direction and desired target state has been established, the estimated entropy between intention and action is recalculated to be lower signaling increased alignment to the vision.

Referencing FIG. 34, at 4113, when an Entropy Decreases, it describes the scenario where an individual's or organization's degree of support, sentiment, and alignment of actions and resources increases in respect to the current state. A ‘lower’ Entropy Score represents decreased uncertainty, increased support, and stronger alignment between goals, actions and resources.

Returning to FIG. 7, next the System may Request the user to Assess How Closely the Vision and Mission Statements Encapsulate the Organization's Vision. Here the system prompts the user for a qualitative assessment regarding the degree to which the vision and mission statements actually embody the desired target state and aspirations of the individual or organization, at 1109.

Referencing FIG. 7, next a Single User (as a Representative of the Organization) may Edit the Statement Draft(s) and Certify their Completion, at 1110. This describes all activities related to a single user revising the vision and/or mission statement previously generated through their responses and structured prompts to generative AI. When multiple user responses and perspectives are required as inputs, the system will require a single user to act as the final arbiter of the revisions.

Referencing FIG. 7, after successfully creating their vision and mission statements (see, e.g., FIG. 4, at 501) the user may now interact with the system in a virtual interview related to structuring progress against the target state 406 by defining unique phases, e.g., as illustrated in FIG. 7, at 406.

Referencing FIG. 7, the Dynamic Delivery Phase Interview may begin with the System Requesting Information Regarding Specific Performance Capability Desired Over Time and Any Milestones that would Designate Capability Attainment, at 1200. This describes the system prompting a user to define the desired capability changes that would result from actions taken by the individual or organization in respect to attaining the target state. The system also prompts the user to describe any specific, tangible outcomes that may act as milestones or proof of sustained progress toward the target state attainment.

Referencing FIG. 7, next the System may Request the User's Preference of Executing Against the Vision in One or More Than One Phase, at 1201. The system will prompt the user to determine whether the organization's vision can be achieved in a single phase or requires multiple delivery phases. They are given the option to organize these into a number of phases manually or for the system to make a recommendation based on the scope of change required to achieve the target state in respect to current performance levels. The recommendation is processed through interaction with a generative AI model (Large Language Model).

Referencing FIG. 7, based on Information Gathered Previously, the System Generates a “Delivery Phase Attainment Statement” for Each Phase defined, at 1202. This describes the system generating a structured prompt for submission to a generative AI model (e.g., LLM 104) based on the information gathered during the interview and the individual's or organization's stated preferences. Based on the results of the AI generated response, the system generates a number of delivery phases and describes the new state of performance, capability, or progress in a ‘delivery phase attainment statement’, (see, e.g., FIG. 4, at 502). This marks the end of the Dynamic Delivery Phase Interview (see, e.g., FIG. 4, at 406) and transition into the Dynamic Phase Goal Interview (see, e.g., FIG. 4, at 407).

Referencing FIG. 4, at this point in the process, the Organization's Intention is Defined and the Dissipative Structure begins to Emerge, at 702. This process describes the emergence of a dissipative structure based on the individual's or organization's intention as described within the Vision and Mission statements and delivery phase descriptions. The Dissipative Structure strengthens when the activities in the workplan are completed, milestones are met, deliverables are produced, at 703 (see also FIG. 34, at 703).

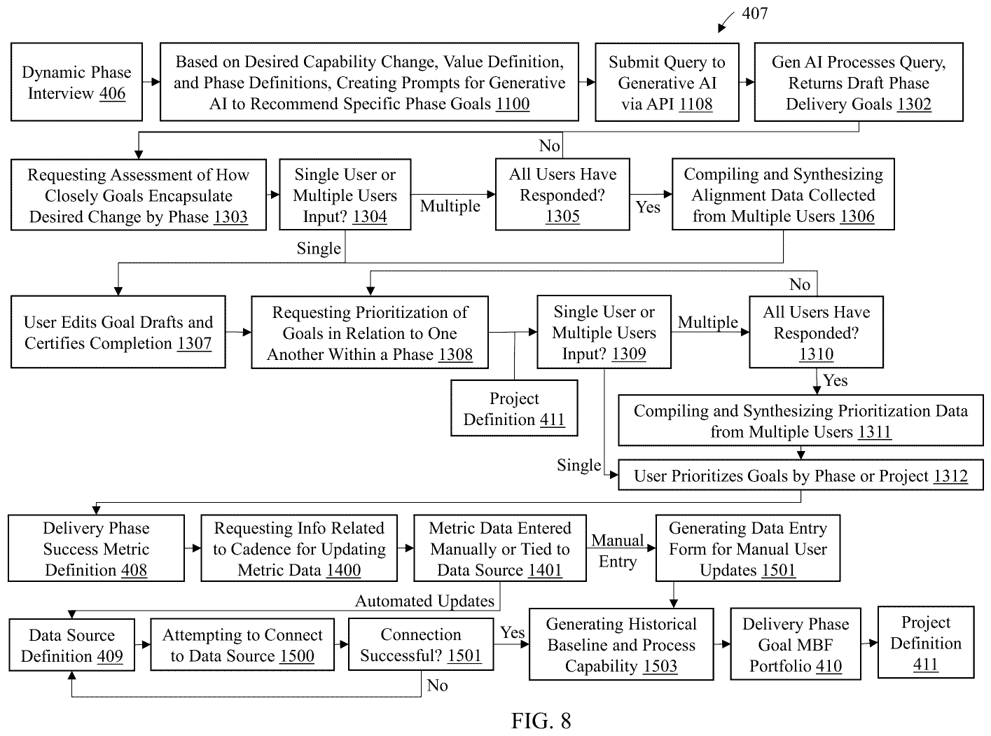

Referencing FIG. 4, now that the user has defined the Delivery Phases 502 of their strategy, they may define and prioritize ‘phase delivery goals’ that signal progress and completion of phase activities, at 407. Phase delivery goals are primarily aligned to the creation of value (in the individual's or organization's terms) or secondarily to development of supporting capabilities that enable value creation. FIG. 8, for example, provides a detailed illustration of an embodiment comprising a Dynamic Delivery Phase Goal Interview.

Referencing FIG. 8, Based on Desired Capability Change, Value Definition, and Phase Definitions, the System may Create Prompt(s) for a Generative AI model to Recommend Specific Phase Goal(s), at 1300. This describes the system creating a structured prompt, based on information previously submitted by the user during the Dynamic Vision Interview and Dynamic Delivery Phase Interview, for processing by a generative AI model. The prompt will request the creation of measurable goals that describe iterative progress toward target state attainment.

FIG. 7, at 1108, illustrates that the System may then Submit the Query to Generative AI through a defined API Connection.

Referencing FIG. 8, the generative AI or LLM (e.g., 104) may then Process the Query and Return Draft(s) of Phase Delivery Goal(s). This describes the process and result of submitting the structured prompt, for either a single user or collated results from multiple users, to a generative AI model which creates Phase Delivery Goal(s), at 1302.

Referencing FIG. 8, once the Phase Delivery Goals have been created, the System may Request the user's Assessment of How Closely the Goals Encapsulate the Desired Change by Phase, at 1303. This describes the system prompting the user for a qualitative assessment as to the degree to which the Delivery Phase Goals actually embody the metrics which describe the desired target state and aspirations of the individual or organization.

Referencing FIG. 8, as previously described in reference to FIG. 7, the system may then prompt the user to select whether the information they have provided represents all perspectives or one of many perspectives, at 1304. The user's response determines how the system-generated prompts are constructed and submitted to a generative AI model in order to construct Delivery Phase Goals.

Referencing FIG. 8, if multiple responses from unique individuals or members of an organization are suggested or required as input, the system might, in some embodiments, not process the Phase Delivery Goal information until all required responses have been received, at 1305.

Referencing FIG. 8, if multiple responses are recommended or required, the System may then Compile and Organize Data Collected from Multiple Users, at 1306. This describes the process of the system preparing all response data into a prompt for submission to a generative AI model (e.g., LLM 104). Unlike a single user's input, the system must first collate the response data received from multiple responses.

Referencing FIG. 8, once the results of the prompt to the LLM (e.g., 104) have been received, a Representative of the Organization may Edit the Goal Draft(s) and Certify Completion, at 1307. This describes all activities related to a single user revising the Phase Delivery Goals previously generated through their responses and structured prompts to generative AI. When multiple user responses and perspectives are required as inputs, the system will require a single user to act as the final arbiter of the revisions.

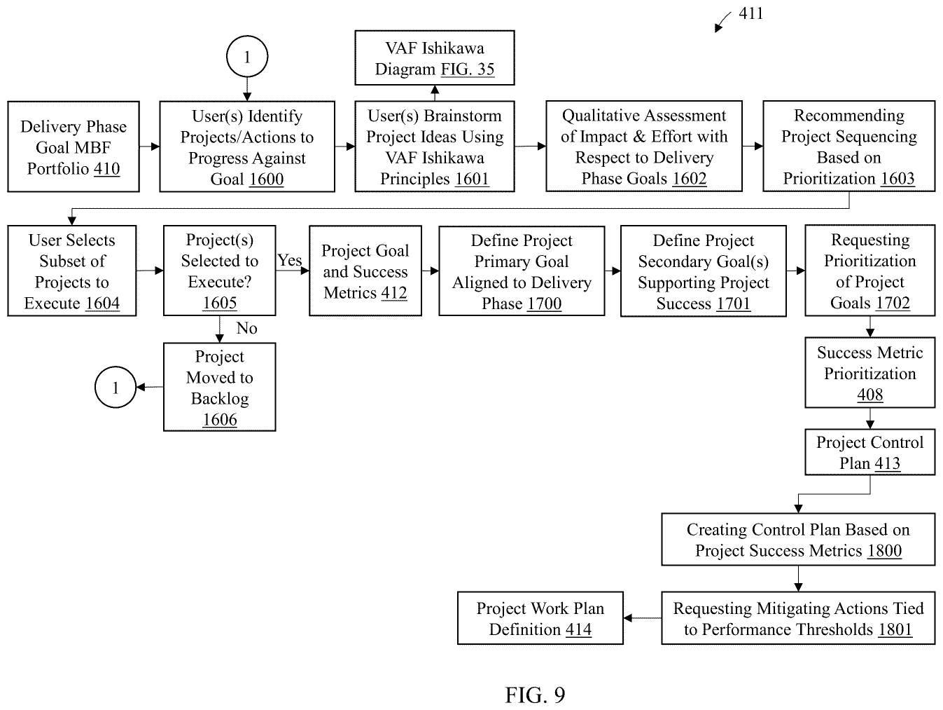

Referencing FIG. 8, the System may next Request the user's Prioritization of the Goals in Relation to One Another Within a Phase, at 1308. Prioritization may be accomplished through but not limited to aggregating preference data by aggregating the results of multiple users individually completing instances of an Analytical Hierarchy Process by utilizing pairwise comparisons, or by ordinal ranking goals by quantifying support and variation between multiple responses for a desired level of prioritization, or by aggregating sentiment through surveys leveraging a Likert scale. Goals will be prioritized according to their percent weight contribution on a 0-1 scale within a Delivery Phase. In some embodiments, an aggregate of the prioritized goals must equal 100% for each phase. In some embodiments, this and the subsequent steps within FIG. 8 (e.g., from 1309-1503) also describe the process(es) for prioritizing Project Success Metrics (see also FIG. 9, at 408).

Referencing FIG. 8, next the system may prompt the user to select whether the information they have provided represents all perspectives or one of many perspectives, at 1309. The user's response determines how the system-generated prompts are constructed and submitted to a generative AI model in order to construct Delivery Phase Goals prioritization.

Referencing FIG. 8, if multiple responses from unique individuals or members of an organization are suggested or required as input, the system may, in some embodiments, not process the Phase Delivery Goal prioritization information until all required responses have been received, at 1310.

Referencing FIG. 8, if multiple responses are suggested or required, the system may prepare all response data into a prompt for submission to a generative AI model (e.g., LLM 104), at 1311. Unlike a single user's input, the system must collate response data from multiple responses.

Referencing FIG. 8, next the user may confirm the Delivery Phase Goal(s)'s prioritization of goals within the context of other goals aligned to the same Delivery Phase, at 1312.

Referencing FIG. 8, this marks the end of the Dynamic Goal Interview (as also depicted in FIG. 4, at 407) and the beginning of a user creating a Success Metric Definition 408 (see, e.g., FIG. 4, at 408).

Referring back to FIG. 4, Phase Delivery Goals 503 may be measured by data-driven Success Metrics 504. After defining their Phase Delivery Goals, the user may define one or more success metrics or measurable outcomes that describe successful goal attainment, at 408. One or more success metrics are required for each defined phase. Success metrics are tracked, at 512, against a performance threshold, historical performance baseline, and current changes to performance once a project is defined, at 411, and execution of the project has begun, at 415. These metrics may describe and integrate with various data sources such as but not limited to finances, social media, and productivity apps.

Returning to FIG. 8, once the Success Metrics have been defined, the System may Request Information Related to Cadence for Updating Metric Data. This describes all activities related to a user describing their preferences for how often the system should collect, aggregate, and analyze data related to metric performance, at 1400.

Referencing FIG. 12, at 4102, the Entropy Score is now Recalculated Given the Introduction of Goals and Metrics. This describes the process for adjusting the Entropy Score given new information about the user and their intentions. Given that the individual or organization has defined specific, measurable goals in respect to the target state, the path toward attaining the target state becomes more defined. This represents a stronger, more organized, and aligned intention, which reduces the Entropy Score.

Referencing FIG. 8, Success metrics, (e.g., as defined according to the process illustrated in FIG. 4, e.g., at 504), may require data to quantify performance. The system may now prompt the user to capture whether the data to substantiate metric performance exists in an online, queryable data source or by the user if performance updates are manually submitted, at 1401.

Referencing FIG. 8, Defining a Data Source connection (see, e.g., FIG. 4, at 409) may encompass some or all activities related to establishing the ability to read data from a source system accessible through the internet (see, e.g., FIG. 4, at 505). Examples of data may describe but are not limited to financial performance, online interactions, human resources information, productivity information, or a project's progress amongst other potential sources and focus areas.

Referencing FIG. 8, next the System may Attempt to Connect to Data Source to make an API call to the source system of metric performance data, at 1500.

Referencing FIG. 8, the system may then classify whether the attempt to establish a connection with the metric performance data's source system was successful or unsuccessful, at 1501, and, if unsuccessful, may prompt the user to revise the Data Source Definition, at 409.

Referencing FIG. 8, if the data must be entered manually by the user, the System may then Generate a Data Entry Form for Manual User Updates, at 1502. This describes the process for the system to create a data entry form based on the user-defined Success Metrics, given that a connection to a source system is not available. Progress and performance will be calculated and tracked based on the user's manual inputs.

Referencing FIG. 8, now that the system has received data that characterizes the success metric, the System may Generate a Historical Baseline and Process Capability, at 1503. This describes the system calculations for establishing a baseline of performance, given either source system historical data or manual user input.

Returning to FIG. 4, establishing a success metric's historical performance baseline marks the end of the success metric's Data Source Definition (see, e.g., FIG. 4, at 409) and resulting Data Source Connection (see, e.g., FIG. 4, at 505) and transition toward defining a Management By Fact Portfolio (see, e.g., FIG. 4, at 410).

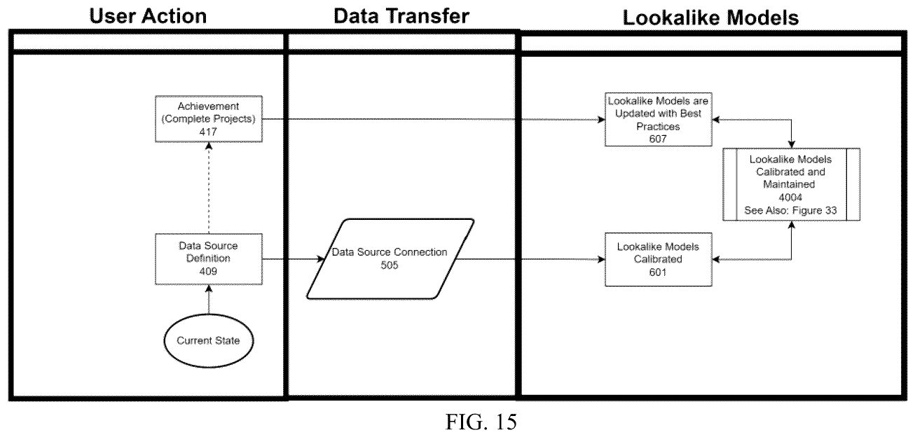

Referencing still to FIG. 4, however, once performance may be quantified by establishing a success metric's historical baseline through a Data Source Connection, at 505, Lookalike Models may now also be Calibrated, at 601 (see also FIG. 15, at 601).

Referencing FIG. 33, a diagram is provided that illustrates an embodiment of a process for calibrating Lookalike Models. Calibrating Lookalike Models describes the creation of mathematical models that predict the individual's or organization's probability of success in achieving a project, goal, or target state. Information gathered from across multiple individuals or organizations at various stages of their strategic development are compared and clustered using Multivariate Cluster Analysis or other analytical methods to establish common success profiles that may inform users in similar circumstances of the historical performance of decisions, goals, and actions (see, e.g., FIG. 15, at 4004).

Referencing FIG. 33, Lookalike Models, in the context of the VAF 200, may require a diverse set of data that is sourced throughout the VAF 200. The data utilized may describe an individual's or organization's Focus 4000, Performance 3026, and Profile 4001.

Referencing FIG. 33, an Organizational Profile 4001 may be derived from the user's responses during the Individual and Organization Information (see, e.g., FIG. 4, at 404, and FIG. 6 for additional data and flow information). The information utilized will include but is not limited to Customer and Market Information 1000, Product Information 1001, High-Level Financial Information 1002, Internal Functions Information 1004, and Organizational Structure Information 1005.

Referencing FIG. 33, the Organizational Profile 4001 describes the result of summarizing information related to the individual or organization into categories that may be compared to other individuals or organizations. Information utilized to create the categories may include but is not limited to the individual or organization's industry, size, margin, profitability, sales transactions, revenue, markets served, customer segments served, types of products offered, number of customers, number of employees, and organizational functions. This information will also form the basis of building a Common Language Model (see, e.g., FIG. 20), its constituent properties, and attributes customized to the unique individual or organization utilizing the VAF 200.

Referencing FIG. 33, an individual's or Organization's Focus 4000 may be derived from the user's responses during the Dynamic Vision Interview 405 (see, e.g., FIG. 4, at 405) and through the Delivery Phase Success Metric Creation 504 (see, e.g., FIG. 4, at 504).

Referencing FIG. 33, Organizational Focus 4000 describes the summarization of the individual's or organization's desired capabilities, within the context of their defined target state as described in the Dynamic Vision Interview (see, e.g., FIG. 4, at 405), and performance as described by the target state's success metrics 504. The system may categorize the individual or organization into segments as defined by their current capabilities, type of new or improved capabilities desired, type of target state success metrics, current levels of success metric performance, and desired level of success metric performance.

Referencing to FIG. 33, Organizational Performance 3026 (e.g., as defined in FIG. 23, at 3026) may describe the degree of success or failure that an organization achieves in aligning their resources and operations toward delivering projects, establishing or improving capabilities, meeting goals, and progressing toward the target state. Organizational Performance 3026 may be derived from data including but not limited to Delivery Phase Success Metrics 504 and the individual's or organization's Entropy Score (see also FIG. 12, at 4102).

Referencing FIG. 33, given the information provided by the Individual or Organization pertaining to their focus, success metrics, historical performance, and profile the system may now construct a Forecast and Probability of Success Calculated Based on Performance Expectations and History, at 2800 (see also FIG. 16, at 2800).

Referencing FIG. 33, the Forecast and Probability of Success 2800 may be calculated for each Organization 4002, which may include an individual, company, or group of people that are customers who are either utilizing or have previously utilized the VAF 200.

Referencing FIG. 33, the Forecast and Probability of Success Calculated Based on Performance Expectations and History 2800 may describe the systematic process of forecasting a project's performance and probability of success, given current state conditions. After a success metric and data source have been defined, the system begins by accessing the metric's historical baseline, performance expectation thresholds, and current performance. The system may then calculate the expected current performance.

In some embodiments, the system may first calculate the expected linear rate of change based on the delta between the baseline metric performance and the metric's performance threshold divided by the number of days in the project timeline. The expected performance may be calculated by multiplying the expected linear rate of change by the number of days since the project's start date. The metric's capability may be calculated as the delta between the performance of the metric's current period, based on the average of a number of previous measurements in a moving average, minus the expected current performance that is then divided by performance threshold.

Continuing with FIG. 33, at 2800, the system then calculates the current momentum and directionality of performance changes over a defined time period. The system may first calculate a periodic performance based on a moving average with a user-defined number of measurement periods. Then the system may calculate the period-over-period change by subtracting the previous period's moving average result from the current period's moving average result. The system may repeat this process until all applicable performance periods have been analyzed. Momentum, which may be defined as the sustained degree of performance change, can be calculated as the sum of the periodic changes over a defined number periods, divided by the number of periods considered in the moving average. Directionality may be established based on the sign of the momentum value and may be characterized as positively-trending, stationary, or negatively-trending. In some embodiments, directionality of the momentum value may be characterized as positively-trending when the momentum value is a sum greater than zero, positively-trending when the sum is either zero or within a determined interval centered around zero, or negatively trending when the sum is less than zero. In some embodiments, a next or subsequent period's forecast value may be calculated based on, e.g., the current period's value and the momentum value, such as by summing these values.

Continuing with FIG. 33, at 2800, the process can further include calculating a probability of achieving the performance threshold by the end of the project's timeline. The system may first calculate the forecasted performance at the end of the project, e.g., by summing the current period performance and the value produced by multiplying momentum by the number of days remaining in the project. The system may then calculate prior probability, e.g., as the number of days in the project where reported performance met or exceeded expected performance divided by the total number of days reported. The system may then divide the forecasted performance at the end of the project by the threshold and multiply that proportion by the prior probability to calculate the probability of achieving the threshold by the project's conclusion.

Referencing FIG. 33, based on the results of each organization's performance analysis, organizational focus, and organizational profile information, the system may now conduct a Multivariate Cluster Analysis 4003. This Multivariate Cluster Analysis 4003 may comprise a process using, e.g., K Means Clustering, Hierarchical Clustering, DBSCAN, Gaussian Mixture Models (GMMs), or other means to group and categorize individuals or organizations with similar attributes. The visualization of the cluster analysis may be performed with methods such as Principal Component Analysis (PCA), or the like.

Referencing FIG. 33, based on the results of the Multivariate Cluster Analysis 4003, Lookalike Models may be calibrated and maintained throughout the remainder of the VAF process (see, e.g., FIG. 15, at 4004 and the written description corresponding to FIG. 33).

Returning to FIG. 4, now that Phase Delivery Goals 503 have been established and quantified through Success Metrics 504 with a defined Data Source Connection 505, the user may complete activities related to the creation of a portfolio of projects or actions 410, structured as a Management By Fact portfolio 506, that are aligned to one another in support of fulfilling a specific phase delivery goal 503 or phase delivery success metric 504.

Referencing FIG. 4, at this point in the process, the user, through interactions with the VAF system, has defined their intention through the Vision and Mission Statements 501 and structured their data-driven measurement strategy according to their defined Phase Delivery Goals 503. According to an embodiment, the User may now identify, define, and align their actions, as organized in the form of Projects 411, to their intention.

Referencing FIG. 4, in the context of the VAF 200, a project, once identified, may be defined as a temporary endeavor undertaken to create a unique product, service, or improvement 507. Projects are characterized by specific goals and objectives, a defined beginning and end, and often constrained by factors such as time, resources, and budget (see, e.g., FIG. 9).

Referencing to FIG. 9, the process of defining projects begins with the system prompting the User(s) Identify Projects or Actions to Progress Against Goal, at 1600. This includes all activities related to a single or multiple users identifying specific projects or actions that will advance the individual or organization towards attaining the target state. The relationship between goals to projects or intention to planned action is established.

Referencing FIG. 12, at 4103, the Entropy Score is now Recalculated Given the Introduction of Desired Actions. This describes the process for adjusting the Entropy Score given new information about the user, their intentions, and proposed actions. Given that the individual or organization has defined specific projects or future actions, the alignment between intention and action is established. The Entropy Score will be lowered to reflect the strength of the relationship between intention and action.

Returning to FIG. 9, user(s) may now engage in Brainstorming Project Ideas Using VAF Ishikawa Principles, at 1601. The process describes targeted idea generation, in respect to projects or actions, based on each category described within the VAF Ishikawa process.

Referencing FIG. 35, a diagram is provided that portrays an exemplary embodiment of the Value-Attribution Framework's Ishikawa Model. The VAF Ishikawa Model is a tool and methodology that utilizes but is not limited to six categories that describe aspects of an individual or organization. These categories may include but are not limited to Manpower (People) 4200, Machines (Equipment) 4201, Materials (Inputs) 4202, Measurement 4203, Method (Process) 4204, and Mother Nature (Environment) 4205. Unlike a traditional Ishikawa or Fishbone Diagram, the intention is not to identify the root causes of issues or failure, rather the tool is used to identify opportunities for new or improved capabilities that may be delivered through executing projects. New and improved capabilities may result in but are not limited to advances in delivering Value 4208, Alignment 4207, or Learning 4206. These benefits serve to strengthen the organization throughout its development from a current state to the desired target state, as described by the VAF 200 (see, e.g., FIG. 4). A more detailed description of several exemplary embodiments is provided below.

Referencing FIG. 35, Manpower (People) 4200 may include all opportunities and issues related to the human resources, their training, skills, and sentiment within an individual or organization. Machines (Equipment) 4201 may include all opportunities or issues related to equipment, machinery, or tools utilized within the operations of an individual or organization. Materials 4202 may include all opportunities or issues related to all non-labor-based resources consumed as inputs in the operations of an individual or organization. Measurement 4203 may include all opportunities or issues related to data captured to calculate progress, performance, and capability within an individual or organization. Method (Process) 4204 may include all opportunities or issues related to the operational processes utilized by an individual or organization. Mother Nature (Environment) 4205 may include all opportunities or issues related to uncontrollable elements or external factors that contribute to an individual's or organization's environment. Learning 4206 describes the process through which individuals, organizations, and systems adapt their behavior based on previous experience to improve their current state including but not limited to their performance, structure, and alignment. Alignment 4207 describes the current state of an individual's or organization's process of ensuring that all its elements, including its goals, strategies, structure, culture, sentiment, and processes, are integrated and working in a coordinated manner to achieve a common purpose. Value 4208 represents the worth, significance, or benefit net of costs that an individual or organization creates through its operations or provides to another individual, organization, or society. Value 4208 is often a multifaceted concept that may be defined and measured in various ways depending on the context of the individual's or organization's vision, mission, and target state. The definition of, and agreement on, Value 4208 is one aspect of the co-operative game that is played out. As illustrated in FIG. 2 and described above, the VAF 200 is a systematic methodology designed to quantify and assign value to specific components or features within an individual's or organization's strategic plans or technological solutions, facilitating informed decision-making for strategic or technical development in respect to investment priorities.

Returning to FIG. 9, now that the user has identified project opportunities, the user may engage in a Qualitative Assessment of Impact & Effort in Respect to Delivery Phase Goals, at 1602. This describes the process of a user assessing the degree to which a specific project will advance or contribute to the Phase Delivery Goal's attainment. Each project is then prioritized, in respect to one another within a Delivery Phase, based on the qualitative impact and effort assessments. The qualitative assessment determines how much the project will contribute toward achieving their goals based on the user's estimate. Users complete an impact/effort assessment for each project opportunity by specifying, for example, Very High, High, Medium, Small, or Very Small in respect to the amount of effort required to produce the project, the costs to produce the project, and the estimated impact of the project toward their goals.

Referencing FIG. 12, at 4104, the Entropy Score is now Recalculated Given expressed Support or Discord in the Project Prioritization. This describes the process for adjusting the Entropy Score given new information about the user, their intentions, proposed actions, and aligned sentiment. During the process of qualitatively prioritizing the projects, information regarding the alignment of resource sentiment may be extrapolated from the users' prioritization preferences. The Entropy Score may be adjusted now based on the amount of agreement and aligned support or disagreement and fragmented discord in the prioritization of projects.

Returning to FIG. 9, following the results of the Qualitative Assessment 1602 the System may Recommend Project Sequencing Based on Prioritization 1603. This describes the process in which the system will recommend a specific order for projects or actions to be executed within a delivery phase. The sequencing will take into account prioritization, dependencies on other projects or actions, and a calculation of cost versus benefit.

Referencing FIG. 9, the User may Select a Subset of Projects to Execute from the prioritized and sequenced list of projects, at 1604. This describes the process in which a user will select specific projects to execute within a Delivery Phase out of all of the identified potential projects. The user will then seek feedback on the ‘desirability’ of the project from the organization's customers or stakeholders. This may be accomplished through simple crowdsourced voting, where the customers or stakeholders select a finite number their most desired projects from the prioritized list, or it may be accomplished by crowdsourcing preference, where the system may aggregate the resulting prioritization as specified by stakeholders and customers who individually complete instances of an Analytical Hierarchy Process utilizing pairwise comparisons, or by crowdsourcing ordinal ranking by utilizing analytics to identify support and variation amongst customers' and stakeholders' preferences, or by crowdsourcing a customer's or stakeholder's willingness to pay through use of a conjoint analysis, or by crowdsourcing sentiment by aggregating the results of qualitative surveys leveraging, for example, a Likert scale.

Referencing FIG. 9, once the selection of specific projects has taken place the system will capture whether a specific project has been selected for execution within a phase based on the user's selection, at 1605.

Referencing FIG. 9, if a project is not selected, then the system may Move the Project to the Backlog, at 1606. This describes the process of creating a list of projects not currently selected for execution, but that may be selected for future execution.

Referencing FIG. 9, once the process of selecting projects is complete, this marks the end of the Project Definition step (see, e.g., FIG. 4, at 411) and transition toward defining Project Goal and Success Metrics 412. The process of defining Project Goal and Success Metrics is further illustrated in FIG. 9, e.g., at 1700.

Returning to FIG. 4, once a project or portfolio of projects has been selected, the system may now Establish an initial Markov Model and Maintain or update the model as new performance and progress are achieved, at 602. Establishing a Markov Model describes the creation of a Markov state-dependent model that is utilized, in conjunction with other models such as decision trees analysis and fault tree analysis, to describe the most efficient and sequential path of actions to execute in progressing toward realizing the target state from any current state position. Markov Models may be recalibrated after each project, goal, milestone, or phase achievement, at 417.

Referencing FIG. 26, a description of a conceptual and exemplary embodiment of a Markov Model may begin with a representation of the individual's or organization's Current State 3300. The Current State 3300 describes the current progress, capability, or performance of an individual or organization in respect to target state attainment.

While in the Current State 3300, the individual or organization may attempt to progress to the next Milestone 3301 on the Efficient Path by taking deliberate actions or executing specific projects. A Milestone 3301 describes a state transition, within the context of a Markov model, that aligns to an optimal Efficient Path. State transitions represent a change in progress, performance, or capability that progresses the individual or organization toward target state attainment.

Still referring to FIG. 26, if the user's actions are unsuccessful in progressing the individual or organization forward toward achieving their goals, then the user may remain in the Current State 3300. In some embodiments, the Probability of Churn (in state) 3303 represents the probability of failure to achieve the desired progress, performance or capability described in the next state of the Markov Model's Efficient Path or Alternative State. Conversely, in some embodiments, the Probability of State Transition 3304 represents the probability of an individual or organization successfully achieving the required capability, progress, or performance as represented by a Milestone or Alternative State within the Markov Model.

As illustrated in FIG. 26, a Milestone describes a state transition, within the context of a Markov model, that aligns to an optimal Efficient Path. State transitions represent a change in progress, performance, or capability that progresses the individual or organization toward target state attainment.

In some embodiments, once an individual or organization achieves their goals for the final Delivery Phase, they may attain the Target State 3302. The Target State 3302 may represent the final state described by a Markov model within the context of the VAF 200. The target state represents the successful achievement of the capabilities and performance described by the Vision Statement or Phase Goals.

Returning to FIG. 9, now the user may Define the Project's Primary Goal and metric that is Aligned to a Delivery Phase, at 1700. This describes the process of an individual or organization establishing the most important goal that indicates successful project achievement. The primary project goal should align to the Delivery Phase Goals by either addressing the entire desired performance change or a portion that contributes to the progress toward that goal.

Referring still to FIG. 9, the user may Define Project Secondary Goal(s) and metric(s) that Support the Project's Success, at 1701. This describes the process of an individual or organization establishing supporting goal(s) that indicate successful project achievement. The secondary goals should describe supporting indicators of success, such as but not limited to adherence to timeline or project slippage, additional work outside of the original scope or scope creep, maintaining cost and effort in respect to original estimates as represented in a burndown chart. This marks the end of a Project's Definition (see, e.g., FIG. 4, at 411) and transition to defining and prioritizing Project Success Metrics (see, e.g., FIG. 4, at 412).

Returning to FIG. 4, at this point in the process, the Organization's Plan for Action is now Aligned to Intention and the Dissipative Structure Strengthens through playing the Cooperative Game as evident through Micro-Behaviors, at 703. This process describes the increased degree of organization of a dissipative structure based on the defined success metrics 504.

Referencing FIG. 14, at 2600, once Projects are Created 507 the Dissipative Structure may Refine 2600, which describes the increased degree of organization of a dissipative structure based on defined and aligned projects. The level of stability of the dissipative structure is consistent with the level of alignment of the resources, sentiment, and actions to the goals of the organization.

Referencing FIG. 14, the Dissipative Structure may Continue to Refine 2601 when a Subset of Projects is confirmed, at 1605 (see also FIG. 9, at 1605). This describes the increased degree of organization of a dissipative structure based on projects selected to be in-scope for executing during the current delivery phase.

Returning to FIG. 4, similar to the Phase Delivery Goals 503, a Project's performance may be measured through the establishment of Project Success Metrics 412. The Project Success Metrics 412 may be measurable outcomes that describe criteria for a project's successful completion and establish the desired capability to be achieved through implementing the project 508. One or more project success metrics are required for each defined project. Success metrics are then tracked against a performance threshold, historical performance baseline, and current changes to performance 512.

Returning to FIG. 9, once the Primary and Secondary Metrics have been established, the System Requests Prioritization of Project Goals 1702. This describes all activities related to a user defining and confirming the prioritization of goals within the context of other goals related to the project. An example of the prioritization process is illustrated in FIG. 8.

Referring back to FIG. 4, once Project Success Metrics 412 have been prioritized, this may mark the end of the Project Goal and Success Metric definition 412 and start a transition toward establishing Project Control Plans 413. Given the establishment of Project Success Metrics 508, a risk mitigation plan may be created 413, e.g., in the form of a Control Plan 509, to outline the processes and strategies for maintaining control over and ensuring the consistent performance of a product or process, including metrics, thresholds, and mitigation plans in relation to the Project's Success Metrics 508.

Returning to FIG. 9, the System may now Create a Control Plan Based on Project Success Metrics 1800. This describes the process, once the Project Success Metrics 508 are defined, of creating a ‘control plan’ that dictates next steps or mitigation required once a metric crosses a negative critical threshold boundary, is forecasted not to be achieved by a specified date, or where progress has not been updated over a specified period of time. Control plans contain the expected level of performance by phase or date, threshold value, cadence assessed, owner, and mitigation action plan.

Referencing FIG. 9, the System may next Request Mitigating Actions Tied to Performance Thresholds 1801. This describes the process of defining specific actions that the individual or organization is recommended to execute once performance in a specific metric has crossed, or is forecasted to cross, a negative performance threshold.

Referencing FIG. 13, once a project's Control Plan 413 is established and created 509, the Markov Model may Incorporate the Control Plan's Mitigating Actions 2501 into possible Alternative States during the process of transitioning from the current state to the target state.

Returning to FIG. 4, once a Control Plan has been established 509, Fault-Trees may be created to Model the Success Criteria in a Markov Path 603. In the context of the VAF 200, Fault-Trees may be utilized to predict the probability of success based on defined Success Metrics 508, Performance Thresholds, and current performance. The Fault Tree predictions may be utilized to inform the probability of success within each Markov Model's recommended and alternative paths.

Still referring to FIG. 4, in the context of the VAF 200, Markov models integrate with Fault-Tree Analysis (FTA) and, later, Decision-Tree Analysis (DTA) in order to provide the probability of success and Expected Value of achieving a defined state within the Efficient Path or Alternative Path.

Illustrated in FIG. 27 is an exemplary embodiment of a simple Fault-Tree Analysis 3400. Here, Project Goal and Success Metrics 508 and Performance Monitoring with Micro-Behaviors 512 may serve as inputs to the Fault-Tree Analysis 3400.

In some embodiments, the Fault-Tree Analysis (FTA) 3400 is utilized as a top-down, systematic, deductive methodology used to determine the various combinations of failures and human errors that could lead to undesired events or system failures. In the context of the VAF 200, Fault-Trees may be utilized to predict the Probability of Success 3401 based on defined Success Metrics, Performance Thresholds, and current performance (see, e.g., FIG. 4, at 603). Additional exemplary embodiments of Fault-Tree Analysis are illustrated in, e.g., FIG. 18.

Still referring to FIG. 27, the Probability of Success 3401 may describe a process of integrating the probability of achieving goals for an event, project, or performance metric. Success Probabilities (e.g., Probability of Success 3401) may be calculated through the use of Bayesian Priors (see, e.g., FIG. 16) within the context and structure of a Fault-Tree Analysis.

FIG. 28 illustrates an example approach for integrating Fault-Trees to a Markov Model, where Fault-Trees provide the Probability of a State Transition 3303.

Returning to FIG. 4, at this point, the establishment of Control Plans Mitigates the Risk of Bifurcation and the Dissipative Structure is Maintained 704. This process describes the decreased risk of a dissipative structure becoming less organized, in respect to its current state, based on detailed control plans 509 to mitigate project failure, including recommended actions if performance negatively exceeds a performance threshold. There is a junction here between traditional Statistical Process Control, Lyapunov functions and the use of entropy scores 600, which all determine stability, bifurcation and control. The entropy scores change based on the components used in the VAF 200 and the user's participation in the cooperative game.

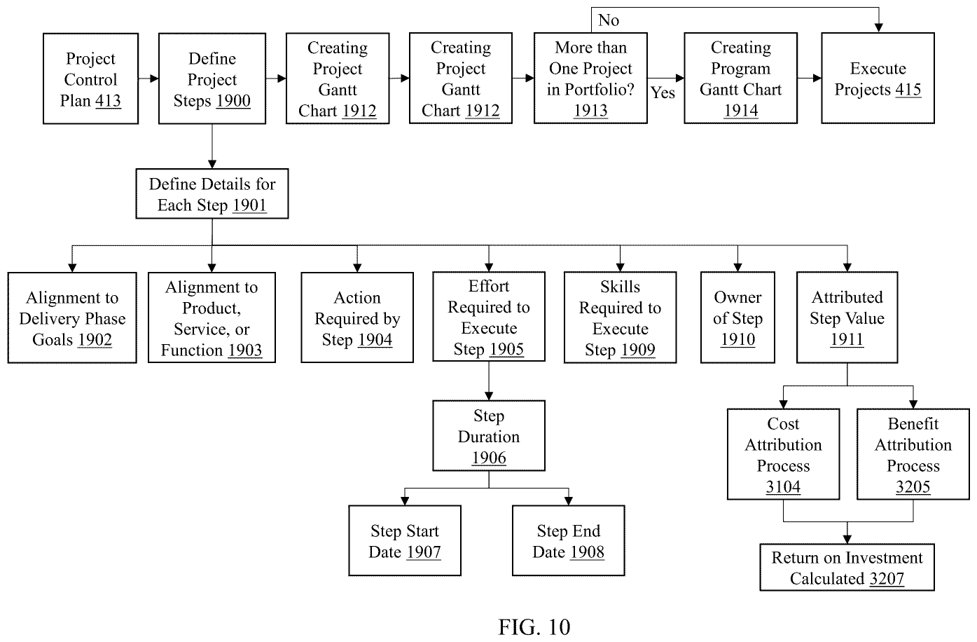

Still referring to FIG. 4, detailed plans for the execution of the project may now be documented in the form of a Work Plan 414. Defining a Work Plan 414 may encompass some or all activities related to building a detailed roadmap that outlines the steps, tasks, resources, costs, and timeline necessary to complete a project 510. The Work Plan 414 may also continue to align the project 507 to defined delivery phases 502, delivery phase goals 503, and project success metrics 508. One example of a process for Work Plan Creation 414 is illustrated in FIG. 10.

In particular, in FIG. 10, a process is illustrated for creating a Work Plan after a Project Control Plan 413 has been established. According to some embodiments, the process for creating the Work Plan can comprise Defining the Project Steps 1900. This encompasses all activities related to a user documenting the specific required, and most often sequential, actions that must be taken within the context of a project in order to successfully complete the project.

According to some embodiments, the process for creating the Work Plan may further include the user Defining Details for Each Step 1901. This describes the process of a user documenting detailed information that describes a project step, including but not limited to the alignment of a step to a Delivery Phase Goal 1902, alignment of a step to an organization's products, services or functions 1903, action required to complete the step 1904, the estimated amount of time required to complete the action 1905, the skills needed to complete the step 1909, the person or owner of the step who is responsible and accountable for its completion 1910, and the value that may be attributed or associated with completing the step 1911.

Still referring to FIG. 10, Alignment to Delivery Phase Goals 1902 comprises the user documenting the relationship between a single action within the context of a project and aligning that action to the delivery phase goals that provide direction to all projects executed within a delivery phase. Alignment to Product, Service, or Function 1903 comprises the user documenting the relationship between a single action within the context of a project and aligning that action as support for delivering revenue producing products or services. Project steps may also be aligned to internal functions that may contribute to revenue generation or may be associated solely with a cost center. Action Required By Step 1904 comprises task(s) that must be performed or action(s) that must be taken to successfully complete a particular step and progress the project forward towards completion. Effort Required to Complete Step 1905 describes the estimated amount of time, as measured in working hours or man-hours, that is required to complete the action associated with the step.

Still referring to FIG. 10, in some embodiments, the Effort Required to Complete Step 1905 may be estimated based on a Step's Duration 1906. Step Duration 1906 may describe the estimated total time elapsing from an (estimated) Step Start Date 1907 and an (estimated) Step End Date 1908, e.g., as measured in full or partial calendar days. In some embodiments, Step Start Date 1907 documents the estimated calendar day that an action is proposed to take place within the context of a project's timeline. In some embodiments, Step End Date 1908 documents the estimated calendar day that an action is proposed to reach completion within the context of a project's timeline.

Still referring to FIG. 10, Skills Required to Execute Step 1909 may describe the specific knowledge and experience required by the step owner that is utilized in the completion of a step. Owner of the Step 1910 may describe the person accountable for the completion of the step. The person identified is most often, but not necessarily, also the person completing the action required to fulfill the step. Attributed Step Value 1911 may describe the estimated contribution that actions performed to complete the step will make on (e.g., add to or detract from) the organization's realized value 1911, e.g., with respect to the individual's or organization's definition of value. In some embodiments, an Attributed Step Value may be calculated based on a Cost Attribution Process 3104 and a Benefit Attribution Process 3205.

In some embodiments, the Cost Attribution Process 3104 describes a process by which all costs associated with a project are quantified, including, but not limited to, labor (see., e.g., FIG. 22), materials (see, e.g., FIG. 21), and process waste (see, e.g., FIG. 23, at 3017). Costs are often, but not necessarily always, directly attributable to the specific project step where the cost is incurred. Costs may be attributed, allocated, and aggregated across numerous entities, including but not limited to functions, programs, portfolios, projects, actions, people, skills, and assets. Costs are always defined in financial terms. A Cost Attribution Logic process, such as that illustrated in FIG. 24 for example, may be used.

In some embodiments, the Benefit Attribution Process 3205 describes a process by which all benefits are attributed, associated, and aggregated across numerous entities, including but not limited to functions, programs, portfolios, projects, project steps, people, skills, and assets, to estimate the respective contribution to the organizations realized value 1911. A VAF Value Attribution Logic process, such as that illustrated in FIG. 25 for example, which includes a Benefit Attribution Process 3205, may be used.

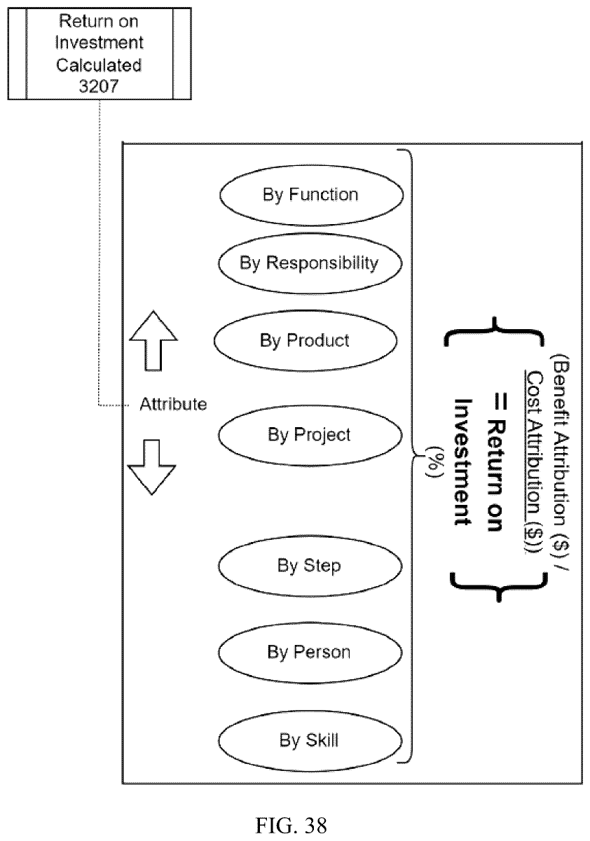

In some embodiments, based at least on the values derived from the Cost Attribution Process 3104 and Benefit Attribution Process 3205, an Attributed Step Value may be expressed in terms of, e.g., a Return on Investment 3207 as illustrated in FIG. 38.

Referring back to FIG. 24, in some embodiments, the Cost Attribution Logic may define how costs are aggregated and attributed within the hierarchy of the VAF 200. In some embodiments, data utilized by the Cost Attribution Logic may be sourced from elements created throughout the VAF process. In some embodiments, the Cost Attribution Logic may begin with the System Requesting Information about the Organization's Structure 1005 (see, e.g., FIG. 6). Organizations are described in the System as being composed of one or more Organizational Functions 3100. An Organizational Function 3100 describes a specialized subdivision within an organization that is designed to perform a specific set of tasks, roles, or responsibilities. Examples of Organizational Functions 3100 may include, but are not limited to, Organizational Management, Product Development, Technical Development, Technical Implementation, Product Management, Business Development, Relationship Management, Marketing, Sales, Finance, and Human Resources.

Referring still to FIG. 24, people or employees are aligned to Organizational Functions 3100 and are assigned a specific Employee Role 3101. An Employee's Role 3101 may describe a specific responsibility or set of responsibilities within an Organizational Function 3100. Employee Roles 3101 may be designated by an employee's title and described by an employee's job description, by values or identifiers associated therewith, or the like.

In some embodiments, an Employee Role 3101 may be associated with a specific set of Role Responsibilities 3102. Role Responsibilities 3102 may be used to describes specific tasks or actions that are associated with an Employee Role 3101. Role Responsibilities 3102 tasks are typically not unique to specific circumstances or specific projects, but rather they are typically genericized descriptions of tasks repeated over many circumstances and situations. Examples of Role Responsibilities 3102 for a particular Employee Role 3101, e.g., a Product Manager, within a particular Organization Function 3100, e.g., Product Development, may include, but are not limited to, Document Business Requirements for Product, Design Product Prototype(s), Design Product Pricing, Build Proforma for Product, Identify Intellectual Property Implications for Product, Manage Patent Opportunities for Product, or Customize and Deliver Product Training for Client.

In some embodiments, employees can be associated with Skills Required to Execute Project Steps 1909 and that may be required as part of the Role Responsibilities 3102 associated with the employee's particular Employee Role 3101. Examples of select required skills are illustrated in FIG. 10, at 1909.

For a particular employee, based at least on the Employee Role 3101, Role Responsibilities 3102, and Skills Required to Execute Project Steps 1909 associated with that particular employee, the employee may be assigned as an Owner of one or more particular Project Steps 1910 (see, e.g., FIG. 10).

Referring still to FIG. 24, at 3100, Organizational Functions may sponsor Projects 411 (see, e.g., FIG. 4, at 411) in order to complete work towards advancing the Organization towards the target state. Projects 411 may comprise one or more Project Steps 1900 (see, e.g., FIG. 10, at 1900).

In some embodiments, a Working Time 3016 (see, e.g., FIG. 22) may describe the effort(s) associated with the Owner of the Step 1910 that is likely/expected/estimated/calculated to be required to complete a Project Step 1900. Working Time 3016 may be aggregated or attributed within the hierarchy of the VAF 200 through an Effort Contribution Calculation 3103.

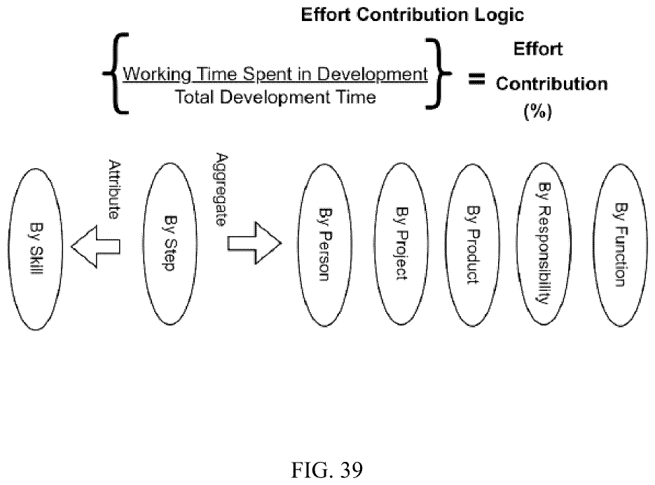

In some embodiments, the Effort Contribution Calculation 3103 (see, e.g., FIG. 39), may be used to calculate an Effort Contribution Factor. In some embodiments, the Effort Contribution Factor may be represented as a percentage of resource time consumed in development at a project step level. In some embodiments, the Effort Contribution Factor may be expressed as a percentage of Working Time Spent in Development to Total Development Time.

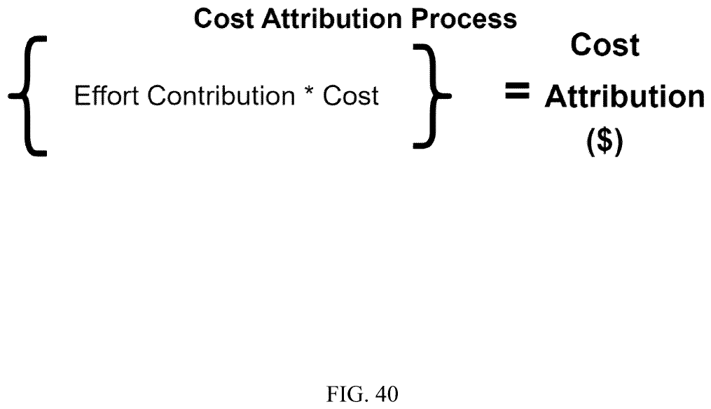

Still referring to FIG. 24, in some embodiments, the Effort Contribution Factor can be utilized within the Cost Attribution Process 3104 (see, e.g., FIG. 40). In some embodiments, the Cost Attribution Process may also utilize Actual Costs associated with the Project Step (see, e.g., FIG. 21, at 3007) for Material Costs (see, e.g., FIG. 22, at 3013) and for Labor Costs. In some embodiments, Actual Costs may represent the sum of all Actual Labor and Materials Costs associated with a project or project step that equate to the total cost of labor and materials actually incurred throughout the project's execution regardless of cost type. The Cost Attribution Process 3104 (see, e.g., FIGS. 10 and 40) may be used to calculate Cost Attribution. For example, the Cost Attribution Process 3104 may comprise multiplying the Effort Contribution Factor by the project step's Actual Costs to calculate the Cost Attribution in financial terms.

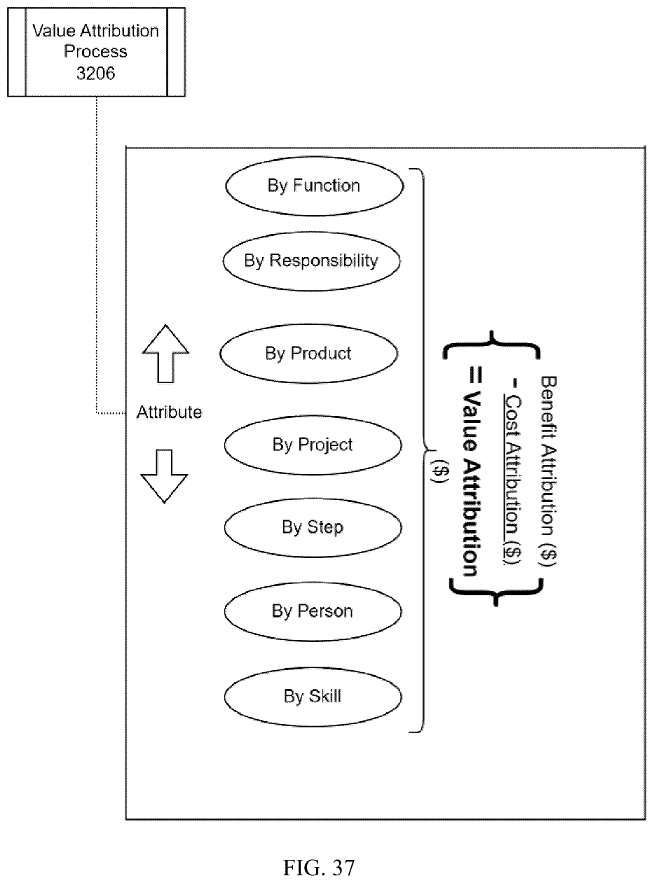

Referring still to FIG. 24, the results of the Cost Attribution Process 3104 can, according to some embodiments, be utilized within the Value Attribution Process 3206 (see, e.g., FIG. 29) and/or in relation to the Value Attribution Logic (see, e.g., FIGS. 25, 36, and 37).

Referring now to FIG. 21, according to some embodiments, Defining Costs within the context of a project may include quantifying the costs of materials utilized by the project's efforts, which may be used to describe the Materials Cost Structure within the context of a project.

In some embodiments, Material Costs can be estimated during the process of Defining the Project's Steps 1900, (see, e.g., FIG. 10). Estimated Required Materials 4304 can be used to describe all non-labor-based resources consumed by a project in support of its completion. Examples of some materials that can be included in Material Costs includes, but is not limited to, raw input materials, finished goods, equipment, machinery, and/or the like.

Still referring to FIG. 21, as Materials are consumed during the Execution Phase 305, the system will determine its path, based for example on the Material's Cost Type 3003, which directs it toward calculating the actual cost of materials for materials that can be categorized as being a Fixed Cost material 3004, a Variable Cost material 3006, or a Free material 3005 in the context of the project.

In some embodiments, Fixed Cost materials 3004 represent materials with a set price regardless of the amount of materials consumed. Examples of some Fixed Costs Materials 3004 may include but are not limited to subscription services with unlimited use, Licensing Fees, Set-up Costs, One-Time Fees to Contracted Organizations, and the like.

In some embodiments, Variable Cost materials 3006 represent materials for which the cost to the project of the material changes as a function of the amount of the material consumed/purchased. Examples of some Variable Cost materials 3006 may include but are not limited to Raw Materials, Office Supplies, Utilities, Fuel, Legal Fees from Outside Counsel, or any other material prices per unit consumed.

In some embodiments, Free materials 3005 represent materials without any cost to the project regardless of the amount of materials consumed. Examples of Free materials 3005 may include but are not limited to Open-Source Software, Public Data Records, Creative Commons Media, By-Products of Existing Processes, or Other Resources, Information, or Tools commonly available in the public domain. Typically, Free materials 3005 would not include materials already owned by the organization that were purchased or otherwise acquired for another project or another stage of the current project, but consumed during the current project or current stage of the project.

In some embodiments, as materials are consumed by the Project, the system may now calculate the Actual Materials Cost 3007 based on a Cost Type associated with the material. This represents the total cost of materials actually incurred through the project's execution regardless of cost type.

In some embodiments, as the project progresses and Performance is Monitored with Micro-Behaviors 512, the system may calculate the Materials Performance 3008. Materials Performance 3008 may be used to represent a difference between the Estimated Required Materials and the Actual Materials Cost, such as by subtracting Estimated Costs from Actual Costs and dividing the result by Estimated Costs, expressed as a percentage.

In some embodiments, the Materials Performance 3008 can be analyzed alongside Labor Performance 3014 (see, e.g., FIG. 22, at 3014) to calculate an On-Budget Performance 3023 of the project.

Referring now to FIG. 22, an example of the Labor Cost Structure within the context of a project's execution is illustrated. In some embodiments, Labor Costs are estimated during the process of Defining the Project's Steps 1900 (see, e.g., FIGS. 10 and 22). In some embodiments, the Labor Cost Structure process begins with estimating the Effort Required to Complete each Project Step 1905 (see, e.g., FIG. 10). In some embodiments, the user(s) can then define the Skills Required to Execute each Project Step 1909 (see, e.g., FIG. 10, at 1909). In some embodiments, user(s) may specify the Skill Proficiency Required to Executed Project Step 4303. In some embodiments, the Skill Proficiency Required to Executed Project Step 4303 describes the level of specific knowledge and experience required by the step owner in order for the step owner to complete a specific step. Skill Proficiency Required to Executed Project Step 4303 may be expressed categorically, such as by using skill proficiency categories such as “Expert,” “Proficient,” “Needs Improvement,” or “Not Rated.”

In some embodiments, steps can be aligned to specific people who are designated as the Step Owner 1910 (see, e.g., FIG. 10, at 1910). Step Owners 1910 can be associated with an Employee Rate 4301. The Employee Rate 4301 can be used to describe the hourly financial cost to the organization of the Step Owner 1910 and/or resources utilized by the Step Owner 1910 to complete a project step. The Employee Rate 4301 may be calculated based on the annual compensation of the Step Owner 1910 divided by the total working hours of the Step Owner 1910 within the same period, such as within the same calendar or fiscal year. In some embodiments, such as when a Step Owner 1910 is associated with/allocated to various different project steps or various different projects, a fraction of the total working hours of the Step Owner 1910 within the same period can be allocated to a specific task or project when calculating an Employee Rate 4301 for the Step Owner 1910 associated with the specific step of the project.

In some embodiments, Labor, in the form of hours worked by people, are consumed by projects during the Execution Phase 305. In some embodiments, the system will determine its path, based on the Labor Cost Type 3003, which directs it toward calculating the actual cost of Labor that either have a Fixed Labor Cost 3010, a Variable Labor Cost 3012, or a Free Labor Cost 3011 to the project.

In terms of Labor, a Fixed Labor Cost 3010 represents labor that incurs a set (static) financial cost to the project per unit of Labor regardless of the amount of Labor associated with/used to complete a particular task/step. Examples of Fixed Labor Costs 3010 may include but are not limited to overtime-exempt salaried employees, or labor resources contracted on a set price by project or activity.

In some embodiments, Variable Labor Costs 3012 represents labor that incurs a changing (dynamic) financial cost to the project per unit of Labor as a function of the amount of Labor associated with/used to complete a particular task/step. In some embodiments, a Variable Labor Cost 3012 may incur a financial cost to the project that increases proportionally with Working Time 3016 as a function of (e.g., multiplied by) Employee Rate 4301. Working Time 3016 describes the actual effort, e.g., measured as a unit of time such as hours, that is consumed by/allocated to a particular project step, task, or activity. Working Time 3016 may be aggregated to the project level by summing the actual effort associated with each project step in a project. Working Time 3016 may be used as a component or variable when calculating Variable Rate costs for the project. Examples of Variable Labor Costs may include but are not limited to overtime-eligible labor resources, hourly labor resources, contracted labor resources paid by the hour, and/or the like.

In some embodiments, Free Labor Costs 3011 represents labor without any cost to the project regardless of the amount of time or effort consumed. Examples of Free Labor Costs 3011 may include but are not limited to Volunteer Labor, Internship Labor, or In-Kind Donations of Labor and time.

In some embodiments, as Labor is consumed by the Project, the system may calculate (e.g., once, iteratively, periodically, semi-periodically, based on one or more triggers, on-demand, or on an ad-hoc basis) the Actual Labor Cost 3013 based on Labor Cost Type 3009. In some embodiments, the Actual Labor Cost 3013 can represent the total cost of labor actually incurred through the project's execution, regardless of cost type.

In some embodiments, as the project progresses and Performance is Monitored with Micro-Behaviors 512, the system may calculate the Labor Performance 3014. Labor Performance 3014 may be used to represent the difference between the Estimated Required Labor and the Actual Labor Cost, e.g., as calculated by subtracting Estimated Costs from Actual Costs and dividing the intermediate result by Estimated Costs, with the final result being expressed as a percentage.

In some embodiments, Labor Performance 3014 can be analyzed alongside Materials Performance 3008 to calculate On-Budget Performance 3023. On-Budget Performance 3023 represents the aggregated difference between the estimated labor and materials costs associated with a project and the actual cost of labor and materials consumed during a project's execution. In some embodiments, On-Budget Performance 3023 can be calculated according to Equation (3):

$$\frac{\begin{matrix}\sum Actual Labor and Material Costs - \\ \sum Estimated Labor and Material Costs\end{matrix}}{\sum Estimated Labor and Material Costs} \times 100 \qquad Equation ( 3 )$$

expressed as a percentage.

In some embodiments, On-Budget Performance 3023 may be one component or variable utilized to calculate Project Performance 3024. In some embodiments, Timeliness Performance 3022 and Capability Performance 3021 are also taken into account when calculating Project Performance 3024.

Referring to FIG. 23, a diagram is provided that illustrates a process for calculating Timeliness Performance 3022 and Capability Performance 3021. In some embodiments, the process for calculating Timeliness Performance 3022 begins with estimating for each step of the project a Step Duration 1906, such as during the process of Defining the Project's Steps 1900 (see, e.g., FIGS. 10 and 21).

In some embodiments, during the Execution Phase 305, users may Execute Project Steps 2000 (see, e.g., FIGS. 11 and 23). When a user begins working on a project step, an Actual Start 3015 of the activity, task, or step is captured by the system. In some embodiments, the Actual Start 3015 represents the point in time (at a desired granularity or specificity, e.g., time, day, week, month, quarter, and/or year) that resources (e.g., Labor) begins to be allocated to that activity, task, or step, or material/resource consumption in support of completion of the activity, task, or step begins.

In some embodiments, Working Time 3016 (such as illustrated in FIGS. 22 and 23) may be used to describe the actual effort, as measured in a unit of time duration (e.g., in hours) consumed during completion of a project step or activity. Additional Time in the form of Waste 3017 may also be consumed during completion of an activity, task, or step. Additional Time in the form of Waste 3017 may be used to describe and quantify an amount of time consumed by non-value producing activities, including but not limited to Defects, Overproduction, Waiting, Non-Utilized Resources, Transportation, Inventory, Motion, or Extra Processing.

Referring now to FIG. 23, as project steps are completed, the system can record the Actual End 3018 and Actual Step Duration 3019 of each step. The Actual End 3018 represents the point in time (e.g., a specific day or specific time on a specific day) that resources complete work in relation to a project step or activity. The Actual Step Duration 3019 represents the amount of time spent (duration of time) between Actual Start and Actual End 3018, including, e.g., Working Time 3016 and Additional Time in the form of Waste 3017.

As project steps are completed, the system can also calculate a Timeliness Performance 3022 (see, e.g., FIG. 21). Timeliness Performance 3022 can be used to represent and calculate the difference between an amount of time estimated 1906 for completion of an activity, task, or step of the project and the Actual Step Duration 3019, as calculated using Equation (4):

$$Timeliness Performance = Actual Duration - Estimated Duration \qquad Equation ( 4 )$$

expressed as a unit of time (e.g., hours, days, weeks, etc.).

In some embodiments, Timeliness Performance 3022 can be aggregated from the step to the project level by summing the effort, expressed in labor hours, associated with project steps that exceeded their estimated duration and dividing that aggregate effort by the total effort required by the project, e.g., according to Equation (5):

$$\frac{\sum 〈 {ALEE}_{T 1} \vert {ALEE}_{T 2} ... \vert {ALEE}_{Tn} 〉}{Total Labor Hours} \times 100 \qquad Equation ( 5 )$$

where ALEE refers to Actual Labor Exceeding Estimate for a particular task, T, from among n tasks.

Referring still to FIG. 23, the illustrated diagram also includes steps for calculating Capability Performance 3021. In some embodiments, the Capability Performance 3021 can be calculated by the system. The system can Generate a Historical Baseline and Process Capability 1503 for a Success Metric (see, e.g., FIG. 8). As projects are executed, the system can Calculate Performance Changes 2202 (see, e.g., FIG. 11). During the Execution Phase 305, as ongoing Performance is Calculated 2202, the system can Determine if the Desired Capability has been Achieved 3020. In some embodiments, Determining if the Desired Capability has been Achieved 3020 may represent a comparison between a current level of performance associated with a Success Metric and the Performance Threshold of the desired level of performance associated with the Success Metric. In some embodiments, if the current performance meets or exceeds the desired level of the Success Metric (e.g., based on metric directionality), then result can be expressed binarily as, e.g., “Yes” or 1. Conversely, if the current performance does not meet the Performance Threshold, then the result can be expressed binarily as, e.g., “No” or 0. In some embodiments, based at least on these assessments, the system can calculate Capability Performance 3021, (see, e.g., FIG. 21, at 3021). In some embodiments, Capability Performance 3021 may represent the degree of performance change between the Historical Baseline of a Success Metric and the current performance level, as calculated using Equation (6):

$$\frac{Current Performance - Baseline Performance}{Baseline Performance} \times 100 \qquad Equation ( 6 )$$

with the result being expressed as a percentage.

In some embodiments, On-Budget Performance 3023, Timeliness Performance 3022, and Capability Performance 3021, (see, e.g., FIGS. 21 and 23) may all be taken into account when calculating Project Performance 3024. In some embodiments, Project Performance 3024 is a composite metric, expressed as a percentage, that is calculated based at least upon organization-defined weighting values or user-defined weighting values for each component. In some embodiments, component weights can be expressed as percentages that, together, sum to 100%.

In some embodiments, Project Performance 3024 may be calculated using Equation (7):

$${P}_{project} = \sum 〈 ( {P}_{cap} \times {W}_{cap} ) \vert ( {P}_{time} \times {W}_{time} ) \vert ( {P}_{budget} \times {W}_{budget} ) 〉 \qquad Equation ( 7 )$$

where P_{project} is Project Performance 3024, P_{cap} is Capability Performance 3021, W_{cap} is the weighting value associated with Capability Performance 3021, Pₜᵢₘₑ is Timeliness Performance 3022, Wₜᵢₘₑ is the weighting value associated with Timeliness Performance 3022, P_{budget} is On-Budget Performance 3023, and W_{budget} is the weighting value associated with On-Budget Performance 3023.

For each project, the Project Performance 3024 can be utilized to describe an organization's overall Functional Performance 3025. Functional Performance 3025 can be used to represent the aggregate the Project Performance 3024 for all projects that are aligned to a specific organizational function. Project Performance 3024 may be aggregated to calculate a Functional Performance 3025 based on, e.g., Equation (8):

$${P}_{function} = \sum 〈 ( {P}_{P 1} \times {W}_{P 1} ) \vert ( {P}_{P 2} \times {W}_{P 2} ) ... \vert ( {P}_{pn} \times {W}_{pn} ) 〉 \qquad Equation ( 8 )$$

where P_{function} is Functional Performance 3025, Pₚ₁ is the Project Performance 3024 for a first project associated with a same particular function, Wₚ₁ is the weighting value associated with the first project, Pₚ₂ is the Project Performance 3024 for a second project associated with the same particular function, Wₚ₂ is the weighting value associated with the second project, Pₚₙ is the Project Performance 3024 for an nth project associated with the same particular function, and Wₚₙ is the weighting value associated with the nth project.

In some embodiments, Functional Performance 3025 may also be calculated based on a Function's internal goals based on a specific metric, where projects within the Function's portfolio contribute to the metric's performance.

In some embodiments, the Project Performance 3024 for each project may be utilized to describe an Organizational Performance 3026. In some embodiments, Organizational Performance 3026 represents the aggregate of Project Performance 3024 for all projects taking place within the entire organization. Organizational Performance 3026 can be calculated according to Equation (9):

$$\sum 〈 {\sum }_{f 1} 〈 ( {P}_{P 1} ) \vert {P}_{P 2} ... \vert ( {P}_{pn} ) 〉 \times {W}_{f 1} \vert {\sum }_{f 2} 〈 ( {P}_{P 1} ) \vert {P}_{P 2} ... \vert ( {P}_{pn} ) 〉 \times {W}_{f 2} ... \vert {\sum }_{fn} 〈 ( {P}_{P 1} ) \vert {P}_{P 2} ... \vert ( {P}_{pn} ) 〉 \times {W}_{fn} 〉 \qquad Equation ( 9 )$$

where Organizational Performance 3026 is calculated as a function-wise sum (of weight-adjusted sums of Project Performance 3024 for projects associated with a first function, f1, a second function, f2, . . . and an nth function. Project Performance 3024 for the first project Pₚ₁, the second project, Pₚ₂, . . . , and the nth project associated with the first function f1, is multiplied by a weighting value W_{f1} for the first function, while Project Performance 3024 values for other projects are multiplied, respectively, by a second weighting value W_{f2} associated with the second function, . . . , and an nth weighting value W_{fn} associated with the nth function.

In some embodiments, the function-specific weight-adjusted Organizational Performance 3026 value can be calculated using function-specific weights (W_{f1}, W_{f2}, W_{fn}) that sum to 100%. In some embodiments, Organizational Performance 3026 may be calculated based on at least (or in view of) the organization's internal goals, which may be based on one or more specific metrics. In some embodiments, projects within the organization's portfolio may contribute to the one or more specific metric, which can be considered during calculation of the Organizational Performance 3026. In some embodiments, Organizational Performance 3026 may also be calculated in view of the organizations' progress made toward target state attainment, based on the desired capability and associated performance describing the target state.

In some embodiments, the calculation of Organizational Performance 3026 may mark the end of the processes required to calculate the project's costs, capability, and timeliness performance.

Referring again to FIG. 10, a process is illustrated therein for Work Plan Creation. In some embodiments, once all of the Step Details are Defined 1901, the system can Create a Project Gantt Chart 1912 that describes the process for, and result of, the system creating a visual timeline representation that displays the duration and sequence of tasks, milestones, and dependencies in a project, based on the information provided to project step details.

In some embodiments, if there exists More than One Project in the Portfolio 1913 that is in-scope for execution, then the system can Create a Program Gantt Chart 1914. This describes the process for and result of the system creating a visual timeline representation that may display information such as the duration and sequence of tasks, milestones, and dependencies associated across all projects that are aligned to a Phase Delivery Goal's portfolio. The information used to construct the Program Gantt Chart may be provided to the system by Defining the Details of Each Step 1901.

Referring to FIG. 4, Defining a Work Plan 414 marks a sequential end of the Planning Phase 304 and a beginning of the Executing Phase 305. Once a project's Work Plan has been defined 414 and created 510, the Markov Model Incorporates Details from Across All Projects and Calculates Most Efficient Path (see, e.g., FIG. 13, at 2502). This describes the process of establishing the most efficient and sequential path between the current state and target state, as described within the context of a Markov Model.

Once work plans are established for potential projects, the associated steps and estimated performance changes may be represented within the Markov Model as states that either support the efficient path or as possible alternative states to the efficient path.

Referring to FIG. 12, at 4105, the Entropy Score is now Updated Based on the Alignment of Granular Action to the Original Vision. This describes the process for adjusting the Entropy Score given new information about the user, their intentions, proposed actions, and aligned sentiment. During the process of creating project work plans, the user must specify the desired actions at a more granular step level and estimate the work effort required to successfully deliver the project. The Entropy Score may now be adjusted based on the amount of effort directly aligned to target attainment vs effort that is unaligned.

Returning to FIG. 4, once Work Plans have been completed, actions, structured in the form of projects, may now be initiated Project Execution 415. In some embodiments, Project Execution 415 may encompass some or all activities related to designing, building, delivering, and monitoring the performance of change-related projects and actions.

Referring now to FIG. 11, users can Execute Project Steps 2000 as components of Project Execution 415. As users Executed Project Steps 2000, analytics may be deployed that measure the actual work completed, or progress, for a project, goal, phase, or target environment in relation to the total work required and in respect to the estimated timeline vs actual completion timing 511. Micro-behaviors involve small, incremental changes in individual actions and routines, leading to lasting improvements in efficiency, productivity, and performance. These subtle adjustments, often related to processes or routines, contribute to continuous optimization, reduced error rates, and enhanced time management. Micro-behaviors also support improved progress tracking, as individuals and teams deploy analytics to measure actual work completion for projects, goals, or phases in relation to the total work required, and with respect to estimated versus actual timelines, all contributing to achieving long-term goals and outcomes.

In some embodiments, Progress Tracking with Micro-Behaviors 511 may require that the system Calculate the Remaining Effort with Respect to Timeline 2100. This describes the systematic process of forecasting a project's progress. The process begins by the system aggregating the estimated effort of all unexecuted steps within a project. The system then calculates the expected duration of the remaining steps in the project based on the maximum expected end date of steps (project's estimated completion date) minus the date of the report. The system then calculates the capacity of the step owners based on their working hours * % project dedication. The system then calculates the step owner's historical on-time performance as a percent. The forecast is then calculated as (Capacity (hrs)/Remaining Effort (hrs))-% on-time=Probability of On-Time Delivery.

Returning to reference FIG. 4, once Progress Tracking with Micro-Behaviors is in-place, the system may now create Decision-Tree Analysis models (DTA) to Model the Choices Between the Markov Model's Efficient Path and Alternative States 604.

Referencing FIG. 4, in the context of the VAF, Fault-Tree Analysis integrates with Decision-Tree Analysis to define the Expected Value or E(x) of achieving the next Milestone or Alternative State within the Markov Model (as depicted in FIG. 18 and FIG. 19, at 3001).

Referencing both FIG. 18 and FIG. 19 Decision Trees Interface with FTA to Calculate Expected Value of Markov State Alternatives 3001 describes the prioritization of alternate paths within the context of a Markov model as informed by the results of integrating Decision-Trees and Fault-Tree Analysis. Decision Tree Analysis provides the alternative choices under consideration. Fault-Tree Analysis is utilized, in combination with Bayesian Priors, to describe the probability of success with selecting an alternative path. The Value-Attribution Process provides the value-based impact associated with the success of attaining the milestones within the path. Utilized together, the probability of success multiplied by the potential impact creates an Expected Value, E(x), associated with each optional path. The E(x) is utilized in prioritizing and optimizing the alternative path choices.

Referencing FIG. 29, the diagram provides the exemplary embodiments that describe a simple Decision-Tree Analysis. The Decision-Tree Analysis (DTA) will utilize Projects aligned to a Management By Fact Portfolio 410 as choices within or as alternatives states within the Efficient Path of the Markov Model (see also FIG. 4, at 604). This describes the creation of Decision Tree Analysis (DTA) models and their integration within the Markov Model 3600. Decision-Tree Analysis is most traditionally utilized as a graphical representation that models decisions and their possible consequences, including outcomes, resource costs, and utility, to facilitate systematic evaluation of alternative choices. In the context of the Value-Attribution Framework, Decision-Trees are utilized to describe the possible choices available to a user from their Current State and the Expected Value associated with achieving that state within the Markov Model's paths toward achieving the target state.

Referencing FIG. 29, for each possible choice, the DTA(s) will utilize the projects' impacts, defined in the context of a user's definition of Value through the Value Attribution Process 3206 as input into the choice's Expected Value or E(x) 3601. The Value-Attribution Process 3206 describes the process for attributing value, expressed as Benefits-Costs, within the context of the Value-Attribution Framework. Benefits are derived from selling or providing products and services to customers and are then attributed to levels of the VAF hierarchy based on the Effort Contribution factor as a percentage of resource time consumed in development. Costs are derived from the labor and materials consumed in development and are attributed to levels of the VAF hierarchy based on the Effort Contribution factor. The Value Attribution Process utilizes the attributed values for benefits and costs derived at the same hierarchical level to express the value attributed to that level (see also FIG. 19, FIG. 24, and FIG. 25, at 3206).

Referencing FIG. 29, the Decision-Tree Analysis will utilize the Probability of Success, as defined by the Fault-Tree Analysis 3401 (described in paragraph above), within the calculation of the Expected Value or E(x) 3601.

Referencing FIG. 29, E(x) represents the probability of success, as described by a Fault-Tree Analysis informed by Bayesian Priors, multiplied by the potential impact, as described by the financial or other value associated with executing the Value-Attribution process, to create an Expected Value, E(x), associated with each optional path within the context of a Markov model 3601. The E(x) is utilized in prioritizing and optimizing the alternative path choices.

Referencing FIG. 30, this diagram portrays the exemplary embodiments that describe the integration of Decision-Tree Analysis within the context of the Markov Model. In these embodiments, a Decision-Tree Analysis 3600 precedes the Fault-Tree Analysis 3400, such that it provides the possible choices or Alternative States 3305 for the Fault-Tree Analysis 3400 to model the Probability of a State Transition 3304.

Referencing FIG. 30, Alternative States 3305 describe a state transition, within the context of a Markov model, that deviates from the optimal Efficient Path. State transitions 3304 represent a change in progress, performance, or capability that progresses the individual or organization toward target state attainment.

Referencing FIG. 31, however, as fully depicted in the exemplary embodiments therein, the relationship between Decision-Tree Analysis and Fault-Tree Analysis is recursive in nature. FIG. 31 depicts the individual or organization transitioning between states within a Markov Model. The initial DTA 3600 provides the FTA 3400 with choices as defined as projects or actions aligned to an MBF that describe the Alternative States 3305. The FTA will then calculate the Probability of Success for a State Transition by utilizing performance information in conjunction with Bayesian Priors. The DTA will then assign an Impact value based on the Value-Attribution associated with attaining each Alternative State. The DTA will then calculate the E(x) for each Alternative State based on multiplying the Probability of Success by the E(x). The E(x) may then be utilized to prioritize, optimize, and recommend the individual's or organization's next actions to progress them toward the Target State. The system determines which alternative states to present or recommend based on the optimization to reduce or limit the individual's or organization's Entropy Score based on a subset of the portfolio. This process is updated and repeated after each transition from an individual's or organization's Current State to the next Milestone or Alternative State.

Returning to reference FIG. 4, once the Decision Tree Analysis has been incorporated into the Markov Model, now the Alignment of Intent to Action is Now Well Established and the Organization is Performing Against Goals. The Dissipative Structure Gradually Transitions Organization from Current to Target State 705, see also FIG. 34 at 705. This process describes a well-organized dissipative structure that is actively and successfully transferring organizational energy from a baseline, or current state, toward target state fulfillment.

Referencing FIG. 4, as users make progress toward completing their projects 511 their actions have an impact on various aspects of the performance of the individual or organization. Performance Monitoring with Micro-Behaviors 512 describes the result of deploying analytics that measure the actual impact of changes, development, or improvement activities in respect to defined goals. When these are combined with Micro-Behaviors there is significant improvement, adaptation, and adoption of new or improved processes.

Returning to reference FIG. 11 at 512, the system will verify the existence of a connected data source utilized to calculate a metric's performance 512. If there is a data source connection, then the system will automatically calculate performance 2202. If there is not a data connection, then the user must manually input the performance data into a data collection mechanism within the system 2201.

Referencing FIG. 11, given the existence of a data connection or presence of manually entered data, the System Calculates Performance 2202. This describes the systematic process for calculating the performance of a project. The process begins by the system accessing the baseline data for a project's success metric. The baseline is then compared to the current metric performance ((baseline performance-current performance)/baseline performance to calculate a metric's % performance change. This result is then multiplied by the success metric's weight within the project, in respect to all other success metrics to quantify the % contribution of the project's current performance. The system then repeats this process for each success metric and aggregates the results to calculate the project's total current performance.

Referencing FIG. 16, at this point in the process, where Projects are Being Executed 415 and Ongoing Progress 511 and Performance Data with Micro-Behaviors 512 are being measured, now the system may Calculate Bayesian Priors Based on the current Performance 605. This action describes the creation of models, utilized to describe the probability of success, for a specific project or action based on prior historical performance. Traditionally, Bayesian Priors represent prior beliefs or knowledge about a parameter, expressed as a probability distribution, which is updated with new data through the Bayesian inference process.

Referencing FIG. 16, within the context of the VAF, Bayesian Priors inform Fault-Tree Analyses 3000 of the probability of success given defined thresholds, performance baselines, current success metric performance and progress toward project and phase completion (see also FIG. 18 at 3000, FIGS. 27 and 28 at 3401).

Referencing FIG. 18 at 3000, Fault Trees Model Probability of Success in Markov State Transitions describes the process of integrating the probability of success for an event, project, or performance metric calculated through Bayesian Priors within the context and structure of a Fault-Tree Analysis, in respect to a set of conditions and criteria established as Project Success Metrics within a Project Control Plan. As new performance information is introduced to the model, the probabilities of success metrics, calculated through integration with Bayesian Priors, will be updated to reflect the either positive or negative change from the previous measurement. Alternative states in the Markov model may describe performance milestones or project milestones that must be reached in order to achieve the target state, whether on the ‘efficient path’ or an alternative path to the target state. As progress and performance changes, the expected value of achieving each state described within the Markov model may also change. As Expected Values change, the system will reprioritize the available options presented to the user.

Returning to reference FIG. 11 at 2202, the System's Calculation of Performance marks the end of Performance Monitoring with Micro-Behaviors (see also FIG. 4, at 512) and transition to Continuous Feedback with Notification and Micro-Behaviors (as depicted in FIG. 4, at 513).

Referencing FIG. 12, at 4106, the Entropy Score is now Updated on Ongoing Basis Based on Progress and Alignment of Action to the Original Vision describes the process for adjusting the Entropy Score given new information about the user, their intentions, proposed actions, and aligned sentiment. During the process of executing projects, work is completed to progress toward target state attainment. The Entropy Score may now be continuously adjusted based on the amount of progress made and the velocity of change deployed toward target state attainment. Stalled projects and missed deadlines will negatively affect the Entropy Score by reflecting an increase in entropy between intention and action, whereas achieving milestones and meeting or exceeding performance expectations will signal a decrease in uncertainty and entropy, thus positively affecting the Entropy Score.

Referencing FIG. 34, at 4111, when Entropy Increases, it describes the scenario where an individual's or organization's degree of support, sentiment, and alignment of actions and resources decreases in respect to the current state. A ‘higher’ Entropy Score represents increased uncertainty, decreased support, and weaker alignment between goals, actions, and resources.

Returning to reference FIG. 4, as performance adjusts 512, either positively or negatively, the system will deliver targeted, relevant, and timely communications to users regarding actual or forecasted performance metric changes, accomplishments or milestones achieved, and mitigation needs for metrics exceeding defined thresholds 513.

Referencing FIG. 11, given the presence of both Progress Tracking 513 and Performance Monitoring 2202, the System may now Update a Performance Dashboard with Progress, Current Performance, and Forecasted Performance 2300. This describes the process for the system updating a visual representation of the project's current state, including, but not limited to current and forecasted progress against timeline; current, target, and forecasted performance against project goals. Progress and performance are represented on a visual dashboard composed of gauges and other charts with associated numeric metric performance.

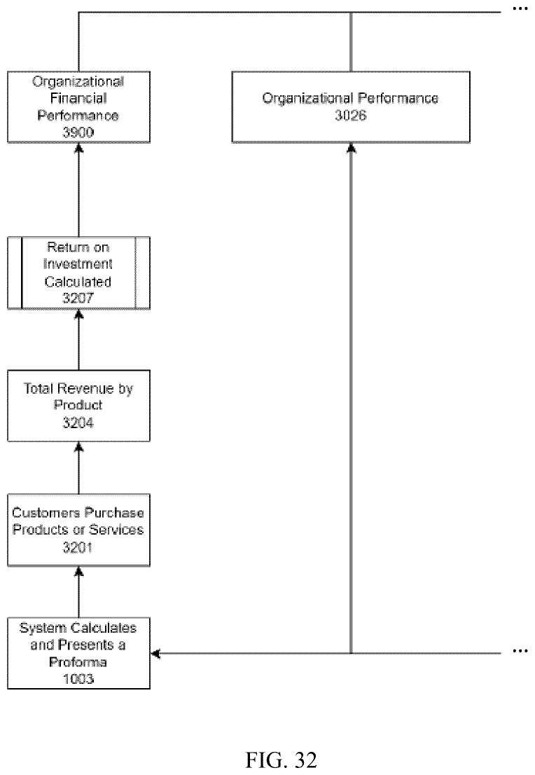

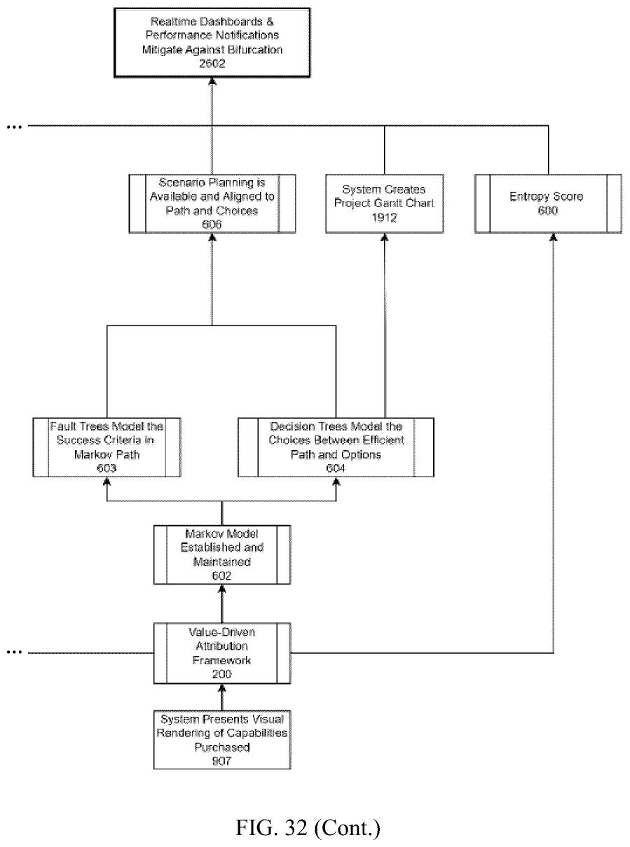

Referencing FIG. 32, the diagram presents the exemplary embodiments that describe the components that comprise the Performance Dashboard's visualization. The Performance Dashboard's components include but are not limited to Organizational Financial Performance 3900, Organizational Performance 3026, Scenario Planning 606, projects' and programs' progress in the form of Gantt Chart(s) 1912, and Entropy Score 600.

Referencing FIG. 32, the process for calibrating the Performance Dashboard begins once the user completes the process of purchasing a subscription to the Value-Attribution Framework, which may include other product modules (see also FIG. 2). At this point, the System will Present a Visual Rendering of the Capabilities Purchased 907 which will determine the scope of the Performance Dashboard's components.

Referencing FIG. 32, the Performance Dashboard will be updated in real-time as the individual or organization makes progress within the Value-Attribution Framework 200 (see also FIG. 2, at 200) by providing information and completing associated actions in relation to achieving the target state.

Referencing FIG. 32, the individual's or organization's Entropy Score 600 (see also FIG. 12) is updated and presented to the user as the scope of their Vision is further defined and as resources and actions align in their progression to the target state. Explanations of the factors and circumstances affecting the Entropy score both positively and negatively will be displayed to the user.

Referencing FIG. 32, from the Performance Dashboard, users will also have access to Scenario Planning that is Aligned to the Markov Path 606 (see also FIG. 31). Scenario Planning will model the available and prioritized choices of actions that the user may take next in their customized path toward the target state. Scenario Planning relies on the existence and use of Fault-Tree Analysis 603, (see also FIG. 18) and Decision-Tree Analysis 604, (see also FIG. 19) that model the probability of success and expected value associated with each of the alternative states within a Markov Model. The Markov Model is Established and Maintained 602 (see also FIG. 13) once the user defines projects or actions intended to progress the individual or organization toward the target state.

Referencing FIG. 32, given the presence of defined projects and actions with detailed work plans (see, e.g., FIG. 10) the System will Create Program and Project level Gantt Charts 1912. Gantt Charts visually represent the progress and estimated timelines of projects and actions as also represented in the Markov Model.

Referencing FIG. 32, as projects are executed, the system will calculate and present a visual representation of Organizational Performance 3026. Organizational Performance encompasses the On-Budget Performance, Timeliness Performance, and Capability Performance of all projects within all of the organization's Functions (see, e.g., FIG. 23).

Referencing FIG. 32, as projects are completed and new products or capabilities are deployed, the system will calculate and present a visual representation of Organizational Financial Performance 3900. This describes the process of comparing the individual's or organization's aggregated revenues, costs, and financial projections against the current year's financial goals. Financial performance is first estimated by the System Calculating and Presenting a Proforma 1003, (see, e.g., FIG. 6). Calculating actual financial performance requires that Customers Purchase Products or Services 3201 (see e.g., FIG. 25). Customer purchases result in Revenue 3204 being received by the individual or organization. A comparison between the costs and revenues received may then be calculated in the form of Return on Investment 3207. Each of these elements will be presented visually to the user as components of Organizational Financial Performance.

Referencing FIG. 32, the Performance Dashboards & Notifications described above are used to Mitigate Against Bifurcation within the Dissipative Structure 2602, (see, e.g., FIG. 14, at 2602). This describes how the process of continuous progress and performance notification maintains the momentum of transformation from the current state to the target state. Alignment to the target state vision is maintained by ensuring that the individual or members of the organization are kept informed with objective, timely, and relevant information regarding their current performance and progress toward attaining the target state.

Referencing FIG. 13, as Projects are being Executed 415 and Risks and Issues are being Mitigated 416, Ongoing Progress and Performance Data with Micro-Behaviors 511, 512 are continually processed by the system, resulting in users receiving Continuous performance Feedback and Notification 513. Given these conditions, the Markov Models are also Updated on Ongoing Basis Based on Adherence or Departure from Efficient Path 2503. Once a project has been completed or a milestone on the Efficient Path has been achieved, then the user's ‘current state’ will change to reflect that progress. Similarly, the user may choose to make decisions to undertake actions or projects that are unrelated to the ‘efficient path’. As these decisions are made and work completed in support of the changes, the user's ‘current state’ will change to reflect the shift in direction. Given that a user may only occupy a single ‘current state’ within the context of the Markov Model, their decisions and actions will be reflected in the model as it continuously seeks to calculate the most efficient path to the target state as well as the most advantageous alternative paths.

Referencing FIG. 12, at 4107, the Entropy Score is now Updated on an Ongoing Basis Based on Progress or Departure from Efficient Path. This describes the process for adjusting the Entropy Score given new information about the user, their intentions, proposed actions, and aligned sentiment. If the performance associated with success metrics does not meet the desired thresholds during the process of executing projects, then mitigating actions will be performed. During the process of executing projects, the user may make decisions to undertake actions or projects that are unrelated to the ‘efficient path’ described in the Markov Model. Both of these scenarios mark departures from the ‘efficient path’ which signals increased uncertainty and potential risk in target state attainment.

Conversely, increased progress and improved performance capability signal alignment to a more organized and stronger target state. Entropy Scores will be adjusted positively (lower) with actions in alignment with the target state and adjusted negatively (higher) with performance and actions that do not support the target state attainment.

Returning to FIG. 4, at this point in the process, Scenario Planning is Available and Aligned to the Markov Efficient Path and Alternative States 606, (see also FIG. 17, at 606). This action describes the creation of models that present users with prioritized alternative paths to achieve the target state.

Referencing FIG. 31, the diagram provides an exemplary embodiment of Scenario Planning. The alternate paths, which may be referred to as ‘Scenarios’ consist of groupings of sequential alternative states, milestones, and decisions that, together, represent a possible ‘path’ toward target state achievement. Decision-Tree Analysis 3600 provides the alternative choices under consideration. Fault-Tree Analysis 3400 is utilized, in combination with Bayesian Priors (see, e.g., FIG. 4, at 605), to describe the probability of success with selecting an alternative path. The Value-Attribution Process (see, e.g., FIG. 25) provides the value-based impact associated with the success of attaining the milestones within the path. Utilized together, the probability of success multiplied by the potential impact creates an Expected Value 3601 or E(x) associated with each optional path. The E(x) is utilized in prioritizing and optimizing the alternative path choices.

Referencing FIG. 17, once a user either completes a Milestone on the Efficient Path or chooses actions that designate an Alternative Path, then Scenarios are Updated Based on Changes to Current and Available Paths 2900. This describes the recalibration of Markov, Fault-Tree, and Decision-Tree models, given new progress and performance changes. Projects will complete, milestones will be achieved, and alternative states will be reached as progress is made in the user's progression to the target state. Once one or more of these accomplishments have been achieved, the user's current state will change to reflect their new position in the Markov path. Users will then be presented with a new set of prioritized alternative paths to achieve the target state. As new capabilities are achieved, or failed to achieve, through the user's actions, performance will also change either positively or negatively. While the success metrics may remain constant, the changes in performance will adjust the probability of success and expected value of the future projects and alternative states on the path. Taken together, both progress and performance changes will affect the options for how the user progresses on the Markov path toward the target state.

Returning to FIG. 11, as Progress and Performance are updated throughout the project's lifecycle 2300, the system will evaluate whether the Performance is In Tolerance with the Control Plan Thresholds 2301. This describes the systematic process of comparing the current level and forecasted level of performance in respect to performance thresholds established in the project's control plan.

Referencing still FIG. 11, if the current level of performance is not in-tolerance of the control plan's defined thresholds, then the user must Mitigate the associated Risks and Issues 416 (see also FIG. 4, at 416). Mitigating Risks and Issues encompasses all activities related to executing the steps to mitigate risk through actions defined in the Control Plan.

Referencing FIG. 4, the mitigation of risks and issues may utilize micro behaviors that enable the users to become better managers of risks and issues. An appropriate management of risk entails a level of strategic gameplay, at 704.

Referencing FIG. 11, the process of Mitigating Risks and Issues begins at 2400, where the System Notifies the User with identified Performance Changes and Recommends Actions to mitigate the risks 2400. This describes the systematic process of communicating negative performance changes to the user based on the user's defined performance thresholds associated with the project's control plan. The system will access the recommended actions from the control plan, based on the specific metric and its defined mitigation plan.

Referencing FIG. 11, upon receiving the system's notification, the User must Execute Mitigating Actions to control the risks 2401. This describes all activity associated with a user enacting the recommended actions associated with a metric within the project's control plan.

Referencing FIG. 11, after the User Executes the Mitigating Actions 2401, the system will reevaluate the metric's performance in order to determine if the Mitigating Actions were Successful 2402. This evaluation captures whether the actions completed by the user have positively affected performance and mitigated the potential risk. If the Mitigating Actions prove successful, then the User will return to Executing Project Steps 2000.

Referencing FIG. 11, however, if the Mitigating Actions 2401 were proved to be unsuccessful, then Dissipative Structure Begins to Bifurcate 4110 (see also FIG. 34). This describes the immediate, increased risk of a dissipative structure becoming less organized in respect to its current state. During this transition, the flow of energy between the current and target states through the dissipative structure decreases or stops completely. The transformation from current to target state ceases and the target state's structure becomes unstable with increased uncertainty. This bifurcation can be progressive over time, and suitably plotted to aid in the development of alternate innovative approaches by the users.

Referencing FIG. 11, at this juncture, the user must determine whether to Halt, Abandon, or Modify Project 2404. Here the user, after unsuccessfully attempting to mitigate project risks, must decide whether to continue the project with modifications, stop current work on the project with an option to continue the project later, or to stop current work and abandon the project permanently.

Referencing FIG. 11, if the user decides to Halt the project, then the Project is Moved to Backlog 1606. This describes the process of creating a list of projects not currently selected for execution, but that may be selected for future execution (see also FIG. 9, at 1606).

Referencing FIG. 11, if the user decides to Modify the project, then they must Identify changes to their Projects or Actions to continue to Progress Against Goals 1600. This describes all activities related to a single or multiple users identifying changes to specific projects or actions that will advance the individual or organization towards attaining the target state (see also FIG. 9, at 1600).

Referencing FIG. 11, however, if the user decides to Abandon the project, then the process Ends 4112. This action signifies the end of a project that has been selected to abandon. At its unsuccessful conclusion, the user will be prompted to document lessons learned from the project for use by future projects. The dissipative structure will now dissolve into chaos.

Referencing FIG. 11, at 2301, if the Performance is In-Tolerance with Control Plan Thresholds, then the System Notifies the User of the Performance Change According to User Communication Preferences 2302. This describes the systematic process of communicating positive performance improvements to the user based on the user's preferred cadence (in respect to the time of the last communication) or preference for event-driven notifications, for example when a metric improves above a threshold or % change.

Referencing FIG. 11, next, the System Rewards User Based On Performance and Progress 2303. This describes the process for rewarding users based on meeting or exceeding performance goals and/or progressing the project on or ahead of schedule. As progress toward milestones and goals is achieved, each user will be incentivized with rewards in the nature of badges displayed on their dashboard and linked social media accounts (depending on user preference), visual depictions of how much they have accomplished and how much work remains to achieve their goal, phase, or vision. They will be reminded of the organization's original vision and why achieving it is important to them. They will receive notifications of success that they may choose to share with others on social media or otherwise. The rewards are considered the Shapley values in the cooperative game theoretic model, which occur as Nash Equilibrium are attained. The Shapley values are also used by the common language models to explain the predictions it makes.

Referencing FIG. 11, after rewarding the user, the system will confirm if All Projects in the current Phase are Complete 2304. Here the system references the completion % of all projects aligned to a phase. If all projects reflect either 100% complete or represent a completion % within a stated tolerance for the phase, then the system will update the phase projects' progress as complete, else the system will continue to monitor and track the completion % of the projects.

Referencing FIG. 4, once the current phase is marked as completed, then the user will transition from the Executing Phase at 305 and transition to the Achievement Phase at 306.

Referencing FIG. 11, as projects are successfully completed, the user may celebrate their Achievements (see also FIG. 4, at 417), which mark the successful completion of a user or organization's project, portfolio, goal, or vision's target state performance. Once a project is completed and new or improved products or capabilities are deployed, the system may now calculate the Actual Benefits, Value, and ROI associated with the project.

Referencing FIG. 25, the depiction of the exemplary embodiments describing the process for calculating benefits begins, given a Project's Completion 417 (see also FIG. 4, at 417) and successful Achievement of the desired Capability 3021 (see also FIG. 23, at 3021).

Referencing FIG. 25, once the Project has proved successful, the individual or organization will Launch the new or Improved Product or Service 3200. This describes the event when the new or improved capabilities associated with a product or service are available and offered to customers for purchase.

Referencing FIG. 25, next Customers will Purchase the Products or Services 3201. This describes the financial transaction between an organization and its customers where the customer pays for the rights to a product or service.

Referencing FIG. 25, based on the purchase, the individual or organization will Receive Revenue from the Product or Service 3203. This describes the transfer of financial currency from a customer to an organization or individual for the rights to a product or service.

Referencing FIG. 25, Total Revenue by Product or Service 3204 may then be quantified as the sum of all financial transactions between customers and the individual or organization that are associated with a specific product or service offering.

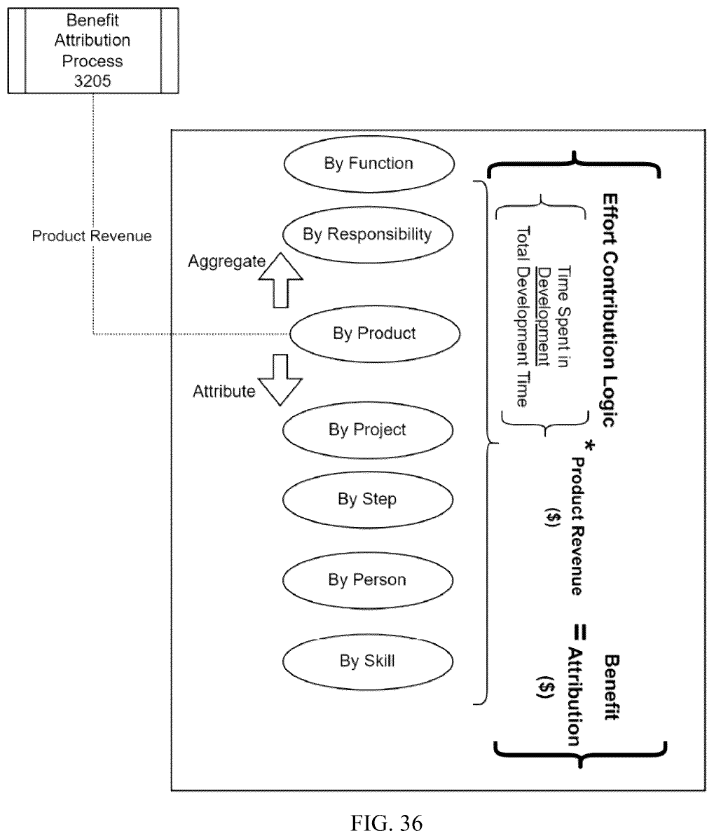

Referencing FIG. 25, the Benefit Attribution Process 3205 (e.g., as depicted conceptually in FIG. 36) describes the process where all benefits, in respect to the individual's or organization's definition of value, are attributed, associated, and aggregated across numerous entities, including but not limited to functions, programs, portfolios, projects, project steps, people, skills, and assets. Benefits describe the contribution of an entity towards increasing the value delivered by the organization or individual. While value is most often denominated in financial terms, it may be denominated in other terms. Benefits may or may not be directly associated with an entity, such as a project, given that many project actions are solely in support of a product or service, but are not related to the actual value-producing transaction of transference between an organization and a consumer. Benefits are most directly associated with the act of selling or providing products and services for consumption by customers.

Referencing FIG. 25, actions associated with the development, improvement, or maintenance of benefit-producing products or services may be attributed a portion of the benefits produced by quantifying the total effort associated with the actions and proportionally allocating the partial benefit to the supporting steps required for its delivery. One embodiment of the process for Calculating the Effort Contribution 3103 is illustrated in FIG. 39.

Referencing FIG. 36, the Benefit Attribution Process (see, e.g., FIG. 25, at 3205) entails a process where the Effort Contribution Factor 3103 is multiplied by the Product's Revenue 3204 to derive the Benefits for a specific level of the VAF hierarchy. Benefits may be either aggregated upwards in the hierarchy or attributed to lower levels within the hierarchy based on the activities represented in the Effort Contribution Factor.

Referencing FIG. 25, once the Benefits 3205 and Costs 3104 (see, e.g., FIG. 40) have been aggregated or attributed within the VAF hierarchy, the system may now calculate the Value Attributed to each level of the hierarchy 3206. The Value Attribution Process 3206 describes the process for attributing value, expressed as Benefits-Costs, within the context of the Value-Attribution Framework.

Referencing FIG. 25, the relationship between Costs and Benefits may now also be expressed in terms of Return on Investment (ROI) 3207 (e.g., as depicted in FIG. 38).

Referencing FIG. 38, the diagram describes the process for calculating the return (benefits, given the individual's or organization's definition of value) on the investment (total costs of the effort in respect to a step, project, portfolio, phase, product, or function) to derive the standard ROI performance value. ROI will be characterized based on how ‘value’ or ‘benefits’ are defined by the user, such that the performance value may be characterized as a percentage (when both the numerator and denominator are financially based) or a rate (when benefits are described in terms other than financial). For example, an organization may spend $100 in costs on a project in order to receive $1000 in revenue. In this instance, ROI would be traditionally calculated as $1000/$100=10×=1000%. Another organization may spend $100 in costs on a project in order to reduce the amount of landfill waste, as measured in pounds, by 25%. In this instance, ROI would be characterized as a rate, where performance is calculated in comparison to a baseline and denominated in dollars representing the costs. ROI in this example may be calculated according to Equation (10):

$$ROI = \frac{( Baseline Performance - Current Performance )}{Costs} \qquad Equation ( 10 )$$

In an example, if the Baseline Performance is 100 lbs. and the Current Performance is 75 lbs., and the Costs are $100, the ROI will be $4 per lb.

Referencing FIG. 12, as projects are completed 417, Performance, Benefits, Costs, Value and ROI will be calculated. The Entropy Score is now also Updated based on the Progress toward Fulfilling the Target State Vision 4108. This describes the process for adjusting the entropy score given new information about the user, their intentions, proposed actions, and aligned sentiment. As projects complete and performance capability improves, entropy scores will be adjusted positively (lower) given the progress in alignment with the target state attainment.

Referencing FIG. 13, after all Projects have been completed 417 for each of the Delivery Phases 2304, which are structured to transform the individual or organization from its baseline state to target state, the User Reaches Target State and Destination of Markov Path 2504. This describes the process of completing the actions and achieving the state transitions required to attain the target state, as described by the last and final state of the Markov Model.

Referencing FIG. 17, at 2901, Scenarios Options Approach Zero Based on Target State Achievement describes the conditions under which the user, individual, or organization successfully achieves the capabilities embodied by the target or final state as described within the current Markov model's structure.

Referencing FIG. 12, at 4109, the Entropy Score now Approaches Zero Given the Successful Fulfillment of the Target State Vision. This describes the process for adjusting the Entropy Score given new information about the user, their intentions, proposed actions, and aligned sentiment. Once the target state's performance capability has been achieved and all actions in-scope to progress toward the target state have been completed, the Entropy Score will be adjusted to approach zero, indicating successful target state attainment.

Returning to FIG. 4, Lookalike Models are now Updated with Best Practices 607 based on the project's, individual's, or organization's performance. This action describes the activities required to recalibrate the Lookalike Models with success outcomes achieved under specified conditions, given a specific individual or organizational profile.

Referencing still FIG. 4, at 706, as the last Delivery Phase is completed, the Target State Vision is Achieved and New Targets may be Established. The Process Begins Anew, marking the Dissipative Structure's Transition to the desired Target State as Complete 706 (see also, e.g., FIG. 18 and FIG. 34, at 706). This process describes the positive outcome of achieving the target state's intention and new performance capability. Upon successful completion, the dissipative structure has fully transitioned the energy of the organization into the support of the target state and may now completely dissolve.

Referencing FIG. 4, now a user must choose whether to complete their journey with the VAF, and not monitor future performance, or to continue their journey by completing a new, revised vision statement to Recalibrate 418 their aims and goals (see also, e.g., FIG. 18, at 418). This recalibration effectively determines their level of continued interaction with the co-operative game 706 (see also, e.g., FIG. 34, at 706). Individuals and organizations are prompted to define their next desired target state and goals for the future and the process begins again. For some organizations, the dissipative structure becomes the stable fabric of the organization, it is the way the organization now functions. In such organizations, they can continue to innovate and transform so long as they remain in alignment with their goals.

The modeling and analysis approach includes an initial Planning phase which includes an initial needs assessment, followed by the gathering of individual and organizational information, a dynamic vision interview, a dynamic phase interview, a dynamic goal interview, processes for defining success metrics and data sources, the establishing of a Management By Fact (MBF) portfolio for the organization, and the establishment of project definitions, project definitions, project success metrics, a Project Control Plan, and Work Plan definitions.

The needs assessment is, generally, a process for asking a user/responder one or more questions or prompts for response, feedback, organizational information input, or organizational data provisioning. Questions and/or prompts during an initial phase of the needs assessment can include, e.g., “do you/the organization currently have a strategy?” “please summarize or provide information about your/the organization's strategy,” “do you/the organization currently have a vision?” “please summarize or provide information about your/the organization's vision,” “do you/the organization currently have a mission or a mission statement?” “please summarize or provide information about your/the organization's mission or mission statement,” do you/the organization currently have a set of organizational values?” and/or “please summarize or provide information about your/the organization's set of values.”

In some embodiments, the needs assessment can be performed by programmatically executing a needs assessment module or program via an interface (e.g., a user interface) between a user device associated with a user/responder/agent associated with the organization and an organizational strategy assessment device (e.g., a server, a computing device, etc.). The user interface can be hosted by and/or otherwise generated by the organizational strategy assessment device and displayed and/or otherwise presented to the user/responder/agent via the user device. In other embodiments, the needs assessment can be performed using an auditory interface, a multi-media interface, a gesture interaction interface, an interactive touch-screen interface, and/or the like. In other embodiments, the needs assessment can be performed using a phone call between an interactive voice response (IVR) system and the user device (e.g., phone, smartphone, etc.) associated with the user/responder/agent associated with the organization. In some embodiments, the needs assessment can be performed via a communications interface between a user device and a chatbot or the like stored/hosted at a server or other such device or system.

In some embodiments, responses provided in response to questions or fields during the needs assessment interview can be provided from the user by entering response information to specific questions into response fields using a keyboard, an interactive display, one or more voice responses/audible responses captured via a microphone, one or more manual-visual responses, such as by performing sign language, images or video of which are captured using an image capturing device, and/or the like. In some embodiments, responses provided in response to questions or fields during the needs assessment interview can be provided from the user by the user providing information needed in order to access third-party or external organizational information, such as financial information, resource use information, revenue information, personnel/stakeholder information, and/or the like. For example, the user can provide login information associated with a third-party provider or service, such as one that provides services to the organization related to accounting, finance, supply chain management, resource use, current or desired labor or personnel needs, labor/personnel allocation, human resources information, payroll information, accounts receivable/accounts payable information, and/or the like.

In some embodiments, the questions provided to responder(s)/user(s) during the Needs Assessment can be dynamically shifted, changed, adjusted, modified, expanded, condensed, added, or eliminated before and during the Needs Assessment. In some embodiments, syntactic analysis or the like can be carried out on responses provided by the responder(s)/user(s). In some embodiments, the information and/or responses provided by user(s)/responder(s) can be used when creating the organizational vision and mission statements.

In some embodiments, when multiple responders/users provide responses, different responders/users may answer the same or similar questions in very different ways and/or using different words or language. A language model, such as a common language model or large language model can be used to evaluate, compare, weight, and/or synthesize the multiple and/or divergent responses from the multiple responders/users.

In some embodiments, the language model-synthesized responses can be structured into prompt(s) that will create artifacts, data outputs, and/or tags that can be used to during later stages and interview, such as when performing guided interview(s) to form a vision statement, a mission statement, goals, phases, etc. for the organization.

Following the initial needs assessment interview, an initial Lookalike model can be generated based on categorizing the organization into an organizational cohort of similar organizations for which proxy organizational profiles and Lookalike models have already been generated. Using the Lookalike model, an entropy score can be generated or calculated for the organization.

As used herein, the term “entropy score” is used to refer to a measure of organizational efficiency, based on operational efficiency, production efficiency, and/or the like. For example, the entropy score can be a measure of how efficiently capital, assets, resources, labor, time, materials, and/or the like are being used to deliver current organizational outcomes, which can be indicated monetarily, financially, or the like.

The Project Control Plan can be created based on resource use/value output analysis and return on investment (ROI) calculations on a project-by-project basis, as well as project-specific probability of success information. The probability of success of various projects can be based upon historical organizational information, among other information received from a user/stakeholder, retrieved from a third-party provider or external database, or estimated/determined based on proxy information about an organizational cohort with which the organization is most aligned.

As part of preparing the Project Control Plan, instructional information can be used to conduct analysis using Lookalike Models, Markov Models, Fault Tree Models, Bayesian Priors, Decision-Tree Models, and/or the like. In some instances, a Markov model can be established for the organization as part of the Project Definition or a Project Creation process. The Markov Model can be used to model an arrangement, such as a hierarchical-temporal arrangement, of all Projects associated with the organization. The Markov Model can be arranged with one or more initial projects being indicated, followed by one or more connections from each of the one or more initial projects being established between the one or more initial projects and one or more subsequent projects. The one or more connections between the one or more initial projects and the one or more subsequent projects can indicate that the one or more subsequent projects are to be carried out subsequent to completion of the one or more initial projects, meaning that the projects are arranged in consecutive order along one or more Markov paths through the arrangement of Projects. The one or more Markov paths through the Markov Model can be reflected, according to various embodiments, in, e.g., FIGS. 30 and 31.

Following the initial Planning phase is an Executing phase in which the responsible users/stakeholders within the organization execute the projects according to the Project Control Plan. During the Executing phase, iterative/ad-hoc performance monitoring is carried out using responses from users/stakeholders and/or Micro-Behaviors Analysis of users/stakeholders.

In some embodiments, an organization may be modeled as a dissipative structure or dissipative system. In the field of thermodynamics, the terms “dissipative”, “dissipative structure”, and “dissipative system” are typically used to describe and model open systems in which energy and matter are regularly or constantly dissipated out of the system. By modeling organizations as dissipative structures, the inputs and outputs to the organization in terms of materials, labor, time, revenue, and/or the like can be characterized according to a variety of permutations of Markov paths through the Markov Model. Generally, the systemic inefficiency and entropy of organizations tends to become increasingly chaotic and inefficient over time absent organizational intervention. A ‘most efficient’ Markov path may be formed.

For an organization, data related to resource use, labor, materials, and return on investment from an organizational transformation/vision/value perspective can be used to generate a single score related to entropy, which can be referred to as the Entropy Score.

In some embodiments, the Entropy Score can be a measure of how much effort, energy, and resources are being used to progress the organization forward towards its ultimate vision (i.e., the target state).

In some embodiments, a cooperative game can be used to enable stakeholders within the organization to dynamically and effectively interact with one another. In some embodiments, there may be coherence between stakeholder feedback during the cooperative game, while in other embodiments there may be much dissonance or misalignment between stakeholders during the cooperative game. The dissonance or misalignment can contribute to the organizational entropy, or disorder.

In some embodiments, stakeholders may be saying one thing and doing another, which reflects a level of maturity or disorder in the organization also. From a game theory perspective, organizations often function as a large cooperative game already, except that not all participants are aware they are playing a game together, and many participants are playing by different rules and towards different goals or ends. In some instances, some organizations may have an increased productivity and probability of success because the stakeholders all playing together according to the same rules and therefore the stakeholders all trust one another, while in other organizations the disorder and misalignment of goals leads to breakdowns in communication and organizational listlessness, project failure, inefficiency of resource use, and pursuit of projects that may not contribute to organizational transformation as much as other projects.

In some embodiments, therefore, during the answers received from stakeholders during the needs assessment may be used as a proxy for more detailed and cooperative/disparate feedback received/calculated later.

In some embodiments, the guided needs assessment and the organizational data are input to a common language model or large language model to develop an intelligent agent for the organization which is augmented by interrogation and reasoning.

In some instances, the amount of discord or disagreement between stakeholders, if there are multiple stakeholders responding to the dynamic vision interviews, can be fed into the entropy model as well. Based on the disparate responses from stakeholders, the language model/intelligent agent can provide a coherent mission statement and vision definition for the organization, e.g., whether or not the organization has a private or public mission statement generated already.

From there, the model can generate phases or milestones associated with phases of organizational transformation between current and target state. The vision for the organization can be broken down into milestones and have an estimated timeline for each milestone.

In some embodiments, microbehaviors can be based on haptics provided to user devices, based on video analysis or audio analysis of user interactions, or the like.

### Examples

Provided below are examples of, e.g., various inputs and outputs for one or more different modules, models, systems, subsystems, and/or the like, such as described herein. For example, in Table 1, an example set of initial questions is provided that may be posed via an interface (e.g., user interface) to one or more possible responders or users associated with an organization. These questions can be used to identify the organization with which the responder(s)/user(s) is/are associated.

TABLE 1
Example of Initial Question Set

| | FIG. | | | | |
|---|---|---|---|---|---|
| | Element | | | | |
| ID | # | Module | Data Question | Possible Responses | Logic |
| 1 | 901 | Initial | Hello, with whom am | Enter Name (First, Last) | |
| | | Questions | I speaking with | | |
| | | | today? | | |
| 2 | 901 | Initial | If you have it, please | 9 Digit Number or Click | Look up EIN in |
| | | Questions | provide the Employer | “I do not know it” | Database |
| | | | Identification Number | | |
| | | | for your organization | | |
| 3 | 901 | Initial | If you do not have it, | Name of Organization | Look up |
| | | Questions | please enter the name | | organizations with |
| | | | of your organization | | the same or similar |
| | | | | | names |
| 4 | 901 | Initial | Please select the Zip | 5 Digit Number | Lookup City, State |
| | | Questions | Code where your | | by Zip Code. |
| | | | organization is | | Refine search by |
| | | | located | | location |
| 5 | 901 | Initial | Is this the correct | Name of Organization | Present the |
| | | Questions | organization? | | organization |
| | | | | | located |
| 6 | 901 | Initial | Is this the current | Board Chair First, Last | Lookup and present |
| | | Questions | leader of the | | Board Chair |
| | | | organization? | | |
| 7 | 901 | Initial | Is this the current | Street Address of | Lookup and present |
| | | Questions | address of the | Organization | address |
| | | | organization? | | |
| 8 | 901 | Initial | Is this the best contact | email or phone number | Lookup and present |
| | | Questions | information for the | associated with | Executive Director |
| | | | organization? | Executive Director or | email address or |
| | | | | Chairman or | phone number |
| | | | | Chairperson, or Chief | |
| | | | | Executive Officer | |
| 9 | 901 | Initial | Please confirm that | Display: | Display the current |
| | | Questions | the organization's | Organization Identifier | or updated fields |
| | | | details are current | Organization Name | describing the |
| | | | | Organization Address | organization. |
| | | | | Board Leader | User confirms or |
| | | | | Executive Director | updates |
| | | | | Contact Information | information. |
| | | | | | Organization |
| | | | | | moves to |
| | | | | | “Claimed” status. |
| | | | | | System Updates the |
| | | | | | Banner to Indicate |
| | | | | | “Claimed” |

In Table 2, an example assessment set is provided that illustrates various example organizational areas or functions that can be presented to a responder/user during a Needs Assessment. The responder/user, when viewing each area or function, provides an input regarding a current capability or performance of the organization in that specific area or function. In some embodiments, a Likert scale can be used to determine values (e.g., integer values, score values, bucketized score values, or the like) for the responder/user to indicate their opinion of the organization's current capabilities across one or more different areas or functions. The example weight values provided in Table 2, as well as the categories,

TABLE 2
Example of Question Set for Needs Assessment

| | | Please indicate your | | | | | | |
|---|---|---|---|---|---|---|---|---|
| | | organization's | | | | | | |
| | | current capabilities | | | | | | |
| | | by selecting a | | | | | | |
| | | number | | | | | | |
| | Corresp. to | corresponding to the | | | | | | |
| | FIG. | scale and | | | | | | Numeric |
| ID # | Element # | descriptions below: | Low = 1 | Med = 5 | High = 10 | Weight | Response | Translation |
| 1 | 902 | Strategy | We do | We have | We have a | 0.2 | High | 9 |
| | | Development | not have | a formal | formal | | | |
| | | | a formal | process | process, | | | |
| | | | process | for | tools, and | | | |
| | | | or | defining | methodology | | | |
| | | | cadence | and | for defining | | | |
| | | | for | developing | strategic | | | |
| | | | defining | strategy | goals on a | | | |
| | | | and | at least | cadence and | | | |
| | | | developing | 1x per | a process for | | | |
| | | | strategy | year | identifying | | | |
| | | | | | and | | | |
| | | | | | executing | | | |
| | | | | | aligned | | | |
| | | | | | projects | | | |
| | | | | | throughout | | | |
| | | | | | the year that | | | |
| | | | | | ties | | | |
| | | | | | operations to | | | |
| | | | | | strategy. | | | |
| 2 | 902 | Strategic Guidance | Strategic | We have | Our | 0.05 | High | 9 |
| | | | guidance | informal | organization | | | |
| | | | comes | strategy | utilizes | | | |
| | | | from our | management | consultants | | | |
| | | | organization's | teams | to help guide | | | |
| | | | leader | that help | our strategic | | | |
| | | | without | align and | development | | | |
| | | | need for | guide our | and | | | |
| | | | outside | strategy | implementation | | | |
| | | | opinions | development | with | | | |
| | | | | and | standardized | | | |
| | | | | implementation | tools and | | | |
| | | | | | methods. | | | |
| 3 | 902 | Project Management | We do | We have | We have a | 0.15 | High | 9 |
| | | | not | an | formal | | | |
| | | | complete | informal | process with | | | |
| | | | projects | process | standardized | | | |
| | | | within | for | tools and | | | |
| | | | our | managing | methods to | | | |
| | | | organization | project | manage and | | | |
| | | | | work | execute | | | |
| | | | | where | projects | | | |
| | | | | each | where | | | |
| | | | | project | performance | | | |
| | | | | leader is | expectations | | | |
| | | | | responsible | and | | | |
| | | | | for | measures are | | | |
| | | | | how thier | transparent, | | | |
| | | | | project is | easily | | | |
| | | | | executed, | accessible, | | | |
| | | | | reported | and directly | | | |
| | | | | and | tied to | | | |
| | | | | performs. | strategy. | | | |
| 4 | 902 | Risk Management | Risks are | Risks are | Risks are | 0.1 | High | 9 |
| | | | managed | anticipated | expected | | | |
| | | | and | through | through | | | |
| | | | resolved | prior | analysis and | | | |
| | | | as they | analysis | signals and | | | |
| | | | appear | but are | proactively | | | |
| | | | without a | either not | mitigated | | | |
| | | | formal | documented | before they | | | |
| | | | process | or | cause harm | | | |
| | | | for | standardized | to the | | | |
| | | | documentation | in | organization | | | |
| | | | or | the | where they | | | |
| | | | mitigation | approach | are tracked | | | |
| | | | | to | and analyzed | | | |
| | | | | resolving | for future | | | |
| | | | | them. | application. | | | |
| 5 | 902 | Strategy | We do | We | We | 0.05 | High | 9 |
| | | Performance | not | formally | constantly | | | |
| | | Management | formally | evaluate | evaluate our | | | |
| | | | evaluate | our | strategies' | | | |
| | | | our | strategies' | performance | | | |
| | | | strategies' | performance | with | | | |
| | | | performance | at | standardized | | | |
| | | | | least 1x | tools and | | | |
| | | | | per year | methods that | | | |
| | | | | | tie | | | |
| | | | | | operations to | | | |
| | | | | | strategy and | | | |
| | | | | | we recognize | | | |
| | | | | | and incent | | | |
| | | | | | performance | | | |
| | | | | | that | | | |
| | | | | | advances our | | | |
| | | | | | strategic | | | |
| | | | | | goals. | | | |
| 6 | 902 | Data Integration and | Our data | Our data | Our data is | 0.15 | High | 9 |
| | | Management | is not | is | formally and | | | |
| | | | managed | informally | strategically | | | |
| | | | and | managed | managed | | | |
| | | | exists in | and | with data | | | |
| | | | the | analyzed | from | | | |
| | | | source | on an | different | | | |
| | | | system | ad hoc | systems | | | |
| | | | only | basis | being | | | |
| | | | | | collocated | | | |
| | | | | | for analytical | | | |
| | | | | | purposes | | | |
| 7 | 902 | Comparative | We do | We have | We have a | 0.1 | High | 9 |
| | | Analytics and | not | an | formal | | | |
| | | Insight Tools | analyze | informal | process for | | | |
| | | | our | process | evaluating | | | |
| | | | competitor's | of | competitiors | | | |
| | | | performance | analyzing | and utilizing | | | |
| | | | or | competitors | and | | | |
| | | | utilize | and | socializing | | | |
| | | | industry | managing | best | | | |
| | | | best | best | practices to | | | |
| | | | practices | practices | further | | | |
| | | | | | advance our | | | |
| | | | | | strategy. | | | |
| 8 | 902 | Operational | Our top | Our | Our | 0.05 | High | 9 |
| | | Financial | & bottom | organization | organization | | | |
| | | Management | line | has a | has a | | | |
| | | | finances | formalized | formalized | | | |
| | | | are | process | process of | | | |
| | | | managed | for | managing | | | |
| | | | informally | managing | finances | | | |
| | | | by the | finances | which | | | |
| | | | organization's | on a | directly tie | | | |
| | | | leader | cadence. | operations to | | | |
| | | | | | our strategic | | | |
| | | | | | efforts. | | | |
| 9 | 902 | Customer Analysis | We do | We have | We have a | 0.05 | High | 9 |
| | | and Management | not | an | formal | | | |
| | | | analyze | informal | process for | | | |
| | | | our | process | analyzing | | | |
| | | | customers' | of | customer | | | |
| | | | behavior | analyzing | behavior and | | | |
| | | | or | customer | managing | | | |
| | | | evaluate | behavior | satisfaction | | | |
| | | | their | and their | that directly | | | |
| | | | satisfaction | satisfaction | ties to our | | | |
| | | | | | organization's | | | |
| | | | | | strategy | | | |
| 10 | 902 | Human Resources | We do | We have | We have a | 0.05 | High | 9 |
| | | Management | not have | an | formal | | | |
| | | | a formal | informal | evaluation | | | |
| | | | evaluation | evaluation | process with | | | |
| | | | process | process | known | | | |
| | | | and | with | criteria for | | | |
| | | | criteria | criteria | human | | | |
| | | | for | for | resource | | | |
| | | | human | human | performance, | | | |
| | | | resource | resource | all workers' | | | |
| | | | performance | performance | resource | | | |
| | | | and | and | capacity is | | | |
| | | | individual | individual | managed | | | |
| | | | resource | resource | collectively | | | |
| | | | capacity | capacity | in pursuit of | | | |
| | | | is | is | strategic | | | |
| | | | managed | managed | goals | | | |
| | | | by the | by the | | | | |
| | | | individual | worker's | | | | |
| | | | worker. | manager. | | | | |
| 11 | 902 | Learning | Learning | Learning | Learning | 0.05 | High | 9 |
| | | Management | within | within | within our | | | |
| | | | our | our | organization | | | |
| | | | organization | organization | is formalized | | | |
| | | | is | is | with defined | | | |
| | | | completed | formalized | curriculum | | | |
| | | | with | with a | and expected | | | |
| | | | on-the- | defined | performance | | | |
| | | | job- | curriculum | that is tied to | | | |
| | | | training | for | succession | | | |
| | | | (OJT) | each | planning and | | | |
| | | | though is | worker | strategy. | | | |
| | | | not | | | | | |
| | | | managed | | | | | |
| | | | or | | | | | |
| | | | evaluated | | | | | |

Table 3 illustrates an example of input values for calculating an entropy score for an example organization.

TABLE 3
Example inputs for continuous update of entropy score calculation.

| | | | | | | | | Adjusted | Adjusted | |
|---|---|---|---|---|---|---|---|---|---|---|
| | FIG. | | | | | Current | Weighted | Entropy | Entropy | Cumulative |
| Capabilities | Element # | Element | Min | Max | Weight | Value | Contribution | Score | Score | Distribution |
| Strategy | 2400 | Purchase | 0 | 1 | 0.19% | 1 | 0.19% | 57.74% | 42.3 | 72.2% |
| Development | | Decision | | | | | | | | |
| Strategy | 1109 | Vision | 0 | 1 | 6.60% | 1 | 6.60% | | | |
| Development | | Statement | | | | | | | | |
| | | Creation | | | | | | | | |
| Strategy | 1109 | Vision | 0% | 100% | 4.52% | 0.29 | 1.30% | | | |
| Development | | Statement | | | | | | | | |
| | | Agreement | | | | | | | | |
| Strategy | 1307 | Phase Goals | 0 | 1 | 4.03% | 1 | 4.03% | | | |
| Development | | Created | | | | | | | | |
| Strategy | 1305 | Phase Goals | 0% | 100% | 4.46% | 0.31 | 1.37% | | | |
| Development | | Agreement | | | | | | | | |
| Strategy | 1311 | Phase Goal | 0% | 100% | 4.22% | 0.07 | 0.30% | | | |
| Development | | Prioritization | | | | | | | | |
| | | Agreement | | | | | | | | |
| Project | 1700 | Projects | 0 | 1 | 3.67% | 1 | 3.67% | | | |
| Management | | Aligned to | | | | | | | | |
| | | Goals | | | | | | | | |
| Project | 1604 | Project | 0% | 100% | 2.23% | 0.01 | 0.02% | | | |
| Management | | Prioritization | | | | | | | | |
| | | Agreement | | | | | | | | |
| Project | 1910 | Work Plan | 0 | 1 | 3.71% | 1 | 3.71% | | | |
| Management | | Creation and | | | | | | | | |
| | | Alignment | | | | | | | | |
| Strategic | 1910 | Vision | 0% | 100% | 11.43% | 41% | 4.73% | | | |
| Guidance | | Progress | | | | | | | | |
| Risk | FIG. 31 | Markov Path | 0% | 100% | 7.77% | 0.5 | 3.89% | | | |
| Management | | Progress or | | | | | | | | |
| | | Departure | | | | | | | | |
| Operational | 3900 | Organizational | 0% | 100% | 12.16% | 0.5 | 6.08% | | | |
| Financial | | Financial | | | | | | | | |
| Management | | Performance | | | | | | | | |
| Strategy | 3026 | Organizational | 0% | 100% | 11.92% | 0.4 | 4.77% | | | |
| Performance | | Performance | | | | | | | | |
| Management | | | | | | | | | | |
| Data | 1503 | Data Source | 0% | 100% | 2.71% | 90% | 2.44% | | | |
| Integration | | Definition | | | | | | | | |
| and | | | | | | | | | | |
| Management | | | | | | | | | | |
| Comparative | 601 | Lookalike | 0 | 1 | 3.71% | 1 | 3.71% | | | |
| Analytics | | Models | | | | | | | | |
| and Insight | | Calibrated and | | | | | | | | |
| Tools | | Maintained | | | | | | | | |
| Customer | TBD | Net Promotor | −100 | 100 | 6.05% | 70% | 4.23% | | | |
| Analysis and | | Score | | | | | | | | |
| Management | | | | | | | | | | |
| Customer | 1000 | Likert Scale | 0% | 100% | 1.39% | 23% | 0.32% | | | |
| Analysis and | | StDev % | | | | | | | | |
| Management | | | | | | | | | | |
| Human | | Role, | 0 | 1 | 1.84% | 1 | 1.84% | | | |
| Resources | | Responsibility, | | | | | | | | |
| Management | | Skills Matrix | | | | | | | | |
| Human | TBD | Employee | 0% | 100% | 5.58% | 60% | 3.35% | | | |
| Resources | | Satisfaction | | | | | | | | |
| Management | | Score | | | | | | | | |
| Learning | | Expertise | 0% | 100% | 1.80% | 67% | 1.20% | | | |
| Management | | Meets Job | | | | | | | | |
| | | Requirements | | | | | | | | |

TABLE 4
Examples of individual and organizational information provided or generated during dynamic interviews

| | FIG. | | | | |
|---|---|---|---|---|---|
| | Element | | | | |
| ID | # | Module | Data Question | Possible Responses | Logic |
| 10 | 1000 | Customer and | What does your organization | User provided text | |
| | | Market | do? Describe it at a fairly | | |
| | | Information | high level. | | |
| 11 | 1000 | Customer and | Why did you, personally, | User provided text | |
| | | Market | decide to join this | | |
| | | Information | organization? | | |
| 12 | 1000 | Customer and | What makes your | User provided text | |
| | | Market | organization unique in | | |
| | | Information | [City]? | | |
| 13 | 1000 | Customer and | Tell me about your | User provides name of customer | Table 5 |
| | | Market | customers or those you serve. | segment [1, 2 . . . n] and a description | |
| | | Information | How would you describe | of the segment in a table that | |
| | | | them in terms of segments or | increases by row with each new | |
| | | | customer categories? | customer segment. | |
| 14 | 1000 | Customer and | How long have [Customer | System displays a table of | Table 6 |
| | | Market | Segment 1] been your | provided customer segments with | |
| | | Information | customers? | columns for length of relationship | |
| | | | | and estimated % of sales | |
| 15 | 1000 | Customer and | What % of revenue would | System displays a table of | Table 6 |
| | | Market | you estimate is attributed to | provided customer segments with | |
| | | Information | [Customer Segment 1] | columns for length of relationship | |
| | | | | and estimated % of sales | |
| 16 | 1000 | Customer and | What makes your [Customer | System displays a table with | Table 7 |
| | | Market | Segment 1] loyal to your | customer segment name in | |
| | | Information | organization? | column 1, description of segment | |
| | | | | in column 2, and column for user | |
| | | | | provided loyalty description. | |
| 17 | 1000 | Customer and | How satisfied would you | System presents a Likert Scale | Table 8 |
| | | Market | estimate that [Customer | with ability to rate each customer | |
| | | Information | Segment 1] is with your | segment on 0-10 scale | |
| | | | organization? | | |
| 18 | 1001 | Product | What are your core products | User provides the name of the | Table 9 |
| | | Information | or services that you provide | product or service and classifies it | |
| | | | or sell to your customers? | as either product or service in a | |
| | | | | table that increases by row with | |
| | | | | each new product or service. | |
| 19 | 1001 | Product | What makes [Product or | System displays a table with | Table 10 |
| | | Information | Service 1] unique from | product or service name in | |
| | | | others offering similar | column 1, column 2 with space to | |
| | | | [product or service]? | input why the product or service | |
| | | | | is unique, a dropdown of why | |
| | | | | customers desire product or | |
| | | | | service | |
| 20 | 1001 | Product | Why do your customers | System displays a table with | Table 10 |
| | | Information | desire [Product or Service | product or service name in | |
| | | | 1]? | column 1, column 2 with space to | |
| | | | | input why the product or service | |
| | | | | is unique, a dropdown of why | |
| | | | | customers desire product or | |
| | | | | service | |
| 21 | 1002 | Financial | How much do customers pay | System displays a table of product | Table 11 |
| | | Information | for [Product or Service 1] | or service names (left column) | |
| | | | | and columns for price, cost to | |
| | | | | produce, and estimated volume of | |
| | | | | transactions (user chooses | |
| | | | | between year, month, week, day, | |
| | | | | or hour). | |
| 22 | 1002 | Financial | Which customer segments | System displays a table of product | Table 12 |
| | | Information | purchase or use [Product or | or service names (left column) | |
| | | | Service 1] | and customer segments (top row). | |
| | | | | The user then inputs the % of | |
| | | | | estimated sales that each segment | |
| | | | | contributes to the product. | |
| 23 | 1003 | Financial | How much do you expect the | System first displays a table of | System |
| | | Information | current sales to change by | customer segments with a column | Calculates |
| | | | customer segment next year? | to enter % change (+/−) for the | and Presents a |
| | | | | following year. | Proforma, |
| | | | | Next the systems calculates the | Tables 13 and |
| | | | | change in volume by product (not | 14 |
| | | | | shown to user) | |
| | | | | Then the system calculates the | |
| | | | | proforma and displays it in tabular | |
| | | | | form. | |
| 24 | 1004 | Internal | What functions does your | System provides a picklist of | Table 15 |
| | | Functions | organization utilize to keep | common internal functions and | |
| | | | operations running that are | provides the ability to add | |
| | | | unrelated to sales? | additional functions that are not | |
| | | | | listed. Table includes a column to | |
| | | | | estimate how much time and | |
| | | | | expense are consumed by each | |
| | | | | function. | |
| 25 | 1004 | Internal | How much time and | System provides a picklist of | Table 15 |
| | | Functions | expenses are consumed by | common internal functions and | |
| | | | these functions? | provides the ability to add | |
| | | | | additional functions that are not | |
| | | | | listed. Table includes a column to | |
| | | | | estimate how much time and | |
| | | | | expense are consumed by each | |
| | | | | function. | |
| 26 | 1005 | Organizational | What departments (if any) is | System provides a picklist of | Table 16 |
| | | Structure | the organization composed | common organizational | |
| | | | of? | departments and provides the | |
| | | | | ability to add additional | |
| | | | | departments that are not listed. | |
| 27 | 1005 | Organizational | What roles are associated | System provides a picklist of | Table 17 |
| | | Structure | within each department? | common roles by organizational | |
| | | | | department (AI generated for | |
| | | | | newly added departments). User | |
| | | | | selects or adds roles to each | |
| | | | | department (1 department at a | |
| | | | | time). | |
| 28 | 1005 | Organizational | What internal functions is | System provides a table listing all | Table 18 |
| | | Structure | each role associated with? | departments (column 1), roles | |
| | | | | within department (column 2), | |
| | | | | and columns for each internal | |
| | | | | function that the user may select. | |
| 29 | 1005 | Organizational | What products are services is | System provides a table listing all | Table 19 |
| | | Structure | each role aligned to? | departments (column 1), roles | |
| | | | | within department (column 2), | |
| | | | | and columns for each product or | |
| | | | | service that the user may select. | |
| 30 | 1006 | Required Skills | What are the critical skills | System provides a table listing all | Table 20 |
| | | by Role | required by each role? | departments (column 1), all roles | |
| | | | | (column 2) and columns | |
| | | | | describing common critical skills | |
| | | | | (examples and AI integration). | |
| | | | | User has ability to add additional | |
| | | | | skills. User must designate the | |
| | | | | level of competency required by | |
| | | | | the role for each skill. | |
| 31 | 1007 | Employee and | Who are the people that work | System provides a blank table | Table 21 |
| | | Volunteer | in these roles either as | with ability to add a person's | |
| | | Information | volunteers, employees, or | name and then add additional | |
| | | | other paid role types. Please | information, including: type | |
| | | | complete the table's | (Employee, Board Member, | |
| | | | information including: the | Contractor, Vendor) ID, | |
| | | | person's ID, department, | department, assigned role(s), | |
| | | | role(s), number of hours | hours per week, weeks worked in | |
| | | | worked per week, the number | a year, rate (total compensation | |
| | | | of weeks worked per year, | decomposed by hour), start date, | |
| | | | the pay rate (if applicable), | and last performance rating. | |
| | | | start date (if applicable). | | |
| 32 | 1008 | Skill | We have prepared a Skills | System provides a prepopulated | Skills |
| | | Assessment | Assessment tailored to each | skills assessment for each | Assessment |
| | | | employee based on their role | employee based on the required | |
| | | | and desired level of | skills and competency level for | |
| | | | competency. | their role, the individual's desired | |
| | | | | level of competency, the | |
| | | | | individual's self-reported level of | |
| | | | | competency, and the reported 360 | |
| | | | | feedback from others in the | |
| | | | | organization. The system then | |
| | | | | analyzes the required, desired, and | |
| | | | | reported levels to provide insights | |
| | | | | for requirement met, agreement | |
| | | | | between reviewers, and growth | |
| | | | | opportunities for the individual. | |

TABLE 5
Example customer segments for organization

| Customer Segment | Description of Segment |
|---|---|
| Customer Segment 1 | High Volume/Low Spend |
| Customer Segment 2 | High Volume/High Spend |
| Customer Segment 3 | Low Volume/Low Spend |
| Customer Segment 4 | Low Volume/High Spend |

TABLE 6
Example customer segment revenue implications for organization

| Customer Segment | Length of Relationship | % of Revenue |
|---|---|---|
| Customer Segment 1 | 1 | 15% |
| Customer Segment 2 | 5 | 50% |
| Customer Segment 3 | 2 | 10% |
| Customer Segment 4 | 5 | 25% |

TABLE 7
Example customer segment characterizations

| Customer Segment | Description of Segment | Loyalty Description |
|---|---|---|
| Customer Segment 1 | High Volume/Low Spend | Love the products |
| Customer Segment 2 | High Volume/High Spend | Love the staff |
| Customer Segment 3 | Low Volume/Low Spend | Need the service |
| Customer Segment 4 | Low Volume/High Spend | Love the service |

TABLE 8
Example Likert scale for different Customer Segments of customer satisfaction,
where 0 is most unsatisfied and 10 is very satisfied

| Customer Segment | Response | 0 | 1 | 2 | 3 | 4 | 5 | 6 | 7 | 8 | 9 | 10 |
|---|---|---|---|---|---|---|---|---|---|---|---|---|
| Customer Segment 1 | 7 | | | | | | | | x | | | |
| Customer Segment 2 | 9 | | | | | | | | | | x | |
| Customer Segment 3 | 5 | | | | | | x | | | | | |
| Customer Segment 4 | 7 | | | | | | | | x | | | |
| Average | 7 | | | | | | | | | | | |
| StDev % | 23% | | | | | | | | | | | |

TABLE 9
Example product/service listing for an organization.

| Name | Type |
|---|---|
| Product 1 | Product |
| Product 2 | Product |
| Product 3 | Product |
| Service 1 | Service |

TABLE 10
Examples of the value of products/services to customers

| Product or Service | Unique Quality | Customer's Desire |
|---|---|---|
| Product 1 | Hard to Find | Great Quality |
| Product 2 | Customized | Tailored for Me |
| Product 3 | Rare Items | Splurge |
| Service 1 | Not offered anywhere else | Need It |

TABLE 11
Examples of product/service pricing and sales information

| Product or Service | Price | Cost to Produce | Volume | Volume Period |
|---|---|---|---|---|
| Product 1 | $100 | $25 | 5000 | Annually |
| Product 2 | $50 | $25 | 10000 | Annually |
| Product 3 | $500 | $50 | 100 | Annually |
| Service 1 | $25 | $10 | 7500 | Annually |

TABLE 12
Example allocation of products/services to different
customer segments for organization

| | Customer | Customer | Customer | Customer |
|---|---|---|---|---|
| | Segment 1 | Segment 2 | Segment 3 | Segment 4 |
| Product 1 | 100% | | | |
| Product 2 | 30% | 50% | 20% | |
| Product 3 | | 25% | | 75% |
| Service 1 | | 20% | 80% | |

TABLE 13
Example pro forma differential by customer segment

| Customer Segment | Next Year % Change |
|---|---|
| Customer Segment 1 | 5% |
| Customer Segment 2 | 10% |
| Customer Segment 3 | −10% |
| Customer Segment 4 | 0% |

TABLE 14
Example pro forma for organization.

| Product or | | Production | | | Forecast | Forecast | Forecast | Forecast |
|---|---|---|---|---|---|---|---|---|
| Service | Revenue | Costs | Profit | Margin | Revenue | Cost | Profit | Margin |
| Product 1 | $500,000 | $125,000 | $375,000 | 75% | $525,000 | $131,250 | $393,750 | 75% |
| Product 2 | $500,000 | $250,000 | $250,000 | 50% | $522,500 | $261,250 | $261,250 | 50% |
| Product 3 | $50,000 | $5,000 | $45,000 | 90% | $51,250 | $5,125 | $46,125 | 90% |
| Service 1 | $187,500 | $75,000 | $112,500 | 60% | $176,250 | $70,500 | $105,750 | 60% |
| Organization | $1,237,500 | $455,000 | $782,500 | 63% | $1,275,000 | $468,125 | $806,875 | 63% |

TABLE 15
Example internal functions for organization
and expenses associated therewith

| | Time | Additional |
|---|---|---|
| Internal | Consumed | Expenses |
| Functions | (hrs: month) | ($: month) |
| Accounting | 5 | $0 |
| Payroll | 2 | $0 |
| Training | 4 | $500 |
| Maintenance | 10 | $0 |
| Marketing | 25 | $1,000 |
| Product Development | 20 | $0 |
| IT Support | 5 | $0 |
| Donor Development | 20 | $500 |
| Fundraising | 30 | $500 |
| Event Planning | 15 | $1,000 |
| Click to Add | 136 | $3,500 |
| an Internal Function | | |

TABLE 16
Examples of departments within organization
Department

Finance
IT
Marketing
Fundraising
Programming

TABLE 17
Examples of roles within a particular department of organization
Finance Roles

Accountant
Analyst

TABLE 18
Example allocation of internal functions to roles and departments within organization

| | | Account- | | Train- | | Market- | Product | IT | Donor | Fund- | Event |
|---|---|---|---|---|---|---|---|---|---|---|---|
| Department | Roles | ing | Payroll | ing | Maintenance | ing | Development | Support | Development | raising | Planning |
| Finance | Accountant | x | | | | | | | | | |
| Finance | Analyst | x | x | | | | | | | | |
| IT | IT | | | x | x | | x | x | | | |
| | Manager | | | | | | | | | | |
| Marketing | Marketing | | | | | x | | | x | x | |
| | Analyst | | | | | | | | | | |
| Marketing | Social | | | | | x | | | | x | |
| | Media | | | | | | | | | | |
| | Development | | | | | | | | | | |
| Fundraising | Event | | | | | | | | | | x |
| | Planner | | | | | | | | | | |
| Fundraising | Donor | | | | | | | | x | | |
| | Relations | | | | | | | | | | |
| | Manager | | | | | | | | | | |
| Programming | Product | | | | | | x | | | | |
| | Development | | | | | | | | | | |
| Programming | Education | | | x | | | | | | | |
| | Manager | | | | | | | | | | |
| Organization- | Executive | | | x | | x | x | | x | x | x |
| Wide | Director | | | | | | | | | | |
| Organization- | Administrative | | | | | x | | | x | x | x |
| Wide | Assistant | | | | | | | | | | |

TABLE 19
Examples allocation of roles within departments to products/services of organization

| Department | Roles | Product 1 | Product 2 | Product 3 | Service 1 | None |
|---|---|---|---|---|---|---|
| Finance | Accountant | x | x | x | x | |
| Finance | Analyst | x | x | x | | |
| IT | IT Manager | x | x | x | | |
| Marketing | Marketing Analyst | x | x | x | x | |
| Marketing | Social Media Development | x | x | x | x | |
| Fundraising | Event Planner | | | | | x |
| Fundraising | Donor Relations Manager | | | | | x |
| Programming | Product Development | x | x | x | | |
| Programming | Education Manager | | | | x | |
| Organization-Wide | Executive Director | | | | | x |
| Organization-Wide | Administrative Assistant | | | | | x |

TABLE 20
Example level of competency for various capabilities for each role within each department in organization

| | | Word | | Soft. | Soft. | Market | Camp. | Camp. | Event | | Vendor |
|---|---|---|---|---|---|---|---|---|---|---|---|
| Dept. | Role | Proc. | Acct. | Install | Maint. | Analysis | Analysis | Devel. | Plan. | Catering | Rel. |
| Fin. | Accnt. | Ind. | Exp. | N/A | N/A | N/A | N/A | N/A | N/A | N/A | NA |
| Fin. | Analyst | Expert | Ind. | N/A | N/A | Nov. | N/A | N/A | N/A | N/A | NA |
| IT | IT Mgr. | Ind. | N/A | Exp. | Exp. | N/A | N/A | N/A | N/A | N/A | Ind. |
| Market. | Mkt. | Exp. | N/A | N/A | N/A | Exp. | Exp. | Ind. | Nov. | N/A | Nov. |
| | Analyst | | | | | | | | | | |
| Market. | Social | Ind. | N/A | N/A | N/A | Ind. | Exp. | Exp. | Ind. | N/A | NA |
| | Media | | | | | | | | | | |
| | Devel. | | | | | | | | | | |
| Fundr. | Event | Ind. | N/A | N/A | N/A | N/A | N/A | N/A | Exp. | Ind. | Ind. |
| | Planner | | | | | | | | | | |
| Fundr. | Donor | Nov. | N/A | N/A | N/A | N/A | N/A | N/A | Nov. | N/A | NA |
| | Relations | | | | | | | | | | |
| | Mgr. | | | | | | | | | | |
| Program. | Product | Exp. | N/A | N/A | N/A | Ind. | N/A | N/A | Nov. | N/A | Ind. |
| | Devel. | | | | | | | | | | |
| Program. | Education | Ind. | N/A | N/A | N/A | N/A | N/A | N/A | N/A | N/A | NA |
| | Mgr. | | | | | | | | | | |
| Org.- | Exec. Dir. | Exp. | Ind. | N/A | N/A | Ind. | Ind. | Ind. | Ind. | N/A | Ind. |
| Wide | | | | | | | | | | | |
| Org.- | Admin. | Ind. | Nov. | N/A | N/A | N/A | N/A | N/A | N/A | N/A | Nov. |
| Wide | Asst. | | | | | | | | | | |

| | | Stakeholder | Product | | Training | Training | Ppl. | Proj. | |
|---|---|---|---|---|---|---|---|---|---|
| Dept. | Role | Mgmt. | Devel. | Testing | Devel. | Del. | Mgmt. | Mgmt. | Facilit. |
| Fin. | Accnt. | N/A | N/A | N/A | N/A | N/A | Ind. | Ind. | N/A |
| Fin. | Analyst | N/A | N/A | Ind. | N/A | N/A | Ind. | Exp. | Ind. |
| IT | IT Mgr. | N/A | Nov. | Exp. | Nov. | N/A | Ind. | Ind. | Nov. |
| Market. | Mkt. | Ind. | Nov. | Ind. | Ind. | Ind. | Nov. | Ind. | Ind. |
| | Analyst | | | | | | | | |
| Market. | Social | Ind. | Nov. | N/A | N/A | N/A | Nov. | Exp. | Ind. |
| | Media | | | | | | | | |
| | Devel. | | | | | | | | |
| Fundr. | Event | Exp. | N/A | N/A | N/A | N/A | Ind. | Exp. | Exp. |
| | Planner | | | | | | | | |
| Fundr. | Donor | Exp. | N/A | N/A | N/A | N/A | Ind. | Ind. | Exp. |
| | Relations | | | | | | | | |
| | Mgr. | | | | | | | | |
| Program. | Product | Ind. | Exp. | Ind. | Ind. | Ind. | Nov. | Expert | Exp. |
| | Devel. | | | | | | | | |
| Program. | Education | Exp. | Ind. | N/A | Exp. | Exp. | Ind. | Ind. | Exp. |
| | Mgr. | | | | | | | | |
| Org.- | Exec. Dir. | Exp. | Ind. | Ind. | Ind. | Ind. | Exp. | Exp. | Exp. |
| Wide | | | | | | | | | |
| Org.- | Admin. | Ind. | N/A | Ind. | Nov. | Nov. | Nov. | Ind. | Nov. |
| Wide | Asst. | | | | | | | | |

TABLE 21
Example set of stakeholders and their role within organization

| | | | | | | | In- | | |
|---|---|---|---|---|---|---|---|---|---|
| | | | | | | | Kind | | |
| | | | | | | Pay | Pay | | Last |
| | | | | Hours: | Weeks: | Rate | Rate | | Performance |
| Name | Role | Type | ID | Week | Year | (Hr) | (Hr) | Start Date | Rating |
| Bob Smith | Accountant | Employee | 1 | 40 | 52 | 40 | 0 | Jan. 1, 2015 | Meets |
| | | | | | | | | | Expectations |
| John Doe | Analyst | Board | 2 | 5 | 50 | 0 | 25 | | Not Applicable |
| | | Member | | | | | | | |
| Sally | IT Manager | Contractor | 3 | 10 | 50 | 75 | 0 | Jan. 1, 2018 | Meets |
| Wallace | | | | | | | | | Expectations |
| Sue | Marketing | Board | 4 | 10 | 50 | 0 | 25 | | Not Applicable |
| Williams | Analyst | Member | | | | | | | |
| Mike | Social Media | Employee | 5 | 40 | 52 | 25 | 0 | Jan. 1, 2020 | Exceeds |
| Henry | Development | | | | | | | | Expectations |
| Henry | Event Planner | Employee | 6 | 40 | 52 | 30 | 0 | Jun. 1, 2015 | Does Not Meet |
| Finkle | | | | | | | | | Expectations |
| Hellen | Donor Relations | Board | 7 | 15 | 50 | 0 | 25 | | Not Applicable |
| Wise | Manager | Member | | | | | | | |
| Amy Johns | Product | Employee | 8 | 50 | 52 | 45 | 0 | Jun. 1, 2023 | Too New to |
| | Development | | | | | | | | Rate |
| Charles | Education | Employee | 9 | 30 | 50 | 32 | 0 | Aug. 1, 2015 | Meets |
| Standish | Manager | | | | | | | | Expectations |
| Mark Hunt | Executive | Employee | 10 | 60 | 52 | 45 | 0 | Jun. 1, 2020 | Exceeds |
| | Director | | | | | | | | Expectations |
| Hunter | Administrative | Employee | 11 | 30 | 52 | 20 | 0 | Jan. 1, 2017 | Meets |
| Beamer | Assistant | | | | | | | | Expectations |
| Mary | Analyst | Board | 12 | 10 | 40 | 0 | 25 | | Not Applicable |
| Smith | | Member | | | | | | | |
| Anne | Marketing | Board | 13 | 5 | 40 | 0 | 25 | | Not Applicable |
| Williams | Analyst | Member | | | | | | | |
| Lee Smart | Product | Board | 14 | 15 | 40 | 0 | 25 | | Not Applicable |
| | Development | Member | | | | | | | |
| Dottie | Product | Board | 15 | 8 | 40 | 0 | 25 | | Not Applicable |
| Jones | Development | Member | | | | | | | |
| Shain | Donor Relations | Board | 16 | 12 | 40 | 0 | 25 | | Not Applicable |
| Stevens | Manager | Member | | | | | | | |
| Ted Smoke | Donor Relations | Board | 17 | 10 | 40 | 0 | 25 | | Not Applicable |
| | Manager | Member | | | | | | | |
| Evan | Donor Relations | Board | 18 | 1 | 40 | 0 | 25 | | Not Applicable |
| Henderson | Manager | Member | | | | | | | |
| Ginger | Event Planner | Board | 19 | 30 | 52 | 0 | 25 | | Not Applicable |
| Cecil | | Member | | | | | | | |
| Stephanie | Event Planner | Board | 20 | 20 | 50 | 0 | 25 | | Not Applicable |
| Hart | | Member | | | | | | | |
| Sean Spike | Social Media | Board | 21 | 15 | 50 | 0 | 25 | | Not Applicable |
| | Development | Member | | | | | | | |

TABLE 22
Example of functions associated with different roles at organization

| Organization | Role Name | Functions |
|---|---|---|
| Organization Name | Executive Director | Organizational |
| | | Management |
| Organization Name | Administrative Assistant | Product |
| | | Development |
| Organization Name | Analyst | Technical |
| | | Development |
| Organization Name | Donor Relations Manager | Business |
| | | Development |
| Organization Name | Education Manager | Technical |
| | | Implementation |
| Organization Name | Event Planner | Product |
| | | Management |
| Organization Name | Accountant | Relationship |
| | | Management |
| Organization Name | IT Manager | Organizational |
| | | Management |
| Organization Name | Marketing Analyst | Technical |
| | | Implementation |

TABLE 23
Examples of different tasks associated with different functions of organization

| Organizational | Product | Technical | Business | Technical | Product | Relationship |
|---|---|---|---|---|---|---|
| Management | Development | Development | Development | Implementation | Management | Management |
| Form LLC | Document | Design, Build, | Research | Assess | Build and | Manage |
| | Business | Manage | Potential | Client | Maintain | Assigned |
| | Requirements | Company and | Clients | Systems | Product | Existing Client |
| | for Product | Product | | | Detailed | Relationships |
| | | Website | | | Descriptions | By Meeting |
| | | | | | and | on Regular |
| | | | | | Requirements | Cadence |
| Recruit | Design | Build | Identify and | Build | Maintain | Continually |
| Employees | Product | and Test | Attend | Technical | Product | Seek |
| and | Prototype(s) | Product | Relevant | Implementation | Webpages | Understanding |
| Partners | | Prototype(s) | Client | Workplans | | of Client's |
| | | | Conferences, | | | Evolving |
| | | | Forums, et all | | | Needs |
| Assign | Design | Document | Identify Best | Integrate | Identify | Identify |
| Work | Product | Technical | Fit Product(s) | with Client | Opportunities | Opportunities |
| Responsibilities | Pricing | Requirements | for Specific | Systems | for Product | for Product |
| | | for Product | Clients | | Enhancement | Enhancement |
| | | | | | and New | and New |
| | | | | | Features | Features |
| Manage | Build | Manage | Identify | Build and | Manage and | Analyze Client |
| Employee | Proforma | Vendor | Customizable | Customize | Prioritize | Adoption and |
| Performance | for | Contracts and | Opportunities | Products for | Product | Impact Post- |
| | Product | Performance | for Specific | Clients | Feature | Implementation |
| | | | Clients | | Backlog | and Ongoing |
| Manage | Identify | Test | Build | Test | Manage | Report on |
| Company | Intellectual | Product(s) - | Client | Product(s) - | Product P&L | Adoption and |
| Finances | Property | CIT, SIT, | Proforma(s) | CIT, SIT, | Finanicals | Impact to |
| | Implications | UAT, Post- | | UAT, Post- | | Client |
| | for Product | Implementation | | Implementation | | |
| Enable | Manage | | Build | Customize and | Manage and/or | Manage Client |
| Work | Patent | | Implementation | Deliver Product | Provide | P&L |
| Tools | Opportunities | | Workplans | Training for | Product | Financials |
| | for Product | | By Client | Client | Support Post | |
| | | | | | Implementation | |
| Attend and | Customize | | Create Pitch | Deploy | Identify | Identify |
| Vote During | and Deliver | | Decks and | Products to | and Resolve | and Resolve |
| Company | Product | | Proposals for | Clients | Product | Client |
| Board | Training for | | Individual | | Issues | Issues |
| Meetings | Client | | Clients | | | |
| | | | Deliver | Provide Product | | |
| | | | Proposals to | Technical | | |
| | | | Clients | Support Post | | |
| | | | | Implementation | | |
| | | | Revise | | | |
| | | | Workplans | | | |
| | | | with Clients | | | |
| | | | Negotiate | | | |
| | | | Pricing with | | | |
| | | | Clients | | | |
| | | | Execute | | | |
| | | | Contracts with | | | |
| | | | Clients | | | |

TABLE 24
Examples of role responsibility for tasks and internal functions at organization

| | | | | | | | | | | | | | Social | | | |
|---|---|---|---|---|---|---|---|---|---|---|---|---|---|---|---|---|
| | Org. | | | | | Donor | | | | | Market. | Prod. | Media | | | |
| | Func- | | Exec. | Admin. | Ana- | Rel. | Edu. | Event | | IT | Ana- | Devel- | Devel- | Word | | Pol. |
| ID | tion | Resp. | Dir. | Assist. | lyst | Mgr. | Mgr. | Plan. | Acct. | Mgr. | lyst | op. | op. | Proc. | Acct. | Mgmt. |
| 1 | Mgmt. | Form | T | F | F | F | F | F | F | F | F | F | F | 0 | 0 | 0 |
| | | LLC | | | | | | | | | | | | | | |
| 2 | Mgmt. | Recruit | T | T | T | F | T | T | T | T | T | T | T | 0 | 0 | 0 |
| | | Employees | | | | | | | | | | | | | | |
| | | and | | | | | | | | | | | | | | |
| | | Partners | | | | | | | | | | | | | | |
| 3 | Mgmt. | Assign | T | F | F | F | F | F | F | F | F | F | F | 0 | 0 | 0 |
| | | Work | | | | | | | | | | | | | | |
| | | Responsi- | | | | | | | | | | | | | | |
| | | bilities | | | | | | | | | | | | | | |
| 4 | Mgmt. | Manage | T | F | F | F | F | F | F | F | F | F | F | 0 | 0 | 0 |
| | | Employee | | | | | | | | | | | | | | |
| | | Perfor- | | | | | | | | | | | | | | |
| | | mance | | | | | | | | | | | | | | |
| 5 | Mgmt. | Manage | T | F | F | F | F | F | F | F | F | F | F | 0 | 0 | 0 |
| | | Company | | | | | | | | | | | | | | |
| | | Finances | | | | | | | | | | | | | | |
| 6 | Mgmt. | Enable | T | F | F | F | F | F | F | F | F | F | F | 0 | 0 | 0 |
| | | Work | | | | | | | | | | | | | | |
| | | Tools | | | | | | | | | | | | | | |
| 7 | Mgmt. | Attend | T | T | T | F | T | T | T | T | T | T | T | 0 | 0 | 0 |
| | | and Vote | | | | | | | | | | | | | | |
| | | During | | | | | | | | | | | | | | |
| | | Company | | | | | | | | | | | | | | |
| | | Board | | | | | | | | | | | | | | |
| | | Meetings | | | | | | | | | | | | | | |
| 8 | Prod. | Document | F | T | F | F | F | F | F | F | F | F | F | 0 | 0 | 0 |
| | Devel. | Business | | | | | | | | | | | | | | |
| | | Require- | | | | | | | | | | | | | | |
| | | ments | | | | | | | | | | | | | | |
| | | for | | | | | | | | | | | | | | |
| | | Product | | | | | | | | | | | | | | |
| 9 | Prod. | Design | F | T | F | F | F | F | F | F | F | F | F | 1 | 0 | 0 |
| | Devel. | Product | | | | | | | | | | | | | | |
| | | Prototype | | | | | | | | | | | | | | |
| | | (s) | | | | | | | | | | | | | | |
| 10 | Prod. | Design | F | T | F | F | F | F | F | F | F | F | F | 0 | 0 | 0 |
| | Devel. | Product | | | | | | | | | | | | | | |
| | | Pricing | | | | | | | | | | | | | | |
| 11 | Prod. | Build | F | T | F | F | F | F | F | F | F | F | F | 1 | 0 | 0 |
| | Dev. | Proforma | | | | | | | | | | | | | | |
| | | for | | | | | | | | | | | | | | |
| | | Product | | | | | | | | | | | | | | |
| 12 | Prod. | Identify | F | T | F | F | F | F | F | F | F | F | F | 0 | 0 | 0 |
| | Dev. | Intel- | | | | | | | | | | | | | | |
| | | lectual | | | | | | | | | | | | | | |
| | | Property | | | | | | | | | | | | | | |
| | | Impli- | | | | | | | | | | | | | | |
| | | cations | | | | | | | | | | | | | | |
| | | for | | | | | | | | | | | | | | |
| | | Product | | | | | | | | | | | | | | |
| 13 | Prod. | Manage | F | T | F | F | F | F | F | F | F | F | F | 0 | 0 | 0 |
| | Dev. | Patent | | | | | | | | | | | | | | |
| | | Oppor- | | | | | | | | | | | | | | |
| | | tunities | | | | | | | | | | | | | | |
| | | for | | | | | | | | | | | | | | |
| | | Product | | | | | | | | | | | | | | |
| 14 | Prod. | Customize | F | T | F | F | F | F | F | F | F | F | F | 0 | 0 | 0 |
| | Dev. | and | | | | | | | | | | | | | | |
| | | Deliver | | | | | | | | | | | | | | |
| | | Product | | | | | | | | | | | | | | |
| | | Training | | | | | | | | | | | | | | |
| | | for | | | | | | | | | | | | | | |
| | | Client | | | | | | | | | | | | | | |
| 15 | Tech. | Design, | T | F | F | F | F | F | F | F | F | F | F | 0 | 0 | 0 |
| | Dev. | Build, | | | | | | | | | | | | | | |
| | | Manage | | | | | | | | | | | | | | |
| | | Company | | | | | | | | | | | | | | |
| | | and | | | | | | | | | | | | | | |
| | | Product | | | | | | | | | | | | | | |
| | | Website | | | | | | | | | | | | | | |
| 16 | Tech. | Build | F | T | F | F | F | F | F | F | F | F | F | 0 | 0 | 0 |
| | Dev. | and | | | | | | | | | | | | | | |
| | | Test | | | | | | | | | | | | | | |
| | | Product | | | | | | | | | | | | | | |
| | | Proto- | | | | | | | | | | | | | | |
| | | type | | | | | | | | | | | | | | |
| | | (s) | | | | | | | | | | | | | | |
| 17 | Tech. | Document | F | T | F | F | F | F | F | F | F | F | F | 0 | 0 | 0 |
| | Dev. | Technical | | | | | | | | | | | | | | |
| | | Require- | | | | | | | | | | | | | | |
| | | ments | | | | | | | | | | | | | | |
| | | for | | | | | | | | | | | | | | |
| | | Product | | | | | | | | | | | | | | |
| 18 | Tech. | Manage | F | T | F | F | F | F | F | F | F | F | F | 0 | 0 | 0 |
| | Dev. | Vendor | | | | | | | | | | | | | | |
| | | Contracts | | | | | | | | | | | | | | |
| | | and | | | | | | | | | | | | | | |
| | | Perfor- | | | | | | | | | | | | | | |
| | | mance | | | | | | | | | | | | | | |
| 19 | Tech. | Test | F | T | F | F | F | F | F | F | F | F | F | 0 | 0 | 0 |
| | Dev. | Product(s)- | | | | | | | | | | | | | | |
| | | CIT, SIT, | | | | | | | | | | | | | | |
| | | UAT | | | | | | | | | | | | | | |
| 20 | Bus. | Research | T | T | T | F | T | T | T | T | T | T | T | 0 | 0 | 0 |
| | Dev. | Potential | | | | | | | | | | | | | | |
| | | Clients | | | | | | | | | | | | | | |
| 21 | Bus. | Identify | T | T | F | F | F | F | F | F | F | F | F | 0 | 0 | 0 |
| | Dev. | and | | | | | | | | | | | | | | |
| | | Attend | | | | | | | | | | | | | | |
| | | Relevant | | | | | | | | | | | | | | |
| | | Client | | | | | | | | | | | | | | |
| | | Confer- | | | | | | | | | | | | | | |
| | | ences, | | | | | | | | | | | | | | |
| | | Forums, | | | | | | | | | | | | | | |
| | | et all | | | | | | | | | | | | | | |
| 22 | Bus. | Identify | F | T | F | F | F | F | F | F | F | F | F | 0 | 0 | 0 |
| | Dev. | Best Fit | | | | | | | | | | | | | | |
| | | Product(s) | | | | | | | | | | | | | | |
| | | for | | | | | | | | | | | | | | |
| | | Specific | | | | | | | | | | | | | | |
| | | Clients | | | | | | | | | | | | | | |
| 23 | Bus. | Identify | F | T | F | F | F | F | F | F | F | F | F | 0 | 0 | 0 |
| | Dev. | Custom- | | | | | | | | | | | | | | |
| | | izable | | | | | | | | | | | | | | |
| | | Oppor- | | | | | | | | | | | | | | |
| | | tunities | | | | | | | | | | | | | | |
| | | for | | | | | | | | | | | | | | |
| | | Specific | | | | | | | | | | | | | | |
| | | Clients | | | | | | | | | | | | | | |
| 24 | Bus. | Build | F | T | F | F | F | F | F | F | F | F | F | 0 | 0 | 0 |
| | Dev. | Client | | | | | | | | | | | | | | |
| | | Proforma | | | | | | | | | | | | | | |
| | | (s) | | | | | | | | | | | | | | |
| 25 | Bus. | Build | F | T | F | F | F | F | F | F | F | F | F | 0 | 0 | 0 |
| | Dev. | Imple- | | | | | | | | | | | | | | |
| | | mentation | | | | | | | | | | | | | | |
| | | Workplans | | | | | | | | | | | | | | |
| | | By | | | | | | | | | | | | | | |
| | | Client | | | | | | | | | | | | | | |
| 26 | Bus. | Create | T | T | F | F | F | F | F | F | F | F | F | 0 | 0 | 0 |
| | Dev. | Pitch | | | | | | | | | | | | | | |
| | | Decks | | | | | | | | | | | | | | |
| | | and | | | | | | | | | | | | | | |
| | | Proposals | | | | | | | | | | | | | | |
| | | for | | | | | | | | | | | | | | |
| | | Individual | | | | | | | | | | | | | | |
| | | Clients | | | | | | | | | | | | | | |
| 27 | Bus. | Deliver | T | T | F | F | F | F | F | F | F | F | F | 0 | 0 | 0 |
| | Dev. | Proposals | | | | | | | | | | | | | | |
| | | to Clients | | | | | | | | | | | | | | |
| 28 | Bus. | Revise | T | T | F | F | F | F | F | F | F | F | F | 0 | 0 | 0 |
| | Dev. | Workplans | | | | | | | | | | | | | | |
| | | with | | | | | | | | | | | | | | |
| | | Clients | | | | | | | | | | | | | | |
| 29 | Bus. | Negotiate | T | T | F | F | F | F | F | F | F | F | F | 0 | 0 | 0 |
| | Dev. | Pricing | | | | | | | | | | | | | | |
| | | with | | | | | | | | | | | | | | |
| | | Clients | | | | | | | | | | | | | | |
| 30 | Bus. | Execute | T | T | F | F | F | F | F | F | F | F | F | 0 | 0 | 0 |
| | Dev. | Contracts | | | | | | | | | | | | | | |
| | | with | | | | | | | | | | | | | | |
| | | Clients | | | | | | | | | | | | | | |
| 31 | Tech. | Assess | F | F | F | T | F | F | F | F | F | F | F | 0 | 0 | 0 |
| | Imple. | Client | | | | | | | | | | | | | | |
| | | Systems | | | | | | | | | | | | | | |
| 32 | Tech. | Build | F | F | F | T | F | F | F | F | F | F | F | 0 | 0 | 0 |
| | Imple. | Technical | | | | | | | | | | | | | | |
| | | Imple- | | | | | | | | | | | | | | |
| | | mentation | | | | | | | | | | | | | | |
| | | Workplans | | | | | | | | | | | | | | |
| 33 | Tech. | Integrate | F | F | F | T | F | F | F | F | F | F | F | 0 | 0 | 0 |
| | Imple. | with | | | | | | | | | | | | | | |
| | | Client | | | | | | | | | | | | | | |
| | | Systems | | | | | | | | | | | | | | |
| 34 | Tech. | Build and | F | F | F | T | F | F | F | F | F | F | F | 0 | 0 | 0 |
| | Imple. | Customize | | | | | | | | | | | | | | |
| | | Products | | | | | | | | | | | | | | |
| | | for | | | | | | | | | | | | | | |
| | | Clients | | | | | | | | | | | | | | |
| 35 | Tech. | Test | F | T | F | T | F | F | F | F | F | F | F | 0 | 0 | 0 |
| | Imple. | Product(s)- | | | | | | | | | | | | | | |
| | | Post- | | | | | | | | | | | | | | |
| | | Imple- | | | | | | | | | | | | | | |
| | | mentation | | | | | | | | | | | | | | |
| 36 | Tech. | Customize | F | T | F | F | F | F | F | F | F | F | F | 0 | 0 | 0 |
| | Imple. | and | | | | | | | | | | | | | | |
| | | Deliver | | | | | | | | | | | | | | |
| | | Product | | | | | | | | | | | | | | |
| | | Training | | | | | | | | | | | | | | |
| | | for | | | | | | | | | | | | | | |
| | | Client | | | | | | | | | | | | | | |
| 37 | Tech. | Deploy | F | F | F | T | F | F | F | F | F | F | F | 0 | 0 | 0 |
| | Imple. | Products | | | | | | | | | | | | | | |
| | | to | | | | | | | | | | | | | | |
| | | Clients | | | | | | | | | | | | | | |
| 38 | Techn. | Provide | F | T | F | T | F | F | F | F | F | F | F | 0 | 0 | 0 |
| | Imple. | Product | | | | | | | | | | | | | | |
| | | Technical | | | | | | | | | | | | | | |
| | | Support | | | | | | | | | | | | | | |
| | | Post | | | | | | | | | | | | | | |
| | | Imple- | | | | | | | | | | | | | | |
| | | mentation | | | | | | | | | | | | | | |
| 39 | Prod. | Build and | F | T | F | F | F | F | F | F | F | F | F | 0 | 0 | 0 |
| | Mgmt. | Maintain | | | | | | | | | | | | | | |
| | | Product | | | | | | | | | | | | | | |
| | | Detailed | | | | | | | | | | | | | | |
| | | Descrip- | | | | | | | | | | | | | | |
| | | tions | | | | | | | | | | | | | | |
| | | and | | | | | | | | | | | | | | |
| | | Require- | | | | | | | | | | | | | | |
| | | ments | | | | | | | | | | | | | | |
| 40 | Prod. | Maintain | F | T | F | F | F | F | F | F | F | F | F | 0 | 0 | 0 |
| | Mgmt. | Product | | | | | | | | | | | | | | |
| | | Webpages | | | | | | | | | | | | | | |
| 41 | Prod. | Identify | T | T | T | F | T | T | T | T | T | T | T | 0 | 0 | 0 |
| | Mgmt. | Oppor- | | | | | | | | | | | | | | |
| | | tunities | | | | | | | | | | | | | | |
| | | for | | | | | | | | | | | | | | |
| | | Product | | | | | | | | | | | | | | |
| | | Enhance- | | | | | | | | | | | | | | |
| | | ment | | | | | | | | | | | | | | |
| | | and New | | | | | | | | | | | | | | |
| | | Features | | | | | | | | | | | | | | |
| 42 | Prod. | Manage | F | T | F | F | F | F | F | F | F | F | F | 0 | 1 | 0 |
| | Mgmt. | and | | | | | | | | | | | | | | |
| | | Prior- | | | | | | | | | | | | | | |
| | | itize | | | | | | | | | | | | | | |
| | | Product | | | | | | | | | | | | | | |
| | | Feature | | | | | | | | | | | | | | |
| | | Backlog | | | | | | | | | | | | | | |
| 43 | Prod. | Manage | F | T | F | F | F | F | F | F | F | F | F | 0 | 0 | 0 |
| | Mgmt. | Product | | | | | | | | | | | | | | |
| | | P&L | | | | | | | | | | | | | | |
| | | Finanicals | | | | | | | | | | | | | | |
| 44 | Prod. | Manage | F | T | F | F | F | F | F | F | F | F | F | 0 | 0 | 0 |
| | Mgmt. | and/or | | | | | | | | | | | | | | |
| | | Provide | | | | | | | | | | | | | | |
| | | Product | | | | | | | | | | | | | | |
| | | Support | | | | | | | | | | | | | | |
| | | Post | | | | | | | | | | | | | | |
| | | Imple- | | | | | | | | | | | | | | |
| | | mentation | | | | | | | | | | | | | | |
| 45 | Prod. | Identify | F | T | F | F | F | F | F | F | F | F | F | 0 | 0 | 0 |
| | Mgmt. | and | | | | | | | | | | | | | | |
| | | Resolve | | | | | | | | | | | | | | |
| | | Product | | | | | | | | | | | | | | |
| | | Issues | | | | | | | | | | | | | | |
| 46 | Relat. | Manage | F | T | F | F | F | F | F | F | F | F | F | 0 | 0 | 0 |
| | Mgmt. | Assigned | | | | | | | | | | | | | | |
| | | Existing | | | | | | | | | | | | | | |
| | | Client | | | | | | | | | | | | | | |
| | | Relation- | | | | | | | | | | | | | | |
| | | ships | | | | | | | | | | | | | | |
| | | By | | | | | | | | | | | | | | |
| | | Meeting | | | | | | | | | | | | | | |
| | | on | | | | | | | | | | | | | | |
| | | Regular | | | | | | | | | | | | | | |
| | | Cadence | | | | | | | | | | | | | | |
| 47 | Relat. | Continually | T | T | F | F | F | F | F | F | F | F | F | 0 | 0 | 0 |
| | Mgmt. | Seek | | | | | | | | | | | | | | |
| | | Under- | | | | | | | | | | | | | | |
| | | standing | | | | | | | | | | | | | | |
| | | of | | | | | | | | | | | | | | |
| | | Client's | | | | | | | | | | | | | | |
| | | Evolving | | | | | | | | | | | | | | |
| | | Needs | | | | | | | | | | | | | | |
| 48 | Relat. | Identify | T | T | T | F | T | T | T | T | T | T | T | 0 | 0 | 0 |
| | Mgmt. | Oppor- | | | | | | | | | | | | | | |
| | | tunities | | | | | | | | | | | | | | |
| | | for | | | | | | | | | | | | | | |
| | | Product | | | | | | | | | | | | | | |
| | | Enhance- | | | | | | | | | | | | | | |
| | | ment | | | | | | | | | | | | | | |
| | | and New | | | | | | | | | | | | | | |
| | | Features | | | | | | | | | | | | | | |
| 49 | Relat. | Analyze | F | T | F | F | F | F | F | F | F | F | F | 1 | 0 | 0 |
| | Mgmt. | Client | | | | | | | | | | | | | | |
| | | Adoption | | | | | | | | | | | | | | |
| | | and | | | | | | | | | | | | | | |
| | | Impact | | | | | | | | | | | | | | |
| | | Post- | | | | | | | | | | | | | | |
| | | Imple- | | | | | | | | | | | | | | |
| | | mentation | | | | | | | | | | | | | | |
| | | and | | | | | | | | | | | | | | |
| | | Ongoing | | | | | | | | | | | | | | |
| 50 | Relat. | Report | F | T | F | F | F | F | F | F | F | F | F | 0 | 0 | 1 |
| | Mgmt. | on | | | | | | | | | | | | | | |
| | | Adoption | | | | | | | | | | | | | | |
| | | and | | | | | | | | | | | | | | |
| | | Impact | | | | | | | | | | | | | | |
| | | to | | | | | | | | | | | | | | |
| | | Client | | | | | | | | | | | | | | |
| 51 | Relat. | Manage | F | T | F | F | F | F | F | F | F | F | F | 1 | 0 | 0 |
| | Mgmt. | Client | | | | | | | | | | | | | | |
| | | P&L | | | | | | | | | | | | | | |
| | | Financials | | | | | | | | | | | | | | |
| 52 | Relat. | Identify | T | T | F | F | F | F | F | F | F | F | F | 0 | 0 | 0 |
| | Mgmt. | and | | | | | | | | | | | | | | |
| | | Resolve | | | | | | | | | | | | | | |
| | | Client | | | | | | | | | | | | | | |
| | | Issues | | | | | | | | | | | | | | |

| | | Soft. | | Market | Camp. | Cam- | | | | | | | | | |
|---|---|---|---|---|---|---|---|---|---|---|---|---|---|---|---|
| | Proi. | In- | Soft. | Ana- | Ana- | paign | Event | Cater- | Vend. | Stake. | Prod. | | Train. | Train. | Facili- |
| ID | Mgmt. | stall | Maint. | lysis | lysis | Dev. | Plan. | ing | Rel. | Mgmt. | Dev. | Test | Dev. | Del. | tation |
| 1 | 0 | 0 | 0 | 0 | 1 | 0 | 0 | 0 | 0 | 0 | 0 | 0 | 0 | 0 | 0 |
| 2 | 0 | 0 | 0 | 0 | 0 | 0 | 0 | 0 | 0 | 0 | 0 | 0 | 0 | 0 | 0 |
| 3 | 0 | 0 | 0 | 0 | 0 | 0 | 0 | 1 | 0 | 0 | 0 | 0 | 0 | 0 | 0 |
| 4 | 0 | 0 | 0 | 0 | 0 | 0 | 0 | 1 | 0 | 0 | 0 | 0 | 0 | 0 | 0 |
| 5 | 0 | 1 | 0 | 0 | 0 | 0 | 0 | 0 | 0 | 0 | 0 | 0 | 0 | 0 | 0 |
| 6 | 0 | 0 | 0 | 0 | 0 | 0 | 0 | 0 | 0 | 0 | 0 | 0 | 0 | 0 | 0 |
| 7 | 0 | 0 | 0 | 0 | 0 | 0 | 0 | 1 | 0 | 0 | 0 | 0 | 0 | 0 | 0 |
| 8 | 0 | 0 | 0 | 0 | 0 | 0 | 0 | 0 | 0 | 0 | 0 | 0 | 1 | 0 | 0 |
| 9 | 0 | 0 | 0 | 0 | 0 | 0 | 0 | 0 | 0 | 0 | 0 | 0 | 1 | 0 | 0 |
| 10 | 0 | 0 | 0 | 0 | 0 | 0 | 0 | 0 | 0 | 0 | 0 | 0 | 0 | 0 | 1 |
| 11 | 0 | 0 | 1 | 0 | 0 | 0 | 0 | 0 | 0 | 0 | 0 | 0 | 0 | 0 | 0 |
| 12 | 0 | 0 | 0 | 0 | 0 | 0 | 0 | 0 | 0 | 1 | 0 | 0 | 0 | 0 | 0 |
| 13 | 0 | 0 | 0 | 0 | 0 | 0 | 0 | 0 | 1 | 0 | 0 | 0 | 0 | 0 | 0 |
| 14 | 0 | 0 | 0 | 0 | 0 | 0 | 0 | 0 | 0 | 0 | 0 | 0 | 0 | 0 | 0 |
| 15 | 0 | 0 | 0 | 0 | 0 | 0 | 0 | 0 | 0 | 0 | 0 | 0 | 0 | 0 | 0 |
| 16 | 0 | 0 | 0 | 0 | 0 | 0 | 0 | 0 | 0 | 0 | 0 | 0 | 0 | 0 | 0 |
| 17 | 0 | 0 | 0 | 0 | 0 | 0 | 0 | 0 | 0 | 0 | 0 | 0 | 1 | 0 | 0 |
| 18 | 0 | 0 | 0 | 0 | 1 | 0 | 0 | 0 | 0 | 0 | 0 | 0 | 0 | 0 | 0 |
| 19 | 0 | 0 | 0 | 0 | 0 | 0 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 |
| 21 | 0 | 0 | 0 | 0 | 0 | 0 | 0 | 0 | 0 | 0 | 0 | 0 | 0 | 0 | 0 |
| 22 | 0 | 0 | 0 | 0 | 0 | 0 | 0 | 0 | 0 | 0 | 0 | 0 | 0 | 0 | 0 |
| 23 | 0 | 0 | 0 | 0 | 0 | 0 | 0 | 0 | 0 | 0 | 0 | 0 | 0 | 0 | 0 |
| 24 | 0 | 0 | 0 | 0 | 0 | 0 | 0 | 0 | 0 | 0 | 0 | 0 | 0 | 0 | 0 |
| 25 | 0 | 0 | 0 | 0 | 0 | 0 | 0 | 0 | 0 | 0 | 0 | 0 | 0 | 0 | 0 |
| 26 | 0 | 0 | 0 | 0 | 0 | 0 | 0 | 0 | 0 | 0 | 0 | 0 | 0 | 0 | 0 |
| 27 | 0 | 0 | 0 | 0 | 0 | 0 | 0 | 0 | 0 | 0 | 0 | 0 | 0 | 0 | 0 |
| 28 | 0 | 0 | 0 | 0 | 0 | 0 | 0 | 0 | 0 | 0 | 0 | 0 | 0 | 0 | 0 |
| 29 | 0 | 0 | 0 | 0 | 0 | 0 | 0 | 0 | 0 | 0 | 0 | 0 | 0 | 0 | 0 |
| 30 | 0 | 0 | 0 | 0 | 0 | 0 | 0 | 0 | 0 | 0 | 0 | 0 | 0 | 0 | 0 |
| 31 | 0 | 0 | 0 | 0 | 0 | 0 | 0 | 0 | 0 | 0 | 0 | 0 | 0 | 0 | 0 |
| 32 | 0 | 0 | 0 | 0 | 0 | 0 | 0 | 0 | 0 | 0 | 0 | 0 | 0 | 0 | 0 |
| 33 | 0 | 0 | 0 | 0 | 0 | 0 | 0 | 0 | 0 | 0 | 0 | 0 | 0 | 0 | 0 |
| 34 | 0 | 0 | 0 | 0 | 0 | 0 | 0 | 1 | 0 | 0 | 0 | 0 | 0 | 0 | 0 |
| 35 | 0 | 0 | 0 | 0 | 0 | 0 | 0 | 0 | 0 | 0 | 0 | 0 | 0 | 0 | 0 |
| 36 | 0 | 0 | 0 | 0 | 0 | 0 | 0 | 0 | 0 | 0 | 0 | 0 | 0 | 0 | 0 |
| 37 | 0 | 0 | 0 | 1 | 0 | 0 | 0 | 0 | 0 | 0 | 0 | 0 | 0 | 0 | 0 |
| 38 | 0 | 0 | 0 | 0 | 0 | 0 | 0 | 0 | 0 | 0 | 0 | 0 | 0 | 0 | 0 |
| 39 | 0 | 0 | 0 | 0 | 0 | 0 | 0 | 0 | 0 | 0 | 0 | 0 | 1 | 0 | 0 |
| 40 | 0 | 0 | 0 | 0 | 0 | 0 | 0 | 0 | 0 | 0 | 0 | 0 | 0 | 0 | 0 |
| 41 | 1 | 0 | 0 | 0 | 0 | 1 | 0 | 0 | 0 | 0 | 0 | 0 | 1 | 0 | 0 |
| 42 | 0 | 0 | 0 | 0 | 0 | 0 | 0 | 0 | 0 | 0 | 0 | 0 | 0 | 0 | 0 |
| 43 | 0 | 1 | 0 | 0 | 0 | 0 | 0 | 0 | 0 | 0 | 0 | 0 | 0 | 0 | 0 |
| 44 | 0 | 0 | 0 | 0 | 0 | 0 | 0 | 0 | 0 | 0 | 0 | 0 | 0 | 0 | 0 |
| 45 | 0 | 0 | 0 | 0 | 0 | 0 | 0 | 0 | 0 | 0 | 0 | 0 | 0 | 0 | 0 |
| 46 | 0 | 0 | 0 | 0 | 0 | 0 | 0 | 0 | 0 | 0 | 0 | 0 | 0 | 0 | 0 |
| 47 | 1 | 0 | 0 | 0 | 0 | 1 | 0 | 0 | 0 | 0 | 0 | 0 | 0 | 0 | 0 |
| 48 | 1 | 0 | 0 | 0 | 0 | 1 | 0 | 0 | 0 | 0 | 0 | 0 | 1 | 0 | 0 |
| 49 | 0 | 0 | 0 | 0 | 0 | 0 | 1 | 0 | 0 | 0 | 0 | 0 | 0 | 0 | 0 |
| 50 | 0 | 0 | 0 | 0 | 0 | 0 | 0 | 0 | 0 | 0 | 1 | 1 | 0 | 1 | 0 |
| 51 | 0 | 1 | 0 | 0 | 0 | 0 | 0 | 0 | 0 | 0 | 0 | 0 | 0 | 0 | 0 |
| 52 | 0 | 0 | 0 | 0 | 0 | 0 | 0 | 0 | 0 | 0 | 0 | 0 | 1 | 0 | 0 |

TABLE 25
Example of labor responsibility and revenue generation associated with different tasks and internal functions of organization

| | | | Working | | Weighted | | | | | | |
|---|---|---|---|---|---|---|---|---|---|---|---|
| | | | Hours | Weight | Responsibility | Weight | | | | | |
| | | | Per | within | Hours | within | Total | Total | Total | | |
| ID | Product | Responsibility | Product | Responsibility | Variable | Product | Revenue | Cost | Value | ROI | Margin |
| 1 | 1 | Form LLC | 0 | 100% | — | 0% | $ — | $ — | $0 | 0% | 0% |
| 2 | 1 | Recruit | 0 | 100% | — | 0% | $ — | $ — | $0 | 0% | 0% |
| | | Employees | | | | | | | | | |
| | | and Partners | | | | | | | | | |
| 3 | 1 | Assign Work | 20 | 100% | 20 | 5% | $26,923 | $1,000 | $25,923 | 2692% | 96% |
| | | Responsibilities | | | | | | | | | |
| 4 | 1 | Manage | 0 | 100% | — | 0% | $ — | $ — | $0 | 0% | 0% |
| | | Employee | | | | | | | | | |
| | | Performance | | | | | | | | | |
| 5 | 1 | Manage | 0 | 100% | — | 0% | $ — | $ — | $0 | 0% | 0% |
| | | Company | | | | | | | | | |
| | | Finances | | | | | | | | | |
| 6 | 1 | Enable Work | 0 | 100% | — | 0% | $ — | $ — | $0 | 0% | 0% |
| | | Tools | | | | | | | | | |
| | | (Google | | | | | | | | | |
| | | Workspace, | | | | | | | | | |
| | | et all) | | | | | | | | | |
| 7 | 1 | Attend and | 0 | 100% | — | 0% | $ — | $ — | $0 | 0% | 0% |
| | | Vote During | | | | | | | | | |
| | | Company | | | | | | | | | |
| | | Board | | | | | | | | | |
| | | Meetings | | | | | | | | | |
| 8 | 1 | Document | 0 | 100% | — | 0% | $ — | $ — | $0 | 0% | 0% |
| | | Business | | | | | | | | | |
| | | Requirements | | | | | | | | | |
| | | for Product | | | | | | | | | |
| 9 | 1 | Design | 80 | 100% | 80 | 21% | $107,692 | $2,125 | $105,567 | 5068% | 98% |
| | | Product | | | | | | | | | |
| | | Prototype(s) | | | | | | | | | |
| 10 | 1 | Design | 0 | 100% | — | 0% | $ — | $ — | $0 | 0% | 0% |
| | | Product | | | | | | | | | |
| | | Pricing | | | | | | | | | |
| 11 | 1 | Build | 0 | 100% | — | 0% | $ — | $ — | $0 | 0% | 0% |
| | | Proforma for | | | | | | | | | |
| | | Product | | | | | | | | | |
| 12 | 1 | Identify | 0 | 100% | — | 0% | $ — | $ — | $0 | 0% | 0% |
| | | Intellectual | | | | | | | | | |
| | | Property | | | | | | | | | |
| | | Implications | | | | | | | | | |
| | | for Product | | | | | | | | | |
| 13 | 1 | Manage | 0 | 100% | — | 0% | $ — | $ — | $0 | 0% | 0% |
| | | Patent | | | | | | | | | |
| | | Opportunities | | | | | | | | | |
| | | for Product | | | | | | | | | |
| 14 | 1 | Customize | 0 | 100% | — | 0% | $ — | $ — | $0 | 0% | 0% |
| | | and Deliver | | | | | | | | | |
| | | Product | | | | | | | | | |
| | | Training for | | | | | | | | | |
| | | Client | | | | | | | | | |
| 15 | 1 | Design, | 0 | 100% | — | 0% | $ — | $ — | $0 | 0% | 0% |
| | | Build, | | | | | | | | | |
| | | Manage | | | | | | | | | |
| | | Company | | | | | | | | | |
| | | and Product | | | | | | | | | |
| | | Website | | | | | | | | | |
| 16 | 1 | Build and | 150 | 100% | 150 | 38% | $201,923 | $4,500 | $197,423 | 4487% | 98% |
| | | Test Product | | | | | | | | | |
| | | Prototype(s) | | | | | | | | | |
| 17 | 1 | Document | 0 | 100% | — | 0% | $ — | $ — | $0 | 0% | 0% |
| | | Technical | | | | | | | | | |
| | | Requirements | | | | | | | | | |
| | | for Product | | | | | | | | | |
| 18 | 1 | Manage | 0 | 100% | — | 0% | $ — | $ — | $0 | 0% | 0% |
| | | Vendor | | | | | | | | | |
| | | Contracts | | | | | | | | | |
| | | and | | | | | | | | | |
| | | Performance | | | | | | | | | |
| 19 | 1 | Test | 80 | 100% | 80 | 21% | $107,692 | $1,600 | $106,092 | 6731% | 99% |
| | | Product(s) - | | | | | | | | | |
| | | CIT, SIT, | | | | | | | | | |
| | | UAT | | | | | | | | | |
| 20 | 1 | Research | 0 | 100% | — | 0% | $ — | $ — | $0 | 0% | 0% |
| | | Potential | | | | | | | | | |
| | | Clients | | | | | | | | | |
| 21 | 1 | Identify and | 0 | 100% | — | 0% | $ — | $ — | $0 | 0% | 0% |
| | | Attend | | | | | | | | | |
| | | Relevant | | | | | | | | | |
| | | Client | | | | | | | | | |
| | | Conferences, | | | | | | | | | |
| | | Forums, | | | | | | | | | |
| | | et all | | | | | | | | | |
| 22 | 1 | Identify | 0 | 100% | — | 0% | $ — | $ — | $0 | 0% | 0% |
| | | Best Fit | | | | | | | | | |
| | | Product(s) | | | | | | | | | |
| | | for Specific | | | | | | | | | |
| | | Clients | | | | | | | | | |
| 23 | 1 | Identify | 0 | 100% | — | 0% | $ — | $ — | $0 | 0% | 0% |
| | | Customizable | | | | | | | | | |
| | | Opportunities | | | | | | | | | |
| | | for Specific | | | | | | | | | |
| | | Clients | | | | | | | | | |
| 24 | 1 | Build Client | 0 | 100% | — | 0% | $ — | $ — | $0 | 0% | 0% |
| | | Proforma(s) | | | | | | | | | |
| 25 | 1 | Build | 0 | 100% | — | 0% | $ — | $ — | $0 | 0% | 0% |
| | | Implementation | | | | | | | | | |
| | | Workplans | | | | | | | | | |
| | | By Client | | | | | | | | | |
| 26 | 1 | Create Pitch | 0 | 100% | — | 0% | $ — | $ — | $0 | 0% | 0% |
| | | Decks and | | | | | | | | | |
| | | Proposals for | | | | | | | | | |
| | | Individual | | | | | | | | | |
| | | Clients | | | | | | | | | |
| 27 | 1 | Deliver | 0 | 100% | — | 0% | $ — | $ — | $0 | 0% | 0% |
| | | Proposals to | | | | | | | | | |
| | | Clients | | | | | | | | | |
| 28 | 1 | Revise | 0 | 100% | — | 0% | $ — | $ — | $0 | 0% | 0% |
| | | Workplans | | | | | | | | | |
| | | with Clients | | | | | | | | | |
| 29 | 1 | Negotiate | 0 | 100% | — | 0% | $ — | $ — | $0 | 0% | 0% |
| | | Pricing with | | | | | | | | | |
| | | Clients | | | | | | | | | |
| 30 | 1 | Execute | 0 | 100% | — | 0% | $ — | $ — | $0 | 0% | 0% |
| | | Contracts | | | | | | | | | |
| | | with Clients | | | | | | | | | |
| 31 | 1 | Assess | 0 | 100% | — | 0% | $ — | $ — | $0 | 0% | 0% |
| | | Client | | | | | | | | | |
| | | Systems | | | | | | | | | |
| 32 | 1 | Build | 0 | 100% | — | 0% | $ — | $ — | $0 | 0% | 0% |
| | | Technical | | | | | | | | | |
| | | Implementation | | | | | | | | | |
| | | Workplans | | | | | | | | | |
| 33 | 1 | Integrate | 0 | 100% | — | 0% | $ — | $ — | $0 | 0% | 0% |
| | | with Client | | | | | | | | | |
| | | Systems | | | | | | | | | |
| 34 | 1 | Build and | 0 | 100% | — | 0% | $ — | $ — | $0 | 0% | 0% |
| | | Customize | | | | | | | | | |
| | | Products for | | | | | | | | | |
| | | Clients | | | | | | | | | |
| 35 | 1 | Test | 0 | 100% | — | 0% | $ — | $ — | $0 | 0% | 0% |
| | | Product(s) - | | | | | | | | | |
| | | CIT, SIT, | | | | | | | | | |
| | | UAT, Post- | | | | | | | | | |
| | | Implementation | | | | | | | | | |
| 36 | 1 | Customize | 0 | 100% | — | 0% | $ — | $ — | $0 | 0% | 0% |
| | | and Deliver | | | | | | | | | |
| | | Product | | | | | | | | | |
| | | Training for | | | | | | | | | |
| | | Client | | | | | | | | | |
| 37 | 1 | Deploy | 20 | 100% | 20 | 5% | $26,923 | $600 | $26,323 | 4487% | 98% |
| | | Products to | | | | | | | | | |
| | | Clients | | | | | | | | | |
| 38 | 1 | Provide | 0 | 100% | — | 0% | $ — | $ — | $0 | 0% | 0% |
| | | Product | | | | | | | | | |
| | | Technical | | | | | | | | | |
| | | Support Post | | | | | | | | | |
| | | Implementation | | | | | | | | | |
| 39 | 1 | Build and | 0 | 100% | — | 0% | $ — | $ — | $0 | 0% | 0% |
| | | Maintain | | | | | | | | | |
| | | Product | | | | | | | | | |
| | | Detailed | | | | | | | | | |
| | | Descriptions | | | | | | | | | |
| | | and | | | | | | | | | |
| | | Requirements | | | | | | | | | |
| 40 | 1 | Maintain | 0 | 100% | — | 0% | $ — | $ — | $0 | 0% | 0% |
| | | Product | | | | | | | | | |
| | | Webpages | | | | | | | | | |
| 41 | 1 | Identify | 0 | 100% | — | 0% | $ — | $ — | $0 | 0% | 0% |
| | | Opportunities | | | | | | | | | |
| | | for Product | | | | | | | | | |
| | | Enhancement | | | | | | | | | |
| | | and New | | | | | | | | | |
| | | Features | | | | | | | | | |
| 42 | 1 | Manage and | 0 | 100% | — | 0% | $ — | $ — | $0 | 0% | 0% |
| | | Prioritize | | | | | | | | | |
| | | Product | | | | | | | | | |
| | | Feature | | | | | | | | | |
| | | Backlog | | | | | | | | | |
| 43 | 1 | Manage | 0 | 100% | — | 0% | $ — | $ — | $0 | 0% | 0% |
| | | Product P&L | | | | | | | | | |
| | | Finanicals | | | | | | | | | |
| 44 | 1 | Manage | 40 | 100% | 40 | 10% | $53,846 | $1,280 | $52,566 | 4207% | 98% |
| | | and/or | | | | | | | | | |
| | | Provide | | | | | | | | | |
| | | Product | | | | | | | | | |
| | | Support Post | | | | | | | | | |
| | | Implementation | | | | | | | | | |
| 45 | 1 | Identify and | 0 | 100% | — | 0% | $ — | $ — | $0 | 0% | 0% |
| | | Resolve | | | | | | | | | |
| | | Product | | | | | | | | | |
| | | Issues | | | | | | | | | |
| 46 | 1 | Manage | 0 | 100% | — | 0% | $ — | $ — | $0 | 0% | 0% |
| | | Assigned | | | | | | | | | |
| | | Existing | | | | | | | | | |
| | | Client | | | | | | | | | |
| | | Relationships | | | | | | | | | |
| | | By Meeting | | | | | | | | | |
| | | on Regular | | | | | | | | | |
| | | Cadence | | | | | | | | | |
| 47 | 1 | Continually | 0 | 100% | — | 0% | $ — | $ — | $0 | 0% | 0% |
| | | Seek | | | | | | | | | |
| | | Understanding | | | | | | | | | |
| | | of Client's | | | | | | | | | |
| | | Evolving | | | | | | | | | |
| | | Needs | | | | | | | | | |
| 48 | 1 | Identify | 0 | 100% | — | 0% | $ — | $ — | $0 | 0% | 0% |
| | | Opportunities | | | | | | | | | |
| | | for Product | | | | | | | | | |
| | | Enhancement | | | | | | | | | |
| | | and New | | | | | | | | | |
| | | Features | | | | | | | | | |
| 49 | 1 | Analyze | 0 | 100% | — | 0% | $ — | $ — | $0 | 0% | 0% |
| | | Client | | | | | | | | | |
| | | Adoption | | | | | | | | | |
| | | and Impact | | | | | | | | | |
| | | Post- | | | | | | | | | |
| | | Implementation | | | | | | | | | |
| | | and | | | | | | | | | |
| | | Ongoing | | | | | | | | | |
| 50 | 1 | Report on | 0 | 100% | — | 0% | $ — | $ — | $0 | 0% | 0% |
| | | Adoption | | | | | | | | | |
| | | and Impact | | | | | | | | | |
| | | to Client | | | | | | | | | |
| 51 | 1 | Manage | 0 | 100% | — | 0% | $ — | $ — | $0 | 0% | 0% |
| | | Client | | | | | | | | | |
| | | P&L | | | | | | | | | |
| | | Financials | | | | | | | | | |

TABLE 26
Examples of different competencies and revenue implications
by task and internal function of organization

| | | | | | | Working | Weight |
|---|---|---|---|---|---|---|---|
| | | | | | | Hours | within |
| | | | | | | Per | Respon- |
| ID | Organization | Product | Function | Responsibility | Skills | Product | sibility |
| 1 | Organization | 1 | Organizational | Form LLC | Word | 0 | 100% |
| | Name | | Management | | Processing | | |
| 2 | Organization | 1 | Organizational | Recruit | Stakeholder | 0 | 100% |
| | Name | | Management | Employees | Management | | |
| | | | | and | | | |
| | | | | Partners | | | |
| 3 | Organization | 1 | Organizational | Assign Work | People | 20 | 100% |
| | Name | | Management | Responsibilities | Management | | |
| 4 | Organization | 1 | Organizational | Manage | People | 0 | 100% |
| | Name | | Management | Employee | Management | | |
| | | | | Performance | | | |
| 5 | Organization | 1 | Organizational | Manage | Accounting | 0 | 100% |
| | Name | | Management | Company | | | |
| | | | | Finances | | | |
| 6 | Organization | 1 | Organizational | Enable | Software | 0 | 100% |
| | Name | | Management | Work Tools | Installation | | |
| | | | | (Google | | | |
| | | | | Workspace, | | | |
| | | | | et all) | | | |
| 7 | Organization | 1 | Organizational | Attend and | Facilitation | 0 | 100% |
| | Name | | Management | Vote | | | |
| | | | | During | | | |
| | | | | Company | | | |
| | | | | Board | | | |
| | | | | Meetings | | | |
| 8 | Organization | 1 | Product | Document | Product | 0 | 100% |
| | Name | | Development | Business | Development | | |
| | | | | Requirements | | | |
| | | | | for | | | |
| | | | | Product | | | |
| 9 | Organization | 1 | Product | Design | Product | 0 | 60% |
| | Name | | Development | Product | Development | | |
| | | | | Prototype(s) | | | |
| 10 | Organization | 1 | Product | Design | Microsoft | 80 | 40% |
| | Name | | Development | Product | Office | | |
| | | | | Prototype(s) | | | |
| 11 | Organization | 1 | Product | Design | Accounting | 0 | 100% |
| | Name | | Development | Product | | | |
| | | | | Pricing | | | |
| 12 | Organization | 1 | Product | Build | Accounting | 0 | 60% |
| | Name | | Development | Proforma | | | |
| | | | | for Product | | | |
| 13 | Organization | 1 | Product | Build | Microsoft | 0 | 40% |
| | Name | | Development | Proforma | Office | | |
| | | | | for Product | | | |
| 14 | Organization | 1 | Product | Identify | Product | 0 | 100% |
| | Name | | Development | Intellectual | Development | | |
| | | | | Property | | | |
| | | | | Implications | | | |
| | | | | for Product | | | |
| 15 | Organization | 1 | Product | Manage | Product | 0 | 100% |
| | Name | | Development | Patent | Development | | |
| | | | | Opportunities | | | |
| | | | | for | | | |
| | | | | Product | | | |
| 16 | Organization | 1 | Product | Customize | Training | 0 | 100% |
| | Name | | Development | and Deliver | Delivery | | |
| | | | | Product | | | |
| | | | | Training | | | |
| | | | | for Client | | | |
| 17 | Organization | 1 | Technical | Design, | Software | 0 | 100% |
| | Name | | Development | Build, | Installation | | |
| | | | | Manage | | | |
| | | | | Company | | | |
| | | | | and Product | | | |
| | | | | Website | | | |
| 18 | Organization | 1 | Technical | Document | Product | 0 | 100% |
| | Name | | Development | Technical | Development | | |
| | | | | Requirements | | | |
| | | | | for | | | |
| | | | | Product | | | |
| 19 | Organization | 1 | Technical | Build and | Testing | 150 | 100% |
| | Name | | Development | Test | | | |
| | | | | Product | | | |
| | | | | Prototype(s) | | | |
| 20 | Organization | 1 | Technical | Manage | | | |
| | Name | | Development | Vendor | Vendor | 0 | 100% |
| | | | | Contracts | Relations | | |
| | | | | and | | | |
| | | | | Performance | | | |
| 21 | Organization | 1 | Technical | Test | Testing | 80 | 100% |
| | Name | | Development | Product(s) - | | | |
| | | | | CIT, SIT, | | | |
| | | | | UAT | | | |
| 22 | Organization | 1 | Business | Research | Stakeholder | 0 | 100% |
| | Name | | Development | Potential | Management | | |
| | | | | Clients | | | |
| 23 | Organization | 1 | Business | Identify | Stakeholder | 0 | 100% |
| | Name | | Development | and Attend | Management | | |
| | | | | Relevant | | | |
| | | | | Client | | | |
| | | | | Conferences, | | | |
| | | | | Forums, | | | |
| | | | | et all | | | |
| 24 | Organization | 1 | Business | Identify | Product | 0 | 100% |
| | Name | | Development | Best Fit | Development | | |
| | | | | Product(s) | | | |
| | | | | for Specific | | | |
| | | | | Clients | | | |
| 25 | Organization | 1 | Business | Identify | Stakeholder | 0 | 100% |
| | Name | | Development | Customizable | Management | | |
| | | | | Opportunities | | | |
| | | | | for Specific | | | |
| | | | | Clients | | | |
| | Organization | 1 | Business | Build | Accounting | 0 | 60% |
| 26 | Name | | Development | Client | | | |
| | | | | Proforma(s) | | | |
| 27 | Organization | 1 | Business | Build | Microsoft | 0 | 40% |
| | Name | | Development | Client | Office | | |
| | | | | Proforma(s) | | | |
| 28 | Organization | 1 | Business | Build | Project | 0 | 80% |
| | Name | | Development | Implementation | Management | | |
| | | | | Workplans | | | |
| | | | | By Client | | | |
| 29 | Organization | 1 | Business | Build | Microsoft | 0 | 20% |
| | Name | | Development | Implementation | Office | | |
| | | | | Workplans | | | |
| | | | | By Client | | | |
| 30 | Organization | 1 | Business | Create | Stakeholder | 0 | 50% |
| | Name | | Development | Pitch Decks | Management | | |
| | | | | and | | | |
| | | | | Proposals | | | |
| | | | | for | | | |
| | | | | Individual | | | |
| | | | | Clients | | | |
| 31 | Organization | 1 | Business | Create | Microsoft | 0 | 50% |
| | Name | | Development | Pitch Decks | Office | | |
| | | | | and | | | |
| | | | | Proposals | | | |
| | | | | for | | | |
| | | | | Individual | | | |
| | | | | Clients | | | |
| 32 | Organization | 1 | Business | Deliver | Stakeholder | 0 | 100% |
| | Name | | Development | Proposals | Management | | |
| | | | | to Clients | | | |
| 33 | Organization | 1 | Business | Revise | Project | 0 | 100% |
| | Name | | Development | Workplans | Management | | |
| | | | | with | | | |
| | | | | Clients | | | |
| 34 | Organization | 1 | Business | Negotiate | Accounting | 0 | 100% |
| | Name | | Development | Pricing | | | |
| | | | | with | | | |
| | | | | Clients | | | |
| 35 | Organization | 1 | Business | Execute | Stakeholder | 0 | 100% |
| | Name | | Development | Contracts | Management | | |
| | | | | with | | | |
| | | | | Clients | | | |
| 36 | Organization | 1 | Technical | Assess | Software | 0 | 100% |
| | Name | | Implementation | Client | Maintenance | | |
| | | | | Systems | | | |
| 37 | Organization | 1 | Technical | Build | Project | 0 | 100% |
| | Name | | Implementation | Technical | Management | | |
| | | | | Implementation | | | |
| | | | | Workplans | | | |
| 38 | Organization | 1 | Technical | Integrate | Software | 0 | 100% |
| | Name | | Implementation | with Client | Installation | | |
| | | | | Systems | | | |
| 39 | Organization | 1 | Technical | Build and | Software | 0 | 100% |
| | Name | | Implementation | Customize | Installation | | |
| | | | | Products | | | |
| | | | | for Clients | | | |
| 40 | Organization | 1 | Technical | Test | Testing | 0 | 100% |
| | Name | | Implementation | Product(s) - | | | |
| | | | | CIT, SIT, | | | |
| | | | | UAT | | | |
| 41 | Organization | 1 | Technical | Customize | Training | 0 | 100% |
| | Name | | Implementation | and Deliver | Delivery | | |
| | | | | Product | | | |
| | | | | Training | | | |
| | | | | for Client | | | |
| 42 | Organization | 1 | Technical | Deploy | Software | 20 | 100% |
| | Name | | Implementation | Products to | Installation | | |
| | | | | Clients | | | |
| 43 | Organization | 1 | Technical | Provide | Software | 0 | 100% |
| | Name | | Implementation | Product | Maintenance | | |
| | | | | Technical | | | |
| | | | | Support | | | |
| | | | | Post | | | |
| | | | | Implementation | | | |
| 44 | Organization | 1 | Product | Build and | Product | 0 | 100% |
| | Name | | Management | Maintain | Development | | |
| | | | | Product | | | |
| | | | | Detailed | | | |
| | | | | Descriptions | | | |
| | | | | and | | | |
| | | | | Requirements | | | |
| 45 | Organization | 1 | Product | Maintain | Software | 0 | 100% |
| | Name | | Management | Product | Installation | | |
| | | | | Webpages | | | |
| 46 | Organization | 1 | Product | Identify | Product | 0 | 100% |
| | Name | | Management | Opportunities | Development | | |
| | | | | for Product | | | |
| | | | | Enhancement | | | |
| | | | | and New | | | |
| | | | | Features | | | |
| 47 | Organization | 1 | Product | Manage and | Project | 0 | 100% |
| | Name | | Management | Prioritize | Management | | |
| | | | | Product | | | |
| | | | | Feature | | | |
| | | | | Backlog | | | |
| 48 | Organization | 1 | Product | Manage | Accounting | 0 | 100% |
| | Name | | Management | Product | | | |
| | | | | P&L | | | |
| | | | | Financials | | | |
| 49 | Organization | 1 | Product | Manage | Stakeholder | 40 | 100% |
| | Name | | Management | and/or | Management | | |
| | | | | Provide | | | |
| | | | | Product | | | |
| | | | | Support | | | |
| | | | | Post | | | |
| | | | | Implementation | | | |
| 50 | Organization | 1 | Product | Identify | Product | 0 | 100% |
| | Name | | Management | and | Development | | |
| | | | | Resolve | | | |
| | | | | Product | | | |
| | | | | Issues | | | |
| 51 | Organization | 1 | Relationship | Manage | Stakeholder | 0 | 100% |
| | Name | | Management | Assigned | Management | | |
| | | | | Existing | | | |
| | | | | Client | | | |
| | | | | Relationships | | | |
| | | | | By Meeting | | | |
| | | | | on Regular | | | |
| | | | | Cadence | | | |
| 52 | Organization | 1 | Relationship | Continually | Stakeholder | 0 | 100% |
| | Name | | Management | Seek | Management | | |
| | | | | Understanding | | | |
| | | | | of Client's | | | |
| | | | | Evolving | | | |
| | | | | Needs | | | |
| 53 | Organization | 1 | Relationship | Identify | Product | 0 | 100% |
| | Name | | Management | Opportunities | Development | | |
| | | | | for Product | | | |
| | | | | Enhancement | | | |
| | | | | and New | | | |
| | | | | Features | | | |
| 54 | Organization | 1 | Relationship | Analyze | Microsoft | 0 | 20% |
| | Name | | Management | Client | Office | | |
| | | | | Adoption | | | |
| | | | | and Impact | | | |
| | | | | Post- | | | |
| | | | | Implementation | | | |
| | | | | and Ongoing | | | |
| 55 | Organization | 1 | Relationship | Analyze | Stakeholder | 0 | 80% |
| | Name | | Management | Client | Management | | |
| | | | | Adoption | | | |
| | | | | and Impact | | | |
| | | | | Post- | | | |
| | | | | Implementation | | | |
| | | | | and Ongoing | | | |
| 56 | Organization | 1 | Relationship | Report on | Facilitation | 0 | 15% |
| | Name | | Management | Adoption | | | |
| | | | | and Impact | | | |
| | | | | to Client | | | |
| 57 | Organization | 1 | Relationship | Report on | Stakeholder | 0 | 15% |
| | Name | | Management | Adoption | Management | | |
| | | | | and Impact | | | |
| | | | | to Client | | | |
| 58 | Organization | 1 | Relationship | Report on | Microsoft | 0 | 40% |
| | Name | | Management | Adoption | Office | | |
| | | | | and Impact | | | |
| | | | | to Client | | | |
| 59 | Organization | 1 | Relationship | Report on | Product | 0 | 30% |
| | Name | | Management | Adoption | Development | | |
| | | | | and Impact | | | |
| | | | | to Client | | | |
| 60 | Organization | 1 | Relationship | Manage | Accounting | 0 | 70% |
| | Name | | Management | Client P&L | | | |
| | | | | Financials | | | |
| 61 | Organization | 1 | Relationship | Manage | Microsoft | 0 | 30% |
| | Name | | Management | Client P&L | Office | | |
| | | | | Financials | | | |
| 62 | Organization | 1 | Relationship | Identify | Stakeholder | 0 | 100% |
| | Name | | Management | and | Management | | |
| | | | | Resolve | | | |
| | | | | Client | | | |
| | | | | Issues | | | |

| | Weighted | | | | | | |
|---|---|---|---|---|---|---|---|
| | Respon- | | | | | | |
| | sibility | Weight | | | | | |
| | Hours | within | Total | Total | Total | | |
| ID | Variable | Product | Revenue | Cost | Value | ROI | Margin |
| 1 | — | 0% | $ — | $ — | $0 | 0% | 0% |
| 2 | — | 0% | $ — | $ — | $0 | 0% | 0% |
| 3 | 20 | 6% | $30,702 | $1,000 | $29,702 | 3070% | 97% |
| 4 | — | 0% | $ — | $ — | $0 | 0% | 0% |
| 5 | — | 0% | $ — | $ — | $0 | 0% | 0% |
| 6 | — | 0% | $ — | $ — | $0 | 0% | 0% |
| 7 | — | 0% | $ — | $ — | $0 | 0% | 0% |
| 8 | — | 0% | $ — | $ — | $0 | 0% | 0% |
| 9 | — | 0% | $ — | $ — | $0 | 0% | 0% |
| 10 | 32 | 9% | $49,123 | $2,125 | $46,998 | 2312% | 96% |
| 11 | — | 0% | $ — | $ — | $0 | 0% | 0% |
| 12 | — | 0% | $ — | $ — | $0 | 0% | 0% |
| 13 | — | 0% | $ — | $ — | $0 | 0% | 0% |
| 14 | — | 0% | $ — | $ — | $0 | 0% | 0% |
| 15 | — | 0% | $ — | $ — | $0 | 0% | 0% |
| 16 | — | 0% | $ — | $ — | $0 | 0% | 0% |
| 17 | — | 0% | $ — | $ — | $0 | 0% | 0% |
| 18 | — | 0% | $ — | $ — | $0 | 0% | 0% |
| 19 | 150 | 44% | $230,263 | $4,500 | $225,763 | 5117% | 98% |
| 20 | — | 0% | $ — | $ — | $0 | 0% | 0% |
| 21 | 80 | 23% | $122,807 | $1,600 | $121,207 | 7675% | 99% |
| 22 | — | 0% | $ — | $ — | $0 | 0% | 0% |
| 23 | — | 0% | $ — | $ — | $0 | 0% | 0% |
| 24 | — | 0% | $ — | $ — | $0 | 0% | 0% |
| 25 | — | 0% | $ — | $ — | $0 | 0% | 0% |
| 26 | — | 0% | $ — | $ — | $0 | 0% | 0% |
| 27 | — | 0% | $ — | $ — | $0 | 0% | 0% |
| 28 | — | 0% | $ — | $ — | $0 | 0% | 0% |
| 29 | — | 0% | $ — | $ — | $0 | 0% | 0% |
| 30 | — | 0% | $ — | $ — | $0 | 0% | 0% |
| 31 | — | 0% | $ — | $ — | $0 | 0% | 0% |
| 32 | — | 0% | $ — | $ — | $0 | 0% | 0% |
| 33 | — | 0% | $ — | $ — | $0 | 0% | 0% |
| 34 | — | 0% | $ — | $ — | $0 | 0% | 0% |
| 35 | — | 0% | $ — | $ — | $0 | 0% | 0% |
| 36 | — | 0% | $ — | $ — | $0 | 0% | 0% |
| 37 | — | 0% | $ — | $ — | $0 | 0% | 0% |
| 38 | — | 0% | $ — | $ — | $0 | 0% | 0% |
| 39 | — | 0% | $ — | $ — | $0 | 0% | 0% |
| 40 | — | 0% | $ — | $ — | $0 | 0% | 0% |
| 41 | — | 0% | $ — | $ — | $0 | 0% | 0% |
| 42 | 20 | 6% | $30,702 | $600 | $30,102 | 5117% | 98% |
| 43 | — | 0% | $ — | $ — | $0 | 0% | 0% |
| 44 | — | 0% | $ — | $ — | $0 | 0% | 0% |
| 45 | — | 0% | $ — | $ — | $0 | 0% | 0% |
| 46 | — | 0% | $ — | $ — | $0 | 0% | 0% |
| 47 | — | 0% | $ — | $ — | $0 | 0% | 0% |
| 48 | — | 0% | $ — | $ — | $0 | 0% | 0% |
| 49 | 40 | 12% | $61,404 | $1,280 | $60,124 | 4797% | 98% |
| 50 | — | 0% | $ — | $ — | $0 | 0% | 0% |
| 51 | — | 0% | $ — | $ — | $0 | 0% | 0% |
| 52 | — | 0% | $ — | $ — | $0 | 0% | 0% |
| 53 | — | 0% | $ — | $ — | $0 | 0% | 0% |
| 54 | — | 0% | $ — | $ — | $0 | 0% | 0% |
| 55 | — | 0% | $ — | $ — | $0 | 0% | 0% |
| 56 | — | 0% | $ — | $ — | $0 | 0% | 0% |
| 57 | — | 0% | $ — | $ — | $0 | 0% | 0% |
| 58 | — | 0% | $ — | $ — | $0 | 0% | 0% |
| 59 | — | 0% | $ — | $ — | $0 | 0% | 0% |
| 60 | — | 0% | $ — | $ — | $0 | 0% | 0% |
| 61 | — | 0% | $ — | $ — | $0 | 0% | 0% |
| 62 | — | 0% | $ — | $ — | $0 | 0% | 0% |

TABLE 27
Examples of stakeholder contribution to revenue by product or service of organization

| | | | | | | Weighted | | | | | | |
|---|---|---|---|---|---|---|---|---|---|---|---|---|
| | | | | Working | Weight | Respon- | | | | | | |
| | | | | Hours | within | sibility | Weight | | | | | |
| | | | | Per | Respon- | Hours | within | Total | Total | Total | | |
| ID | Organization | Product | People | Product | sibility | Variable | Product | Revenue | Cost | Value | ROI | Margin |
| 1 | Organization | Product | Bob | 20 | 100% | 20 | 5% | $26,923 | $1,000 | $25,923 | 2692% | 96% |
| | Name | 1 | Smith | | | | | | | | | |
| 2 | Organization | Product | John | 0 | 100% | — | 0% | $ — | $ — | $0 | 0% | 0% |
| | Name | 1 | Doe | | | | | | | | | |
| 3 | Organization | Product | Sally | 0 | 100% | — | 0% | $ — | $ — | $0 | 0% | 0% |
| | Name | 1 | Wallace | | | | | | | | | |
| 4 | Organization | Product | Sue | 80 | 100% | 80 | 21% | $107,692 | $2,125 | $105,567 | 5068% | 98% |
| | Name | 1 | Williams | | | | | | | | | |
| 5 | Organization | Product | Mike | 0 | 100% | — | 0% | $ — | $ — | $0 | 0% | 0% |
| | Name | 1 | Henry | | | | | | | | | |
| 6 | Organization | Product | Henry | 170 | 100% | 170 | 44% | $228,846 | $10,200 | $218,646 | 2244% | 96% |
| | Name | 1 | Finkle | | | | | | | | | |
| 7 | Organization | Product | Hellen | 0 | 100% | — | 0% | $ — | $ — | $0 | 0% | 0% |
| | Name | 1 | Wise | | | | | | | | | |
| 8 | Organization | Product | Amy | 0 | 100% | — | 0% | $ — | $ — | $0 | 0% | 0% |
| | Name | 1 | Johns | | | | | | | | | |
| 9 | Organization | Product | Charles | 40 | 100% | 40 | 10% | $53,846 | $1,280 | $52,566 | 4207% | 98% |
| | Name | 1 | Standish | | | | | | | | | |
| 10 | Organization | Product | Mark | 0 | 100% | — | 0% | $ — | $ — | $0 | 0% | 0% |
| | Name | 1 | Hunt | | | | | | | | | |
| 11 | Organization | Product | Hunter | 80 | 100% | 80 | 21% | $107,692 | $1,600 | $106,092 | 6731% | 99% |
| | Name | 1 | Beamer | | | | | | | | | |
| 12 | Organization | Product | Mary | 0 | 100% | — | 0% | $ — | $ — | $0 | 0% | 0% |
| | Name | 1 | Smith | | | | | | | | | |
| 13 | Organization | Product | Anne | 0 | 100% | — | 0% | $ — | $ — | $0 | 0% | 0% |
| | Name | 1 | Williams | | | | | | | | | |
| 14 | Organization | Product | Lee | 0 | 100% | — | 0% | $ — | $ — | $0 | 0% | 0% |
| | Name | 1 | Smart | | | | | | | | | |
| 15 | Organization | Product | Dottie | 0 | 100% | — | 0% | $ — | $ — | $0 | 0% | 0% |
| | Name | 1 | Jones | | | | | | | | | |
| 16 | Organization | Product | Shane | 0 | 100% | — | 0% | $ — | $ — | $0 | 0% | 0% |
| | Name | 1 | Stevens | | | | | | | | | |
| 17 | Organization | Product | Ted | 0 | 100% | — | 0% | $ — | $ — | $0 | 0% | 0% |
| | Name | 1 | Smoke | | | | | | | | | |
| 18 | Organization | Product | Evan | 0 | 100% | — | 0% | $ — | $ — | $0 | 0% | 0% |
| | Name | 1 | Henderson | | | | | | | | | |
| 19 | Organization | Product | Ginger | 0 | 100% | — | 0% | $ — | $ — | $0 | 0% | 0% |
| | Name | 1 | Cecil | | | | | | | | | |
| 20 | Organization | Product | Stephanie | 0 | 100% | — | 0% | $ — | $ — | $0 | 0% | 0% |
| | Name | 1 | Hart | | | | | | | | | |
| 21 | Organization | Product | Sean | 0 | 100% | — | 0% | $ — | $ — | $0 | 0% | 0% |
| | Name | 1 | Spike | | | | | | | | | |

TABLE 28
Example of revenue/costs associated with particular skills
or competencies of stakeholders of organization

| | SUM of | SUM of | |
|---|---|---|---|
| Skills | Total Revenue | Total Cost | Margin |
| Accounting | $ — | $ — | 0% |
| Facilitation | $ — | $ — | 0% |
| Microsoft | $49,123 | $2,125 | 96% |
| Office | | | |
| People | $30,702 | $1,000 | 97% |
| Management | | | |
| Product | $ — | $ — | 0% |
| Development | | | |
| Project | $ — | $ — | 0% |
| Management | | | |
| Software | $30,702 | $600 | 98% |
| Installation | | | |
| Software | $ — | $ — | 0% |
| Maintenance | | | |
| Stakeholder | $61,404 | $1,280 | 98% |
| Management | | | |
| Testing | $353,070 | $6,100 | 98% |
| Training | $ — | $ — | 0% |
| Delivery | | | |
| Vendor | $ — | $ — | 0% |
| Relations | | | |
| Grand | $525,000 | $11,105 | 98% |
| Total | | | |

TABLE 29
Example of a skills assessment for a particular stakeholder of organization
Skills Assessment for: Bob Smith

| | | | | | | Meets | |
|---|---|---|---|---|---|---|---|
| | Required | Desired | Self- | 360 | Reviewer | Required | Opportunity |
| | Level | Level | Assessment | Assessment | Agreement | Level | to Deepen |
| Required Skills | | | | | | | |
| Word | Independent | Expert | Independent | Novice | Group | Competency | Growth |
| Processing | | | | | Assessment | Met | Opportunity |
| | | | | | Lower | | |
| Accounting | Expert | Expert | Expert | Expert | Agreement | Competency | Requirement |
| | | | | | | Met | Met |
| People | Independent | Independent | Independent | Independent | Agreement | Competency | Requirement |
| Management | | | | | | Met | Met |
| Project | Independent | Expert | Expert | Independent | Group | Competency | Requirement |
| Management | | | | | Assessment | Exceeded | Met |
| | | | | | Lower | | |
| Optional Skills | | | | | | | |
| Software | No | No | No | Not Rated | Agreement | Competency | Requirement |
| Installation | Experience | Experience | Experience | | | Met | Met |
| Software | No | No | No | Not Rated | Agreement | Competency | Requirement |
| Maintenance | Experience | Experience | Experience | | | Met | Met |
| Market | No | Expert | Novice | No | Group | Competency | Growth |
| Analysis | Experience | | | Experience | Assessment | Not Met | Opportunity |
| | | | | | Lower | | |
| Campaign | No | Independent | Novice | Novice | Agreement | Competency | Growth |
| Analysis | Experience | | | | | Not Met | Opportunity |
| Campaign | No | Independent | Novice | No | Group | Competency | Growth |
| Development | Experience | | | Experience | Assessment | Not Met | Opportunity |
| | | | | | Lower | | |
| Event | No | Novice | Novice | Novice | Agreement | Competency | Requirement |
| Planning | Experience | | | | | Not Met | Met |
| Catering | No | No | No | Not Rated | Agreement | Competency | Requirement |
| | Experience | Experience | Experience | | | Met | Met |
| Vendor | No | No | No | Not Rated | Agreement | Competency | Requirement |
| Relations | Experience | Experience | Experience | | | Met | Met |
| Stakeholder | No | No | No | Not Rated | Agreement | Competency | Requirement |
| Management | Experience | Experience | Experience | | | Met | Met |
| Product | No | Independent | Independent | Independent | Agreement | Competency | Requirement |
| Development | Experience | | | | | Not Met | Met |
| Testing | No | No | No | Not Rated | Agreement | Competency | Requirement |
| | Experience | Experience | Experience | | | Met | Met |
| Training | No | No | No | Not Rated | Agreement | Competency | Requirement |
| Development | Experience | Experience | Experience | | | Met | Met |
| Training | No | No | No | Not Rated | Agreement | Competency | Requirement |
| Delivery | Experience | Experience | Experience | | | Met | Met |
| Facilitation | No | Independent | Novice | Independent | Group | Competency | Growth |
| | Experience | | | | Assessment | Not Met | Opportunity |
| | | | | | Higher | | |

TABLE 30
Example questions asked during a dynamic interview

| Question | Response |
|---|---|
| Organization Name | Organization A LLC |
| What was the greatest challenge you have | We are a start-up that, like most, must develop every aspect of our |
| ever faced or are currently facing as an | organization from the ground up: Product, pricing, customers, |
| organization? | marketing, technology, analysis. Simply put, the greatest challenge |
| | that I face is having to fulfill each of those roles and deliver upon my |
| | commitments each and every time. |
| How did your organization overcome the | We are still working through it but have come a long way. I have |
| challenge? | worked very hard to learn these new competencies, much of which |
| | through trial and error. |
| What did you learn through the challenging | Hard work is important but advisors, mentorship, and the |
| experience? | entrepreneurial community have helped me navigate these new |
| | areas, learn from missteps, and progress forward. |
| What was your happiest moment or | The happiest moment was when I decided to stop looking for new |
| greatest achievement with your | jobs. It was the moment when I fully committed to making this a |
| organization? | reality into its success. |
| Why is this moment so important to the | It is a brave and scary thing to do when opening a organization, I |
| organization? | have a lot of respect for all of those before me. |
| What continually motivates or inspires the | I am continually motivated by the challenge of making complex |
| people working or volunteering within your | concepts simpler and more intuitive through data, mathematics, and |
| organization? | analysis. I know that the more approachable I can make the product, |
| | the more it will be used and the more value it can create. |
| If you could sum up your organization's | Organizational and Customer Empathy |
| guiding or core value, which describes | |
| what you stand for or how you operate, | |
| what would that be in one or a few words? | |
| (Example: Integrity, Customer Empathy, | |
| Organization Grit)? | |
| Why is this value important to the | I feel that empathy is a reflection of who we are fundamentally, as it |
| organization? | requires each of us to intentionally perceive situations from another's |
| | perspective, think about what is important to them, and act in their |
| | best interest. This is fundamental to establishing a relationship built |
| | on trust which will inevitably result in loyal customers, stakeholders, |
| | and team. |
| Now, please define and describe the value | We help organizations realize their goals and ultimately their vision. |
| that this organization brings to its | In doing so, we help build stronger philanthropic ecosystems that |
| community, customers, and stakeholders. | serve the needs of our communities. In essence, we enable their |
| | missions and help achieve the outcomes that they seek. |
| If you could imagine your organization in | In five years time, I envision Value-Driven Strategic Consulting |
| five years from now and everything is | serving thousands of small communities across the nation. I see our |
| working just like you've always wanted it | products changing the entire organizational culture of our clients. |
| to, what does that look like? | Decisions previously made on gut-feel, intuition, and ‘the way its |
| | always been’ are now driven by data, facts and analysis. |
| | Organizations are emboldened to achieve their vision in what |
| | success means to them. We want to play a large part in that |
| | transformation. |
| How will the value that your organization | With a large client base, we will be in a position to provide deeper |
| creates for its community, customers, and | insights, greater positive influence, and expand the breadth of our |
| stakeholders change once you've reached | products and client segments. In summary, we will help enable more |
| your target state? | success stories that yield positive benefits across the nation. |
| What obstacles could prevent your | Change is difficult; it can be challenging for everyone and within |
| organization from achieving that vision of | every company. We also live in tough financial times. My company's |
| success? | success will require partnerships with organizations willing to |
| | change and evolve their practices. Together we will prove the power |
| | and value of these tools and strategies. |
| How will you know when you've | We will know that we've been successful when we're no longer |
| successfully achieved your vision? | simply selling our product's capabilities, but are selling our proven |
| | experience and track record of delivering value for our clients. |
| Can the criteria be for reaching the vision | When we have built a large client base (20,000+ relationships) and |
| be quantified? What metrics (existing or | are generating significant revenues ($25MM+) then we'll know |
| not) could be used to measure your | we've really made it. |
| success? | |

TABLE 31
Example vision agreement between stakeholders

| Vision | Bob | John | Sally | Sue |
|---|---|---|---|---|
| Agreement | Smith | Doe | Wallace | Williams |
| 1 | 10 | 8 | 9 | 4 |

TABLE 32
Example vision difference comparison between stakeholders

| Rater | Comparison | Abs Difference | Weighted Diff |
|---|---|---|---|
| Bob Smith | John Doe | 2 | 1.6 |
| Bob Smith | Sally Wallace | 1 | 0.9 |
| Bob Smith | Sue Williams | 6 | 2.4 |
| John Doe | Sally Wallace | 1 | 0.9 |
| John Doe | Sue Williams | 4 | 2.4 |
| Sally Wallace | Sue Williams | 5 | 2.5 |

TABLE 33
Example weights applied for different absolute
difference values between stakeholders

| ABS Difference | Weight |
|---|---|
| 0 | 1 |
| 1 | 0.9 |
| 2 | 0.8 |
| 3 | 0.7 |
| 4 | 0.6 |
| 5 | 0.5 |
| 6 | 0.4 |
| 7 | 0.3 |
| 8 | 0.2 |
| 9 | 0.1 |
| 10 | 0 |

TABLE 34
Example agreement score of level of agreement between
stakeholders responding during dynamic interviews

| | |
|---|---|
| Sum of Weighted Differences | 10.7 |
| Max Possible Weighted Difference | 2.5 |
| Agreement Score | 0.29 |
| Interpretation | Low Agreement: Significant |
| | variation between raters. |

TABLE 35
Example interpretations of agreement score results

| Agreement | |
|---|---|
| Score Range | Interpretation |
| 0.00 | Very Low or No Agreement: |
| | Almost no consensus among raters. |
| 0.17 | Low Agreement: |
| | Significant variation between raters. |
| 0.33 | Moderate to Low Agreement: |
| | Raters diverge more, but there is still some alignment. |
| 0.50 | Moderate Agreement: |
| | Noticeable differences, but still a general consensus. |
| 0.67 | Moderate to High Agreement: |
| | Minor differences between raters. |
| 0.83 | High Agreement: |
| | Very little disagreement between raters. |

TABLE 36
Example of questions and responses from dynamic interview

| | Figure | | | | |
|---|---|---|---|---|---|
| | Element | | | | |
| ID | # | Module | Data Question | Possible Responses | Logic |
| 52 | 1200 | Dynamic | How will you know when you've | User provided text or | If the user has |
| | | Delivery | successfully achieved your | Prepopulated from | completed the Dynamic |
| | | Phase | vision? | Dynamic Vision Interview | Vision Statement |
| | | Interview | | | Interview, then the |
| | | | | | system will populate the |
| | | | | | answer. Otherwise the |
| | | | | | system will capture the |
| | | | | | users response and save |
| | | | | | it to the database. |
| 53 | 1200 | Dynamic | Can the criteria be for reaching | User provided text or | If the user has |
| | | Delivery | the vision be quantified? What | Prepopulated from | completed the Dynamic |
| | | Phase | metrics (existing or not) could | Dynamic Vision Interview | Vision Statement |
| | | Interview | be used to measure your | | Interview, then the |
| | | | success? | | system will populate the |
| | | | | | answer. Otherwise the |
| | | | | | system will capture the |
| | | | | | users response and save |
| | | | | | it to the database. |
| 54 | 1200 | Dynamic | Please use your answers to the | System provides the ability | System begins to build |
| | | Delivery | questions above and state what | to enter the metric name | table 21 with data from |
| | | Phase | capability or performance must | and the desired | user responses. |
| | | Interview | be reached in order to satisfy the | performance level. | |
| | | | vision's objective. | | |
| 55 | 1200 | Dynamic | In how many years is this | System provides ability for | System continues to |
| | | Delivery | desired level of performance to | user to enter the number of | build table 21 with data |
| | | Phase | be achieved by? | years in which the | from user responses. |
| | | Interview | | performance acheivement is | |
| | | | | desired | |
| 56 | 1200 | Dynamic | For the same metric, what is the | System provides ability for | System continues to |
| | | Delivery | current level of performance | user to enter the baseline | build table 21 with data |
| | | Phase | today? | performance. | from user responses. |
| | | Interview | | | |
| 57 | 1200 | Dynamic | How much has the metric | System provides ability for | System continues to |
| | | Delivery | changed over the past 5 years? | user to answer in either real | build table 21 with data |
| | | Phase | | or percentage based terms. | from user responses. |
| | | Interview | | | |
| 58 | 1200 | Dynamic | Based on the performance | | The system completes |
| | | Delivery | change over the previous 5 | | the calculations in |
| | | Phase | years, the organization has | | tables 21-22, using |
| | | Interview | progressed [##]% to date, | | tables 23-24 for |
| | | | representing a [##]% CAGR. | | classification. |
| | | | Based on the current baseline | | |
| | | | and desired future performance, | | |
| | | | attaining the vision represents a | | |
| | | | [##]% performance change. | | |
| | | | If the organization continues | | |
| | | | with the current CAGR without | | |
| | | | any changes, the goal may be | | |
| | | | achieved in [##] years. | | |
| | | | Given the new performance is | | |
| | | | desired in [##] years, this | | |
| | | | represents a [##]% required | | |
| | | | CAGR. | | |
| | | | Based on these circumstances, | | |
| | | | the organization's goals may be | | |
| | | | described as [Label], meaning | | |
| | | | that [Goal Insight]. | | |
| 59 | 1200 | Dynamic | Do you wish to continue with | System provides user with | Table 21 |
| | | Delivery | the desired level of change or | ability to modify any user- | |
| | | Phase | adjust it? | provided inputs in table 21. | |
| | | Interview | | | |
| 60 | 1200 | Dynamic | In order to acheive the desired | System provides user with a | Table 25 using Table 26 |
| | | Delivery | level of performance, the | blank table that includes | for Classification |
| | | Phase | organization will need to enact | columns for milestone | |
| | | Interview | changes to its current processes, | name, type, size, and year. | |
| | | | technology, or products and | User then populates the | |
| | | | services. Please list several | table with the required | |
| | | | milestones that must be in | information. | |
| | | | achieved in order to for the | | |
| | | | organization to stay on track to | | |
| | | | meet its goals. | | |
| | | | Examples of Milestones may be | | |
| | | | major improvement projects, | | |
| | | | performance changes in other | | |
| | | | areas of the organization, | | |
| | | | introduction of new products or | | |
| | | | services, organizational changes, | | |
| | | | etc. | | |
| | | | Please list the milestones, | | |
| | | | classify them by type, classify | | |
| | | | them by size of effort, and | | |
| | | | assign a year when desired. | | |
| 61 | 1201 | Dynamic | Now that you have input your | If user selects “Manually” | Tables 27-29 and LLM |
| | | Delivery | milestones and required | then the system will | Prompt |
| | | Phase | capability by year, would you | provide a column to align | |
| | | Interview | like to organize these into | the milestones to phases. If | |
| | | | delivery phases or would you | the user selects | |
| | | | prefer for the system to | “Recommend” then the | |
| | | | recommend phases? | system will upload the | |
| | | | | “LLM Prompt for Phases” | |
| | | | | tables and submit with the | |
| | | | | prompt | |
| 62 | 1202 | Dynamic | Please review the recommended | System provides the Phase | Table 30 |
| | | Delivery | Phases with capability and | Milestones with Descriptive | |
| | | Phase | milestones. Would you like to | Labels table | |
| | | Interview | make any adjustments? If so | | |
| | | | please revise the content. | | |

TABLE 37
Example of organization pro forma

| Period | Real Performance |
|---|---|
| 5-Years Prior | 10,000 |
| Current | 25,000 |
| Desired | 100,000 |
| Prior to Current | 150% |
| CAGR | 20% |
| Desired Time to Attain | 5.00 |
| Current to Desired | 300% |
| Desired Performance | 101-300% |
| Range | |
| Required CAGR | 32% |
| Difference in CAGR | 12% |
| Difference in CAGR | +10-25% |
| Range | |
| Expected Time to Attain | Year 8 |
| Goal Label | Aggressive but Achievable |
| Goal Insight | Requires substantial changes |
| | to strategy, process optimization, |
| | and resources to meet the goal. |

TABLE 38
Example of organizational CAGR projections

| CAGR | Baseline | Year 1 | Year 2 | Year 3 | Year 4 | Year 5 | Year 6 | Year 7 | Year 8 | Year 9 | Year 10 |
|---|---|---|---|---|---|---|---|---|---|---|---|
| Current | 25,000 | 30,028 | 36,067 | 43,322 | 52,035 | 62,500 | 75,070 | 90,169 | 108,304 | 130,086 | 156,250 |
| CAGR | | | | | | | | | | | |
| Required | 25,000 | 32,988 | 43,528 | 57,435 | 75,786 | 100,000 | 131,951 | 174,110 | 229,740 | 303,143 | 400,000 |
| CAGR | | | | | | | | | | | |

TABLE 39
Example of milestones along transformation pathway towards a target state

| Milestone | Milestone Type | Milestone Size | Desired Year |
|---|---|---|---|
| Launch New/Initial Product | Product or Service Change | Medium | 2025 |
| Generate $1MM in ARR | Performance Change | Large | 2027 |
| Hire 5 New Employees | People Change | Medium | 2026 |
| Learn Python | People Change | Small | 2025 |
| Implement Cohort Clustering | Technology Change | Small | 2025 |
| Launch Marketing Campaigns | Capability Change | Large | 2025 |
| Secure Investors | Organizational Change | Large | 2026 |
| Hire 10 New Employees | People Change | Medium | 2027 |
| Launch New Product | Product or Service Change | Large | 2025 |
| Launch Product Add-Ons | Product or Service Change | Large | 2027 |
| Generate $10MM ARR | Performance Change | Large | 2029 |
| Speak at Conferences | Capability Change | Small | 2026 |
| Achieve B-Corp Status | Capability Change | Medium | 2027 |

TABLE 40
Example of milestone types
Milestone Type

Product or Service Change
Organizational Change
Process Change
Technology Change
People Change
Capability Change
Performance Change

TABLE 41
Example of metrics for organizational performance evaluation

| Metric or Label | Values |
|---|---|
| Prior Revenue - 2019 | 10,000 |
| Current Revenue - 2024 | 25,000 |
| Desired Revenue - 2029 | 100,000 |
| Performance Change 2019-2024 | 150% |
| CAGR 2019-2024 | 20% |
| Desired Time to Attain in Years | 5.00 |
| Desired Performance Change 2024-2029 | 300% |
| Desired Performance Change Range | 101-300% |
| Required CAGR - 2029 | 32% |
| Difference in CAGR between 2019-2024 | 12% |
| and 2024-2029 | |
| Difference in CAGR (2019-2014 and | +10-25% |
| 2024-2029) | |
| Expected Time to Attain Desired | Year 8 |
| Performance | |
| Goal Label | Aggressive but Achievable |
| Goal Insight | Requires substantial changes |
| | to strategy, process |
| | optimization, and resources |
| | to meet the goal. |

TABLE 42
Examples of financial milestones by year for organization

| Year | Desired Revenue |
|---|---|
| 2024 | 25,000 |
| 2025 | 32,988 |
| 2026 | 43,528 |
| 2027 | 57,435 |
| 2028 | 75,786 |
| 2029 | 100,000 |
| 2030 | 131,951 |
| 2031 | 174,110 |
| 2032 | 229,740 |
| 2033 | 303,143 |
| 2034 | 400,000 |

TABLE 43
Examples of milestones by phase

| Phase Milestones (Ungrouped) | Milestone Type | Milestone Size | Desired Year |
|---|---|---|---|
| Launch New/Initial Product | Product or Service Change | Medium | 2025 |
| Generate $1MM in ARR | Performance Change | Large | 2027 |
| Hire 5 New Employees | People Change | Medium | 2026 |
| Learn Python | People Change | Small | 2025 |
| Implement Cohort Clustering | Technology Change | Small | 2025 |
| Launch Marketing Campaigns | Capability Change | Large | 2025 |
| Secure Investors | Organizational Change | Large | 2026 |
| Hire 10 New Employees | People Change | Medium | 2027 |
| Launch New Product | Product or Service Change | Large | 2025 |
| Launch Product Add-Ons | Product or Service Change | Large | 2027 |
| Generate $10MM ARR | Performance Change | Large | 2029 |
| Speak at Conferences | Capability Change | Small | 2026 |
| Achieve B-Corp Status | Capability Change | Medium | 2027 |

TABLE 44
Examples of phases along transformational path towards target state

| Phase | | Year to | Performance to | |
|---|---|---|---|---|
| Number | Phase Label | Achieve | Achieve | Milestones |
| 1 | Foundation and | 2025 | 39,685 | Launch New/Initial Product(s), Learn Python, |
| | Expansion | | | Launch Marketing Campaigns, Implement |
| | | | | Cohort Clustering |
| 2 | Scaling and | 2027 | 62,996 | Secure Investors, Hire 15 New Employees, |
| | Optimization | | | Launch Product Add-Ons, Speak at |
| | | | | Conferences |
| 3 | Sustainability and | 2029 | 100,000 | Generate $10MM ARR, Achieve B-Corp |
| | Leadership | | | Status |

TABLE 45
Examples of questions and possible answers from dynamic interviews

| | Patent | | | | |
|---|---|---|---|---|---|
| | Figure | | | | |
| ID | # | Module | Data Question | Possible Responses | Logic |
| 64 | 1301 | Dynamic | N/A | System submits | Phase Goal LLM Prompt |
| | | Delivery | | structured prompt | |
| | | Phase Goal | | requesting goal | |
| | | Interview | | generation. | |
| 65 | 1302 | Dynamic | Based on the information | System returns goals | LLM Response |
| | | Delivery | provided during earlier | generated by LLM in a | |
| | | Phase Goal | portions of this interview, we | tabular format | |
| | | Interview | have created a series of goals | | |
| | | | for your review by each | | |
| | | | defined Delivery Phase. | | |
| 66 | 1303 | Dynamic | How well do the newly | System presents a | Likert Scale for Phase |
| | | Delivery | defined goal statements | Likert Scale with | Delivery Goals |
| | | Phase Goal | encapsulate the iterative | ability to rate each | |
| | | Interview | change required to achieve the | customer segment on | |
| | | | organization's vision for the | 0-10 scale | |
| | | | future? Use the scale below to | | |
| | | | indicate how well or how | | |
| | | | poorly the goals align to your | | |
| | | | vision. | | |
| 67 | 1305 | Dynamic | Have all raters submitted their | Yes/No | After selecting “Yes”, the |
| | | Delivery | scores? | | system will calculate the |
| | | Phase Goal | | | Mean Absolute Difference |
| | | Interview | | | (MAD) comparison statistic |
| 68 | 1307 | Dynamic | Please revise the goals, as | System provides user | |
| | | Delivery | needed, and certify their | with ability to certify | |
| | | Phase Goal | completion. | the phases | |
| | | Interview | | | |
| 69 | 1308 | Dynamic | Now please prioritizde the | System provides the | For voting as a group - ‘Goal |
| | | Delivery | goals against one another by | user with access to the | Prioritization - Group’ |
| | | Phase Goal | phase using the pair-wise | pairwise voting tools | For rating as a single user - |
| | | Interview | comparison tool. There are | with ability to rate each | ‘Goal Prioritization - Single’ |
| | | | seperate tools available for | goal in respect to other | |
| | | | voting as a group vs rating as a | goals within the same | |
| | | | single individual. | phase. | |
| 70 | 1310 | Dynamic | Have all raters submitted their | Yes/No | If the user selects “No” then |
| | | Delivery | priorities? | | the system will wait to |
| | | Phase Goal | | | process the data. |
| | | Interview | | | |
| 71 | 1311 | Dynamic | NA | System Compiles and | After selecting “Yes”, the |
| | | Delivery | | Synthesizes | system will calculate the |
| | | Phase Goal | | Prioritization Data | Kendall's W score for |
| | | Interview | | Collected from | aggregate aggrement between |
| | | | | Multiple Users | raters and the Mean Absolute |
| | | | | | Difference (MAD) |
| | | | | | comparison statistic for |
| | | | | | agreement between raters by |
| | | | | | goal. |
| | | | | | The System will then create |
| | | | | | the Heatmap of Ratings vs |
| | | | | | Rater and Goal and the |
| | | | | | normal distribution plot of the |
| | | | | | Kendall's W with the |
| | | | | | organization's score (Red) |
| | | | | | and mean (Black) |
| 72 | 1312 | Dynamic | Please review the analysis of | System provides ability | |
| | | Delivery | rater agreement and then make | for user to update the | |
| | | Phase Goal | any adjustments to the goal | goal weights in a | |
| | | Interview | weights. | tabular form. | |

TABLE 46
Examples of performance thresholds associated with milestones

| Phase | | Year to | Performance to | |
|---|---|---|---|---|
| Number | Phase Label | Achieve | Achieve | Milestones |
| 1 | Foundation and | 2025 | 39,685 | Launch New/Initial Products, Learn Python, |
| | Expansion | | | Launch Marketing Campaigns, Implement |
| | | | | Cohort Clustering |
| 2 | Scaling and | 2027 | 62,996 | Secure Investors, Hire 15 New Employees, |
| | Optimization | | | Launch New Product, Launch Product Add- |
| | | | | Ons, Speak at Conferences |
| 3 | Sustainability and | 2029 | 100,000 | Generate $10MM ARR, Achieve B-Corp Status |
| | Leadership | | | |

TABLE 47
Examples of goals/tasks by phase

| Phase | | |
|---|---|---|
| Number | Phase Label | SMART Goals |
| 1 | Foundation and | 1. Launch New/Initial Product by Q4 2025 to provide initial data-driven |
| | Expansion | solutions to clients. |
| | | 2. Launch New/Initial Product by Q3 2025 to establish the foundational |
| | | product suite. |
| | | 3. Complete team-wide Python training by Q2 2025 to enhance technical skills |
| | | and capabilities for implementing advanced analytics and automation. |
| | | 4. Develop and deploy at least three targeted marketing campaigns by Q4 2025 |
| | | to increase brand awareness and secure 50 new client engagements. |
| | | 5. Implement cohort clustering for 80% of client organizations by Q4 2025 to |
| | | refine data segmentation and provide actionable insights. |
| 2 | Scaling and | 1. Secure $5M in investor funding by Q4 2027 to support scaling operations |
| | Optimization | and product development. |
| | | 2. Recruit and onboard 15 new employees by Q4 2027 to expand operational |
| | | capacity and ensure client success. |
| | | 3. Launch at least three Product add-ons (e.g., Product Analytics, Product |
| | | Grants Manager) by Q3 2027 to diversify revenue streams and enhance |
| | | product offerings. |
| | | 4. Present at a minimum of five industry conferences by Q4 2027 to establish |
| | | thought leadership and attract new clients. |
| 3 | Sustainability and | 1. Achieve $10MM in Annual Recurring Revenue (ARR) by Q4 2029 to |
| | Leadership | ensure financial sustainability and solidify market presence. |
| | | 2. Attain B-Corp certification by Q4 2029 to demonstrate commitment to |
| | | social and environmental performance, accountability, and transparency. |
| | | 3. Expand the client base to 2,000 organizations by Q4 2029, ensuring broader |
| | | impact across communities nationwide. |
| | | 4. Establish an in-house innovation lab by Q3 2029 to continuously develop |
| | | and test new solutions aligned with client needs. |

TABLE 48
Examples of a dynamic interview response framework

| | | | 1 | 2 | 3 | 4 | 5 | |
|---|---|---|---|---|---|---|---|---|
| | | | A is | A is | A & B | A is | A is | |
| | | | Much | Somewhat | are | Somewhat | Much | |
| Which is more important? | | | More | More | About | Less | Less | |
| By how much? | | | Important | Important | the | Important | Important | Average |
| # | A = Row | B = Column | than B | than B | Same | than B | than B | Rating |

| | | | | | | | |
|---|---|---|---|---|---|---|---|
| 1 | 1. Launch | 2. Launch | | | 1 | | Row |
| | New/Initial | New/Initial | | | | | somewhat |
| | Product(s) by Q4 | Product(s) by Q3 | | | | | less |
| | 2025 to provide | 2025 to establish | | | | | important |
| | initial data-driven | the foundational | | | | | than |
| | solutions to | product suite. | | | | | column |
| | clients. | | | | | | |
| 2 | 1. Launch | 3. Complete team- | | | | 1 | Row much |
| | New/Initial | wide Python | | | | | less |
| | Product(s) by Q4 | training by Q2 | | | | | important |
| | 2025 to provide | 2025 to enhance | | | | | than |
| | initial data-driven | technical skills | | | | | column |
| | solutions to | and capabilities | | | | | |
| | clients. | for implementing | | | | | |
| | | advanced | | | | | |
| | | analytics and | | | | | |
| | | automation. | | | | | |
| 3 | 1. Launch | 4. Develop and | | | 1 | | Row |
| | New/Initial | deploy at least | | | | | somewhat |
| | Product(s) by Q4 | three targeted | | | | | less |
| | 2025 to provide | marketing | | | | | important |
| | initial data-driven | campaigns by Q4 | | | | | than |
| | solutions to | 2025 to increase | | | | | column |
| | clients. | brand awareness | | | | | |
| | | and secure 50 | | | | | |
| | | new client | | | | | |
| | | engagements. | | | | | |
| 4 | 1. Launch | 5. Implement | | | 1 | | Row |
| | New/Initial | cohort clustering | | | | | somewhat |
| | Product(s) by Q4 | for 80% of client | | | | | less |
| | 2025 to provide | organizations by | | | | | important |
| | initial data-driven | Q4 2025 to refine | | | | | than |
| | solutions to | data segmentation | | | | | column |
| | clients. | and provide | | | | | |
| | | actionable | | | | | |
| | | insights. | | | | | |
| 5 | 2. Launch | 3. Complete team- | | | | 1 | Row much |
| | New/Initial | wide Python | | | | | less |
| | Product(s) by Q3 | training by Q2 | | | | | important |
| | 2025 to establish | 2025 to enhance | | | | | than |
| | the foundational | technical skills | | | | | column |
| | product suite. | and capabilities | | | | | |
| | | for implementing | | | | | |
| | | advanced | | | | | |
| | | analytics and | | | | | |
| | | automation. | | | | | |
| 6 | 2. Launch | 4. Develop and | | | | 1 | Row much |
| | New/Initial | deploy at least | | | | | less |
| | Product(s) by Q3 | three targeted | | | | | important |
| | 2025 to establish | marketing | | | | | than |
| | the foundational | campaigns by Q4 | | | | | column |
| | product suite. | 2025 to increase | | | | | |
| | | brand awareness | | | | | |
| | | and secure 50 | | | | | |
| | | new client | | | | | |
| | | engagements. | | | | | |
| 7 | 2. Launch | 5. Implement | | 1 | | | Row |
| | New/Initial | cohort clustering | | | | | somewhat |
| | Product(s) by Q3 | for 80% of client | | | | | more |
| | 2025 to establish | organizations by | | | | | important |
| | the foundational | Q4 2025 to refine | | | | | than |
| | product suite. | data segmentation | | | | | column |
| | | and provide | | | | | |
| | | actionable | | | | | |
| | | insights. | | | | | |
| 8 | 3. Complete team- | 4. Develop and | | 1 | | | Row |
| | wide Python | deploy at least | | | | | somewhat |
| | training by Q2 | three targeted | | | | | more |
| | 2025 to enhance | marketing | | | | | important |
| | technical skills | campaigns by Q4 | | | | | than |
| | and capabilities | 2025 to increase | | | | | column |
| | for implementing | brand awareness | | | | | |
| | advanced | and secure 50 | | | | | |
| | analytics and | new client | | | | | |
| | automation. | engagements. | | | | | |
| 9 | 3. Complete team- | 5. Implement | 1 | | | | Row much |
| | wide Python | cohort clustering | | | | | more |
| | training by Q2 | for 80% of client | | | | | important |
| | 2025 to enhance | organizations by | | | | | than |
| | technical skills | Q4 2025 to refine | | | | | column |
| | and capabilities | data segmentation | | | | | |
| | for implementing | and provide | | | | | |
| | advanced | actionable | | | | | |
| | analytics and | insights. | | | | | |
| | automation. | | | | | | |
| 10 | 4. Develop and | 5. Implement | | | 1 | | Row |
| | deploy at least | cohort clustering | | | | | somewhat |
| | three targeted | for 80% of client | | | | | less |
| | marketing | organizations by | | | | | important |
| | campaigns by Q4 | Q4 2025 to refine | | | | | than |
| | 2025 to increase | data segmentation | | | | | column |
| | brand awareness | and provide | | | | | |
| | and secure 50 new | actionable | | | | | |
| | client | insights. | | | | | |
| | engagements. | | | | | | |

TABLE 49
Example of a weighted response ranking of project/task priorities for
a particular stakeholder based on responses during dynamic interview

| | Ordinal | Percent | Percent |
|---|---|---|---|
| Bob Smith | Rank | Rank | Weight |
| 1. Launch New/Initial Product(s) by Q4 2025 to provide initial data-driven | 2 | 50 | 22.2% |
| solutions to clients. | | | |
| 2. Launch New/Initial Product(s) by Q3 2025 to establish the foundational | 1 | 100 | 44.4% |
| product suite. | | | |
| 3. Complete team-wide Python training by Q2 2025 to enhance technical | 5 | 0 | 0.0% |
| skills and capabilities for implementing advanced analytics and automation. | | | |
| 4. Develop and deploy at least three targeted marketing campaigns by Q4 | 4 | 25 | 11.1% |
| 2025 to increase brand awareness and secure 50 new client engagements. | | | |
| 5. Implement cohort clustering for 80% of client organizations by Q4 2025 to | 2 | 50 | 22.2% |
| refine data segmentation and provide actionable insights. | | | |

TABLE 50
Example of comparative results from multiple responding
stakeholders during dynamic stakeholder interviews

| | | | 1 | 2 | 3 | 4 | 5 | |
|---|---|---|---|---|---|---|---|---|
| | | | A is | A is | A & B | A is | A is | |
| | | | Much | Somewhat | are | Somewhat | Much | |
| Which is more important? | | | More | More | About | Less | Less | |
| By how much? | | | Important | Important | the | Important | Important | Average |
| # | A = Row | B = Column | than B | than B | Same | than B | than B | Rating |
| 1 | 1. Launch | 2. Launch | | 3 | 1 | | | Row same |
| | New/Initial | New/Initial | | | | | | importance |
| | Product(s) by Q4 | Product(s) by Q3 | | | | | | as column |
| | 2025 to provide | 2025 to establish | | | | | | |
| | initial data-driven | the foundational | | | | | | |
| | solutions to | product suite. | | | | | | |
| | clients. | | | | | | | |
| 2 | 1. Launch | 3. Complete | 4 | | | | | Row much |
| | New/Initial | team-wide Python | | | | | | more |
| | Product(s) by Q4 | training by Q2 | | | | | | important |
| | 2025 to provide | 2025 to enhance | | | | | | than |
| | initial data-driven | technical skills | | | | | | column |
| | solutions to | and capabilities | | | | | | |
| | clients. | for implementing | | | | | | |
| | | advanced | | | | | | |
| | | analytics and | | | | | | |
| | | automation. | | | | | | |
| 3 | 1. Launch | 4. Develop and | | 4 | | | | Row |
| | New/Initial | deploy at least | | | | | | somewhat |
| | Product(s) by Q4 | three targeted | | | | | | more |
| | 2025 to provide | marketing | | | | | | important |
| | initial data-driven | campaigns by Q4 | | | | | | than |
| | solutions to | 2025 to increase | | | | | | column |
| | clients. | brand awareness | | | | | | |
| | | and secure 50 | | | | | | |
| | | new client | | | | | | |
| | | engagements. | | | | | | |
| 4 | 1. Launch | 5. Implement | | 3 | 1 | | | Row same |
| | New/Initial | cohort clustering | | | | | | importance |
| | Product(s) by Q4 | for 80% of client | | | | | | as column |
| | 2025 to provide | organizations by | | | | | | |
| | initial data-driven | Q4 2025 to refine | | | | | | |
| | solutions to | data segmentation | | | | | | |
| | clients. | and provide | | | | | | |
| | | actionable | | | | | | |
| | | insights. | | | | | | |
| 5 | 2. Launch | 3. Complete | 4 | | | | | Row much |
| | New/Initial | team-wide Python | | | | | | more |
| | Product(s) by Q3 | training by Q2 | | | | | | important |
| | 2025 to establish | 2025 to enhance | | | | | | than |
| | the foundational | technical skills | | | | | | column |
| | product suite. | and capabilities | | | | | | |
| | | for implementing | | | | | | |
| | | advanced | | | | | | |
| | | analytics and | | | | | | |
| | | automation. | | | | | | |
| 6 | 2. Launch | 4. Develop and | 4 | | | | | Row much |
| | New/Initial | deploy at least | | | | | | more |
| | Product(s) by Q3 | three targeted | | | | | | important |
| | 2025 to establish | marketing | | | | | | than |
| | the foundational | campaigns by Q4 | | | | | | column |
| | product suite. | 2025 to increase | | | | | | |
| | | brand awareness | | | | | | |
| | | and secure 50 | | | | | | |
| | | new client | | | | | | |
| | | engagements. | | | | | | |
| 7 | 2. Launch | 5. Implement | | 2 | | 2 | | Row |
| | New/Initial | cohort clustering | | | | | | somewhat |
| | Product(s) by Q3 | for 80% of client | | | | | | less |
| | 2025 to establish | organizations by | | | | | | important |
| | the foundational | Q4 2025 to refine | | | | | | than |
| | product suite. | data segmentation | | | | | | column |
| | | and provide | | | | | | |
| | | actionable | | | | | | |
| | | insights. | | | | | | |
| 8 | 3. Complete | 4. Develop and | | | | 3 | 1 | Row much |
| | team-wide Python | deploy at least | | | | | | less |
| | training by Q2 | three targeted | | | | | | important |
| | 2025 to enhance | marketing | | | | | | than |
| | technical skills | campaigns by Q4 | | | | | | column |
| | and capabilities | 2025 to increase | | | | | | |
| | for implementing | brand awareness | | | | | | |
| | advanced | and secure 50 | | | | | | |
| | analytics and | new client | | | | | | |
| | automation. | engagements. | | | | | | |
| 9 | 3. Complete | 5. Implement | | | | | 4 | Row much |
| | team-wide Python | cohort clustering | | | | | | less |
| | training by Q2 | for 80% of client | | | | | | important |
| | 2025 to enhance | organizations by | | | | | | than |
| | technical skills | Q4 2025 to refine | | | | | | column |
| | and capabilities | data segmentation | | | | | | |
| | for implementing | and provide | | | | | | |
| | advanced | actionable | | | | | | |
| | analytics and | insights. | | | | | | |
| | automation. | | | | | | | |
| 10 | 4. Develop and | 5. Implement | | 1 | 3 | | | Row same |
| | deploy at least | cohort clustering | | | | | | importance |
| | three targeted | for 80% of client | | | | | | as column |
| | marketing | organizations by | | | | | | |
| | campaigns by Q4 | Q4 2025 to refine | | | | | | |
| | 2025 to increase | data segmentation | | | | | | |
| | brand awareness | and provide | | | | | | |
| | and secure 50 | actionable | | | | | | |
| | new client | insights. | | | | | | |
| | engagements. | | | | | | | |

TABLE 51
Examples of weighted response ranking of project/task priorities for multiple
stakeholders based on their responses during dynamic interviews

| | Ordinal | Percent | Percent |
|---|---|---|---|
| | Rank | Rank | Weight |
| 1. Launch New/Initial Product(s) by Q4 2025 to provide initial data-driven | 2 | 50 | 22.2% |
| solutions to clients. | | | |
| 2. Launch New/Initial Product(s) by Q3 2025 to establish the foundational | 1 | 100 | 44.4% |
| product suite. | | | |
| 3. Complete team-wide Python training by Q2 2025 to enhance technical | 5 | 0 | 0.0% |
| skills and capabilities for implementing advanced analytics and automation. | | | |
| 4. Develop and deploy at least three targeted marketing campaigns by Q4 | 4 | 25 | 11.1% |
| 2025 to increase brand awareness and secure 50 new client engagements. | | | |
| 5. Implement cohort clustering for 80% of client organizations by Q4 2025 to | 2 | 50 | 22.2% |
| refine data segmentation and provide actionable insights. | | | |

TABLE 52
Example of organizational goals based on multiple stakeholder responses to dynamic interviews

| | | | | | | Bob | John | Sally | Sue | | | |
|---|---|---|---|---|---|---|---|---|---|---|---|---|
| | Bob | John | Sally | Sue | Mean | Smith - | Doe - | Wallace - | Williams - | MAD | Rank | Squared |
| Goals | Smith | Doe | Wallace | Williams | Rank | AD | AD | AD | AD | Score | Sum | Deviations |
| 1. Launch | 3 | 2 | 4 | 1 | 2.5 | 0.5 | 0.5 | 1.5 | 1.5 | 1 | 10 | 2.56 |
| New/Initial | | | | | | | | | | | | |
| Product(s) | | | | | | | | | | | | |
| by Q4 2025 | | | | | | | | | | | | |
| to provide | | | | | | | | | | | | |
| initial data- | | | | | | | | | | | | |
| driven | | | | | | | | | | | | |
| solutions to | | | | | | | | | | | | |
| clients. | | | | | | | | | | | | |
| 2. Launch | 1 | 4 | 3 | 2 | 2.5 | 1.5 | 1.5 | 0.5 | 0.5 | 1 | 10 | 2.56 |
| New/Initial | | | | | | | | | | | | |
| Product(s) | | | | | | | | | | | | |
| by Q3 2025 | | | | | | | | | | | | |
| to establish | | | | | | | | | | | | |
| the | | | | | | | | | | | | |
| foundational | | | | | | | | | | | | |
| product | | | | | | | | | | | | |
| suite. | | | | | | | | | | | | |
| 3. Complete | 5 | 1 | 1 | 5 | 3 | 2 | 2 | 2 | 2 | 2 | 12 | 0.16 |
| team-wide | | | | | | | | | | | | |
| Python | | | | | | | | | | | | |
| training by | | | | | | | | | | | | |
| Q2 2025 to | | | | | | | | | | | | |
| enhance | | | | | | | | | | | | |
| technical | | | | | | | | | | | | |
| skills and | | | | | | | | | | | | |
| capabilities | | | | | | | | | | | | |
| for | | | | | | | | | | | | |
| implementing | | | | | | | | | | | | |
| advanced | | | | | | | | | | | | |
| analytics | | | | | | | | | | | | |
| and | | | | | | | | | | | | |
| automation. | | | | | | | | | | | | |
| 4. Develop | 1 | 5 | 5 | 3 | 3.5 | 2.5 | 1.5 | 1.5 | 0.5 | 1.5 | 14 | 5.76 |
| and deploy | | | | | | | | | | | | |
| at least three | | | | | | | | | | | | |
| targeted | | | | | | | | | | | | |
| marketing | | | | | | | | | | | | |
| campaigns | | | | | | | | | | | | |
| by Q4 2025 | | | | | | | | | | | | |
| to increase | | | | | | | | | | | | |
| brand | | | | | | | | | | | | |
| awareness | | | | | | | | | | | | |
| and secure | | | | | | | | | | | | |
| 50 new | | | | | | | | | | | | |
| client | | | | | | | | | | | | |
| engagements. | | | | | | | | | | | | |
| 5. | 4 | 2 | 2 | 4 | 3 | 1 | 1 | 1 | 1 | 1 | 12 | 0.16 |
| Implement | | | | | | | | | | | | |
| cohort | | | | | | | | | | | | |
| clustering | | | | | | | | | | | | |
| for 80% of | | | | | | | | | | | | |
| client | | | | | | | | | | | | |
| organizations | | | | | | | | | | | | |
| by Q4 | | | | | | | | | | | | |
| 2025 to | | | | | | | | | | | | |
| refine data | | | | | | | | | | | | |
| segmentation | | | | | | | | | | | | |
| and | | | | | | | | | | | | |
| provide | | | | | | | | | | | | |
| actionable | | | | | | | | | | | | |
| insights. | | | | | | | | | | | | |

TABLE 53
Examples of agreement score (e.g., Kendall's W Score) categories

| Agreement Score Range | Category |
|---|---|
| 0 | Perfect Agreement |
| 0.1 | High Agreement |
| 1.1 | Moderate Agreement |
| 2.1 | Low Agreement |
| 3.1 | Very Low Agreement |

TABLE 54
Alternative examples of agreement score
(e.g., Kendall's W Score) categories

| Agreement Score Range | Category |
|---|---|
| 0 | Very Low Agreement |
| 0.1 | Low Agreement |
| 0.3 | Moderate Agreement |
| 0.5 | High Agreement |
| 0.7 | Very High Agreement |

TABLE 55
Examples of MAD score and weights for stakeholder-defined goals

| | | | | User |
|---|---|---|---|---|
| | MAD | | | Defined |
| Goal | Score | Interpretation | Weight | Weights |
| 1. Launch New/Initial Product(s) by Q4 2025 to provide | 1 | High Agreement | 22.2% | 20% |
| initial data-driven solutions to clients. | | | | |
| 2. Launch New/Initial Product(s) by Q3 2025 to establish the | 1 | High Agreement | 44.4% | 40% |
| foundational product suite. | | | | |
| 3. Complete team-wide Python training by Q2 2025 to | 2 | Moderate | 0.0% | 10% |
| enhance technical skills and capabilities for implementing | | Agreement | | |
| advanced analytics and automation. | | | | |
| 4. Develop and deploy at least three targeted marketing | 1.5 | Moderate | 11.1% | 10% |
| campaigns by Q4 2025 to increase brand awareness and | | Agreement | | |
| secure 50 new client engagements. | | | | |
| 5. Implement cohort clustering for 80% of client | 1 | High Agreement | 22.2% | 20% |
| organizations by Q4 2025 to refine data segmentation and | | | | |
| provide actionable insights. | | | | |

TABLE 56
Examples of goal rankings by different stakeholders

| | Bob | John | Sally | Sue |
|---|---|---|---|---|
| Goals | Smith | Doe | Wallace | Williams |
| 1. Launch New/Initial Product(s) by Q4 2025 to provide initial data- | 3 | 2 | 4 | 1 |
| driven solutions to clients. | | | | |
| 2. Launch New/Initial Product(s) by Q3 2025 to establish the | 1 | 4 | 3 | 2 |
| foundational product suite. | | | | |
| 3. Complete team-wide Python training by Q2 2025 to enhance | 5 | 1 | 1 | 5 |
| technical skills and capabilities for implementing advanced analytics | | | | |
| and automation. | | | | |
| 4. Develop and deploy at least three targeted marketing campaigns by | 1 | 5 | 5 | 3 |
| Q4 2025 to increase brand awareness and secure 50 new client | | | | |
| engagements. | | | | |
| 5. Implement cohort clustering for 80% of client organizations by Q4 | 4 | 2 | 2 | 4 |
| 2025 to refine data segmentation and provide actionable insights. | | | | |

TABLE 57
Examples of different questions and responses during dynamic interviews

| | FIG. | | | | |
|---|---|---|---|---|---|
| | Element | | | | |
| ID | # | Module | Data Question | Possible Responses | Logic |
| 73 | 1400 | Delivery | Now that your goals for | System Recommend or | |
| | | Phase | each phase are defined and | User Defined | |
| | | Success | prioritized, we need to | | |
| | | Metric | determine how to measure | | |
| | | Definition | progress and success. | | |
| | | | System can either suggest | | |
| | | | metric definitions or you | | |
| | | | may determine your own. | | |
| | | | Which do you prefer? | | |
| 74 | 1400 | Delivery | NA | NA | If the User selects “System |
| | | Phase | | | Recommend” then the system |
| | | Success | | | will gather the related data |
| | | Metric | | | (Tables 36-38) and produce a |
| | | Definition | | | prompt for LLM to suggest |
| | | | | | goals (Table 39) with an |
| | | | | | attached PDF of the tables. |
| 75 | 1400 | Delivery | Please review the suggested | System provides access to a | Table 40 |
| | | Phase | Phase Goal Success Metrics | table of suggested metrics | |
| | | Success | and select, edit or add the | by goal with the ability for | |
| | | Metric | metrics that the organization | the user to select between | |
| | | Definition | would like to utilize in | them, assign a weight, and | |
| | | | measuring their goals. Then | define a cadence for | |
| | | | manually weight the success | updates. | |
| | | | metrics within each goal. | | |
| 76 | 1400 | Delivery | NA | If the User selects “User | Table 40 |
| | | Phase | | Defined” the system shall | |
| | | Success | | provide access to a table | |
| | | Metric | | containing the defined | |
| | | Definition | | goals by phase and ability | |
| | | | | for the user to add and | |
| | | | | weight success metrics | |
| | | | | associated to the goal and | |
| | | | | define a cadence for | |
| | | | | updates. | |
| 77 | 1401 | Delivery | Is the data for this metric | Data Source or Manually | |
| | | Phase | associated with an online, | Entered | |
| | | Success | queriable data source or will | | |
| | | Metric | users manually enter the | | |
| | | Definition | data on a cadence? | | |
| 78 | 409 | Data Source | Please complete this form | User completes form | If the user seleccts “Data |
| | | Definition | for each metric that is | | Source” the system will |
| | | | in-scope for measurement. | | present a form (1: each |
| | | | | | metric) for the user to |
| | | | | | complete that defines the |
| | | | | | data source, data connection, |
| | | | | | schema, table, and logic |
| | | | | | for aggregating the data. |
| | | | | | Data Connection Form |
| 79 | 1500 | Data Source | NA | NA | Based on the user inputs the |
| | | Definition | | | system will construct a |
| | | | | | connection string and query |
| | | | | | the data source. |
| | | | | | Data Connection String |
| 80 | 1501 | Data Source | The connection was | User makes changes | If the connection is |
| | | Definition | unsuccessful, please update | | unsuccessful, the system |
| | | | the data connection string | | will prompt the user to |
| | | | manually or correct the | | troubleshoot the connection |
| | | | fields in the form. | | error(s). |
| 81 | 1503 | Data Source | NA | NA | If the connection is |
| | | Definition | | | successful, the system will |
| | | | | | display the current, |
| | | | | | forecasted, and difference |
| | | | | | in performance. Table 43 |
| 82 | 1502 | Data Source | Please complete this form | System provides access to a | Table 43 |
| | | Definition | for each metric that is | table containing the Goal | |
| | | | in-scope for measurement. | information and Success | |
| | | | | Metric information with | |
| | | | | ability to enter measurement | |
| | | | | period start/end and metric | |
| | | | | value for the period. | |
| 83 | 1503 | Data Source | NA | NA | Once complete, the system |
| | | Definition | | | will display the current, |
| | | | | | forecasted, and difference |
| | | | | | in performance by period of |
| | | | | | the selected metric. Table 43 |

TABLE 58
Examples of success metrics, weightings, and update periodicity for different organizational goals

| | | | Success Metric | |
|---|---|---|---|---|
| | | User | Weight within | Cadence for |
| Goal | Recommended Success Metrics | Selected | Goal | Data Updates |
| 1. Launch New/Initial | Product Launch Date: Successfully launch | x | 50% | Weekly |
| Product(s) by Q4 2025 | New/Initial Product(s) by the end of Q4 2025. | | | |
| | Client Onboarding: Secure 10 pilot client | | | |
| | organizations using New/Initial Product(s) | | | |
| | within the first 6 months. | | | |
| | Initial Product Satisfaction: Achieve a user | | | |
| | satisfaction score ≥80% (via post-launch | | | |
| | survey). | | | |
| | Feature Completion: Ensure all core features | x | 50% | One Time |
| | are operational at launch (e.g., analytics, | | | |
| | user navigation). | | | |
| 2. Launch New/Initial | Product Readiness: Complete New/Initial | x | 33% | Weekly |
| Product(s) by Q3 2025 | Product(s) MVP development by Q3 2025. | | | |
| | Client Conversion: Onboard 25 | x | 33% | Montly |
| | organizations using New/Initial Product(s) | | | |
| | within 6 months of launch. | | | |
| | Feature Stability: System performance | x | 33% | Weekly After |
| | achieves 95%+ uptime post-launch. | | | Launch |
| 3. Complete team- | Skill Certification: 100% of designated team | x | 100% | Monthly |
| wide Python training | members complete Python certification or | | | |
| | equivalent proficiency training. | | | |
| | Project Application: Apply Python to at | | | |
| | least two internal projects (e.g., | | | |
| | analytics automation, reporting). | | | |
| 4. Develop and deploy | Campaign Deployment: Successfully deploy | x | 50% | Weekly |
| three marketing | 3 targeted campaigns by Q4 2025. | | | |
| campaigns | Lead Generation: Generate 150+ new leads and | | | |
| | convert at least 10% into client contracts. | | | |
| | Brand Awareness: Increase website traffic | x | 25% | Monthly |
| | by 20% and social media engagement by 25%. | | | |
| | Campaign ROI: Achieve a positive return on | x | 25% | Monthly |
| | investment (ROI) ≥150% for at least 2 of | | | |
| | the 3 campaigns. | | | |
| 5. Implement cohort | Cohort Implementation: Implement cohort | x | 50% | One Time |
| clustering | clustering for 80% of client organizations | | | |
| | by Q4 2025. | | | |
| | Client Insights: Achieve a 30% improvement | | | |
| | in actionable insights delivered to clients | | | |
| | through clustering. | | | |
| | Client Engagement: Ensure 90% of | x | 50% | Monthly |
| | organizations using clustering actively | | | |
| | engage with the insights monthly. | | | |

TABLE 59
Examples of different goal performance targets for an example organizational goal

| | | | | | | Mea- | Mea- | | | Forecasted | |
|---|---|---|---|---|---|---|---|---|---|---|---|
| Goal | Goal | Metric | | Goal | | surement | surement | Metric | % to | % to | Perfor- |
| Name | Weight | Name | Definition | Weight | Cadence | Start | End | Value | Target | Target | mance |
| 2. | 40% | Client | Onboard | 33% | Monthly | Dec. 29, 2024 | Feb. 1, 2025 | 1 | 4% | 17% | −13% |
| Launch | | Conversion | 25 | | | Jan. 28, 2025 | Mar. 3, 2025 | 5 | 20% | 33% | −13% |
| New/ | | | organizations | | | Feb. 28, 2025 | Apr. 3, 2025 | 15 | 60% | 50% | 10% |
| Initial | | | using New/ | | | Mar. 30, 2025 | May 3, 2025 | 15 | 60% | 67% | −7% |
| Product (s) | | | Initial | | | Apr. 30, 2025 | Jun. 3, 2025 | 15 | 60% | 83% | −23% |
| by Q3 | | | Product(s) | | | May 30, 2025 | Jul. 3, 2025 | 20 | 80% | 100% | −20% |
| 2025 | | | within 6 | | | Jun. 30, 2025 | Aug. 3, 2025 | 21 | 84% | 100% | −16% |
| | | | months of | | | Jul. 30, 2025 | Sep. 2, 2025 | 25 | 100% | 100% | 0% |
| | | | launch. | | | | | | | | |

TABLE 60
Examples of questions and responses provided during dynamic interview

| | FIG. | | | | |
|---|---|---|---|---|---|
| | Element | | | | |
| ID | # | Module | Data Question | Possible Responses | Logic |
| 84 | 1601 | Project | Now that we have identified our | User begins to | |
| | | Definition | goals and success metrics, we now | document project | |
| | | | need to identify projects or actions | ideas with a | |
| | | | that will improve performance | title, brief | |
| | | | toward meeting the goal. Please | description, and | |
| | | | review the Ishikawa training material | alignment to the | |
| | | | and then begin to document projects | Ishikawa model. | |
| | | | based on each Ishikawa category. | | |
| 85 | 1602 | Project | Now that you have identified your | System provides | Project Group |
| | | Definition | current list of projects, we will begin | ability for user to | Prioritization, |
| | | | to prioritize them against one | access and utilize | Project Single |
| | | | another. Please complete the criteria | the tools. | Prioritization |
| | | | prioritization first (either as a single | | Project Evaluation, |
| | | | user or as through group voting) and | | Project Assessment |
| | | | then prioritize the projects using the | | |
| | | | Project Evaluation tool. Review your | | |
| | | | assessments in the Project | | |
| | | | Assessment tool. | | |
| 86 | 1604 | Project | Please select which projects are | System ranks the | Project Assessment |
| | | Definition | in-scope for execution and | projects according to | Survey Response |
| | | | crowdsourcing desirability | the prioritization | Data, Survey |
| | | | | criteria and responses. | Response Analysis |
| | | | | User selects a subset | Prep, Survey |
| | | | | of projects to execute | Analysis, Survey |
| | | | | and seek feedback on | Results |
| | | | | the ‘desirability’ of | Visualization |
| | | | | the project from the | |
| | | | | organization's | |
| | | | | customers or | |
| | | | | stakeholders. | |
| | | | | System sends survey | |
| | | | | to selected users. | |
| | | | | System analyzes the | |
| | | | | responses and presents | |
| | | | | visualized results | |
| 87 | 412 | Project Goal | | | Follows same |
| | | and Success | | | process as Phase |
| | | Metrics | | | Success Metrics |
| 88 | 1700 | Project Goal | Now that you have defined goals and | System provides the | Project Goals |
| | | and Success | success metrics for each project, we | ability for the user to | |
| | | Metrics | now need to align these to the Phase | select phase goals and | |
| | | | Goals and Success Metrics. Select | phase success metrics | |
| | | | the Phase Goal that the project aligns | that are aligned to | |
| | | | to and then select which Phase | individual projects and | |
| | | | Success Metric aligns with the | their success metrics. | |
| | | | project's Success Metrics. If the | | |
| | | | metric does not support the goals of | | |
| | | | the phase, then select “No Alignment”. | | |
| 89 | 1701 | Project Goal | After you have aligned the metrics, | System provides the | Project Goals |
| | | and Success | please classify the Project Success | ability for the user to | |
| | | Metrics | Metrics as either Primary or | classify the project | |
| | | | Secondary Metrics. | metrics as either | |
| | | | | primary or secondary | |
| 90 | 1702 | Project Goal | Once you have completed | System provides | Project Goals |
| | | and Success | classifying the metrics, please | ability for user to | |
| | | Metrics | allocate a weight to each metric | allocate weights that | |
| | | | within the scope of the project. | total to 100% within | |
| | | | | the scope of the project. | |
| 91 | 408 | Success Metric | | | See Phase Success |
| | | Prioritization | | | Metric |
| | | | | | Prioritization |
| 92 | 1800 | Project | Please review the system generated | | Project Control |
| | | Control Plan | control plan for accuracy and revise | | Plan |
| | | | or complete any fields as required. | | |
| 93 | 1801 | Project | Based on the Upper and Lower | | Project Control |
| | | Control Plan | Specification Limits and Target | | Plan |
| | | | Performance, define what mitigating | | |
| | | | actions must be taken in the event of | | |
| | | | an out of control condition | | |

TABLE 61
Example of different Isikawa Categories

| Manpower | Machines | Materials | Measurement | Method | Mother Nature |
|---|---|---|---|---|---|
| The training, | Maintenance | Are raw | Are methods of | Does the | Often uncontrollable |
| skill, and | of machines, | materials and | measurement and | production | environmental factors |
| attitude of the | whether | inputs properly | control correct and | process have the | like fire or bad |
| employees or | upgrades to | labeled, stored, | accurate. Do they | most efficient | weather, but certain |
| workers | better | and of high | need to be | number of steps, | safety measures can |
| | technology | quality. Have | adjusted? | are there | be undertaken, as well |
| | is needed | they been | | bottlenecks, is it | as insurance |
| | | ordered in the | | overly complex | purchased for damage |
| | | right size and | | and error-prone? | or disaster |
| | | quantity? | | | |

TABLE 62
Examples of different projects and most relevant Isikawa Category

| | | | Date | Isikawa |
|---|---|---|---|---|
| ID | Project Idea | Description | Identified | Category |
| 1 | Project ABC | Brief description of | Jan. 1, 2025 | Manpower |
| | | project | | |
| 2 | Project 123 | Brief description of | Jan. 1, 2025 | Mother Nature |
| | | project | | |
| 3 | Project DYZ | Brief description of | Jan. 1, 2025 | Materials |
| | | project | | |
| 4 | Project 987 | Brief description of | Jan. 1, 2025 | Measurement |
| | | project | | |
| 5 | Project X | Brief description of | Feb. 1, 2025 | Mother Nature |
| | | project | | |
| 6 | Project Y | Brief description of | Jan. 6, 2025 | Method |
| | | project | | |
| 7 | Project V | Brief description of | Mar. 7, 2025 | Materials |
| | | project | | |

TABLE 63
Example comparison of different projects based upon cost, impact,
desirability, and impact or value to organizational transformation

| | Ordinal | Percent | | User Defined |
|---|---|---|---|---|
| | Rank | Rank | % Weight | Weight |
| Impact | 1 | 67 | 40% | 30% |
| Effort to Implement | 3 | 33 | 20% | 30% |
| Cost to Implement | 4 | 0 | 0% | 20% |
| Desirability and Support | 1 | 67 | 40% | 20% |

TABLE 64
Example comparison of projects based on impact or value to organizational
transformation, effort to produce, and cost to produce

| | | | | | | | | | 1 | 3 |
|---|---|---|---|---|---|---|---|---|---|---|
| | | | 1 | 3 | 5 | 7 | 9 | | Effort to Produce | |
| | | | Impact | | | | | | Low | |
| | | | Low | | Medium | | High | | <40 | |
| | Project | Project | Minor | Medium- | Moderate | Medium- | Large | | Man | Medium- |
| | Idea | Description | Impact | Low | Impact | High | Impact | | Hours | Low |
| 1 | Project | Brief | | 3 | 2 | | | Medium | 3 | 1 |
| | ABC | description | | | | | | | | |
| | | of project | | | | | | | | |
| 2 | Project | Brief | | 1 | 1 | 2 | 1 | Medium- | 1 | 2 |
| | 123 | description | | | | | | High | | |
| | | of project | | | | | | | | |
| 3 | Project | Brief | | | 3 | 2 | | Medium- | | 1 |
| | DYZ | description | | | | | | High | | |
| | | of project | | | | | | | | |
| 4 | Project | Brief | 3 | 1 | 1 | | | Medium- | | 1 |
| | 987 | description | | | | | | Low | | |
| | | of project | | | | | | | | |
| 5 | Project | Brief | | 4 | 1 | | | Medium | | 2 |
| | X | description | | | | | | | | |
| | | of project | | | | | | | | |
| 6 | Project | Brief | 3 | 1 | 1 | | | Medium- | 4 | |
| | Y | description | | | | | | Low | | |
| | | of project | | | | | | | | |
| 7 | Project | Brief | | 4 | | 1 | | Medium | | 4 |
| | V | description | | | | | | | | |
| | | of project | | | | | | | | |
| 8 | | | | | | | | | | |

| | 5 | 7 | 9 | | | | | | | |
|---|---|---|---|---|---|---|---|---|---|---|
| | Effort to Produce | | | | | | | | | |
| | Medium | | High | | 1 | 3 | 5 | 7 | 9 | |
| | ~200 | | >1000 | | Cost to Produce | | | | | |
| | Man | Medium- | Man | | Low | Medium- | Medium | Medium- | High | |
| | Hours | High | Hours | | <$5000 | Low | ~$20000 | High | >$50000 | |
| 1 | | | 1 | Medium- | 4 | 1 | | | | Medium- |
| | | | | Low | | | | | | Low |
| 2 | 1 | | 1 | Medium | 3 | 2 | | | | Medium- |
| | | | | | | | | | | Low |
| 3 | 1 | 2 | 1 | Medium- | | | 1 | 4 | | Medium- |
| | | | | High | | | | | | High |
| 4 | 2 | 1 | 1 | Medium- | 4 | | 1 | | | Medium- |
| | | | | High | | | | | | Low |
| 5 | 2 | 1 | | Medium | | 4 | 1 | | | Medium |
| 6 | 1 | | | Medium- | 4 | 1 | | | | Medium- |
| | | | | Low | | | | | | Low |
| 7 | | 1 | | Medium | | | 1 | 2 | | Medium- |
| | | | | | | | | | | High |
| 8 | | | | | | | | | | |

TABLE 65
Example scoring criterial for scoring projects based on sometimes competing characteristics
such as impact to organization, effort/cost to implement, desirability, etc.

| Project | | | | | | |
|---|---|---|---|---|---|---|
| Portfolio | | | | | Scoring Criteria | |
| Collected | | | | | | 30% |
| During: | | | | | | Effort to |
| Instructions: | | | | | 30% | Implement |
| On this tab, | | | | | Impact | Low |
| qualitatively | | | | | Low = | Effort = |
| rate the ideas | | | | | (Low | (<40 FTE |
| and declare | | | | | Impact) | Hours) Medium |
| scope. Select | | | | | Medium = | Effort = |
| which ideas are | | Select Max | | | (Moderate | (~200 FTE |
| in-scope for | Jan. 1, 2025- | Rank for | | | Impact) | Hours) |
| crowdsourcing. | Mar. 7, 2025 | Implementation: | 3 | Scope | High = | High Effort = |
| Project | Project | Project | Isikawa | In | (Large | (>1000 |
| ID | Title: | Description | Category | Scope? | Impact) | Hours) |
| 1 | Project | Brief | Manpower | Yes | Medium | Medium- |
| | ABC | description | | | | Low |
| | | of project | | | | |
| 2 | Project | Brief | Mother | Yes | Medium- | Medium |
| | 123 | description | Nature | | High | |
| | | of project | | | | |
| 3 | Project | Brief | Materials | Yes | Medium- | Medium- |
| | DYZ | description | | | High | High |
| | | of project | | | | |
| 4 | Project | Brief | Measurement | Yes | Medium- | Medium- |
| | 987 | description | | | Low | High |
| | | of project | | | | |
| 5 | Project | Brief | Mother | Yes | Medium | Medium |
| | X | description | Nature | | | |
| | | of project | | | | |
| 6 | Project | Brief | Method | Yes | Medium- | Medium- |
| | Y | description | | | Low | Low |
| | | of project | | | | |
| 7 | Project | Brief | Materials | Yes | Medium | Medium |
| | V | description | | | | |
| | | of project | | | | |

| Project | | | | | |
|---|---|---|---|---|---|
| Portfolio | Scoring Criteria | | | | |
| Collected | | 20% | | | |
| During: | | Desirability | | | |
| Instructions: | | and | | | |
| On this tab, | | Support | | | |
| qualitatively | 20% | Low = | | | |
| rate the ideas | Cost to | Bottom | | | |
| and declare | Implement | 50% | | | |
| scope. Select | Low = | Medium = | | | |
| which ideas are | (<$5000) | 3rd | | | |
| in-scope for | Medium = | Quartile | | | |
| crowdsourcing. | (~$20000) | High = | | | |
| Project | High = | Top | Raw | Rank | Select for |
| ID | (>$50000) | Quartile | Score | Order | Implementation? |
| 1 | Medium- | Medium- | 5.6 | 1 | Yes |
| | Low | Low | | | |
| 2 | Medium- | Low | 5.2 | 2 | Yes |
| | Low | | | | |
| 3 | Medium- | Medium- | 4.2 | 6 | |
| | High | Low | | | |
| 4 | Medium- | Medium- | 4.6 | 4 | |
| | Low | High | | | |
| 5 | Medium | Medium- | 4.6 | 5 | Yes |
| | | Low | | | |
| 6 | Medium- | Medium- | 5.0 | 3 | |
| | Low | Low | | | |
| 7 | Medium- | Low | 3.8 | 7 | |
| | High | | | | |

TABLE 66
Examples of employee responses to specific strategy(ies) during dynamic interviews

| | | | | | | | What do you |
|---|---|---|---|---|---|---|---|
| | | | | | | | feel is the most |
| | | | | | | | important |
| | | | | | How many | | action that the |
| | | | | | hours | | organization |
| | | | | | (monthly) | | can take to |
| | | | | How | are you | | positively |
| | | | How strongly | likely are | willing and | | progress our |
| | | | do you feel that | you to | able to | | vision? |
| | | | the strategy is | support | work | | Please select 3 |
| | | What is | aligned to the | the | towards | Total | project |
| | | your role | organization's | execution | executing | Volunteer | opportunities |
| | | within the | vision and | of this | the | Hours | from the list |
| Timestamp | Name | organization? | mission? | strategy? | strategy? | (Year) | below. |
| Sep. 15, 2024 | Bob | Employee | 9 | 10 | 5 | 35 | Project ABC;, |
| 13:21:41 | Smith | | | | | | Project 123;, |
| | | | | | | | Project DYZ |
| Sep. 16, 2024 | John | Board | 7 | 9 | 5 | 35 | Project 123;, |
| 13:21:41 | Doe | Member | | | | | Project DYZ;, |
| | | | | | | | Project 987 |
| Sep. 17, 2024 | Sally | Contractor | 7 | 10 | 20 | 140 | Project DYZ;, |
| 13:21:41 | Wallace | | | | | | Project 987;, |
| | | | | | | | Project X |
| Sep. 18, 2024 | Sue | Board | 7 | 6 | 4 | 28 | Project 987;, |
| 13:21:41 | Williams | Member | | | | | Project X;, |
| | | | | | | | Project Y |
| Sep. 19, 2024 | Mike | Employee | 7 | 8 | 6 | 42 | Project X;, |
| 13:21:41 | Henry | | | | | | Project Y;, |
| | | | | | | | Project V |
| Sep. 20, 2024 | Henry | Employee | 8 | 9 | 20 | 140 | Project Y;, |
| 13:21:41 | Finkle | | | | | | Project V;, |
| | | | | | | | Project ABC |
| Sep. 21, 2024 | Hellen | Board | 5 | 6 | 5 | 35 | Project ABC;, |
| 13:21:41 | Wise | Member | | | | | Project DYZ;, |
| | | | | | | | Project 987 |
| Sep. 22, 2024 | Amy | Employee | 9 | 9 | 10 | 70 | Project 123;, |
| 13:21:41 | Johns | | | | | | Project DYZ;, |
| | | | | | | | Project 987 |
| Sep. 23, 2024 | Charles | Employee | 7 | 2 | 8 | 56 | Project X;, |
| 13:21:41 | Standish | | | | | | Project Y;, |
| | | | | | | | Project V |
| Sep. 24, 2024 | Mark | Employee | 2 | 3 | 1 | 7 | Project 987;, |
| 13:21:41 | Hunt | | | | | | Project X;, |
| | | | | | | | Project Y |
| Sep. 25, 2024 | Hunter | Employee | 10 | 6 | 2 | 14 | Project ABC;, |
| 13:21:41 | Beamer | | | | | | Project 123;, |
| | | | | | | | Project DYZ |
| Sep. 26, 2024 | Mary | Board | 2 | 2 | 1 | 7 | Project ABC;, |
| 13:21:41 | Smith | Member | | | | | Project Y;, |
| | | | | | | | Project V |
| Sep. 27, 2024 | Anne | Board | 7 | 2 | 1 | 7 | Project 987;, |
| 13:21:41 | Williams | Member | | | | | Project X;, |
| | | | | | | | Project Y |
| Sep. 28, 2024 | Lee | Board | 10 | 10 | 16 | 112 | Project DYZ;, |
| 13:21:41 | Smart | Member | | | | | Project 987;, |
| | | | | | | | Project X |

TABLE 67
Example results related to project-specific stakeholder support

| | | What do you feel is | | | | |
|---|---|---|---|---|---|---|
| | | the most important | | | | |
| | | action that the | | | | |
| | | organization can | | | | |
| | | take to positively | | SUM of How | SUM of How | |
| | | progress our | | strongly do you feel | likely are | |
| | | vision? | | that the strategy is | you to | SUM of |
| | | Please select 3 | | aligned to the | support the | Total |
| | What is your | project | | organizaiton's | execution of | Volunteer |
| | role within the | opportunities from | COUNTA | vision and | this | Hours |
| Name | organization? | the list below. | of Name | mission? | strategy? | (Year) |
| Amy | Employee | Project 123;, | 1 | 9 | 9 | 70 |
| Johns | | Project DYZ;, | | | | |
| | | Project 987 | | | | |
| Anne | Board | Project 987;, | 1 | 7 | 2 | 7 |
| Williams | Member | Project X;, | | | | |
| | | Project Y | | | | |
| Bob | Employee | Project ABC;, | 1 | 9 | 10 | 35 |
| Smith | | Project 123;, | | | | |
| | | Project DYZ | | | | |
| Charles | Employee | Project X;, | 1 | 7 | 2 | 56 |
| Standish | | Project Y;, | | | | |
| | | Project V | | | | |
| Hellen | Board | Project ABC;, | 1 | 5 | 6 | 35 |
| Wise | Member | Project DYZ;, | | | | |
| | | Project 987 | | | | |
| Henry | Employee | Project Y;, | 1 | 8 | 9 | 140 |
| Finkle | | Project V;, | | | | |
| | | Project ABC | | | | |
| Hunter | Employee | Project ABC;, | 1 | 10 | 6 | 14 |
| Beamer | | Project 123;, | | | | |
| | | Project DYZ | | | | |
| John | Board | Project 123;, | 1 | 7 | 9 | 35 |
| Doe | Member | Project DYZ;, | | | | |
| | | Project 987 | | | | |
| Lee | Board | Project DYZ;, | 1 | 10 | 10 | 112 |
| Smart | Member | Project 987;, | | | | |
| | | Project X | | | | |
| Mark | Employee | Project 987;, | 1 | 2 | 3 | 7 |
| Hunt | | Project X;, | | | | |
| | | Project Y | | | | |
| Mary | Board | Project ABC;, | 1 | 2 | 2 | 7 |
| Smith | Member | Project Y;, | | | | |
| | | Project V | | | | |
| Mike | Employee | Project X;, | 1 | 7 | 8 | 42 |
| Henry | | Project Y;, | | | | |
| | | Project V | | | | |
| Sally | Contractor | Project DYZ;, | 1 | 7 | 10 | 140 |
| Wallace | | Project 987;, | | | | |
| | | Project X | | | | |
| Sue | Board | Project 987;, | | | | |
| Williams | Member | Project X;, | 1 | 7 | 6 | 28 |
| | | Project Y | | | | |

TABLE 68
Example phase success metrics

| | | Success Metric | |
|---|---|---|---|
| | | Weight within | Cadence for |
| Phase Goal | Phase Success Metrics | Goal | Data Updates |
| 1. Launch New/Initial | Product Launch Date: Successfully launch | 50% | Weekly |
| Product(s) by Q4 2025 | New/Initial Product(s) by the end of Q4 2025. | | |
| | Feature Completion: Ensure all core features | 50% | One Time |
| | are operational at launch (e.g., analytics, | | |
| | user navigation). | | |
| 2. Launch New/Initial | Product Readiness: Complete New/Initial | 33% | Weekly |
| Product(s) by Q3 2025 | Product(s) MVP development by Q3 2025. | | |
| | Client Conversion: Onboard 25 organizations | 33% | Montly |
| | using New/Initial Product(s) within 6 months | | |
| | of launch. | | |
| | Feature Stability: System performance | 33% | Weekly After |
| | achieves 95%+ uptime post-launch. | | Launch |
| 3. Complete team-wide | Skill Certification: 100% of designated team | 100% | Monthly |
| Python training | members complete Python certification or | | |
| | equivalent proficiency training. | | |
| 4. Develop and deploy | Campaign Deployment: Successfully deploy 3 | 50% | Weekly |
| three marketing | targeted campaigns by Q4 2025. | | |
| campaigns | Brand Awareness: Increase website traffic by | 25% | Monthly |
| | 20% and social media engagement by 25%. | | |
| | Campaign ROI: Achieve a positive return on | 25% | Monthly |
| | investment (ROI) ≥150% for at least 2 of the | | |
| | 3 campaigns. | | |
| | Cohort Implementation: Implement cohort | 50% | One Time |
| | clustering for 80% of client organizations | | |
| | by Q4 2025. | | |
| 5. Implement cohort | Client Engagement: Ensure 90% of | 50% | Monthly |
| clustering | organizations using clustering actively | | |
| | engage with the insights monthly. | | |

TABLE 69
Examples of success metrics and project goals by phase

| | | | | | Success | |
|---|---|---|---|---|---|---|
| | | | | | Metric | |
| | Project to | Project | Project | Project Metric | Weight | Cadence |
| | Phase Goal | Primary | Goals | Alignment to | within | for Data |
| Project | Alignment | Goal | Type | Phase Metrics | Project | Updates |
| Project | 1. Launch | Complete | Primary | Product Launch Date: | 75% | One Time |
| ABC | New/Initial | ABC | Goal | Successfully launch | | |
| | Product(s) by | | | New/Initial Product(s) | | |
| | Q4 2025 | | | by the end of | | |
| | | | | Q4 2025. | | |
| | | Execute | Secondary | Product Launch Date: | 25% | Weekly |
| | | Project | Goal | Successfully launch | | |
| | | On-Time | | New/Initial Product(s) | | |
| | | | | by the end of | | |
| | | | | Q4 2025. | | |
| Project | 2. Launch | Complete | Primary | Product Readiness: | 60% | One |
| 123 | New/Initial | 123 | Goal | Complete New/Initial | | Time |
| | Product(s) by | | | Product(s) MVP development | | |
| | Q3 2025 | | | by Q3 2025. | | |
| | | Execute | Secondary | No Alignment | 40% | Monthly |
| | | Project | Goal | | | |
| | | On-Budget | | | | |
| Project | 3. Complete | Complete | Primary | Skill Certification: | 80% | One |
| DYZ | team-wide | 100% of | Goal | 100% of designated team | | Time |
| | Python | Training | | members complete Python | | |
| | training | | | certification or equivalent | | |
| | | | | proficiency training. | | |
| | | Do not impact | Secondary | Product Readiness: | 20% | Montly |
| | | timeline of | Goal | Complete New/Initial | | |
| | | Project 123 | | Product(s) MVP development | | |
| | | | | by Q3 2025. | | |
| Project | 4. Develop and | Launch | Primary | Campaign Deployment: | 70% | One |
| 987 | deploy three | Marketing | Goal | Successfully deploy 3 targeted | | Time |
| | marketing | Campaign | | campaigns by Q4 2025. | | |
| | campaigns | Achieve | Secondary | Campaign ROI: Achieve a | 30% | Weekly |
| | | positive | Goal | positive return on investment | | |
| | | return on | | (ROI) ≥150% for at least | | |
| | | campaign | | 2 of the 3 campaigns. | | |
| Project | 5. Implement | Complete | Primary | Cohort Implementation: | 90% | One |
| X | cohort | Project X | Goal | Implement cohort clustering | | Time |
| | clustering | | | for 80% of client | | |
| | | | | organizations by Q4 2025. | | |
| | | Test all | Secondary | No Alignment | 10% | Weekly |
| | | features | Goal | | | |
| Project | 2. Launch | Design | Secondary | Product Readiness: | 60% | Weekly |
| Y | New/Initial | Solution by | Goal | Complete New/Initial | | |
| | Product(s) by | Jun. 30, 2025 | | Product(s) MVP development | | |
| | Q3 2025 | | | by Q3 2025. | | |
| | | Launch | Primary | Product Readiness: | 40% | One |
| | | Solution | Goal | Complete New/Initial | | Time |
| | | | | Product(s) MVP development | | |
| | | | | by Q3 2025. | | |
| Project | 1. Launch | Launch | Primary | Product Launch Date: | 80% | One |
| V | New/Initial | Project V | Goal | Successfully launch | | Time |
| | Product(s) by | | | New/Initial Product(s) | | |
| | Q4 2025 | | | by the end of Q4 2025. | | |
| | | Execute | Secondary | Product Launch Date: | 20% | Weekly |
| | | Project | Goal | Successfully launch | | |
| | | On-Time | | New/Initial Product(s) | | |
| | | | | by the end of Q4 2025. | | |

TABLE 70
Examples of questions and responses provided during dynamic interviews

| | Patent | | | | |
|---|---|---|---|---|---|
| | FIG. | | | | |
| ID | # | Module | Data Question | Possible Responses | Logic |
| 94 | 1900 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 95 | 1902 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 96 | 1903 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 97 | 1904 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 98 | 1905 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 99 | 1909 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 100 | 1910 | Work Plan | Now its time to hash out the details of the | System provides access | Example |
| | | Creation | projects by creating work plans that describe | for the user to document | Work Plan |
| | | | the steps, resources, costs, time, and alignment | the project details within | |
| | | | of the project. Please utilize the Work Plan | the context of a work plan. | |
| | | | template to get started. | | |
| 101 | 1912 | Work Plan | Congratulations on defining your first project | System displays the | Gannt |
| | | Creation | work plan, click here to view the project's | completed gantt chart | Chart |
| | | | Gantt chart | based on the project data | |

TABLE 71
Examples of phase and project cost, labor, and timing budget data

| | | | | | Project | | | | |
|---|---|---|---|---|---|---|---|---|---|
| | | | | | or | | | | |
| | Phase | Project | Project | | Service | | | Skills | Skill |
| # | Name | Name | Step | Type | Name | Function | Responsibility | Required | Count |
| 1 | Foundation | Project | Start | Product | Product 1 | Organizational | Assign | People | 1 |
| | and | ABC | Project | | | Management | Work | Management | |
| | Expansion | | | | | | Responsibilities | | |
| 2 | Foundation | Project | Design | Product | Product 1 | Product | Design | Microsoft | 1 |
| | and | ABC | Project | | | Development | Product | Office | |
| | Expansion | | | | | | Prototype(s) | | |
| 3 | Foundation | Project | Built | Product | Product 1 | Technical | Built | Testing | 1 |
| | and | ABC | Project | | | Development | and | | |
| | Expansion | | | | | | Test | | |
| | | | | | | | Product | | |
| | | | | | | | Prototype(s) | | |
| 4 | Foundation | Project | Test | Product | Product 1 | Technical | Test | Testing | 1 |
| | and | ABC | Project | | | Development | Product(s) - | | |
| | Expansion | | | | | | CIT, | | |
| | | | | | | | SIT, | | |
| | | | | | | | UAT | | |
| 5 | Foundation | Project | Implement | Product | Product 1 | Technical | Deploy | Software | 1 |
| | and | ABC | Project | | | Implementation | Products | Installation | |
| | Expansion | | | | | | to | | |
| | | | | | | | Clients | | |
| 6 | Foundation | Project | Support | Product | Product 1 | Product | Manage | Stake-holder | 1 |
| | and | ABC | Project | | | Management | and/or | Management | |
| | Expansion | | | | | | Provide | | |
| | | | | | | | Product | | |
| | | | | | | | Support | | |
| | | | | | | | Post | | |
| | | | | | | | Implementation | | |

| | | Additional | Duration | | | | | |
|---|---|---|---|---|---|---|---|---|
| | Working | Time | (Business | | | Resource | Hourly | Forecasted |
| # | Hours | Required | Days) | Role | Name | Type | Rate | Cost |
| 1 | 20 | 0 | 2.5 | Executive | Bob | Employee | $40 | $800 |
| | | | | Director | Smith | | | |
| 2 | 80 | 0 | 10 | Marketing | Sue | Board | $25 | $2,000 |
| | | | | Analyst | Williams | Member | | |
| 3 | 150 | 0 | 18.75 | IT | Henry | Employee | $30 | $4,500 |
| | | | | Manager | Finkle | | | |
| 4 | 80 | 0 | 10 | Administrative | Hunter | Employee | $20 | $1,600 |
| | | | | Assistant | Beamer | | | |
| 5 | 20 | 0 | 2.5 | IT | Henry | Employee | $30 | $600 |
| | | | | Manager | Finkle | | | |
| 6 | 40 | 160 | 25 | Donor | Charles | Employee | $32 | $1,280 |
| | | | | Relations | Standish | | | |
| | | | | Manager | | | | |

| | Forecasted | Forecasted | | | Actual | | | |
|---|---|---|---|---|---|---|---|---|
| | Start | End | Actual | Actual | Working | Actual | | |
| # | Date | Date | Start | End | Hours | Cost | Progress | Status |
| 1 | Oct. 1, | Oct. 3, | Aug. 30, | Oct. 3, | 25 | $1,000 | 100% | Complete |
| | 2024 | 2024 | 2024 | 2024 | | | | |
| 2 | Oct. 4, | Oct. 18, | Oct. 4, | Oct. 31, | 85 | $2,125 | 100% | Complete |
| | 2024 | 2024 | 2024 | 2024 | | | | |
| 3 | Oct. 21, | Nov. 14, | Nov. 1, | Dec. 15, | 150 | $4,500 | 100% | Complete |
| | 2024 | 2024 | 2024 | 2024 | | | | |
| 4 | Nov. 15, | Nov. 29, | Dec. 16, | | 80 | $1,600 | 10% | In- |
| | 2024 | 2024 | 2024 | | | | | Progress |
| 5 | Dec. 2, | Dec. 4, | | | 20 | $600 | 0% | Not |
| | 2024 | 2024 | | | | | | Started |
| 6 | Dec. 5, | Jan. 9, | | | 40 | $1,280 | 0% | Not |
| | 2024 | 2025 | | | | | | Started |

TABLE 72
Example of project cost, desirability, completion, success rate, timeliness, and budget data

| | | | | | | Project | | | | |
|---|---|---|---|---|---|---|---|---|---|---|
| | | | | | | vs | | | | |
| | Project | Project | Project | Project | Portfolio | Average | Project | Project | Project | Project |
| ID | Name | Lead | Type | Size | Contribution % | Size | Cost | Cost % | Goal | Goal % |
| 0 | A | Sue | Product | 4,500 | 21% | 84% | $112,500 | 10% | $5,500,000 | 55% |
| | | Williams | | | | | | | | |
| 1 | B | Bob | Product | 5,000 | 23% | 93% | $200,000 | 17% | $3,500,000 | 35% |
| | | Smith | | | | | | | | |
| 2 | C | Sally | Infrastructure | 10,000 | 47% | 186% | $750,000 | 65% | $500,000 | 5% |
| | | Wallace | | | | | | | | |
| 3 | D | Amy | Product | 2,000 | 9% | 37% | $90,000 | 8% | $1,000,000 | 10% |
| | | Johns | | | | | | | | |

| | | | | | | Project | | | | |
|---|---|---|---|---|---|---|---|---|---|---|
| | | | | | Project | Lead | | Lack | Lack | |
| | Project | | Project | | Lead | Success | Months | of | of | Over |
| ID | Desirability | Support | Completion | Dependencies | Trained | Rate | Remaining | Resources | Support | Budget |
| 0 | High | 100% | 80% | None | Exceeds | 90% | 5 | −0.05 | −0.03 | −0.04 |
| 1 | Med- | 75% | | None | Meets | 75% | 12 | 0.01 | 0.02 | −0.02 |
| | High | | | | | | | | | |
| 2 | High | 100% | | 1 | Meets | 50% | 7 | −0.02 | −0.1 | 0.03 |
| 3 | Med- | 25% | | None | Exceeds | 100% | 1 | 0.1 | 0.2 | 0.05 |
| | Low | | | | | | | | | |

TABLE 73
Example of entropy scores and organizational information for example organizations in a cohort

| | | | | | | Port- | Port- | Port- | | | | |
|---|---|---|---|---|---|---|---|---|---|---|---|---|
| Organi- | | | | Org | Distance | folio | folio | folio | Average | # of | Hours | % |
| zation | | Entropy | Org | Perfor- | to | Size | Size | Size | Project | Re- | Avail- | Capac- |
| ID | Cohort | Score | Goal | mance | Vision | (Projects) | (Hours) | ($) | Size | sources | able | ity |
| * | 1 | 72 | $25,000,000 | $15,000,000 | 40% | 3 | 17,000 | $561,000 | 5,667 | 21 | 22,770 | 25% |
| 1 | 1 | 90 | $10,000,000 | $9,000,000 | 10% | 10 | 33,000 | $891,000 | 3,300 | 30 | 45,000 | 27% |
| 2 | 1 | 95 | $1,500,000 | $750,000 | 50% | 2 | 9,000 | $495,000 | 4,500 | 10 | 15,000 | 40% |
| 3 | 1 | 51 | $15,000,000 | $10,000,000 | 33% | 5 | 25,000 | $1,225,000 | 5,000 | 19 | 28,500 | 12% |
| 4 | 1 | 86 | $5,500,000 | $4,000,000 | 27% | 7 | 18,000 | $828,000 | 2,571 | 15 | 22,500 | 20% |
| 5 | 1 | 82 | $5,000,000 | $1,000,000 | 80% | 6 | 16,000 | $800,000 | 2,667 | 15 | 22,500 | 29% |
| 6 | 1 | 45 | $750,000 | $600,000 | 20% | 3 | 1,000 | $21,000 | 333 | 1 | 1,500 | 33% |
| 7 | 2 | 65 | $1,500,000 | $150,000 | 90% | 6 | 9,000 | $396,000 | 1,500 | 6 | 9,000 | 0% |
| 8 | 2 | 99 | $500,000 | $100,000 | 80% | 4 | 1,900 | $106,400 | 475 | 2 | 3,000 | 37% |
| 9 | 2 | 22 | $2,000,000 | $100,000 | 95% | 15 | 3,000 | $165,000 | 200 | 2.5 | 3,750 | 20% |
| 10 | 2 | 78 | $150,000 | $80,000 | 47% | 10 | 2,000 | $58,000 | 200 | 2 | 3,000 | 33% |

TABLE 74
Examples of project failures and failure
reason from fault tree analysis

| | |
|---|---|
| Project ID | 1 |

| | Failures | | |
|---|---|---|---|
| Count In-Scope | Lack of Resources | Lack of Support | Over Budget |
| 6 | 2 | 1 | 1 |
| | Lack of Resources | Lack of Support | Over Budget |
| n | 6 | 6 | 4 |
| Threshold | 9% | 43% | 10% |
| Bayes Adjustment | 12% | 25% | 8% |

TABLE 75
Example of project data by project type

| | | | | | Project | | | | |
|---|---|---|---|---|---|---|---|---|---|
| | | | Project | | vs | | | | |
| Org | Project | Project | Size | Portfolio | Average | Project | Project | Project | Project |
| ID | ID | Type | (hrs) | Contribution % | Size | Cost | Cost % | Goal | Goal % |
| 1 | 10 | Product | 2,000 | 6% | 60.6% | $75,000 | 8% | $300,000 | 30% |
| 1 | 11 | Infrastructure | 2,555 | 8% | 77.4% | $148,190 | 17% | $148,374 | 15% |
| 1 | 12 | Product | 2,502 | 8% | 75.8% | $122,598 | 14% | $108,580 | 11% |
| 2 | 13 | Infrastructure | 1,711 | 19% | 38.0% | $71,862 | 15% | $701,443 | 94% |
| 2 | 14 | Product | 1,674 | 19% | 37.2% | $61,938 | 13% | $400,231 | 53% |
| 3 | 15 | Product | 2,896 | 12% | 57.9% | $75,000 | 6% | $1,642,906 | 33% |
| 3 | 16 | Infrastructure | 2,659 | 11% | 53.2% | $75,000 | 6% | $1,482,884 | 30% |
| 3 | 17 | Product | 3,000 | 12% | 60.0% | $93,194 | 8% | $1,782,337 | 36% |
| 3 | 18 | Infrastructure | 6,750 | 27% | 135.0% | $169,840 | 14% | $1,739,043 | 35% |
| 4 | 19 | Product | 1,515 | 8% | 58.9% | $89,385 | 11% | $750,000 | 50% |
| 4 | 20 | Product | 4,000 | 22% | 155.6% | $88,816 | 11% | $410,252 | 27% |
| 4 | 21 | Infrastructure | 1,562 | 9% | 60.7% | $53,108 | 6% | $289,229 | 19% |
| 4 | 22 | Product | 2,080 | 12% | 80.9% | $91,520 | 11% | $238,547 | 16% |
| 4 | 23 | Infrastructure | 1,633 | 9% | 63.5% | $100,000 | 12% | $1,305,311 | 87% |
| 5 | 24 | Product | 1,650 | 10% | 61.9% | $57,680 | 7% | $713,633 | 18% |
| 5 | 25 | Product | 1,073 | 7% | 40.2% | $60,088 | 8% | $518,010 | 13% |
| 5 | 26 | Infrastructure | 1,161 | 7% | 43.5% | $50,000 | 6% | $606,166 | 15% |
| 5 | 27 | Product | 2,000 | 13% | 75.0% | $67,310 | 8% | $1,500,000 | 38% |
| 6 | 28 | Infrastructure | 212 | 21% | 63.6% | $6,572 | 31% | $63,934 | 43% |
| 6 | 29 | Product | 187 | 19% | 56.1% | $8,041 | 38% | $57,270 | 38% |
| 6 | 30 | Product | 178 | 18% | 53.4% | $10,146 | 48% | $61,204 | 41% |
| 7 | 31 | Infrastructure | 500 | 6% | 33.3% | $36,540 | 9% | $500,000 | 37% |
| 8 | 32 | Product | 376 | 20% | 79.2% | $18,800 | 18% | $179,127 | 45% |
| 8 | 33 | Infrastructure | 319 | 17% | 67.2% | $7,337 | 7% | $131,276 | 33% |
| 8 | 34 | Product | 150 | 8% | 31.6% | $7,722 | 7% | $166,789 | 42% |
| 9 | 35 | Product | 154 | 5% | 77.0% | $5,082 | 3% | $170,789 | 9% |
| 9 | 36 | Infrastructure | 187 | 6% | 93.5% | $6,171 | 4% | $194,278 | 10% |
| 10 | 37 | Product | 166 | 8% | 83.0% | $9,960 | 17% | $13,451 | 19% |
| 10 | 38 | Infrastructure | 80 | 4% | 40.0% | $7,990 | 14% | $20,000 | 29% |
| 10 | 39 | Product | 159 | 8% | 79.5% | $6,837 | 12% | $12,440 | 18% |

| | | | | | Project | | | |
|---|---|---|---|---|---|---|---|---|
| | | | | Project | Lead | | | |
| Org | Project | | Project | Lead | Success | Failure | | In- |
| ID | Desirability | Support | Completion | Trained | Rate | Reason | Success | Scope |
| 1 | High | 100% | 61% | Meets | 82% | Over | 0 | 1 |
| | | | | | | Budget | | |
| 1 | Med- | 75% | 83% | Exceeds | 55% | Lack of | 0 | 0 |
| | High | | | | | Resources | | |
| 1 | Medium | 50% | 12% | Does | 95% | Over | 0 | 0 |
| | | | | Not | | Budget | | |
| | | | | Meet | | | | |
| 2 | Med- | 25% | 46% | Meets | 66% | | 1 | 0 |
| | Low | | | | | | | |
| 2 | Low | 10% | 43% | Exceeds | 26% | | 1 | 0 |
| 3 | High | 100% | 64% | Does | 1% | Over | 0 | 0 |
| | | | | Not | | Budget | | |
| | | | | Meet | | | | |
| 3 | Med- | 75% | 41% | Meets | 91% | | 1 | 1 |
| | High | | | | | | | |
| 3 | Medium | 50% | 72% | Exceeds | 50% | Lack of | 0 | 1 |
| | | | | | | Resources | | |
| 3 | Med- | 25% | 45% | Does | 85% | | 1 | 0 |
| | Low | | | Not | | | | |
| | | | | Meet | | | | |
| 4 | Med- | 25% | 74% | Meets | 68% | Lack of | 0 | 1 |
| | Low | | | | | Support | | |
| 4 | High | 100% | 70% | Exceeds | 60% | | 1 | 0 |
| 4 | Med- | 75% | 6% | Does | 25% | | 1 | 0 |
| | High | | | Not | | | | |
| | | | | Meet | | | | |
| 4 | Medium | 50% | 84% | Meets | 45% | | 1 | 0 |
| 4 | Med- | 25% | 34% | Exceeds | 42% | Over | 0 | 0 |
| | Low | | | | | Budget | | |
| 5 | Low | 10% | 7% | Does | 46% | Lack of | 0 | 0 |
| | | | | Not | | Support | | |
| | | | | Meet | | | | |
| 5 | High | 100% | 27% | Meets | 61% | Lack of | 0 | 0 |
| | | | | | | Support | | |
| 5 | Med- | 75% | 24% | Exceeds | 83% | | 1 | 0 |
| | High | | | | | | | |
| 5 | Medium | 50% | 57% | Does | 59% | Lack of | 0 | 1 |
| | | | | Not | | Resources | | |
| | | | | Meet | | | | |
| 6 | Med- | 25% | 69% | Meets | 17% | Lack of | 0 | 0 |
| | Low | | | | | Support | | |
| 6 | Low | 10% | 40% | Exceeds | 83% | | 1 | 0 |
| 6 | High | 100% | 76% | Does | 89% | | 1 | 0 |
| | | | | Not | | | | |
| | | | | Meet | | | | |
| 7 | Medium | 50% | 80% | Meets | 45% | Lack of | 0 | 0 |
| | | | | | | Support | | |
| 8 | Medium | 50% | 38% | Exceeds | 6% | Lack of | 0 | 0 |
| | | | | | | Support | | |
| 8 | Med- | 25% | 42% | Does | 85% | | 1 | 1 |
| | Low | | | Not | | | | |
| | | | | Meet | | | | |
| 8 | Low | 10% | 64% | Meets | 9% | Lack of | 0 | 0 |
| | | | | | | Resources | | |
| 9 | High | 100% | 35% | Exceeds | 92% | | 1 | 0 |
| 9 | Med- | 75% | 32% | Does | 80% | Lack of | 0 | 0 |
| | High | | | Not | | Resources | | |
| | | | | Meet | | | | |
| 10 | Medium | 50% | 22% | Meets | 39% | | 1 | 0 |
| 10 | Med- | 25% | 80% | Exceeds | 99% | | 1 | 0 |
| | Low | | | | | | | |
| 10 | Low | 10% | 12% | Does | 50% | Lack of | 0 | 0 |
| | | | | Not | | Resources | | |
| | | | | Meet | | | | |

TABLE 76
Example of probabilistic analysis data for a particular failure cause

| | Lack of Resources |
|---|---|
| | Portfolio Contribution % |
| Status | 0 |
| Current | 23% |
| Threshold | 9% |
| Microbehaviors (Month) | 0.01 |
| Months Remaining | 12 |
| Future Value | 26% |
| Event Condition | Greater Than |
| Probability of Event | 50% |
| Bayesian Adjustment | 12% |
| Future Value | 14% |
| Probability of Event | 3% |

TABLE 77
Example of probabilistic analysis data for a particular failure cause

| | Lack of Support |
|---|---|
| | Support |
| Status | 1 |
| Current | 75% |
| Threshold | 43% |
| Microbehaviors (Month) | 0.02 |
| Months Remaining | 12 |
| Future Value | 93% |
| Event Condition | Less Than |
| Probability of Event | 50% |
| Bayesian Adjustment | 25% |
| Future Value | 31% |
| Probability of Event | 35% |

TABLE 78
Example of probabilistic analysis data for a particular failure cause

| | Over Budget |
|---|---|
| | Project Cost % |
| Status | 0 |
| Current | 17.4% |
| Threshold | 10.1% |
| Microbehaviors (Month) | −0.02 |
| Months Remaining | 12 |
| Future Value | 13% |
| Event Condition | Greater Than |
| Probability of Event | 50% |
| Bayesian Adjustment | 8% |
| Future Value | 6% |
| Probability of Event | 86% |

TABLE 79
Example of success probability for a particular
project by success criterion

| | | Project Probability |
|---|---|---|
| Project ID | Criteria | of Success |
| 1 | Current w MicroBehaviors | 13% |

TABLE 80
Examples of Markov path/scenario selection criteria for selecting between alternative Markov paths

| Current w | Markov Scenario Selection & DTA Expected Value | | | | | | | | |
|---|---|---|---|---|---|---|---|---|---|
| MicroBehaviors | Current | | | | | Project | Probability | Expected | Scenario |
| Scenario | Baseline | Project 1 | Project 2 | Project 3 | Dependencies | Goal | of Success | Value | Selection |
| 1 | 0 | 1 | 2 | 3 | 1 | $5,000,000 | 0% | $10,985 | 0 |
| 2 | 0 | 1 | 3 | 2 | 1 | $5,000,000 | 0% | $10,985 | 0 |
| 3 | 0 | 2 | 1 | 3 | 0 | $0 | 0% | $0 | 0 |
| 4 | 0 | 2 | 3 | 1 | 0 | $0 | 0% | $0 | 0 |
| 5 | 0 | 3 | 1 | 2 | 1 | $5,000,000 | 0% | $10,985 | 0 |
| 6 | 0 | 3 | 2 | 1 | 0 | $0 | 0% | $0 | 0 |
| 7 | 0 | 1 | 2 | None | 1 | $4,000,000 | 2% | $67,600 | 0 |
| 8 | 0 | 1 | 3 | None | 1 | $4,500,000 | 2% | $76,050 | 0 |
| 9 | 0 | 2 | 1 | None | 0 | $0 | 2% | $0 | 0 |
| 10 | 0 | 2 | 3 | None | 0 | $0 | 2% | $0 | 0 |
| 11 | 0 | 3 | 1 | None | 1 | $4,500,000 | 2% | $76,050 | 0 |
| 12 | 0 | 3 | 2 | None | 0 | $0 | 2% | $0 | 0 |
| 13 | 0 | 1 | None | None | 1 | $3,500,000 | 13% | $455,000 | 1 |
| 14 | 0 | 2 | None | None | 0 | $0 | 13% | $0 | 0 |
| 15 | 0 | 3 | None | None | 1 | $1,000,000 | 13% | $130,000 | 0 |

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

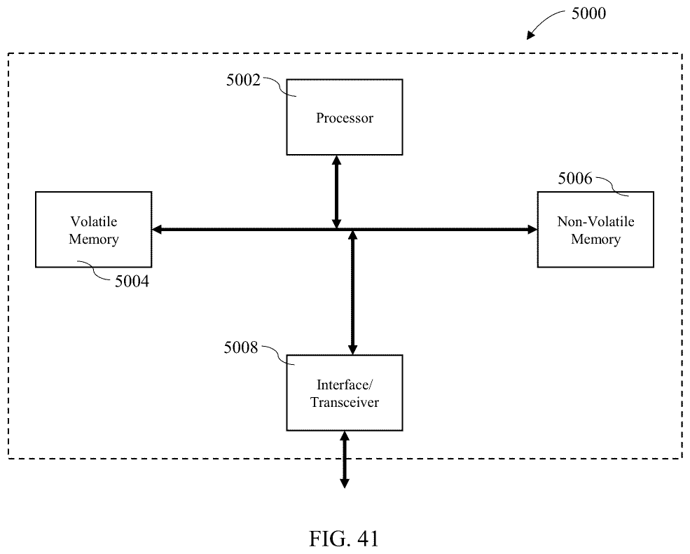

FIG. 41 provides a schematic of a computing device 5000 that can be configured to perform some or all of various methods such as those described herein. The computing device 5000 may comprise one or more processing elements, such as a processor 5002, one or more volatile memories 5004, one or more non-volatile memories 5006, and/or one or more interfaces/transceivers 5008 (e.g., “transceivers 5008”). In some embodiments, the computing device 5000 is configured to store one or more computer program products, computer program code, a computer-readable media comprising instructions, and/or the like.

In some embodiments, the computing device 5000 is configured to determine or receive information from a user device. In other embodiments, the regarding a current temperature of one or more portions of, e.g., a server farm, a current pressure within one or more portions of a heat sink cooling system (e.g., 300), and/or other information regarding a current status of the system. Information can be received by the computing device 5000 from a manual input, one or more sensors, and/or the like. In some embodiments, the computing device 5000 is configured, using any suitable means, to be in wired or wireless communication, such as via the transceivers 5008, with one or more motors, valves, actuators, pumps, sensors, and/or the like (not shown) that are configured to cause communication of liquid heat exchange fluid into one or more of the vapor-barrier heat sinks and/or allow communication of vapor heat exchange fluid out of one or more of the vapor-barrier heat sinks. In some embodiments, the computing device 5000 can be configured to communicate a set of instructions to one or more motors, actuators, sensors, valves, pumps, and/or the like, for one or a series of actions to be carried out. In some embodiments, the computing device 5000 can provide flow rate instructions, e.g., in conjunction with other instructions, to one or more of motors, actuators, sensors, valves, pumps, and/or the like in order for the proper flow rate or discrete volume of liquid heat exchange fluid to be communicated throughout the heat exchange system or to one or more particular vapor-membrane heat exchangers within an array of vapor-membrane heat exchangers, as desired.

In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes can be performed on data, content, information, and/or similar terms used herein interchangeably.

The processor 5002 may be of any type suitable to the local technical network and may include one or more of the following: general purpose computers, special purpose computers, microprocessors, digital signal processors (DSPs) and processors based on multicore processor architecture, as non-limiting examples. The computing device 5000 may have multiple processors, such as an application specific integrated circuit chip that is slaved in time to a clock which synchronizes the main processor.

According to some embodiments, the non-volatile memory 5006 may include or comprise a Read Only Memory (ROM), an electrically programmable read only memory (EPROM), a flash memory, a hard disk, a compact disc (CD), a digital video disk (DVD), and other magnetic storage and/or optical storage. Examples of the volatile memory 5004 can include, but are not limited to, a random access memory (RAM) and other volatile memories, such as those that will not last in the power-down duration.

In some embodiments, one or more computer program may be stored on the volatile memory 5004 or the non-volatile memory 5006. Computer program(s) can comprise computer executable instructions that are executed by the processor 5002. In some embodiments, computer programs may be stored in ROM. The processor 5002 may perform any suitable actions and processing, such as by loading the computer program into RAM.

Various embodiments of the present disclosure may be implemented by means of one or more computer program so that the computing device 5000 may perform any process of the disclosure as discussed herein. The embodiments of the present disclosure may also be implemented by hardware or by a combination of software and hardware.

In some embodiments, the computer program may be tangibly contained in a computer program product, such as a non-transitory computer-readable storage medium, which may be included in the device 5000 (such as in the non-volatile memory 5006) or other storage devices that are accessible by the device 5000, such as an external storage device. The computing device 5000 may load the computer program(s) from the non-volatile computer-readable storage medium to, e.g., RAM for execution by the processor 5002. The non-transitory computer-readable storage medium may include any types of tangible non-volatile storage, such as ROM, EPROM, a flash memory, a hard disk, CD, DVD, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out various methods described herein. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may he executed within a local or distributed device. In a distributed device, program modules may be located in both local and remote storage media.

Program code(s) for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the instructions, computer-executable instructions, programs, codes, program codes, computer program codes or related data may be carried by any suitable carrier to enable the computing device 5000, another device or apparatus, or system/sub-component to perform various processes and operations as described herein. Examples of the carrier include a signal, a computer-readable storage medium, a non-transitory computer-readable storage medium, and the like.

The non-transitory computer-readable storage medium may include, but is not limited to, an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

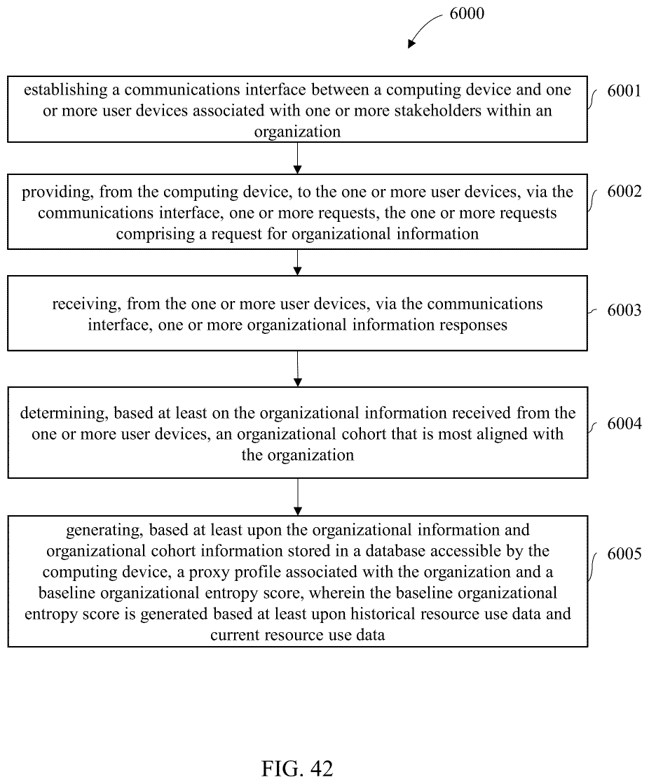

Referring now to FIG. 42, a method 6000 can be carried out by means such as the computing device 5000. The method 6000 can comprise: establishing a communications interface between a computing device and one or more user devices associated with one or more stakeholders within an organization, at 6001. In some embodiments, the method 6000 can further comprise: providing, from the computing device, to the one or more user devices, via the communications interface, one or more requests, the one or more requests comprising a request for organizational information, at 6002. In some embodiments, the method 6000 can further comprise: receiving, from the one or more user devices, via the communications interface, one or more organizational information responses, at 6003. In some embodiments, the method 6000 can further comprise: determining, based at least on the organizational information received from the one or more user devices, an organizational cohort that is most aligned with the organization, at 6004. In some embodiments, the method 6000 can further comprise: generating, based at least upon the organizational information and organizational cohort information stored in a database accessible by the computing device, a proxy profile associated with the organization and a baseline organizational entropy score, wherein the baseline organizational entropy score is generated based at least upon historical resource use data and current resource use data, at 6005.

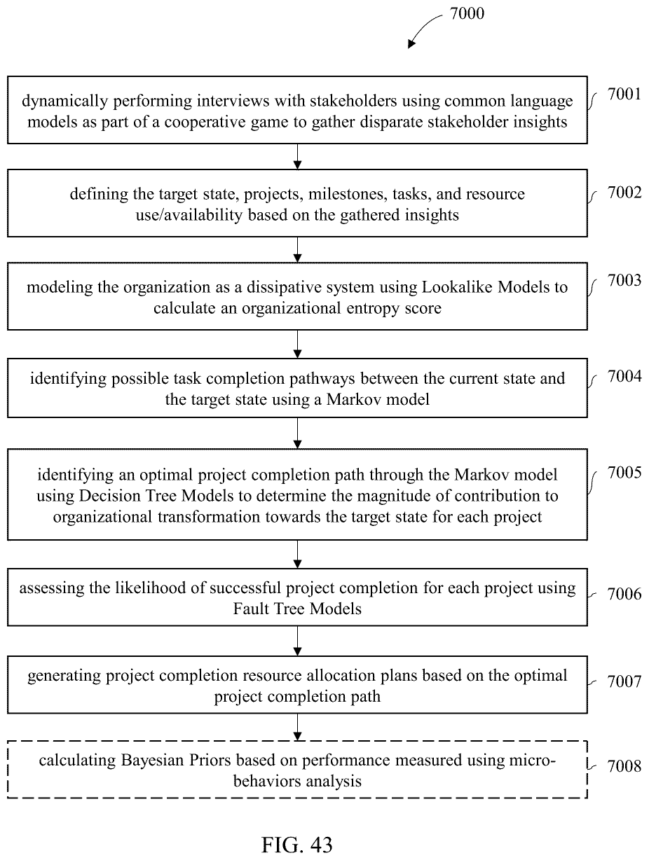

Referring now to FIG. 43, a method 7000 can be carried out by means such as the computing device 5000. The method 7000 can comprise: dynamically performing interviews with stakeholders using common language models as part of a cooperative game to gather disparate stakeholder insights, at 7001. In some embodiments, the method 7000 can further comprise: defining the target state, projects, milestones, tasks, and resource use/availability based on the gathered insights, at 7002. In some embodiments, the method 7000 can further comprise: modeling the organization as a dissipative system using Lookalike Models to calculate an organizational entropy score, at 7003. In some embodiments, the method 7000 can further comprise: identifying possible task completion pathways between the current state and the target state using a Markov model, at 7004. In some embodiments, the method 7000 can further comprise: identifying an optimal project completion path through the Markov model using Decision Tree Models to determine the magnitude of contribution to organizational transformation towards the target state for each project, at 7005. In some embodiments, the method 7000 can further comprise: assessing the likelihood of successful project completion for each project using Fault Tree Models, at 7006. In some embodiments, the method 7000 can further comprise: generating project completion resource allocation plans based on the optimal project completion path. In some embodiments, the method 7000 can, optionally, further comprise: calculating Bayesian Priors based on performance measured using micro-behaviors analysis, at 7008.

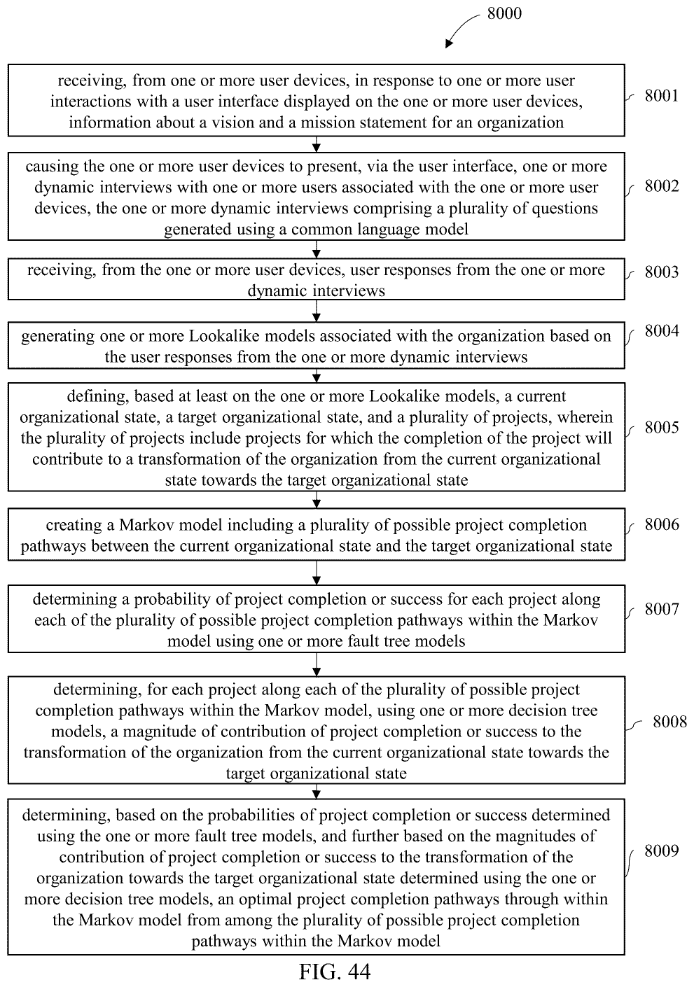

Referring now to FIG. 44, a method 8000 can be carried out by means such as the computing device 5000. The method 8000 can comprise: receiving, from one or more user devices, in response to one or more user interactions with a user interface displayed on the one or more user devices, information about a vision and a mission statement for an organization, at 8001. In some embodiments, the method 8000 can further comprise: causing the one or more user devices to present, via the user interface, one or more dynamic interviews with one or more users associated with the one or more user devices, the one or more dynamic interviews comprising a plurality of questions generated using a common language model, at 8002. In some embodiments, the method 8000 can further comprise: receiving, from the one or more user devices, user responses from the one or more dynamic interviews, at 8003. In some embodiments, the method 8000 can further comprise: generating one or more Lookalike models associated with the organization based on the user responses from the one or more dynamic interviews, at 8004. In some embodiments, the method 8000 can further comprise: defining, based at least on the one or more Lookalike models, a current organizational state, a target organizational state, and a plurality of projects, wherein the plurality of projects include projects for which the completion of the project will contribute to a transformation of the organization from the current organizational state towards the target organizational state, at 8005. In some embodiments, the method 8000 can further comprise: creating a Markov model including a plurality of possible project completion pathways between the current organizational state and the target organizational state, at 8006. In some embodiments, the method 8000 can further comprise: determining a probability of project completion or success for each project along each of the plurality of possible project completion pathways within the Markov model using one or more fault tree models, at 8007. In some embodiments, the method 8000 can further comprise: determining, for each project along each of the plurality of possible project completion pathways within the Markov model, using one or more decision tree models, a magnitude of contribution of project completion or success to the transformation of the organization from the current organizational state towards the target organizational state, at 8008. In some embodiments, the method 8000 can further comprise: determining, based on the probabilities of project completion or success determined using the one or more fault tree models, and further based on the magnitudes of contribution of project completion or success to the transformation of the organization towards the target organizational state determined using the one or more decision tree models, an optimal project completion pathways through within the Markov model from among the plurality of possible project completion pathways within the Markov model, at 8009.

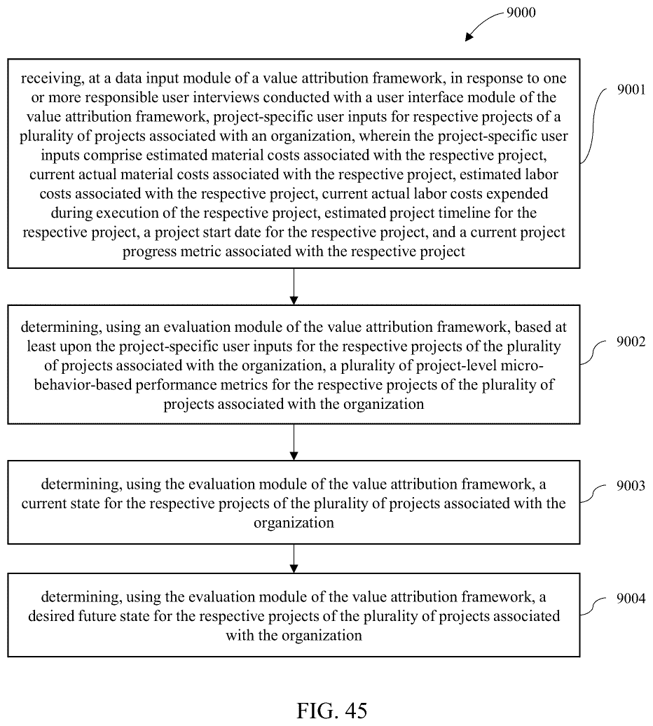

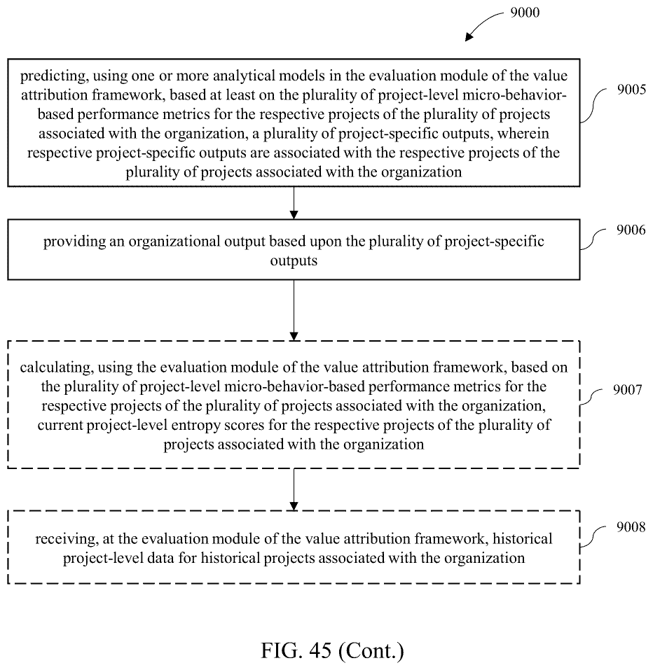

Referring now to FIG. 45, a method 9000 can be carried out by means such as the computing device 5000. The method 9000 can comprise: receiving, at a data input module of a value attribution framework, in response to one or more responsible user interviews conducted with a user interface module of the value attribution framework, project-specific user inputs for respective projects of a plurality of projects associated with an organization, wherein the project-specific user inputs comprise estimated material costs associated with the respective project, current actual material costs associated with the respective project, estimated labor costs associated with the respective project, current actual labor costs expended during execution of the respective project, estimated project timeline for the respective project, a project start date for the respective project, and a current project progress metric associated with the respective project, at 9001. In some embodiments, the method 9000 can further comprise: determining, using an evaluation module of the value attribution framework, based at least upon the project-specific user inputs for the respective projects of the plurality of projects associated with the organization, a plurality of project-level micro-behavior-based performance metrics for the respective projects of the plurality of projects associated with the organization, at 9002. In some embodiments, the method 9000 can further comprise: determining, using the evaluation module of the value attribution framework, a current state for the respective projects of the plurality of projects associated with the organization, at 9003. In some embodiments, the method 9000 can further comprise: determining, using the evaluation module of the value attribution framework, a desired future state for the respective projects of the plurality of projects associated with the organization, at 9004. In some embodiments, the method 9000 can further comprise: predicting, using one or more analytical models in the evaluation module of the value attribution framework, based at least on the plurality of project-level micro-behavior-based performance metrics for the respective projects of the plurality of projects associated with the organization, a plurality of project-specific outputs, wherein respective project-specific outputs are associated with the respective projects of the plurality of projects associated with the organization, at 9005. In some embodiments, the method 9000 can further comprise: providing an organizational output based upon the plurality of project-specific outputs, at 9006. In some embodiments, the method 9000 can, optionally, further comprise: calculating, using the evaluation module of the value attribution framework, based on the plurality of project-level micro-behavior-based performance metrics for the respective projects of the plurality of projects associated with the organization, current project-level entropy scores for the respective projects of the plurality of projects associated with the organization, at 9007. In some embodiments, the method 9000 can, optionally, further comprise: receiving, at the evaluation module of the value attribution framework, historical project-level data for historical projects associated with the organization, at 9008.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A method for organizational transformation from a current state to a target state, comprising:
dynamically performing interviews with stakeholders using common language models as part of a cooperative game to gather disparate stakeholder insights;
defining the target state, projects, milestones, tasks, and resource use/availability based on the gathered insights;
modeling the organization as a dissipative system using Lookalike Models to calculate an organizational entropy score;
identifying possible task completion pathways between the current state and the target state using a Markov model;
identifying an optimal project completion path through the Markov model using Decision Tree Models to determine the magnitude of contribution to organizational transformation towards the target state for each project;
assessing the likelihood of successful project completion for each project using Fault Tree Models;
generating project completion resource allocation plans based on the optimal project completion path; and
calculating Bayesian Priors based on performance measured using micro-behaviors analysis.

2. The method of claim 1, wherein the common language models are configured to adaptively refine interview questions based on stakeholder responses.

3. The method of claim 1, wherein the Lookalike Models are further configured to simulate various organizational scenarios to predict potential outcomes.

4. The method of claim 1, wherein the Decision Tree Models incorporate project value data to evaluate and compare project contributions to overall organizational transformation towards the target state.

5. The method of claim 1, wherein the Fault Tree Models are used to identify and mitigate potential risks associated with project completion.

6. The method of claim 1, wherein the Bayesian Priors are continuously recalibrated based on ongoing performance metrics and feedback.

7. The method of claim 1, further comprising:
analyzing data collected from stakeholder interviews to identify patterns and insights relevant to organizational transformation.

8. The method of claim 1, wherein the optimal project completion path through the Markov model is dynamically recalculated based on real-time data and changes in project variables.

9. The method of claim 1, further comprising:
using organizational historic project data to inform the Markov model and improve the accuracy of task completion pathway predictions.

10. The method of claim 1, wherein financial data of the organization is utilized to generate Bayesian Priors, enhancing the precision of resource allocation and project planning.

11. The method of claim 1, wherein Bayesian Priors are generated by integrating historical project performance data and financial metrics to predict future project outcomes and resource needs.

12. A method comprising:
receiving, from one or more user devices, in response to one or more user interactions with a user interface displayed on the one or more user devices, information about a vision and a mission statement for an organization;
causing the one or more user devices to present, via the user interface, one or more dynamic interviews with one or more users associated with the one or more user devices, the one or more dynamic interviews comprising a plurality of questions generated using a common language model;
receiving, from the one or more user devices, user responses from the one or more dynamic interviews;
generating one or more Lookalike models associated with the organization based on the user responses from the one or more dynamic interviews;
defining, based at least on the one or more Lookalike models, a current organizational state, a target organizational state, and a plurality of projects, wherein the plurality of projects include projects for which the completion of the project will contribute to a transformation of the organization from the current organizational state towards the target organizational state;
creating a Markov model including a plurality of possible project completion pathways between the current organizational state and the target organizational state;
determining a probability of project completion or success for each project along each of the plurality of possible project completion pathways within the Markov model using one or more fault tree models;
determining, for each project along each of the plurality of possible project completion pathways within the Markov model, using one or more decision tree models, a magnitude of contribution of project completion or success to the transformation of the organization from the current organizational state towards the target organizational state; and
determining, based on the probabilities of project completion or success determined using the one or more fault tree models, and further based on the magnitudes of contribution of project completion or success to the transformation of the organization towards the target organizational state determined using the one or more decision tree models, an optimal project completion pathways through within the Markov model from among the plurality of possible project completion pathways within the Markov model.

13. The method of claim 12, further comprising:
calculating, based on a plurality of project-level micro-behavior-based performance metrics for the respective projects of the plurality of projects associated with the organization, current project-level entropy scores for the respective projects of the plurality of projects associated with the organization.

14. The method of claim 12, further comprising:
receiving historical project-level data for historical projects associated with the organization.

15. The method of claim 14, wherein the historical project-level data comprises one or more of: initially estimated material costs associated with respective historical projects, actual material costs associated with the respective historical projects, initially estimated labor costs associated with the respective historical projects, actual labor costs expended during execution of the respective historical projects, initially estimated project timeline for the respective historical projects, an actual project start date for the respective historical projects, or an actual project end date for the respective historical projects.

16. A method comprising:
receiving, at a data input module of a value attribution framework, in response to one or more responsible user interviews conducted with a user interface module of the value attribution framework, project-specific user inputs for respective projects of a plurality of projects associated with an organization, wherein the project-specific user inputs comprise estimated material costs associated with the respective project, current actual material costs associated with the respective project, estimated labor costs associated with the respective project, current actual labor costs expended during execution of the respective project, estimated project timeline for the respective project, a project start date for the respective project, and a current project progress metric associated with the respective project;
determining, using an evaluation module of the value attribution framework, based at least upon the project-specific user inputs for the respective projects of the plurality of projects associated with the organization, a plurality of project-level micro-behavior-based performance metrics for the respective projects of the plurality of projects associated with the organization;
determining, using the evaluation module of the value attribution framework, a current state for the respective projects of the plurality of projects associated with the organization;
determining, using the evaluation module of the value attribution framework, a desired future state for the respective projects of the plurality of projects associated with the organization;
predicting, using one or more analytical models in the evaluation module of the value attribution framework, based at least on the plurality of project-level micro-behavior-based performance metrics for the respective projects of the plurality of projects associated with the organization, a plurality of project-specific outputs, wherein respective project-specific outputs are associated with the respective projects of the plurality of projects associated with the organization; and
providing an organizational output based upon the plurality of project-specific outputs.

17. The method of claim 16, further comprising:
calculating, using the evaluation module of the value attribution framework, based on the plurality of project-level micro-behavior-based performance metrics for the respective projects of the plurality of projects associated with the organization, current project-level entropy scores for the respective projects of the plurality of projects associated with the organization.

18. The method of claim 16, further comprising:
receiving, at the evaluation module of the value attribution framework, historical project-level data for historical projects associated with the organization.

19. The method of claim 18, wherein the historical project-level data comprises one or more of: initially estimated material costs associated with respective historical projects, actual material costs associated with the respective historical projects, initially estimated labor costs associated with the respective historical projects, actual labor costs expended during execution of the respective historical projects, initially estimated project timeline for the respective historical projects, an actual project start date for the respective historical projects, or an actual project end date for the respective historical projects.

20. The method of claim 18, wherein the one or more analytical models in the evaluation module of the value attribution framework comprise one or more of: a dissipative structure model, a lookalike model, a Bayesian priors model, a fault-tree analysis model, a decision-tree analysis model, a common language model, a large language model, or a cost-benefit attribution logical analysis model.
